(19) United States
(12) Patent Application Publication
(10) Pub. No.: US 2007/0005477 A1
(43) Pub. Date: Jan. 4, 2007

(54) INTERACTIVE ASSET DATA VISUALIZATION GUIDE

(76) Inventor: Pauline McAtamney, Geraldine (NZ)

Correspondence Address: MORGAN & FINNEGAN, L.L.P., 3 WORLD FINANCIAL CENTER, NEW YORK, NY, 10281-2101, US

(21) Appl. No.: 11/425,927

(22) Filed: Jun. 22, 2006

Related U.S. Application Data
(60) Provisional application No. 60/693,864, filed on Jun. 24, 2005.

(51) Int. Cl. G06Q 40/00

(52) U.S. Cl. 705/35

(57) ABSTRACT

A data visualization method for guiding investment based on market data involves graphically displaying market-related information by arranging a plurality of regions, each representing a component of a universe, in one of multiple interrelated areas, and selecting a reference position based upon a user preference for indicating to a user the advantageousness of investing in a particular component of the universe based upon position of the region corresponding to the particular component relative to the reference position.

### CROSS REFERENCE TO RELATED APPLICATIONS

This application is related to and claims the benefit of priority, pursuant to 35 U.S.C. §119(e), U.S. Provisional Application Ser. No. 60/693,864, filed Jun. 24, 2005, the entirety of which is incorporated herein by reference as if fully set forth herein.

### BACKGROUND OF THE INVENTION

Dynamic changes in technology have introduced improvements to the investment management industry allowing real-time, data manipulation, resulting in more informed decisions. The investment process requires complex information to be analyzed, traditionally performed by an investment professional known as an active funds manager (or “manager”). Increasingly, new computer driven index tracker funds (or exchange-traded funds “ETF”) and quantitative computer-driven program trading have been used, each of these automatically making investment allocations. In the past, professionals invested intuitively, buying what they evaluated to be attractive within their “universe,” with the objective of outperforming their nominated benchmark, since outperforming the benchmark would bring in new funds to manage and the associated fees.

Standards for operational technology have developed and improved but there has been no complement on the analytical side, which is still primarily left to the intelligence of the manager. The challenges voiced in 1987 post “Black Monday” remain the same, opportunities for merging the intelligence of the industry into software application remains to be achieved. The industry is now in consolidation after 20 years of rapid growth with mutual funds controlling a large segment of the individuals' wealth. The Investment Company Institute (“ICI”) estimates that 94.9 million individuals own a Mutual Fund and that 54.3 million US households owned mutual funds as of May 2002, which is 49.6% of all US households compared to 5.7% in 1980 (ICI vol. 11 no. 5, Oct. 2002). Equities funds were the most common 4765 funds out of 8250 or 57% of mutual funds available in the USA at the year-end 2002. The combined assets of the US mutual funds was $7.414 trillion by the end of 2003, up from $3.526 trillion at the end of 1996 according to the ICI's official survey of the mutual fund industry. Equity funds constitute 49.7% of all mutual funds reflecting changes in the allocation of assets at end of 2003, representing an estimated 26% of the US equity market.

Software has increased the speed at which data can be analyzed by the professionals, due to databases allowing cross-sectional time analysis of assets and the risks associated with the investments. Similarly, individuals can do so using software programs like Smart Money's “Map of the Market”.

Mutual funds are a product customized by a investment style or by country, sold to audiences by the defined styles and risks, tailored to get the best performance from their investment insights within a specified product, irrespective of cycle or returns- positive or negative through the cycle. Outperforming the index makes money for the industry, with the skill of stock picking resting, to a large degree, on the professional manager's judgment. Thus, an intelligent professional is needed for a mutual fund to out-perform the market.

Portfolio performance depends on the selection of assets class and often categorizes securities to one of the following styles: value, growth, and income to name a few. Securities are also defined by the ratios meeting the criteria defined below:
Growth Stock is one that earns higher returns than other stocks of equivalent risk. Although a firm might be recognized as a growth company, its price may already reflect those growth expectations, and the stock will earn only the risk-adjusted required return.
Defensive Stock is a stock that will not decline as much as the market when the overall market declines. The returns of defensive stocks have a low correlation with the returns of the market. Thus, defensive stocks are characterized by having low beta values.
Cyclical Stock is a stock with rates of return that will change more than the changes in the return on the overall market. These are stocks with betas greater than one, indicating more than a one-to-one reaction to changes in the return on the market

### SUMMARY OF THE INVENTION

I have developed an invention that provides advantages through a data visualization approach for guiding investment. Aspects of the approach represent improvements in the field of data visualization, particularly in applications rinvolving visualization of financial data and provide advantages over and above visualization approaches in the prior art.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 shows an example asset sphere as described herein;

FIG. 2 shows an example alternative variant oif the asset sphere of FIG. 1;

FIG. 3 shows an example hierarchical structure and level of display fields for use in an example implementation of an asset data visualization guide;

FIG. 4 shows an example embodiment of a main asset wheel;

FIG. 5 shows an example Equities wheel;

FIG. 6 shows an example Cash wheel;

FIG. 7 shows an example Industry wheel;

FIG. 8 shows an example Price Wheel;

FIG. 9 shows an alternative example Price Wheel;

FIG. 10 shows an alternative example wheel;

FIG. 11 shows a further alternative example wheel;

FIG. 12 illustrates one example schematic representation of a configuration of a computer system suitable for creating an implementation according to the present invention;

FIG. 13 shows a further example implementation;

FIG. 14 is an example of a “Type A” chart;

FIG. 15 shows a simplified implementation example;

FIG. 16 shows an example of a dual universe approach; and

FIG. 17 illustrates an example variant including a representative user control ring embedded within the chart.

### DETAILED DESCRIPTION

For ease of understanding, this invention is conceptualized as part of a sphere with rings or wheels, however, it can be implemented in any number of ways. Of course, as this will likely be implemented on a computer system, geometric shapes are irrelevant and one can implement this invention in a number of visual representations, including, for example, in a series of hierarchical drop down lists. Additionally, as this may be implemented in the form of a physical model, one may do so by employing any number of shapes or structures electromechanically through a series of gears or interconnected shapes for example. The essence of this invention is not the actual or conceptual shape it takes, but rather, the interrelationship between the parts and how the selection of one item or a certain user input affects the next step in the use of this invention.

In addition, although the description herein contains references to particular colors, it should be understood that there is no particular importance to the choice of any particular color mentioned herein. Indeed, the selection of particular colors is arbitrary, in the sense that colors are intended to be used to represent relationships and provide visual correlation and differentiation. Thus, reference to “blue” in a particular description could just as arbitrarily have been “green” or some other color, so long as consistency is maintained in accordance with the description herein. Stated another way, while an important aspect for some implementations is color, the use of colorper se is not critical to the invention.

The purpose and advantages of the present invention will be set forth in or may be apparent from the description that follows, or by practice of the invention. Additional advantages of the invention can be realized and attained by the methods and systems in the written description and claims hereof, as well as from the appended drawings.

In summary overview, the subject interactive asset data visualization guide (or “guide”) described herein is concerned with providing an easy to interpret graphical interface so that a user can graphically see, or “visualize” the risk and direction of the particular assets based upon the size and position on the GUI.

In overvierw, the approach can be described, in a simplified form, with reference to three interrelated charts. Through use of these charts the a “mountain” of data can be presented, and hence graphically visualized, saving time necessary to analyze data. This approach provides the ability to turn data into a hierarchically interrelated group of pictures that enable faster understanding of the hierarchy and the values associated with each component of the hierarchy, which, in many cases will illustrate a user defined universe. It facilitates presentation of the data in a factual, impartial manner while enabling the user to quickly and easily identify the importance of each component within the hierarchy, relative to others and relative to the total. In short, approaches using the invention provide a graphical vehicle for dynamically presenting interrelated multi-dimensional data in a concise, flexible format.

Using the approach, (in the following examples represented as charts) a user is enabled to see a picture of the whole hierarchy in one visual, along with the relative importance of each component of the hierarchy, ranked to user's criteria. Moreover, the approach can be used to filter information and/or “drill down” into components or subcomponents of the hierarchy. The approach can be used to graphically show proportion and order, through numerical values attached to each component. It can also be used to visualize the size and position of those values under different scenarios.

Moreover, in the case of sphere, oval or circle-based chart implementations the center can define the input and, based upon the interrelationships that define the hierarchy, the chart can display the output. Conceptually, the approach resembles, in some respects, a building having different levels, each containing different rooms. Through navigation within the hierarchy, different information is presented, while maintaining the interrelationships, thereby empowering the user to make informed decisions.

Visualization is made possible due to the data's position, magnitude and the color of the categories contained within a chart. It transforms complex data such as used in the financial services industry (e.g., asset class, asset, asset subcomponent, etc.), real estate (e.g. state, county, town, section, street, lot) or any system that can be represented as a hierarchy into a visual picture, enabling a user to better understand the information as a whole or simply increase the user's understanding of the components and their position relative to the other components within the user defined universe with the additional ability to ranked components to the user's criteria.

Example implementations of the asset data visualization guide are made up of one or more of three charts, a “Type A” chart called a “price wheel”, a “Type B” chart called a “market wheel”, and a “Type C” chart called a “Clock”. These charts make up what is collectively referred to herein as an example of an “Asset Sphere”. In addition, these three charts can be interacted with together or independently. The charts enable a user to define a universe and, based upon certain relationships, the charts will position data relating to that universe into embedded formulae associated with the universe, and the rank the components relative to user inputaccording to the user's requirements.

These charts generally have three functions; 1) present a picture of the hierarchy, with the components broken out by sectors and sub sectors within the categories, 2) position each component within the hierarchy structure into specified value ranges, and 3) controls the positioning of visulals representing the data according to the user's criteria and/or notification positions.

The charts use multiple notifications to highlight the importance of certain data relative to the total and/or according to user-specified criteria. The relationship among subcomponents of the overall data can be displayed relative to total data graphically in, for example a sphere, oval or circular approach, as arcs where the size of an individual arc is reflective of its relationship to its “peer” subcomponents or the whole. In addition, in some implementations, color can be used to provide further information, with such an approach, an element is genrally assigned one color in the first level of a hierarchy and that color is maintained for all subcomponent of that element, and even for their sub-subcomponents, theerby maintaing a visual connection to the element as a whole. Moreover, the data can be positioned into ranges. A range may be of any value, increasing or decreasing and both can again be used to reflect the contribution of the components to the hierarchy as a whole. Still further, components can be viewed relative to a one or more “notification” positions. In this manner, the ordering can be used to reflect the users input relative to a notification point, and, consequently, its importance to the hierarchy.

In some implementations a “noon” position is conceptually used along with the concept of “proximity to the center”, with the farther away an element is from each (in a specified manner) the less attractive it will be under the user's criteria and the less important it wil be with respect to the hierarchy as a whole. For example, in the context of real estate, if the center is reflective of a state itself, e.g. Texas, moving outward would reflect a passage into a component denoting county, followed by town, followed by section of town, followed by street and ultimately individual property lots. In each case, the outward movement into a further subcomponent would take one into a less “influential” component of those components closer to the center. Moreover, by positioning of individual components within the categories, and the position of the categories relative to the universe requested, by specifying certain notifications, the categories nearest to the notifications will be more favorable relative to the user's criteria. The charts visualize the significance of a segment and its relevance to both the user's criteria and within the hierarchy. In other words, if the notification is value growth as reflected in selling price inflation, this approach allows one to take the data reflective of individual sales which otherwise might be two scarce to individually analize and visualize which counties might be more desirable from an investment perspective.

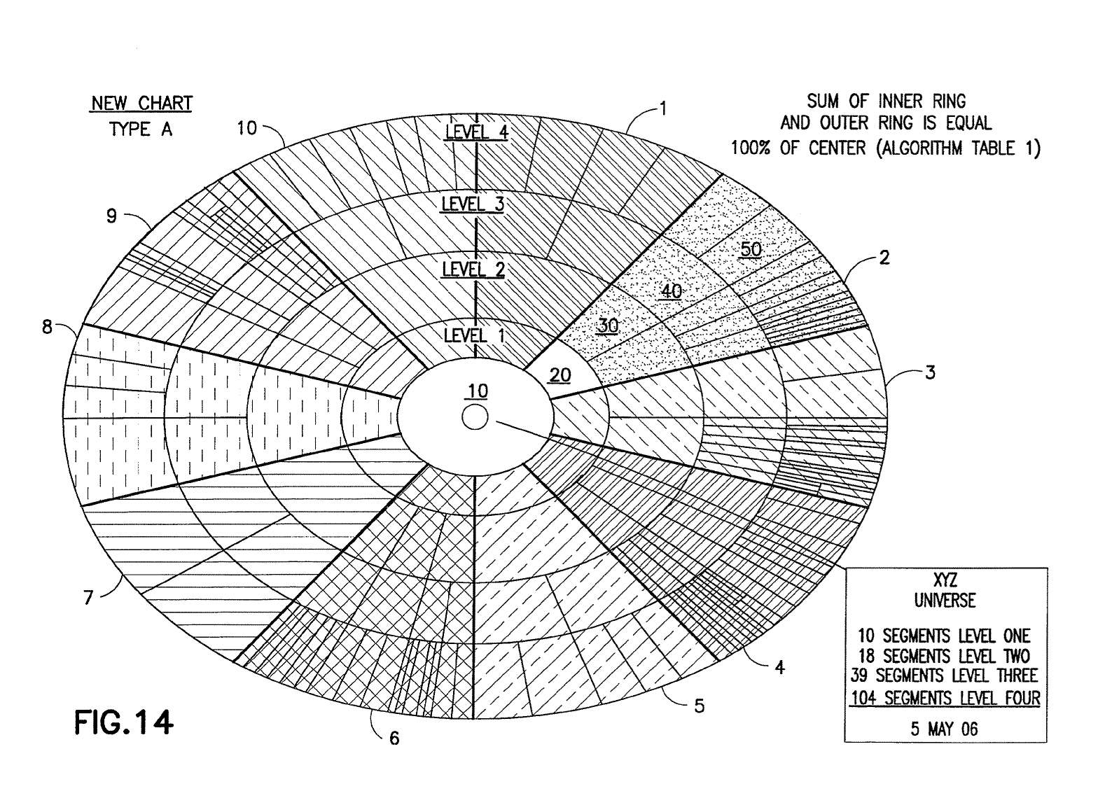

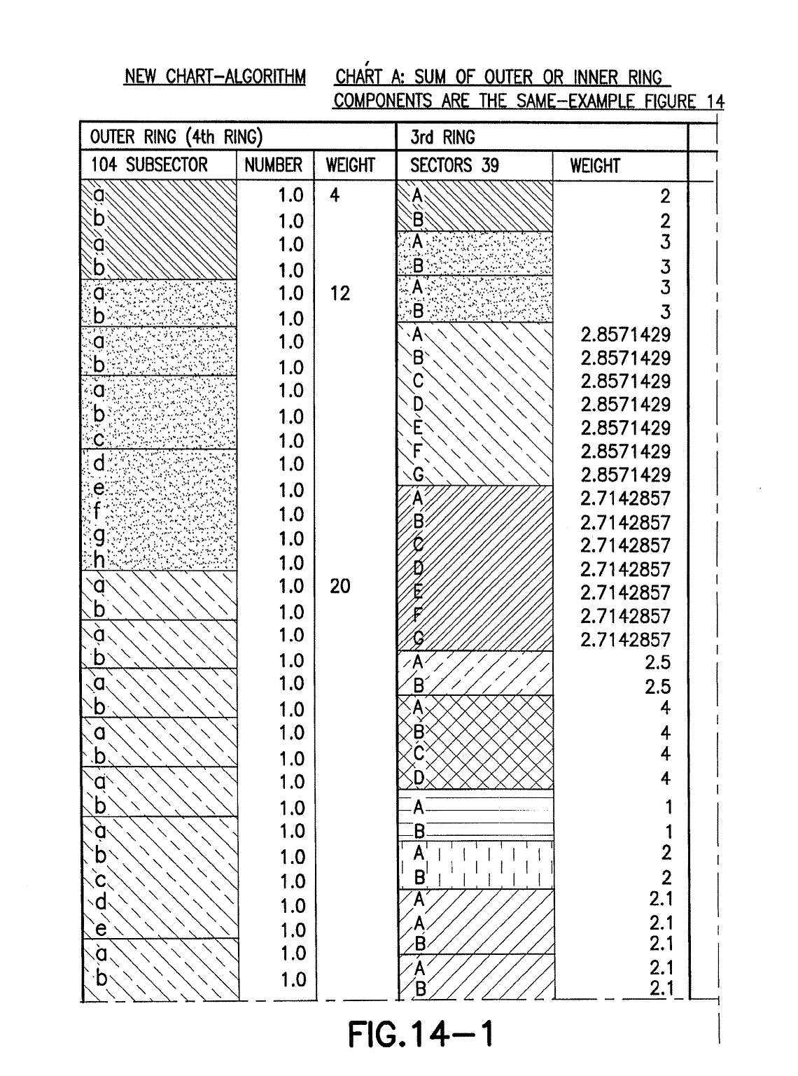

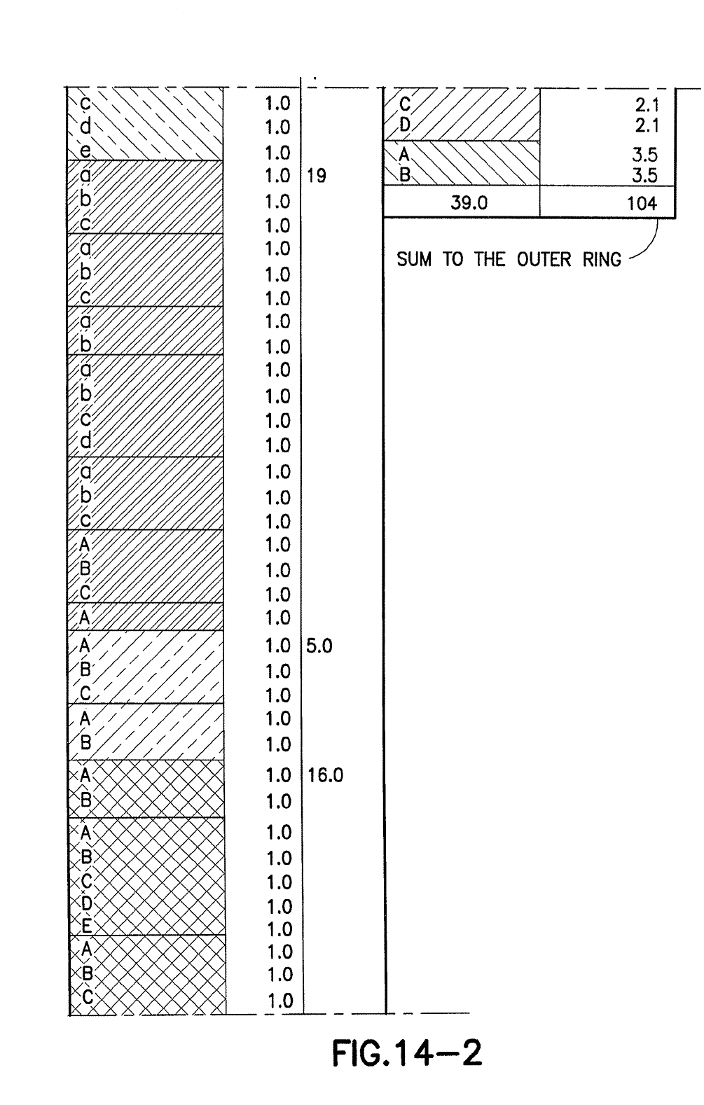

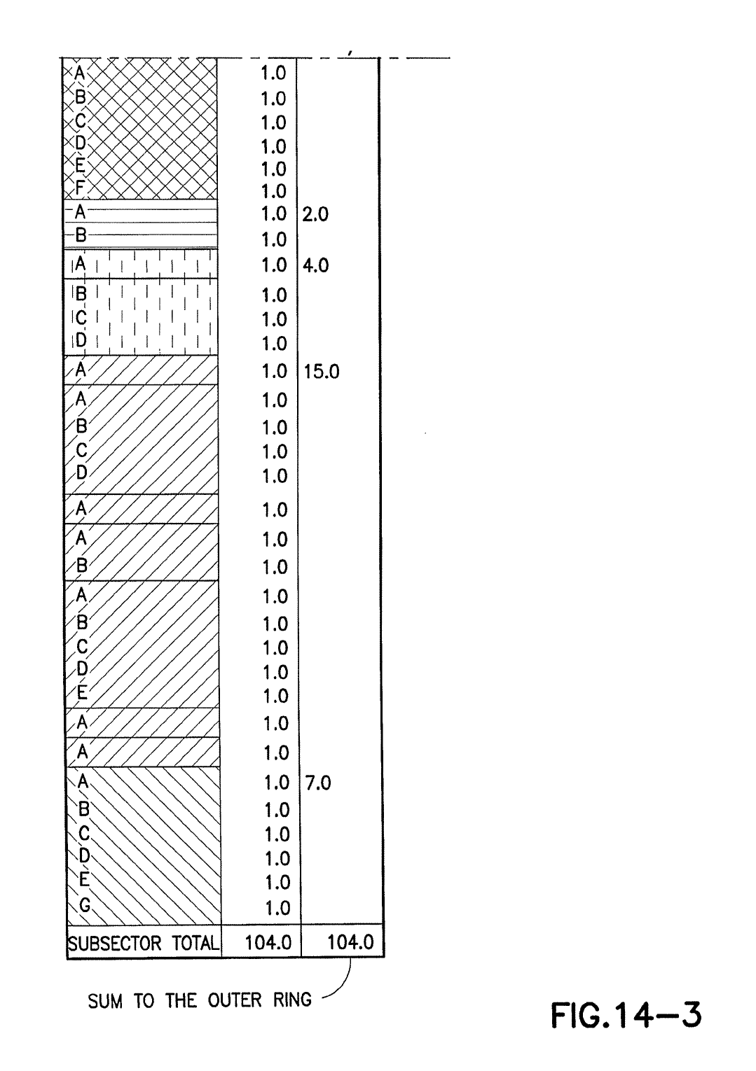

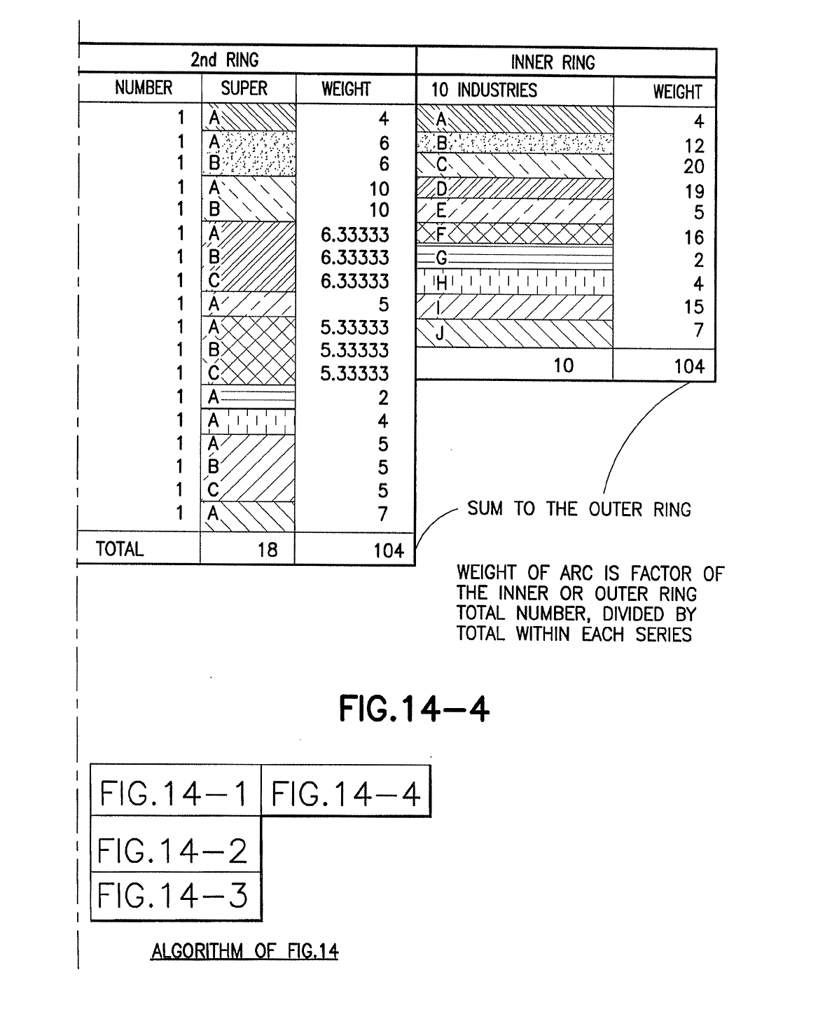

FIG. 14 is an example of a “Type A” chart, with the algorithm used to visualize the arc components being shown in the associated table. This algorithm enables the information to be positioned and the data displayed to the user's requirements for interrogation by the user, through the embedded notifications contained within the chart. Specifically, FIG. 14 illustarates, in simplified form, an example of a hierarchy. The center 10 defines a hierarchy of the universe “XYZ”. This universe is made up of 4 levels each of respectively smaller aspects of the whole with the ten basic components represented as segments in the ring 20 of level one, those being made up of eighteen further components that are illustrated as segments in the ring 30 of level two, those, in turn, being made up of 39 further components that are illustrated as segments in the ring 40 of level 3, and finally those being broken down further into 104 further components that are illustrated as segments in the ring 50 of level 4. Thus, all components (and their respective constituents and sub-constituents) are visualized within this hierarchy, with the center and the total at each level representing 100% of the universe.

The “Type A” chart, uses an algorithm to determine the relative magnitude of an arc throughout the rings relative to a category group. Each ring is the sum of the inner (or, in an reverse representation, outer ring), divided by the number of components within each of the respective categories of the adjacent ring, to determine the value of that ring. Each ring's total is the same as the inner or outer ring depending on which ring has been used. The color of each segment identifies the categories within the rings and is maintained throughout the charts and levels.

In this example, summing is to the outer ring's total value, in this case equaling 104. Therefore each ring's value is the sum of its outer ring. For example level 4 of the outermost ring (50) has categories that have been divided by the ring 40 of level 3 categories to derive the level 3 values in the ring 40. Thus, although each segment within each category may have a different value, they collectively sum to the total of the level 4 ring 50. All rings are ultimately grouped into categories of the ring 20 of level one. In this example there are 10 categories, represented as segments, and therefore there are 10 arc's, each represented with individual unique colors that are maintained for their respective constituents and sub-constituents thoughout the rings. Ring 50 contains 104 segments and ring 40 has 39 segments, yet both have 10 categories, representing the 10 segments of the inner ring 20.

The components within ring 40 are similarly divided into categories according to those of ring 20, with the ring being equal to the sum of ring 50, e.g. level 4 such that arc 1, has 4 segments, and arc 1 of level 3 has 2 components, therefore 4 divided by 2 equals 2, and this represents the value for the two segments of arc 1 in ring 40. This calculation is performed for all the rings that are categories within this universe.

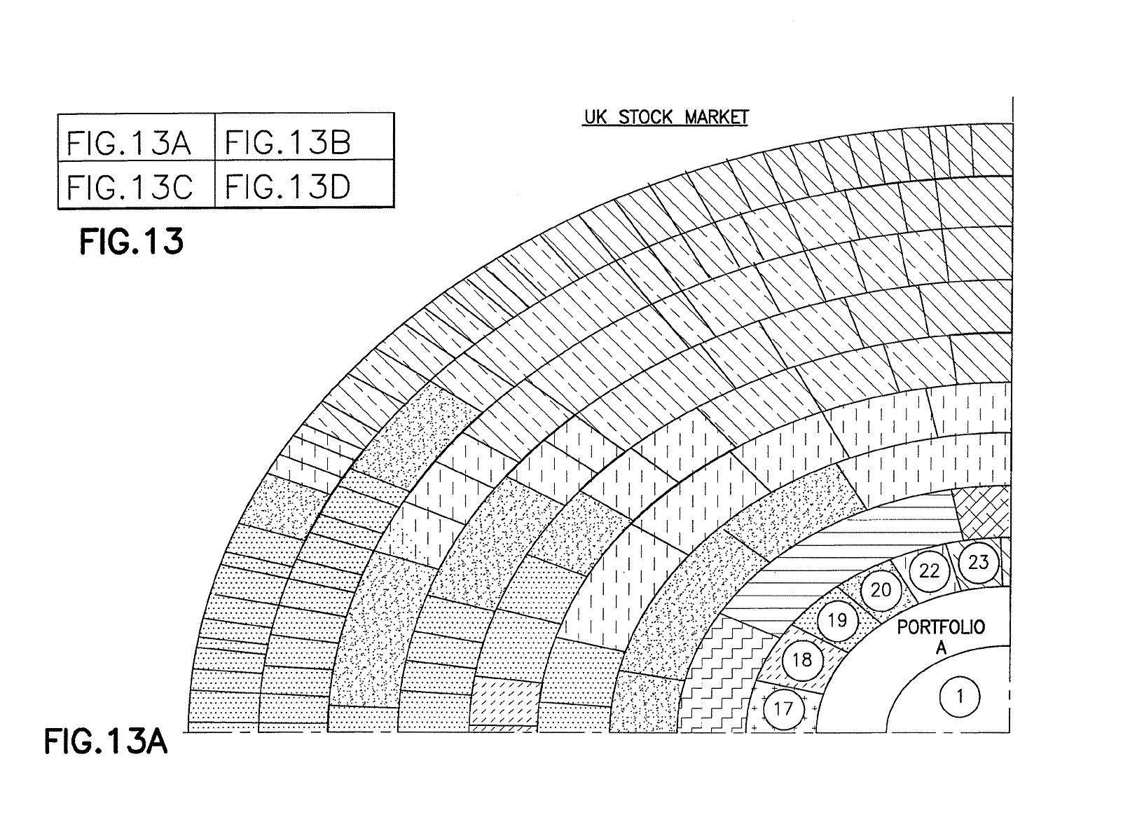

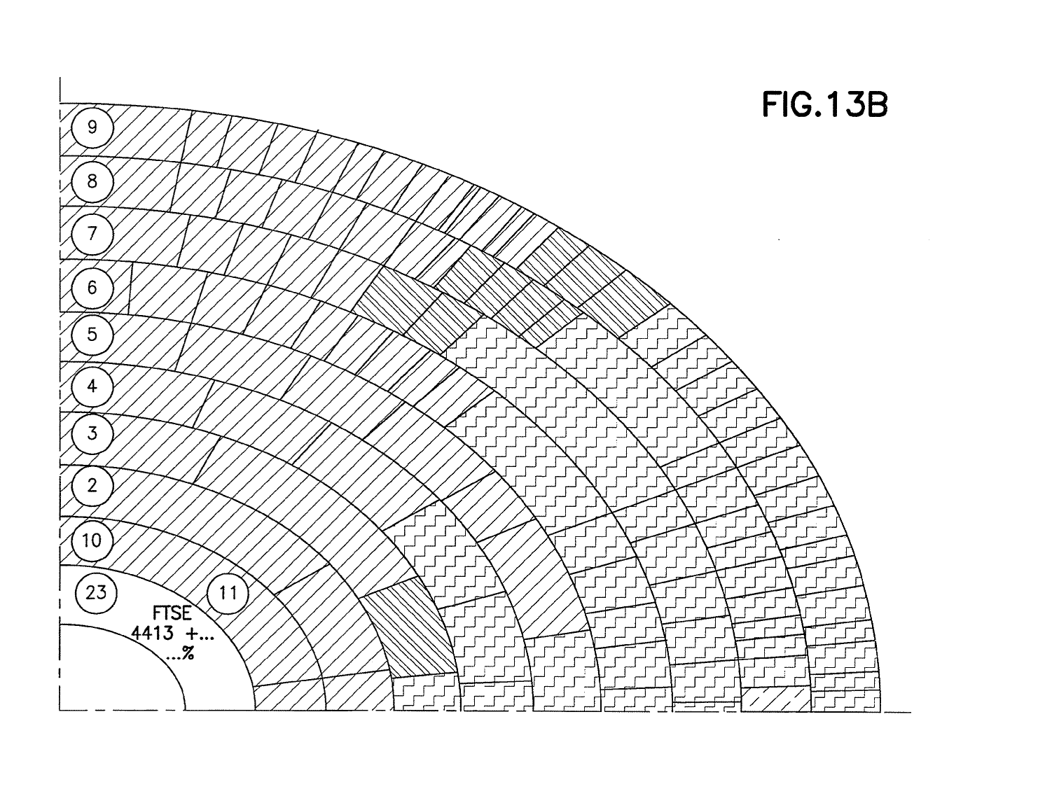

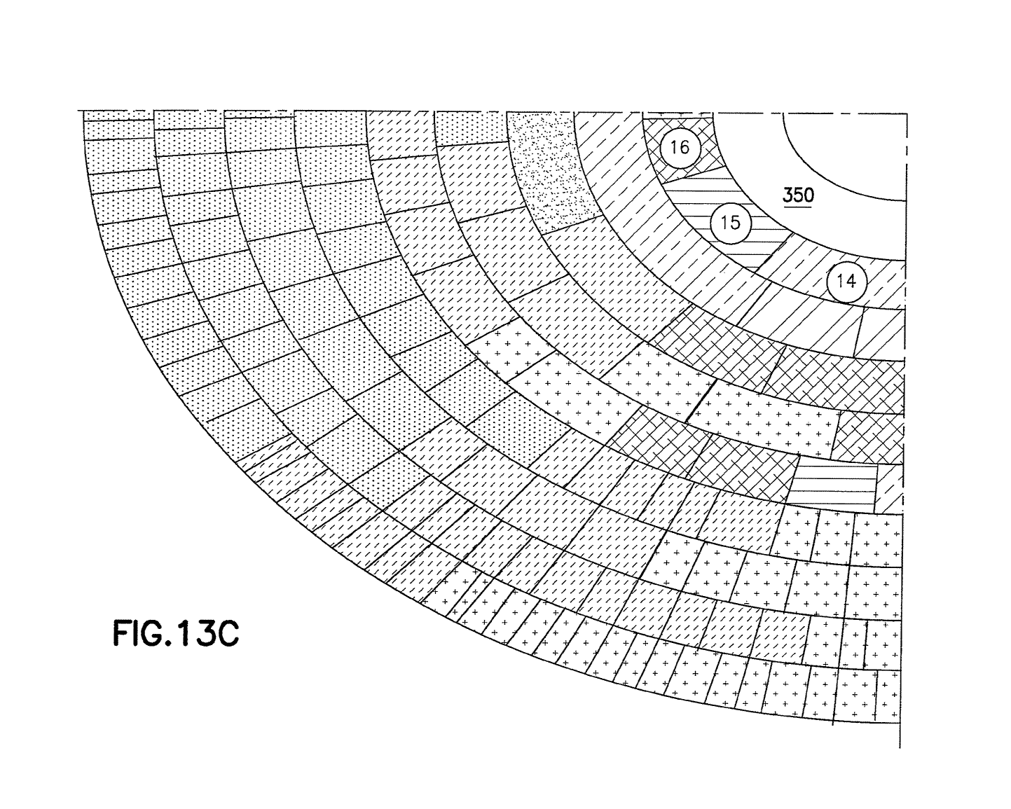

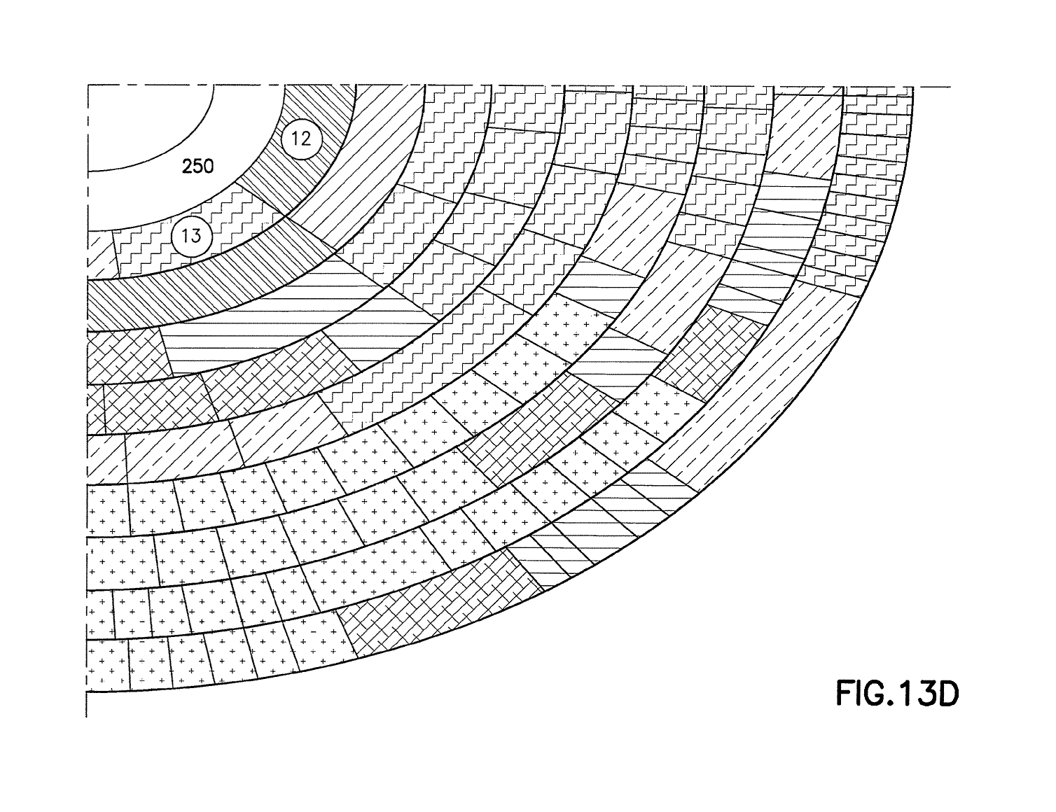

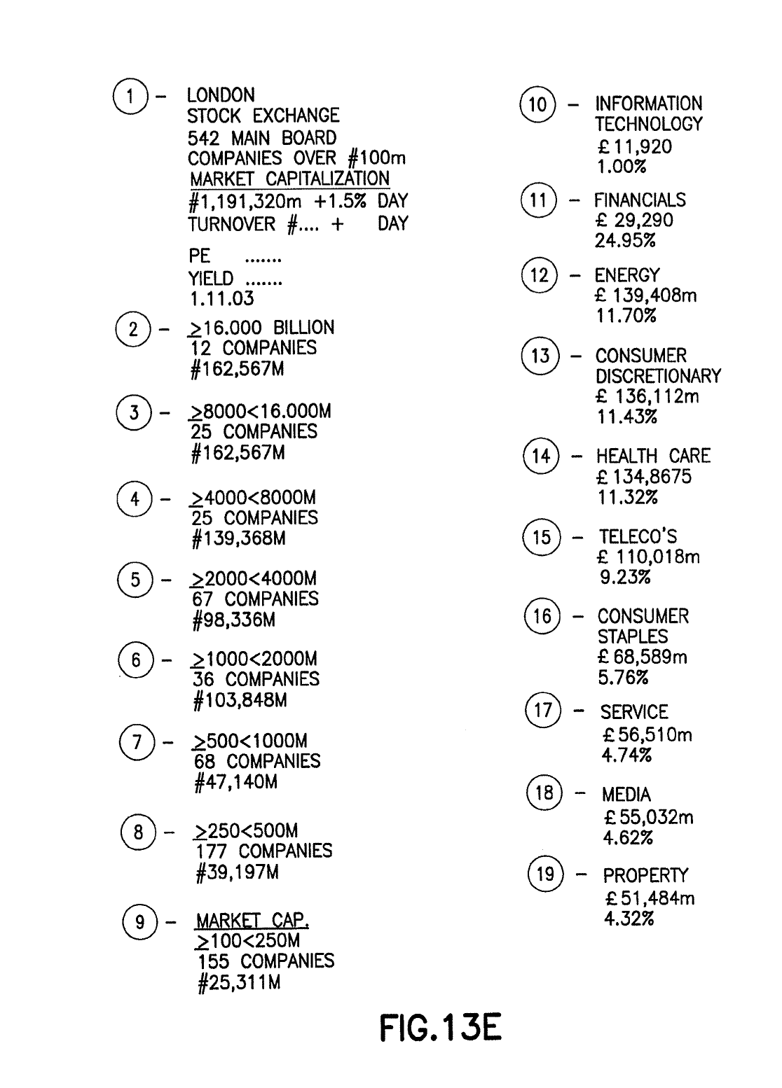

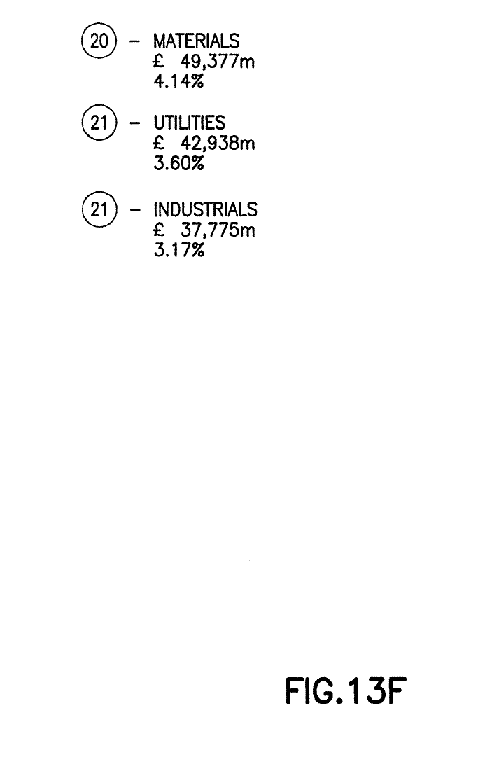

At this point it is important to note that, for various reasons, it may be desirable to not display a particular arc or level. Nevertheless, the relationships will be maintained so that the arcs or rings that are visualized will properly reflect and represent the percentage of the inner categories throughout the chart Referring now to the example of FIG. 13, which illustrates an example implememtation, Financials (arbitrarily designated red) represent 24.9% of the chart. Using this approach, because each component of Financials is of the same color, one can immediately see the displacement of financials throughout the chart. In this example, the algorithm represents the actual value of each segment for the series for each ring. The sum of the individual segments or the sum of the categories (identified by color) equals 100% of the center value.

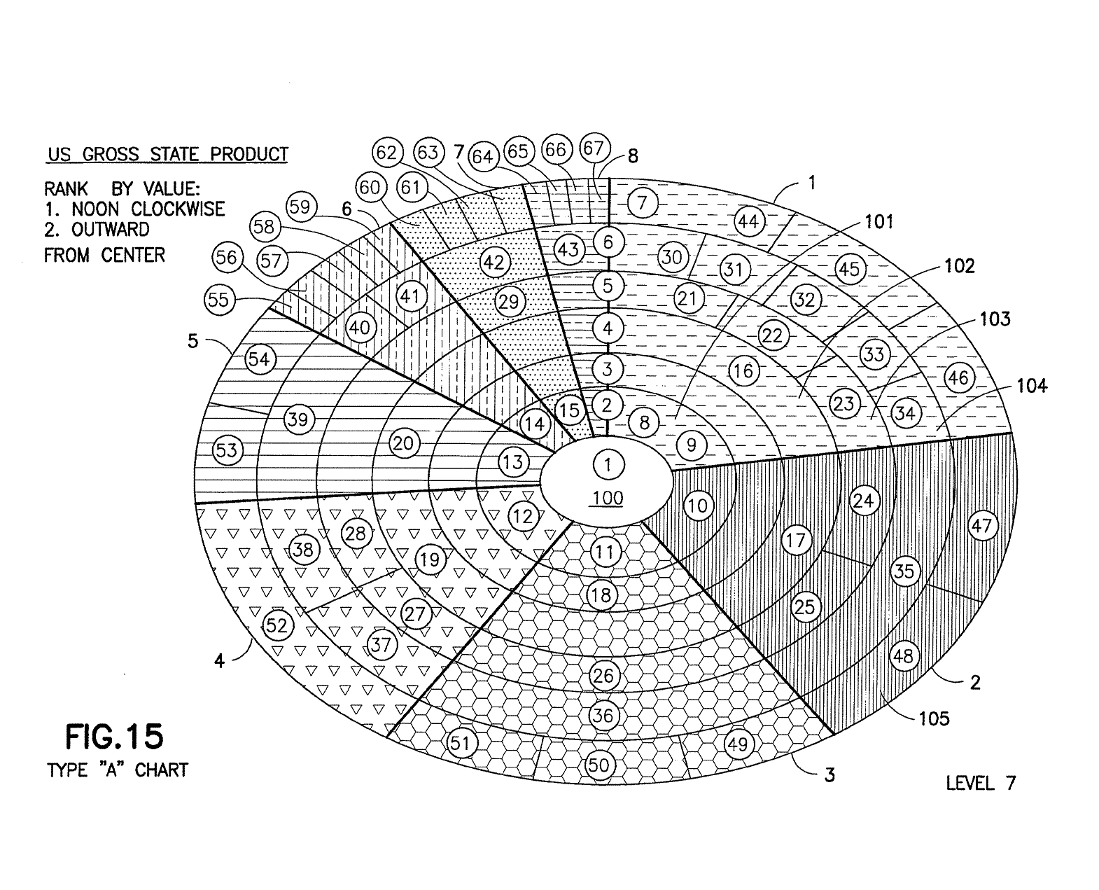

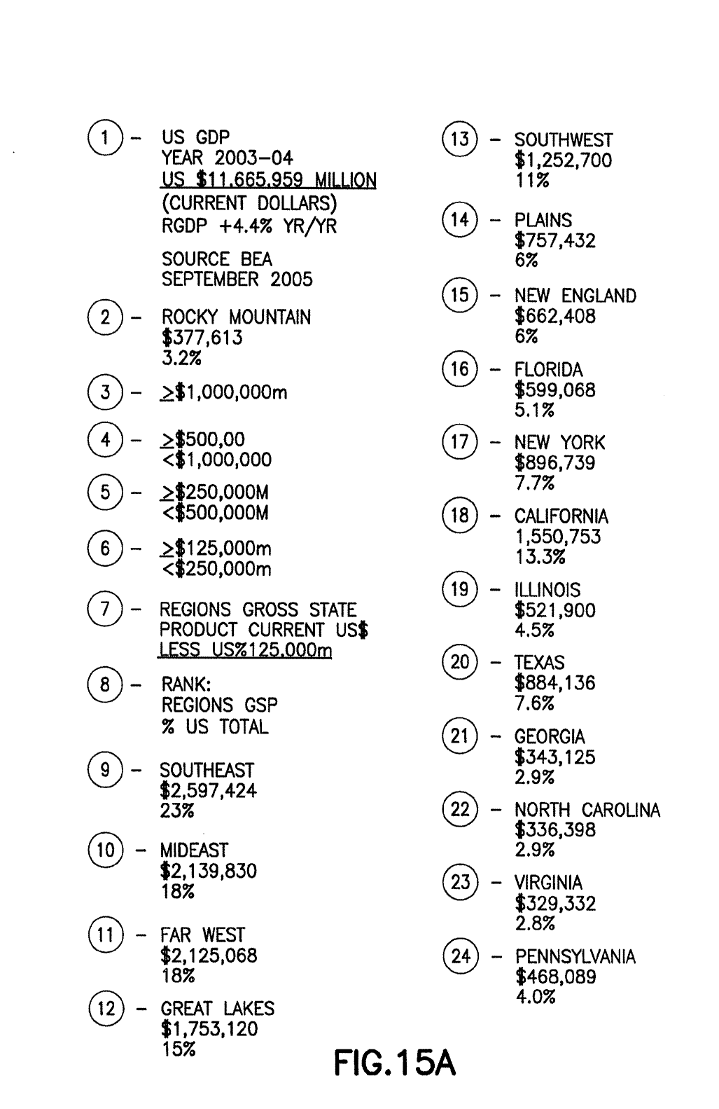

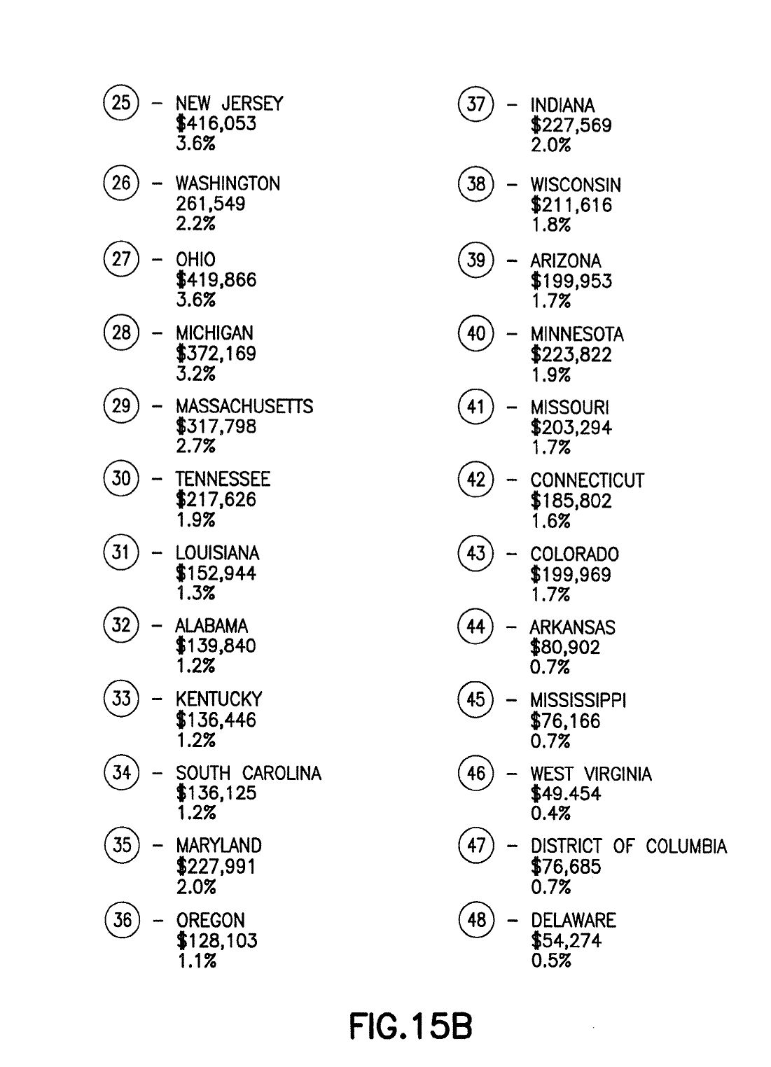

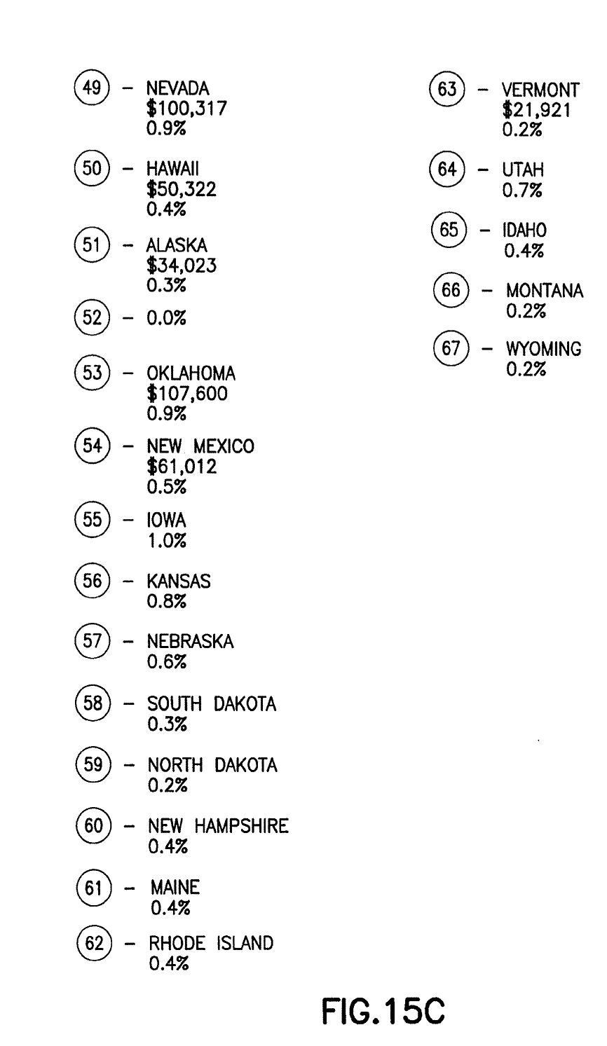

FIG. 15 is another representative example implementation. The components are visualized within two hierarchy systems, one by value and one by of physical location. The universe in this example is the US and is positioned in the center representing 100% of the universe requested, the chart displays all the States within the US. The chart uses concentric rings to show the components within a range of values. Each state has been postioned into its respective value range; each ring reduces in value reflecting a reduced contribution to the US as a whole and is graphically viewed further from the center.

This chart gives context to the size of each State and the location within the United Sates.

In this example, the value used is “Gross State Product” and the arcs are grouped to reflect the 8 inner category locations. Referring to arcs, the number 1 contributor, is color coded and positioned starting at noon, reflecting that it is largest and represents 23% of the center value and proportionally represents 23% of the chart. The arcs thereafter reduce in size as one moves clockwise around the chart. Ring 101 contains the states that have the largest value within the respective value ranges. For example only one State has a value within the inner value range, and represents the largest state by value. Ring 102 has 4 states within the value range, and so on. The color and position of each State within the value ranges give a clear understanding as to the relevance of each segment to the other segments and to the total. In some implementations, the individual segments can be drilled into. Thus, in this particular example, a user can drill into each State, for example by clicking on a segment representing that State. In such a case, a new chart would replicate only the selected state, positioning it in the center and displaying the category components making up that State within a value range, for example, with the magnitude representing each county's value within the that state. This enables multidimensional views of the United States, by value, location, and user criteria such that:

1. The size of the categories are shown relative to each other within the value ranges, the further away from the center indicating lesser importance to the center;

2. The magnitude of the categories represents the size or value of the arc; and

3. The position of the individual arcs relative to noon such that, clockwise movement away from noon represents a smaller contribution.

As appropriate or desired, a particular chart can be configured to include user controls to enable them to rank and define the chart. These controls are referred to herein as the “control rings” and can be embedded in the chart. These controls or control rings mechanically position data to the user's requirements when an input is selected. The control rings can be displayed or not and can be embedded within the chart or contained in a legend outside of the chart in such a manner as would allow a user to select or input as desired.

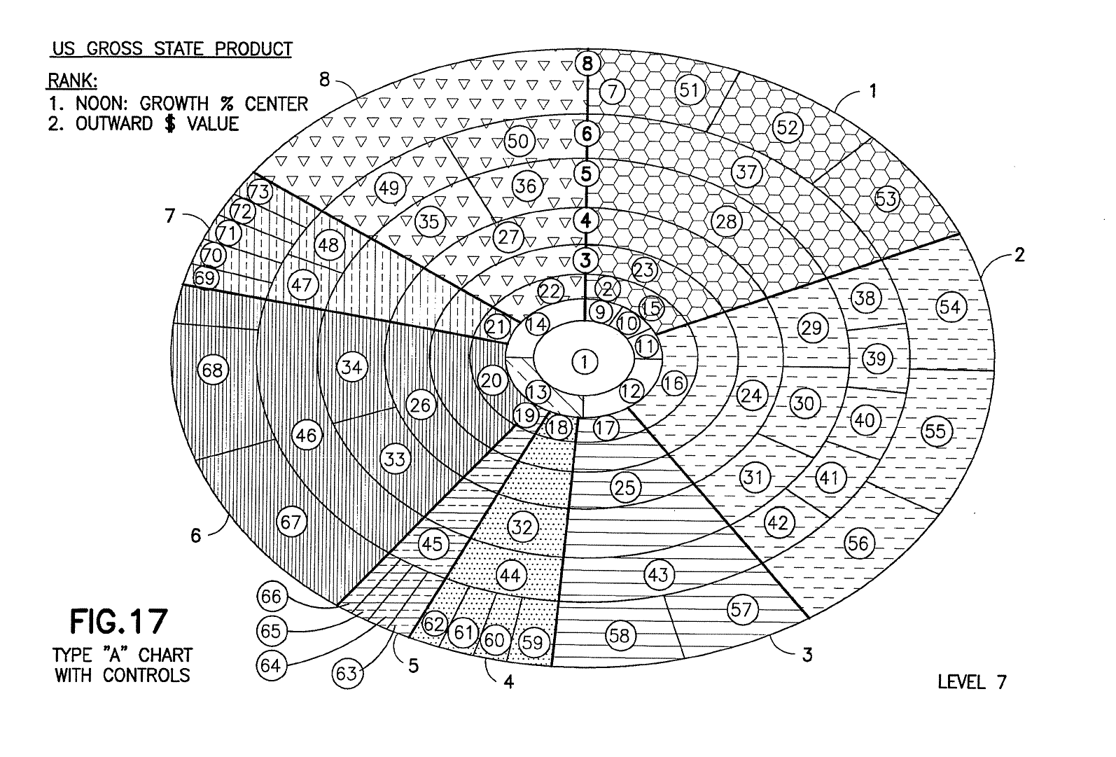

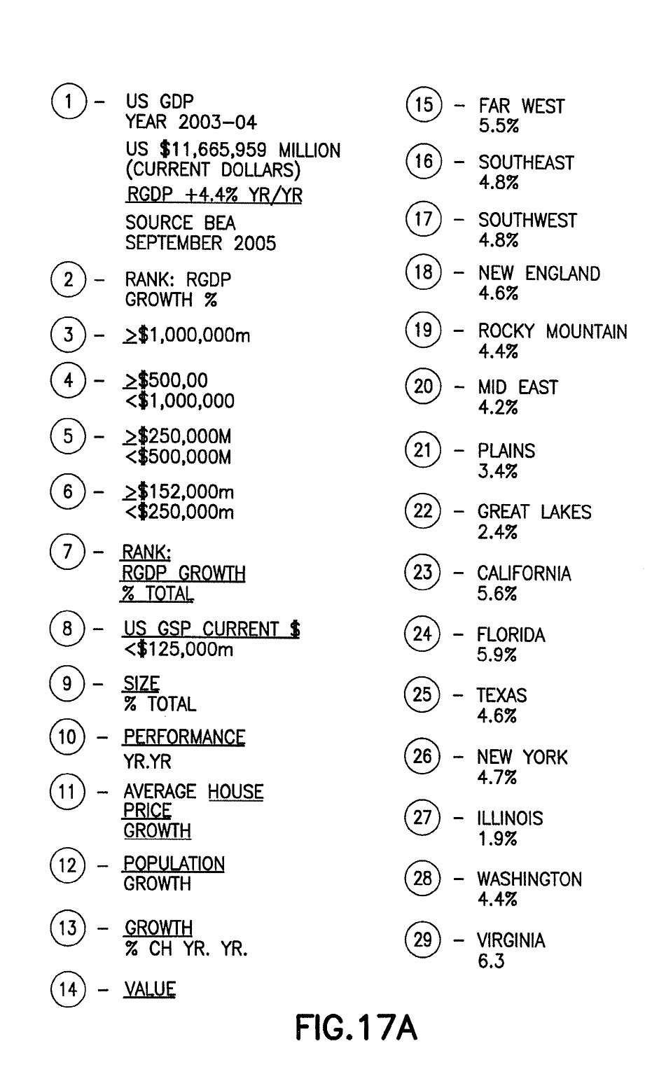

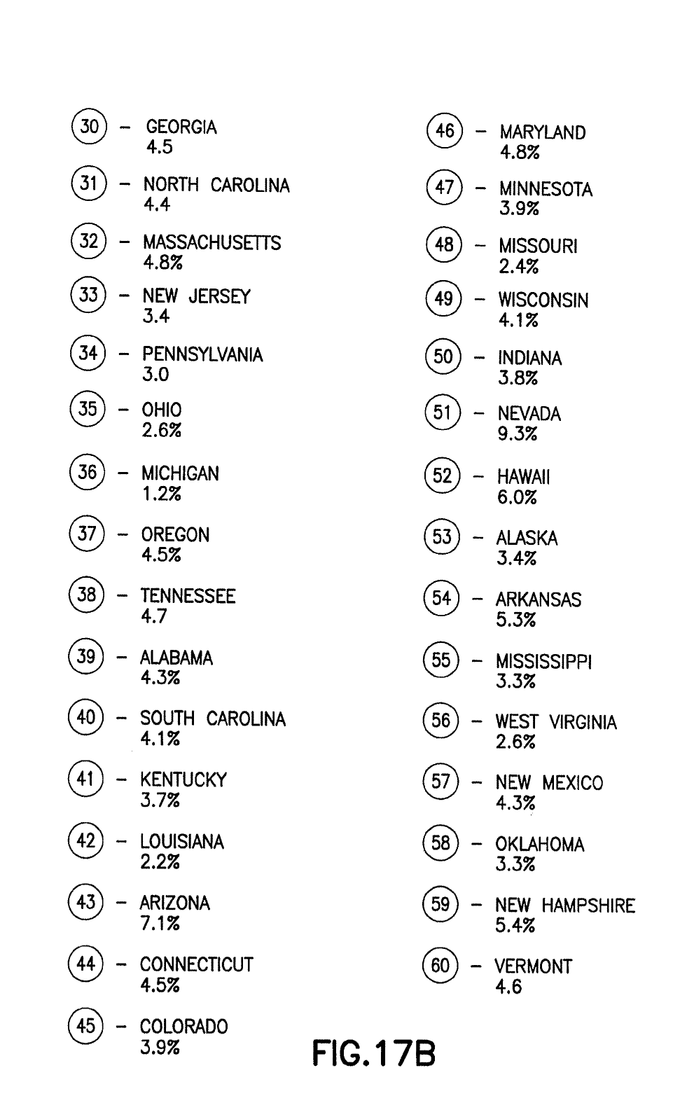

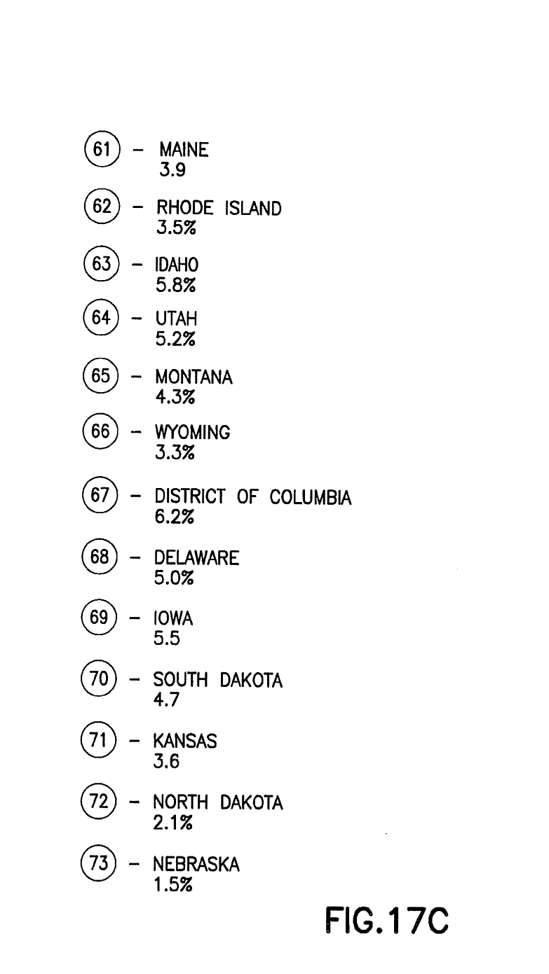

FIG. 17 illustrates an example variant including a representative user control ring embedded within the chart and positioned next to the center. A user selecting a segment in the inner ring control ring will reposition the outer arc and components according to the user's criteria. In this example the input criteria is reflected in a segment arbitrarily defined as “blue” in the inner control ring. This FIG. shows the US by value and by the growth rate of each state relative to each other and relative to the total. The 8 arcs and components have been ranked from noon, going clockwise around the chart, reflecting the declining growth rate, while maintaining the size of the arc representing the 8 categories' total value, enabling a three dimensional view of the hierarchy in one chart. It thus provides a simple way to visualize the size of each regions and the growth rate, e.g. position relative to the center and from noon.

In this example one can see by reference to a unique color for each category, how they are positioned relative to each other and to the center. For example the user can quickly identified that one arc 1 (arbitrarily denoted pink) represents 18% of the chart and it is in the noon position. It has the highest growth rate at 5.5% compared to the center growth rate of 4.4%, and each arc's reducing size reflecting a smaller growth rate as one moves clockwise around the chart. The position of the States within the arc reflects the order of each State in the respective rings. Note that, in FIG. 15, because the chart was ranked by size, the same pink arc 3 was placed in the third position. Although the magnitude has not changed, the user can see, in FIG. 17, that three arcs make up over 50% of the value of the United States. In other words, as graphically represented on the chart, over 50% of the total comes from these three states, and they have the highest growth rate, positioned accordinly from noon, clockwise.

Thus, in FIG. 17, California is positioned in the ring nearest to the classification ring that defines the arc, indicating it is the largest component of both the center value and classification segment. It is also positioned at noon within the concentric rings value range, indicating it has the highest growth rate within the category within that value range. In the outer ring at noon Nevada has the highest growth at 9.3%, but is significantly smaller in total value, therefore positioned in the ring furthest from the center according to the range in values where the outer rings value less than $125 billion.

The order within each arc is also ranked, by way of example, using closer to noon clockwise to represent the more favorable it is to the user's criteria. It is possible to visualize all categories in this manner. For example one could select to display the value range for the rings by population, with output of the regions representing the magnitude of the arc. The order could be determined by the growth rate of either the population or the output of each state. Alternatively the average house price per state could be displayed relative to the growth rate, with the value range of the rings being by dollar value of the house price, and the magnitude of the arc representing the output of each state. The Arc could then be ranked to noon to show which state has the highest growth in house prices relative to the price of the house and relative to the output of the country, state, counties, towns and neighborhoods depending on the user input defining both the universes and the ratio.

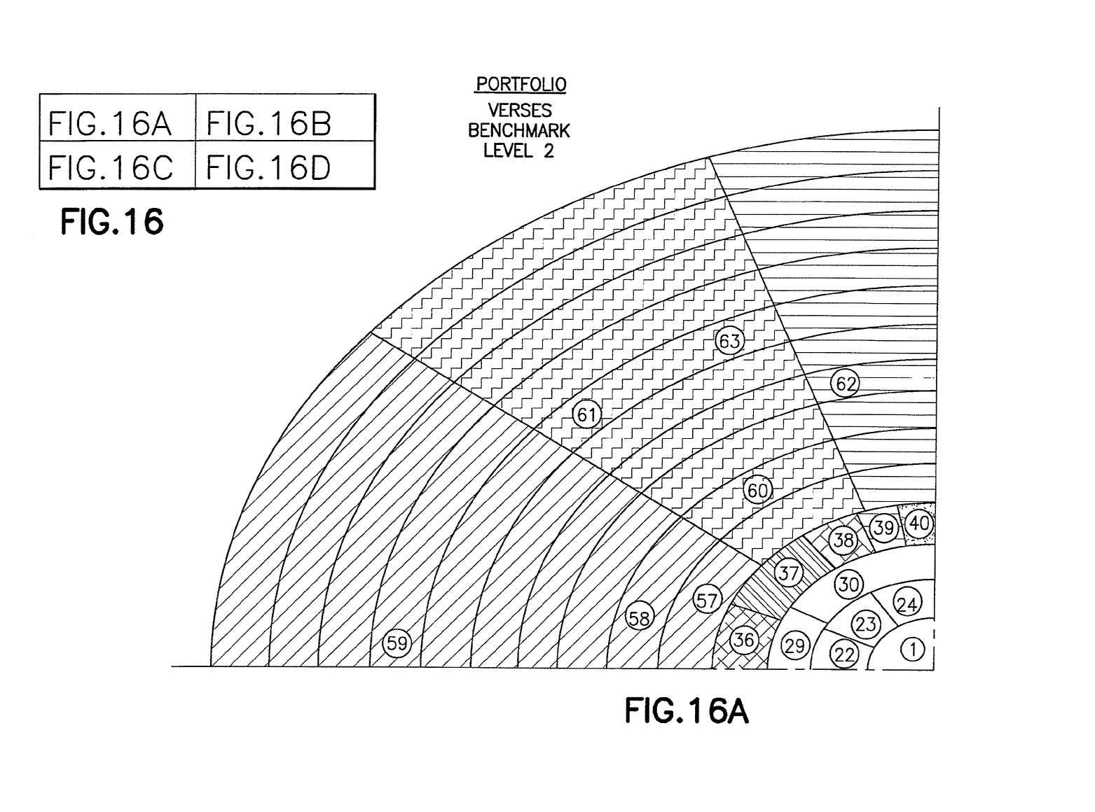

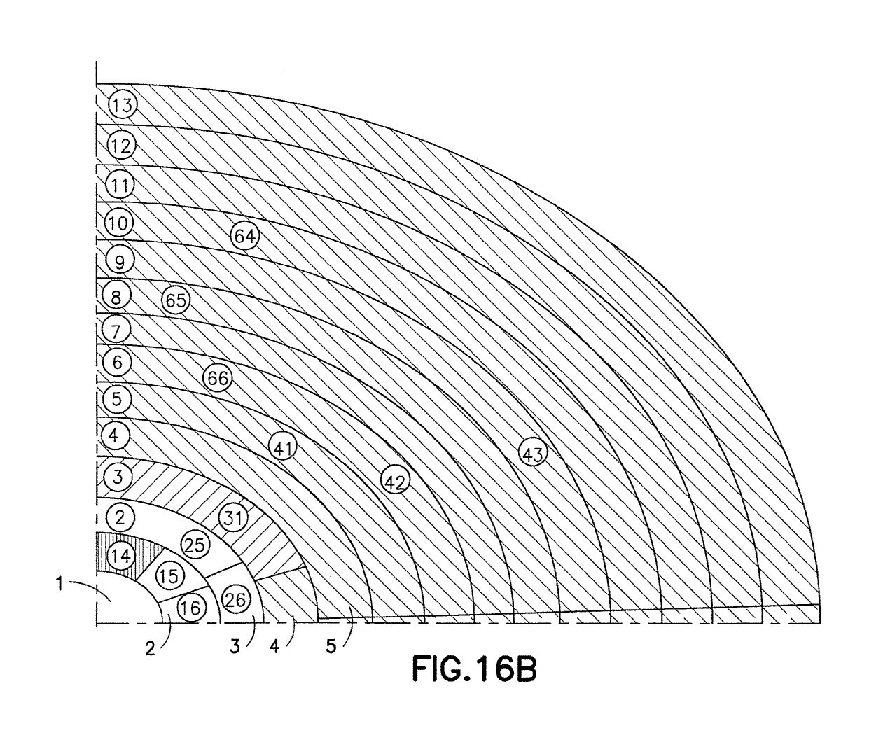

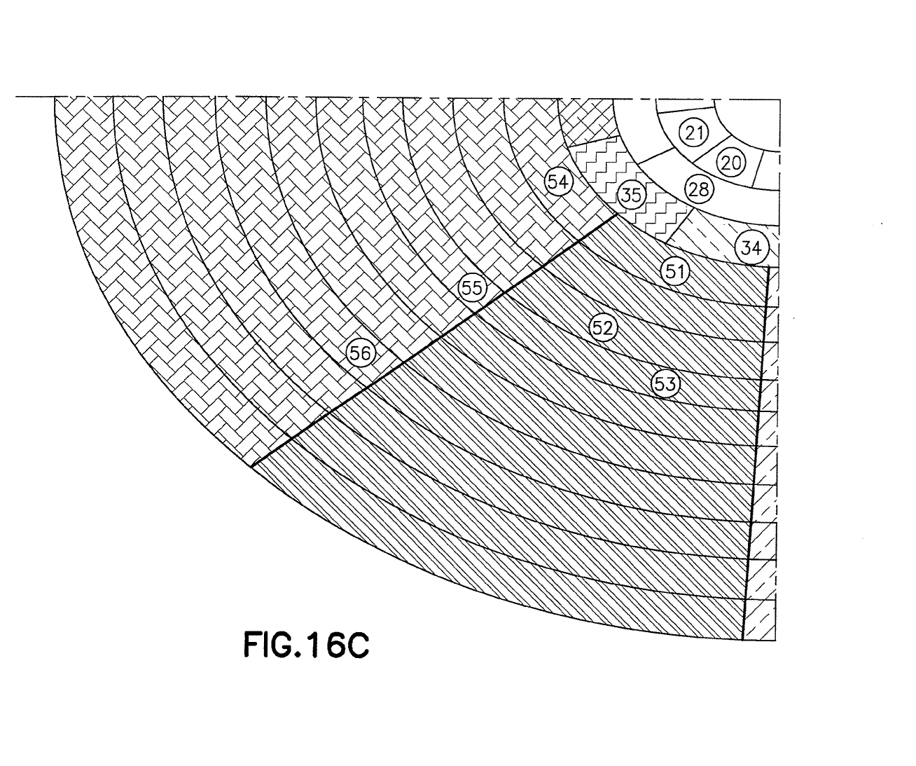

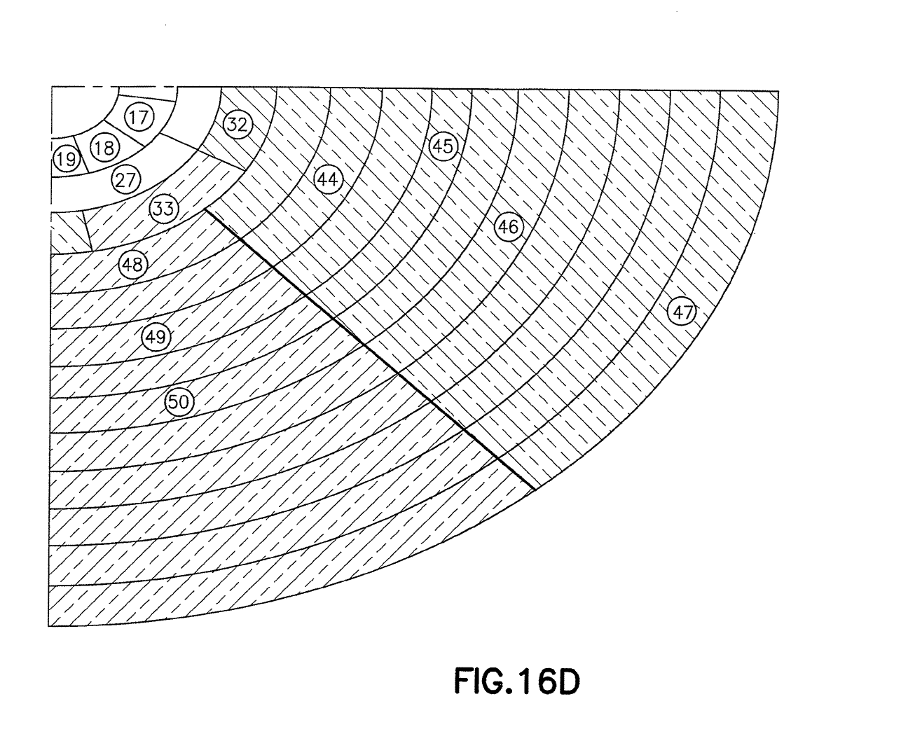

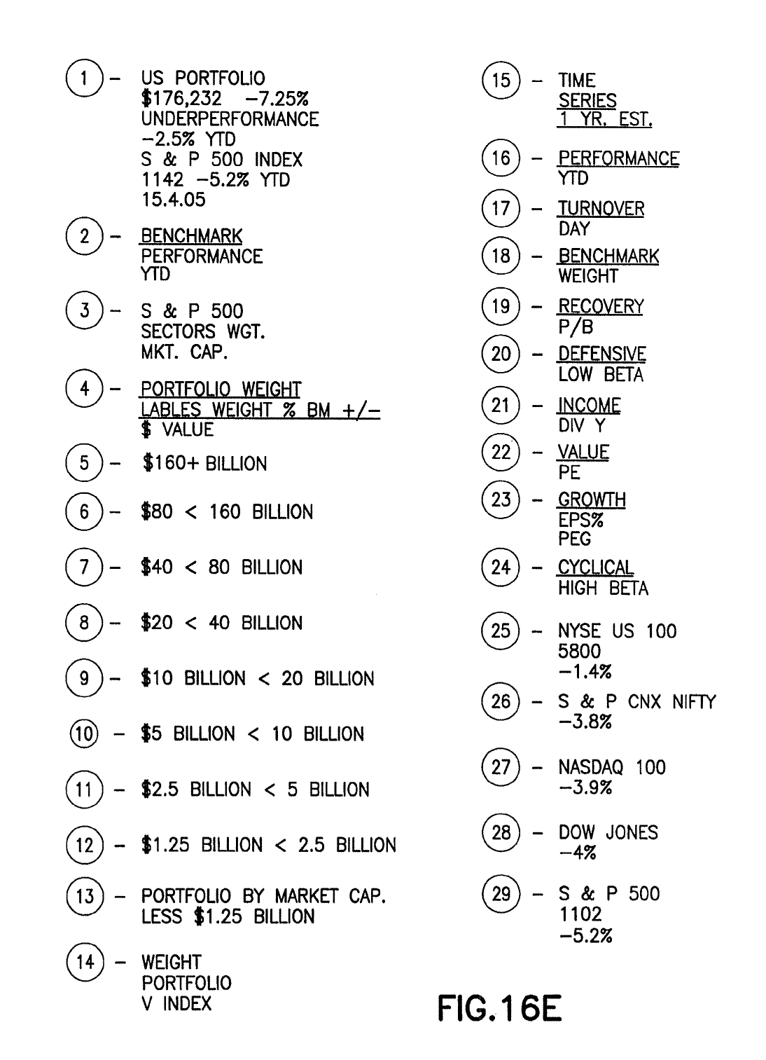

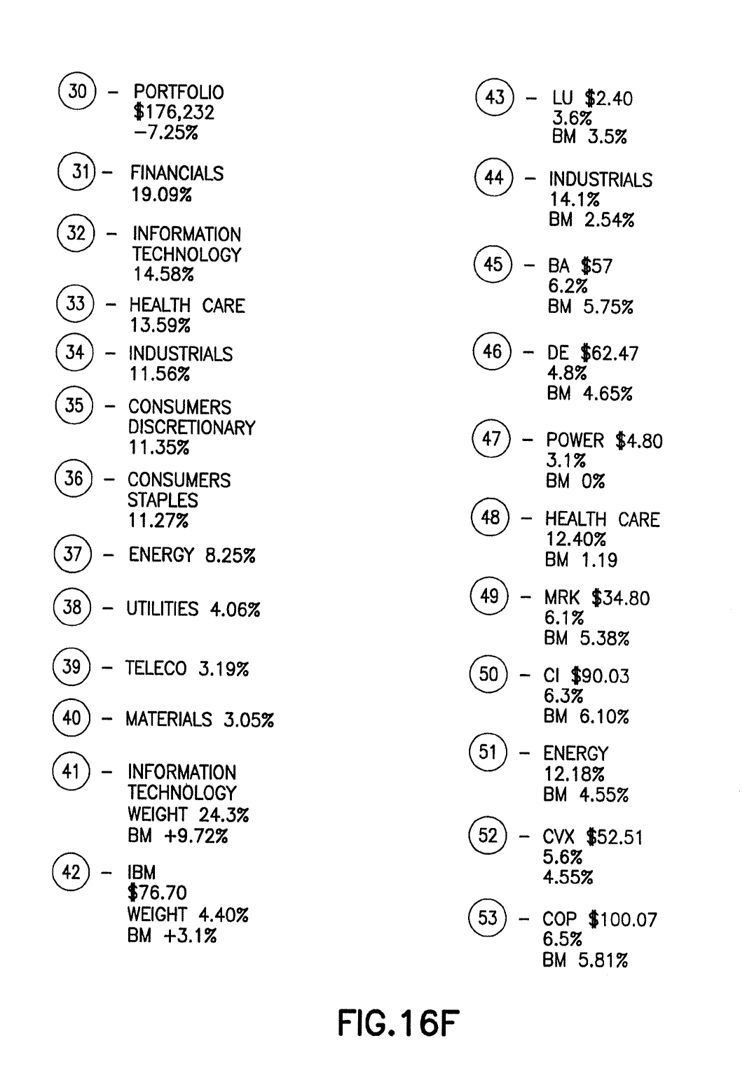

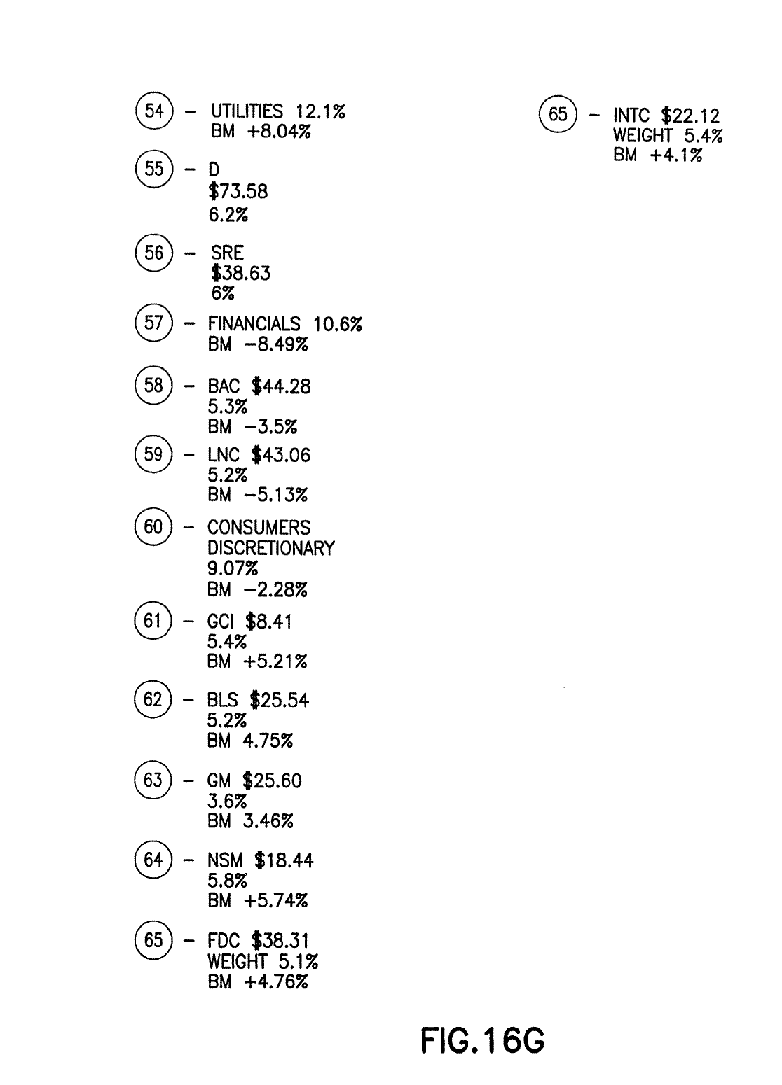

The charts have the ability to rank multiple data series within one interface to show the categories' suitability to the user criteria due to the positioning of the arc (color). The charts can rotate one or more of the rings into the order selected by the user, and, where appropriate, introducing new rings to enable viewing of different criteria, while keeping the magnitude of the arc the same because the universe is the same. When the arc (color) is inline, that is, it is in the same position on one or more of the rings that rotate to the required notification, this will indicate whether the category is more favorable or less favorable depending on where the arc is position on the chart. The charts can also show two universes at the same time, enabling a comparison of different arcs. Again when the arcs are inline, that is the magnitude is the same, the two different universes are inline. This approach can provide significant benefits to some users, for example, those in the financial industry, because it allow one to compare one portfolio to another portfolio or to compare a portfolio to an Index. FIG. 16 illustrates a dual universe approach.

A Type B chart also has multiple concentric rings, but with this chart, the algorithm is simply the sum of each ring, and this can be displayed equally on the ring or in proportion to the series. Each ring contains either different data labels and series, or the same components with different values. Each segment size can be graphically represented relative to other segments within the series. The center is the user input, and its position is traced throughout the chart, enabling a user to see the relative position of the input to other components within the series and within the chart. Each ring within the chart can mathematically deriver the ratio required, by using the values of the respective components from one series to other series, calculating the required ratio, and determing the postion of the components within the chart. This enables a comparison of one component's positions and values to relative to another and relative to a notification point. For example the chart can have multiple series with each ring containing the same components but with different values attached. The size within each ring displays the segment in proportion to the total of each series. It can derive the order of the required ratio of each series values, e.g. ring A divided by ring B respective components, whereby the required ratio is calculated, establishing the order of the components on the chart relative to the user's required order for that ratio.

A Type C chart is a “Clock”, and it allows the user to see what would happen to the value of a component on a Type A or Type B chart if a variable changes, e.g. what happens to the price of a component on the Type A or Type B chart if oil goes from $40 or $100 a barrel, or if interest rates move between 1% and 5%. Quite simply this chart reflects what effect a change in the independent variable has on the dependent variables. It graphically shows the position of the components relative to the notifications calculated by the users input. The clock may use different notifications compared to the Type A and Type B charts.

Having described each of t he three types of charts in overview, the three charts and their function can now be explained in greater detail, using financial data, to illustrate how one can interrogate and position the relevant data at the click of a mouse to gain insight into the makeup of a hierarchy and structures.

The interactive asset data visualization guide of the following example includes a number of interrelated and interacting parts. Key examples of the these parts are a “Meridian Ring,” and various types of “Wheels or Spheres” representing the Type A and Type B charts in the “Asset Sphere” and the “Clock”, when the meridian ring is combined with the Asset Sphere. The center defines the values at risk to preserve, maximize, or outperform. The meridian directs assets on the sphere according to the direction estimated by a user on the meridian. Insight to the overall direction of the assets is attained by industry defined cycles such as the Business cycle reflected by the economic clock merged with the stock market terms, Bull (i.e. at least a 20% rally) and Bear (i.e. at least a 20% decline). The GUI provides an easy to use tool, facilitating a user's specific series and ratios within a defined universe, utilizing the notifications contained within the guide. The specific terminology is, of course, for the purpose of explanation and not limitation, while the elements described by particular terms may be named differently than set forth herein, the primary focus being the functionality of and interaction among the parts.

Wheels

One example implementation of the concepts described herein includes wheels.

Wheels may consist of three parts: center, inner control rings, and outer choice rings. The Engine to controlling the center lies embedded in the “control rings” comprising of an ownership, style and benchmark ring. The inner control rings power the wheel, each controlling the next. The Style ring ranks components relative to a “noon” notification. The Benchmark ring, displaying components on the outer choice rings which in turn can become the center value at risk. Wheels form each of the two styles of charts the Type A chart “Price” or Type B chart “Market”. Price wheels can form a “Clock” which is a guide to the relative direction of the assets on the sphere inline with the physical direction of clock hands, where left is increasing, and right is decreasing. Market wheels have the ability to generate a central “noon” notification for the wheel, weighted to the selected style of the investor.

The GUI for the wheels visually represents the pre-selected values and ratios for selected assets, and how those values compare with the same values of other assets, graphically representing the asset's physical size, while ranking the asset by value or ratio within the GUI. The values may include all traditional values, such as market capitalization, total assets, earnings, market liquidity, market performance, or a value such as earnings per share. The ratios may include Price to Earning (PE), volatility, beta, performance, Dividend Yield, Price to Book, Earnings Per Share Growth, Price Earnings to Growth, and the like. Visualization is aided firstly by the geometry of the subject guide, specifically a sphere, circles and/or rings and sectors. Additionally, visualization is aided by size (e.g., by the angle encompassed by a sector, the width of a ring). For example, the larger the market capitalization of a particular asset, the larger the size of the graphical representation of that asset may be. That is, viewed by a user, the area (e.g., in square centimeters) is actually larger for the region representing that asset than for assets having a lower market capitalization.

On an additional level, assets may be positioned based on each asset's value for a particular criterion. For example, if a user is interested in so-called “value” assets, then each asset shown (which may be further limited to particular classes of assets) can be arranged by its P/E, Return on equity (ROE), or the like. In one embodiment, such arrangement occurs within each displayed ring in a clockwise manner starting at a vertical position as “noon” on a clock (relative to the circular field of the GUI). Additionally, assets can be physically arranged based on their relative risk. In one embodiment, increased risk of an asset places the asset (graphically) further from the center of the field of the GUI.

Further, color is utilized to distinguish classes of assets from one another. For example, assets like gold, real estate (property), cash, bonds and equities can each be assigned a unique color or family of colors.

The guide indicates a user input and related component positions throughout the wheel, tracing by a country code, name of a company or portfolio, adjusting the signals as position or selected criteria changes, this enables quick visualization of ranking of the input compared to the universe.

Accordingly, if a user is familiar with the way in which the subject asset data visualization guide is configured to be utilized, the user can interpret and understand more quickly and easily, depending on his or her input criteria, how different classes of assets compare with one another, how different equities are performing in comparison with one another, and accordingly, can make an intelligent investment decision. Thus, once a user is accustomed with the subject asset data visualization guide, it may be advantageously utilized equally by an individual investor as by a fund manager, since historical patterns and research can be “built in” to the software operating the asset data visualization guide, trends can therefore be calculated when desired by a user. The power of the subject interactive asset data visualization guide is deeply embedded in its GUI. Simply by using the application a user will follow well-tested financial disciplines and be able to make better investment decisions for themselves or for their clients. Thus, the usual knowledge, experience and intuition of a fund manager is not as essential for making the best possible investment decisions as it would be without use of the subject interactive asset data visualization guide.

One aspect of the GUI of the subject interactive asset data visualization guide is the representation of its physical shape. More particularly, many displayed screens (or printed regions for printed, non-electronic publications which comprise an alternate embodiment of the invention) for use by a user are overall circular in shape and include a set of concentric rings (annuli) therein. In some embodiments, the displayed screens are spherical and are able to be used and manipulated on a computer as if truly three-dimensional. The circular field can be displayed as an undivided circle, or in many embodiments, a circle divided into a plurality of rings with a center circle remaining. The concentric rings can in-turn be subdivided into annulus sectors (or “arcs”). The user enters an input by physically selecting an asset class or a more particular subset of an asset class. Alternatively, the user may select a particular country, particular securities, or an entire index as the subject of a prospective investment. Such selection, in some embodiments, is made by selecting (e.g., “clicking”) segments or sectors of displayed rings that have the ability, through a computer interface, to receive input data. Depending on the embodiment, any region can be enabled to act as a point of displaying information, and can alternatively or additionally be enabled to act as a point for user input or selection. In an alternative, such selections may be made through a more conventional menu-based interface.

The asset data visualization guide, more particularly, the computer system operating it, retrieves data from various databases and displays the requested information. The information is physically arranged on the user's screen, and is sorted by predetermined criteria, by user-selected criteria, or by both (such as a P/E ratio for a stock, and/or risk, and/or market capitalization, for example). The subject guide is preferably provided with a default criteria setting by which assets are initially ranked. For example, the first screen seen by a user can be one arranging assets based on risk and market capitalization. As an example of such an arrangement, assets having the largest capitalization are provided a display region having a commensurately large area (they are displayed as being physically larger than others), and are arranged clockwise, within a predetermined ring, or a sector/ region representing the asset with largest capitalization being placed nearest a vertical line (such as a line representing “noon” on a clock). Sequentially, regions representing assets having successively lower capitalization are arranged clockwise from the first. Also, in this example, risk is graphically illustrated by arranging, in positions relatively farther from a center of the circular field of the GUI, regions representing assets having relatively higher risk.

The computer system that supports and operates the subject asset data visualization guide can continuously monitor and change the displayed position of different assets based on the predetermined or user-selected criteria. Such criteria can be input directly in certain rings particularly configured to accept user input. The user can then select a ratio (a user input) from an inner ring specifically for this purpose, which is called herein the “style ring.” Alternatively, the central circle that is concentric with the rings, can be configured to accept user input. When input is provided, regions representing various assets (rings, sectors, etc.) automatically readjust in order to reflect the user input, based on then current market valuations. These market valuations are received by the operating computer system of the guide, and stored within a database of the computer to be utilized when needed. The asset data visualization guide can be configured to monitor the user input, and continuously or periodically readjust positions of regions representing assets or classes of assets, according to market fluctuations.

The interactive asset data visualization guide technology provides the capability to perform cross sectional time series analytical calculations, creating a dynamic financial analysis software application. In one example implementation, using the concept of the clock, the rings rotate clockwise, where “noon” is known as the “notification” within a ring. That is, the “noon” position is defined as an identifiable location on the circular field where regions (sectors, annulus sectors) representing assets that most favorably meet pre-selected or user-input criteria are arranged. Additional notification for each sector is provided in each concentric ring or “risk band” in the same “noon” location then sequentially on the vertical line closest to noon within the sector within the risk band. In many embodiments, the inner circle that remains within the annularly sub-divided field is the total value of invested assets (“the center value”), or assets proposed to be invested, the quantity of which is to be preserved and maximized. As particular assets are assigned higher risk, the regions representing these assets are arranged, in many embodiments, farther from the center of the field. This graphical placement is for the benefit of the user, so that relative risk can be seen easily. Additionally, this increased risk is coupled, in the software code running the GUI of the guide, to have less of an effect on the center value than less risky assets arranged more closely to the center of the field. The extent of which variations in valuation of risky and less-risky assets affect the center value is determined by specific settings that are chosen by a user. More particularly, a tolerance for risk is selected either explicitly or in terms of a user-selected investment style (“value,” “growth,” etc.).

With one example embodiment, the interactive asset data visualization guide's first (innermost) ring sets out asset classes from which a user can choose to invest (“investable assets”). The asset classes (e.g., chosen from the group of: gold, bonds, cash, equity and real estate (property)) are divided into sectors or quadrants if four equally-sized sectors are provided. Accordingly, each sector is defined by a radius, which is a majority of a radius of the circular field, and by an angle, which can be any angle. In the case of four equal quadrants, the angle is 90 degrees. Also in this embodiment, the second ring, a portion of which is encompassed within each respective sector can be further divided into segments (e.g., segments of an annulus sector). The size of the second ring, as with the first ring, is determined based on the angle for the sector, such as 90 degrees. Categories and sub-categories can be graphically related when moving from the center toward the outside. Specifically, if one category, represented in a sector of one ring, and that category is divided into 3 sub-categories that are represented in the next ring, the regions that graphically represent the sub-categories will not exceed a size in terms of the above-mentioned angle, that is greater than that of the larger category.

In other example embodiments, a hierarchical structure can be defined in which, rather than moving from top to bottom or left to right, order is seen in moving from the center to the outside of the field, passing through rings that delineate the hierarchical levels.

The user can “drill down” by selecting a sector or by selecting a segment in a ring of a sector in which each ring can lead to a corresponding wheel or sphere with more detailed information on assets related to that sector or segment. The computer system running the interactive asset data visualization guide responds to multiple data inputs, and rearranges representative asset regions accordingly. The arrangement of the asset regions gives the data meaning within the defined universe, thus empowering the user. The process enables comparison of center to each segment in the ring since segments within sectors are closely related valuations of adjacent rings affect values and performance of another, with the objective of preserving the center value or outperforming the center. The GUI visually represents the objective and the risks due to the positioning on the wheel. Each wheel defines risks to the center be it the assets direction, allocation, country, sector or the stock risk, the rings on the wheels effectively compares the components asking the question of risk verses reward compared to the center values.

Meridian Ring

The World's population and natural resources can be represented on both the supply side and the demand side of the Sphere. The meridian ring can be used to monitor both demand and supply measured by the Gross Domestic Product (GDP) position on the left, and supply being measured by the Consumer Price Index (CPI), with interest rates (rates having implicit assumptions on future CPI) on the right side of the ring. The employment growth, unemployment rate, population growth, money supply, velocity of money (speed money moves around) and foreign exchange (or “FX”) rate are all variables affecting the supply and demand for money and thus, its value thereby changing the price of assets on the sphere. The price of money (on the foreign exchange, for example), will fluctuate with changes in supply and demand for a particular currency, primarily due to a change of demand and supply for jobs and wages (money), which will change the supply demand for goods and services in a country. Demand for jobs (wages) will rise and fall in that country, as will the price of money, as supply and demand adjusts. Wages will rise in low cost countries as will demand and there will be a fall in the high cost countries as jobs are transferred around the world as the skills in low cost countries improve and compete with those of high cost countries. In the long term, the value of currency and wealth will vary cyclically.

In one example implementation of the concepts described herein, the Meridian Ring is arranged around the circumference of the displayed circular or spherical GUI field referred to herein as an “Asset Sphere” and has two styles of clocks, a “Correlation Clock” and a “Beta Clock”. The Meridian Ring accepts input, and monitors user estimates, of variables (e.g., GDP, interest rates) that can change prices of assets represented in the GUI field- in the concentric rings, and therefore also the value in the inner circle. The user sets a first hand on the clock corresponding to user estimated direction, which rotates a predetermined ring. In one example embodiment, this is the second ring from the center. The first hand is configured to be oriented and “fixed” to the ring such that when the first hand is set at the forecast direction given users input, certain asset classes (e.g., equity, cash, bonds), which are represented by regions on the ring, are rotated into directional notification position, given the user forecast using historical correlation's of the asset classes. In an example embodiment the assets on the left side of the “Correlation Clock” (level 8) will outperform assets on the right side of the clock. Additional user notification being the first hand pointing to indicia: Bull, Bear, Peak or Trough, representing the variable's direction positioned on the right side of the meridian ring. Notification is inline with the physical direction of the hand corresponding to the asset class to which it is fixed i.e. right side down, left side up.

Notification for a “Beta Clock” (level 6) is where an embodiment of the asset sphere indicates that assets on the right side will outperform the left and center in a falling market, equally the left side will outperform the right and center in an appreciating market. Additional notification can be provided, for example, when the Big hand of the clock is pointing to an indicia: Bull, Bear, Peak or Trough, representing both the variable's direction and the sectors that will outperform on the sphere. A hand reflects the overall direction indicated on the Asset or sector sphere, such that the direction of all three should correspond over the cycle. These notifications positions are valid only when the meridian ring circumferences the spherical GUI field of the sphere. A user should note the direction is over the cycle being peak to peak, i.e. over a long period of time, in a short time-frame an asset class may go in the opposite direction, due to market liquidity, market sentiment or herd mentality to name a few.

When the Meridian ring input value changes, and thus a direction input change exists, the user rotates the first hand, which then rotates the corresponding ring. The position of the first hand (or “small” hand) is related to the position of a second hand (or “big” hand). The position of these hands is mutually related by way of a predetermined factor. This factor can be based on historical data and/or a mathematical relationship. The first and second hands can provide notification to the user of the degree of “bearishness” contraction or “bullishness” expansion for that segment, peak and trough indicating a change in direction of that segment. Each hand points to an economic indicator, which describes, in words, historical economic factors based on the forecast direction and change in magnitude of economic indicators. Of the variables, bearishness or bullishness of interest rates are indicated by the first (e.g., “minute”, or “small”) hand, and for demand (GDP), by the second hand (e.g., “hour” or “big hand”) of the clock. Interest rates control the growth rate. In one embodiment, the left side of meridian ring lists values for variables for which the first (e.g., small) hand indicates direction (e.g., bullish/bearish), and the degree of that direction. The Meridian ring is capable of monitoring any variable.

In one example implementation described when using the subject guide, the user is initially presented with a macroeconomic view of the investment universe, which may be termed the “Meridian Influence” on the guide (i.e., the valuations of listed assets and asset classes). The user provides inputs for the above-described economic variables (e.g., current & forecast GDP, and current & forecast interest rate), in one embodiment by “clicking” on the appropriate value displayed in the GUI, on the Meridian ring portion thereof.

The wheel values are sensitive to a change in the variables on the meridian. The Independent variables on the Meridian ring are linked to the dependent variables in the individual asset regions displayed in the rest of the GUI. As mentioned above, direction is set based on current and forecast values. The system and software operating the guide and/or the GUI of the guide links ratios of these current and forecast values to values associated with a user-defined style of stock selection (e.g., value, growth), which adds meaning to the displayed values throughout the individual asset regions on the GUI, which is, in essence, the user's universe. Accordingly, the guide becomes a dynamic, data mining search engine, providing perspective to data ratios and values not just simply providing the price. Asset classes and specific assets are represented in context, relative to the size of the total market and not just a segment in the market, which is typical for the industry. The guide can empower the professional or the individual by drilling down on each ring of the sphere, and by customizing style criteria, while gaining perspective and clarity to the economic cycle. Variables that change the speed and direction of cycle are monitored, along with an individual security's or an individual segment's position in the cycle. For example a change in direction of a forecasted variable on the meridian ring from increasing to an estimated fall may change the asset class's position on the sphere, changing the notification from the bearish right side of the sphere to the bullish left side of the sphere. The other asset class gets readjusted on the sphere inline with correlations, or beta to each other. The present value of money and the correlation or the beta drives the sphere positions. The GUI reminds the user to reassess variable's forecasts, as variables on Meridian ring are dependent on each other, just like the hands of the clock the small hand drives the big hand, here interest rates (small hand) drives GDP (Big Hand).

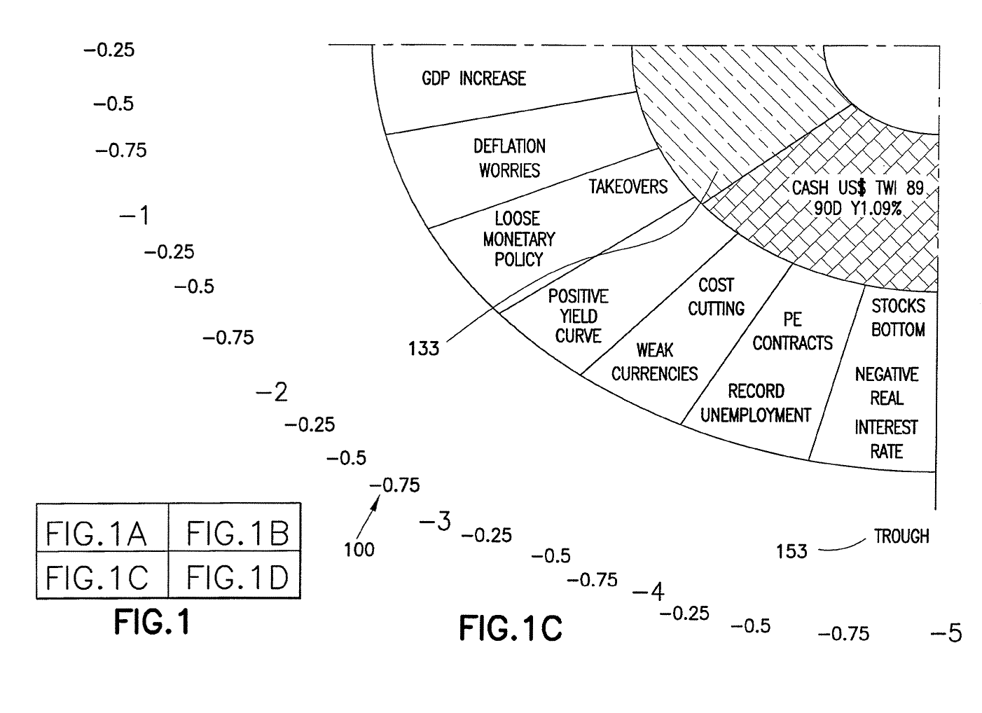

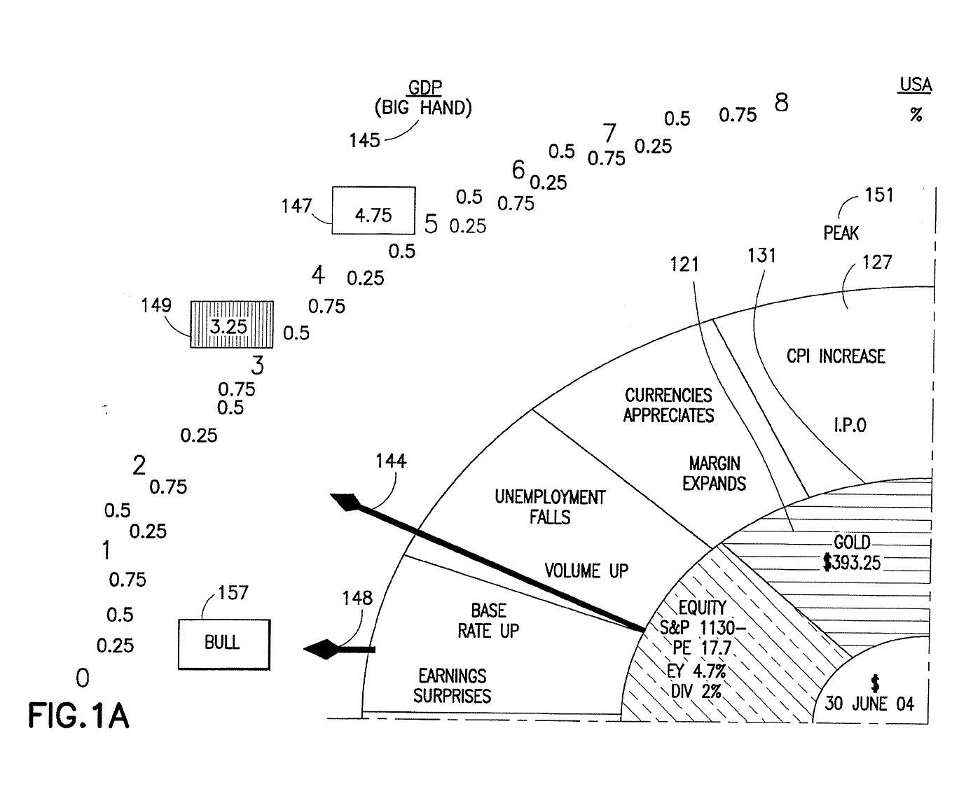

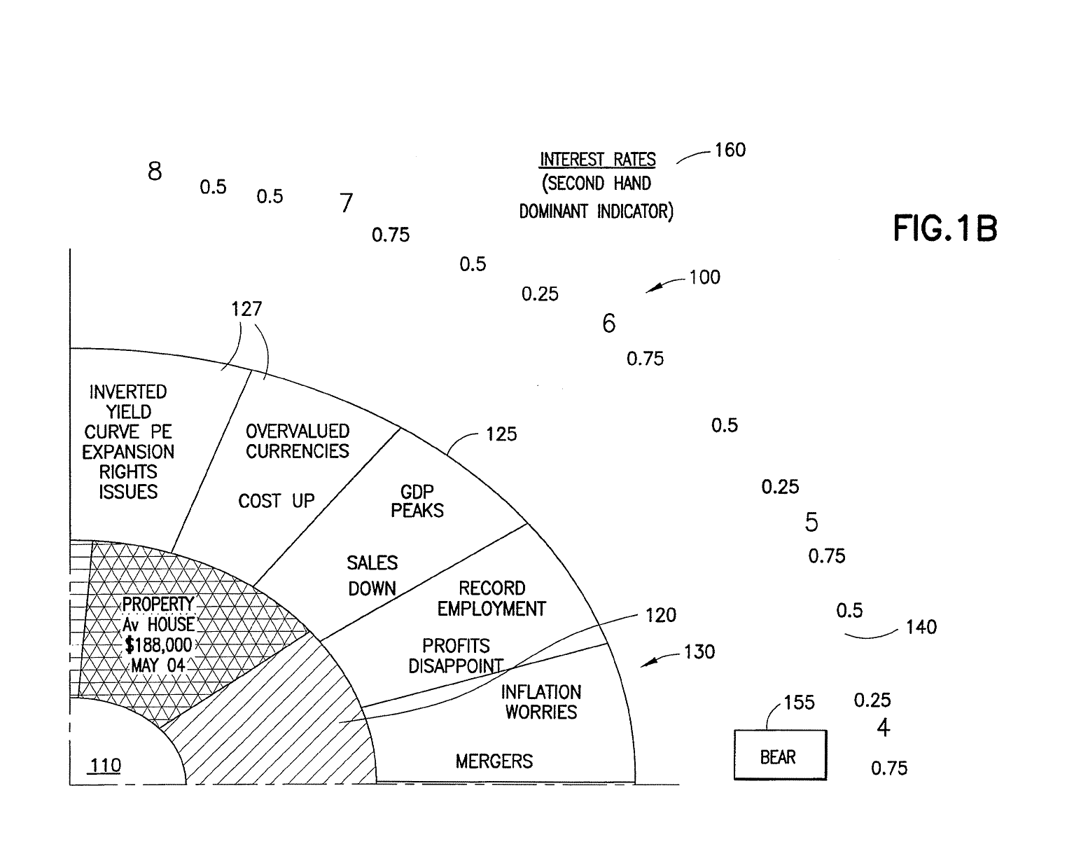

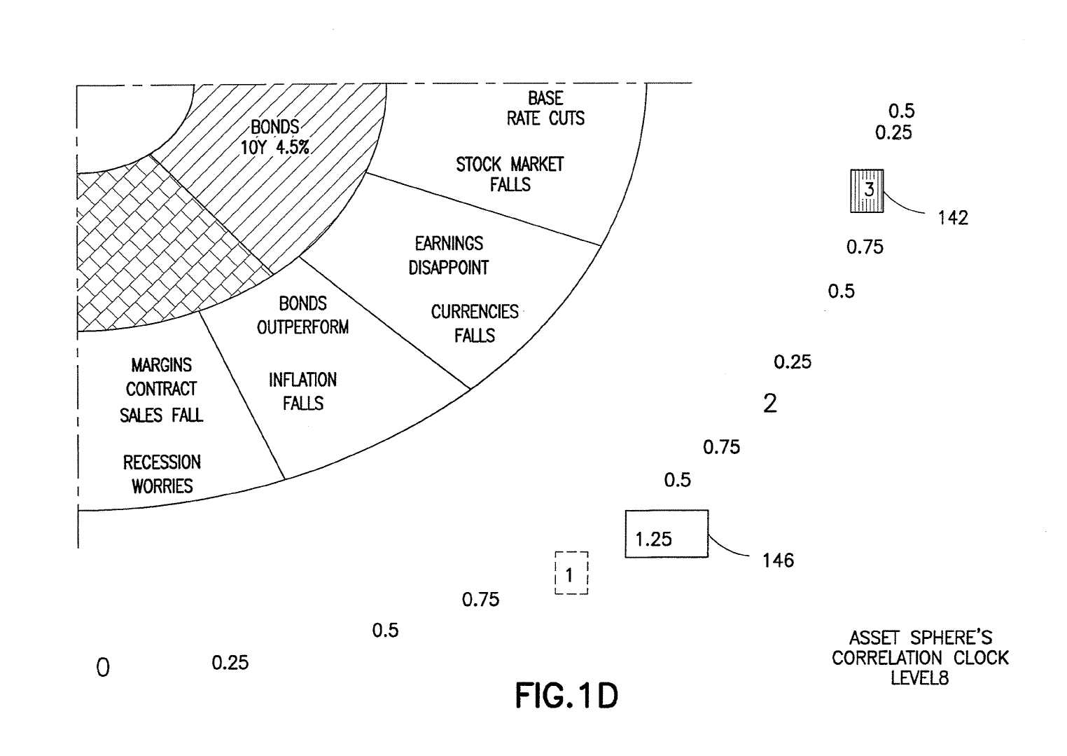

The FIGS. herein collectively outline and illustrate in simplified form how the Guide functions, demonstrating the interaction and some of the notifications contained within the guide as an example of how the system could be configured. Notification position for the wheels are taken at noon position, with the Price Wheels having additional notification sequentially on the vertical line closest to the noon position moving in a clockwise direction within each sector on the wheel. The efficiency wheel FIG. 1D demonstrates the central noon notification. The Clock exhibits the directional notifications.

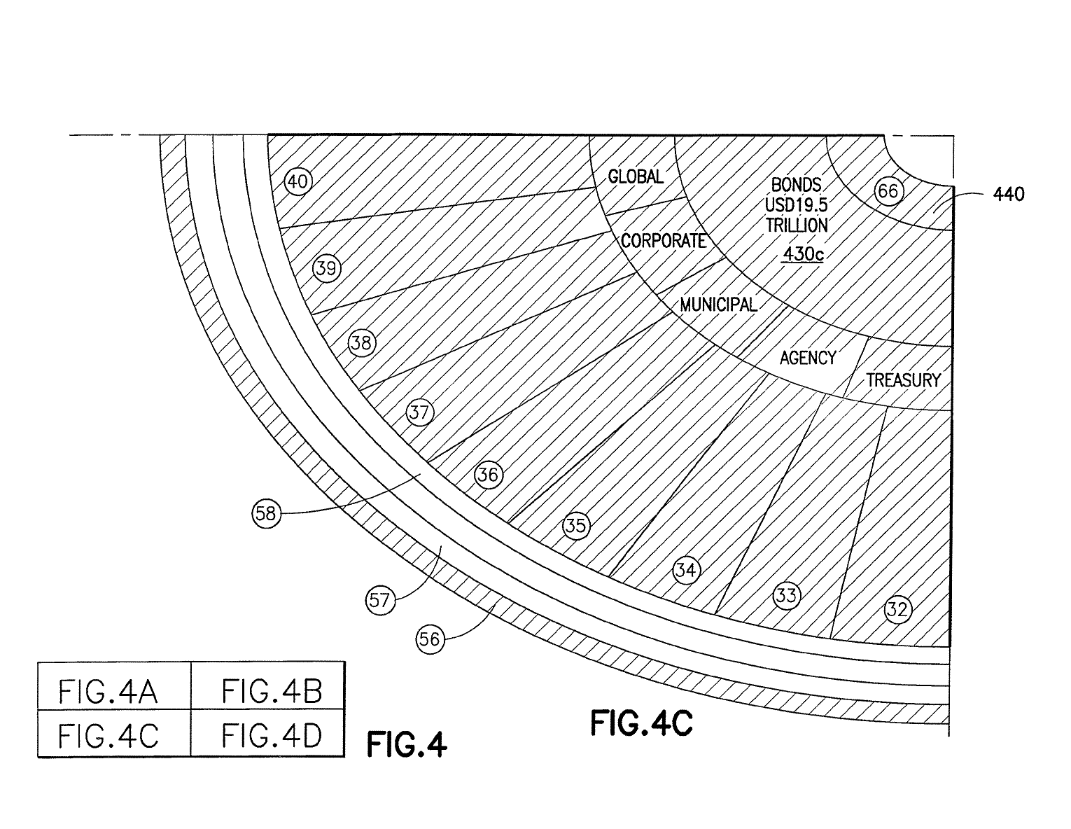

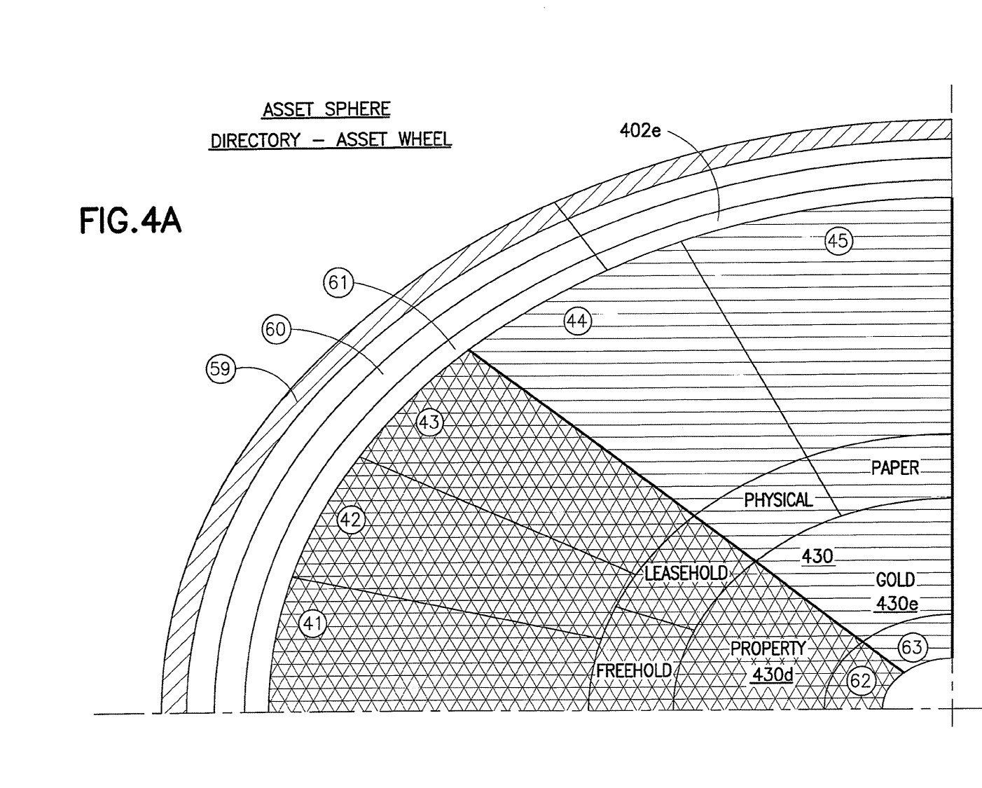

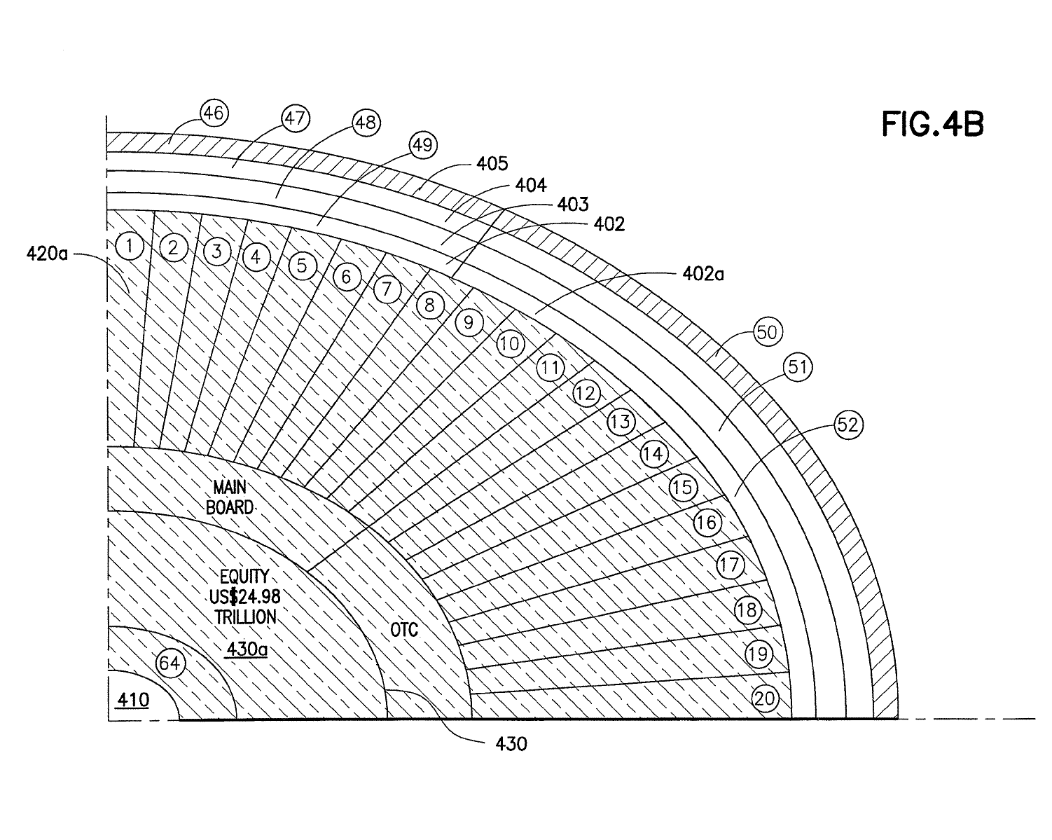

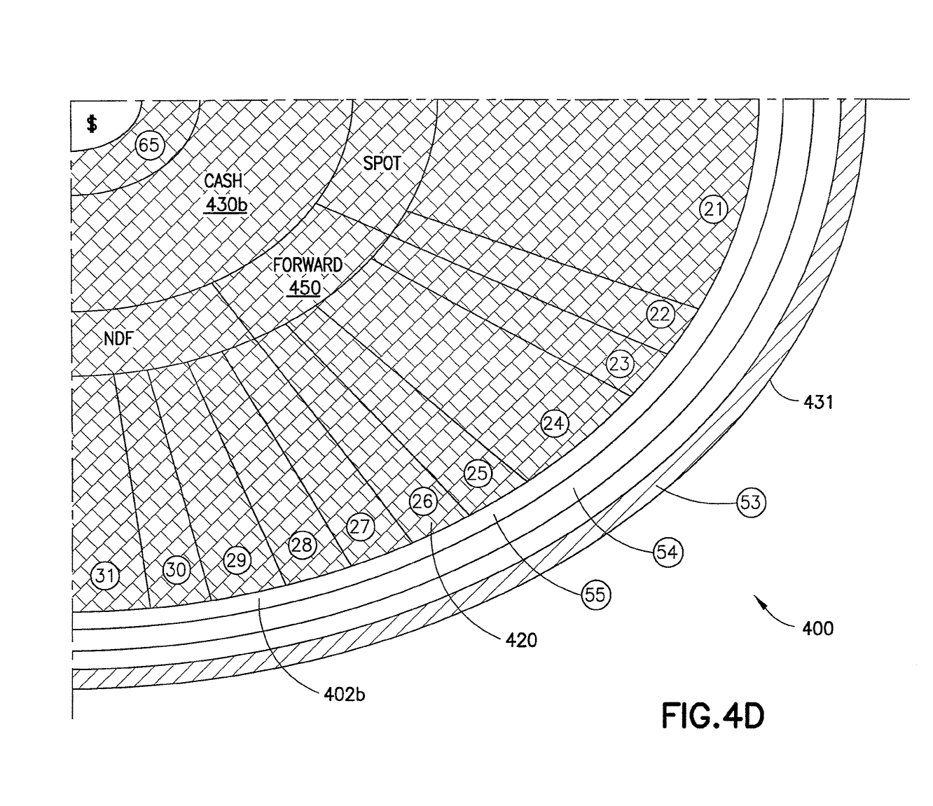

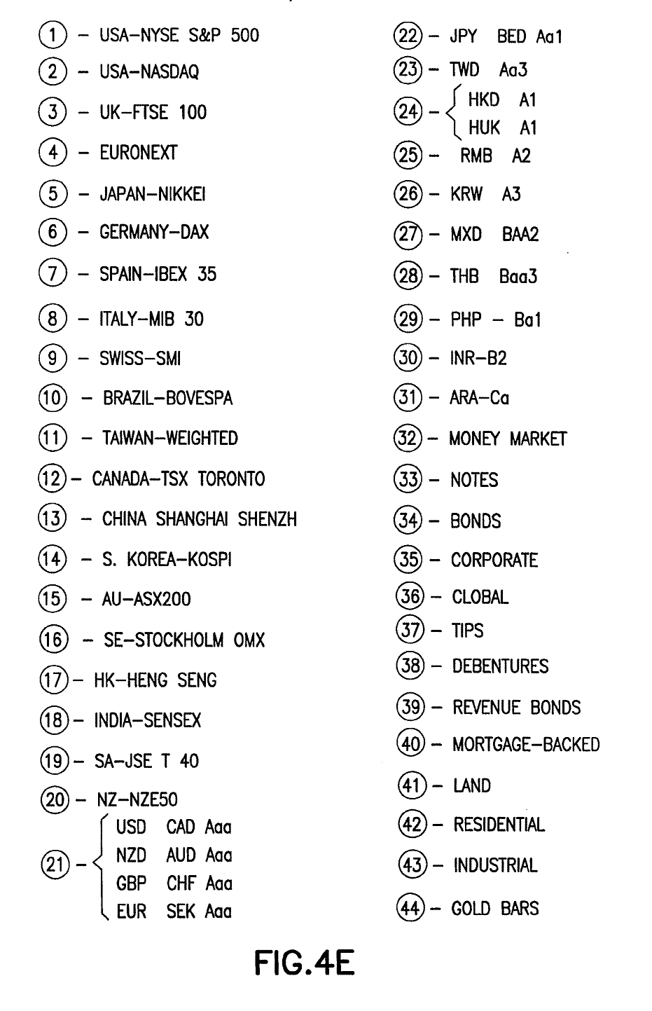

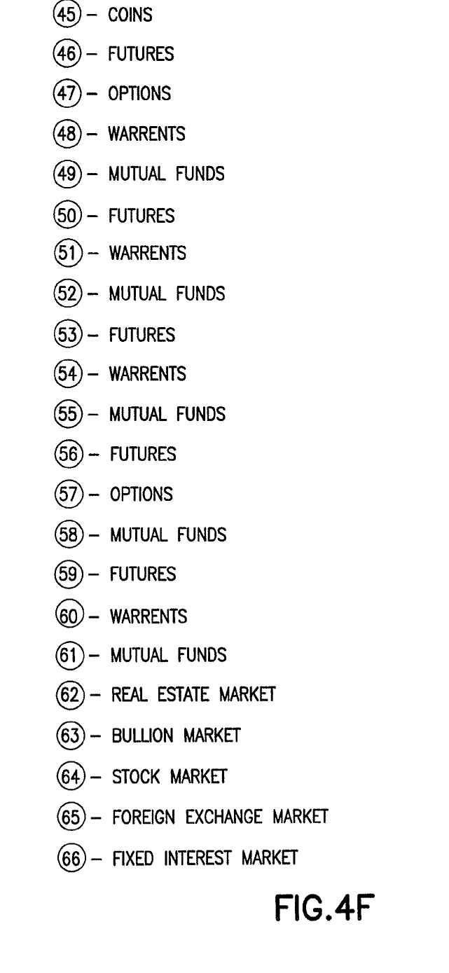

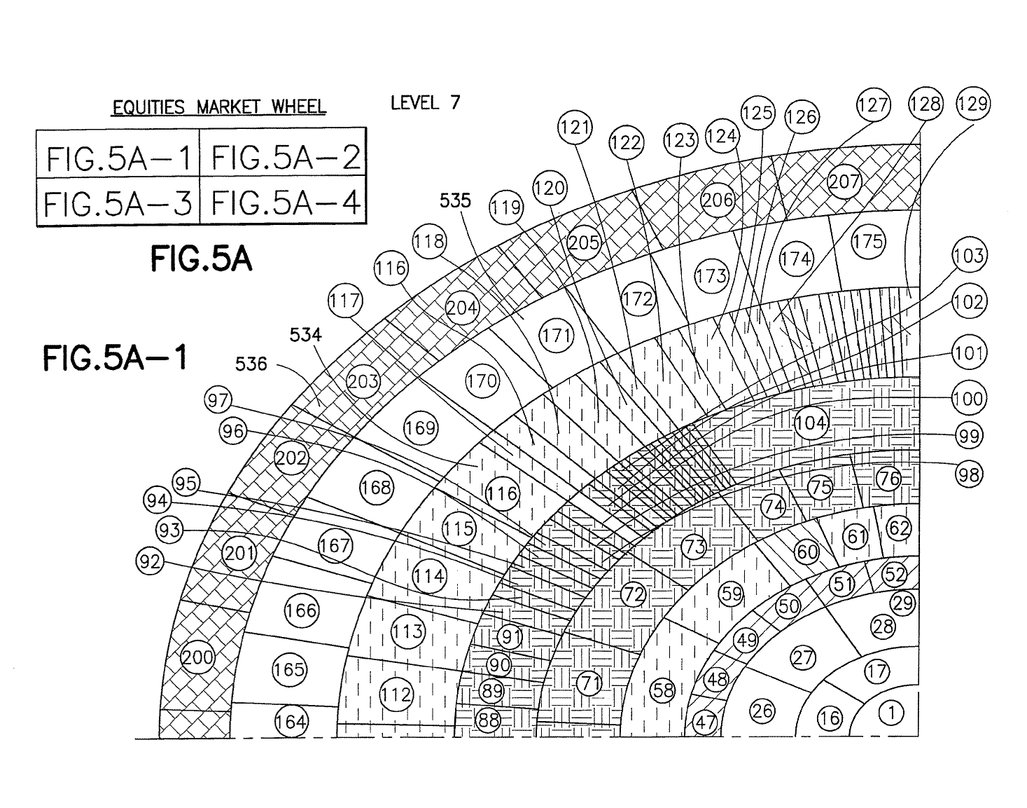

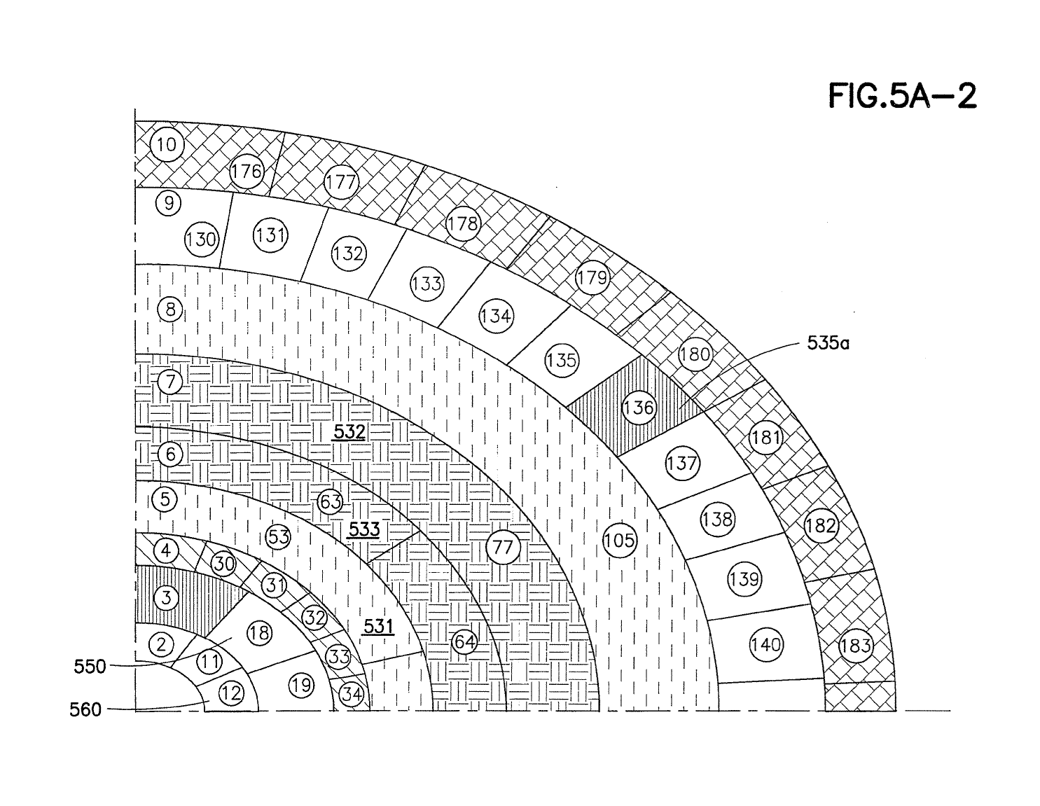

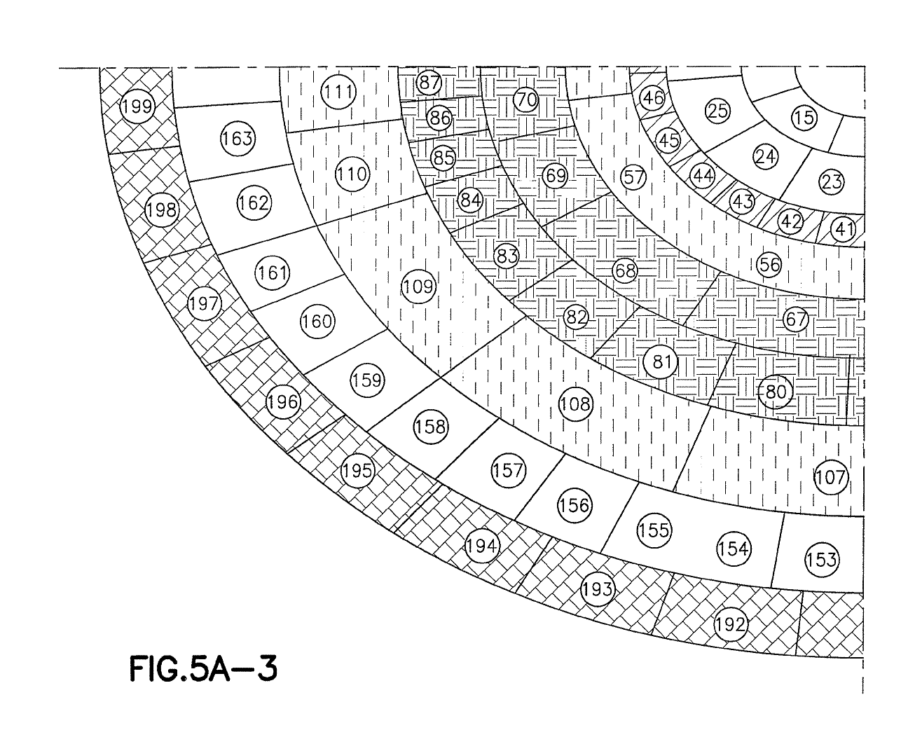

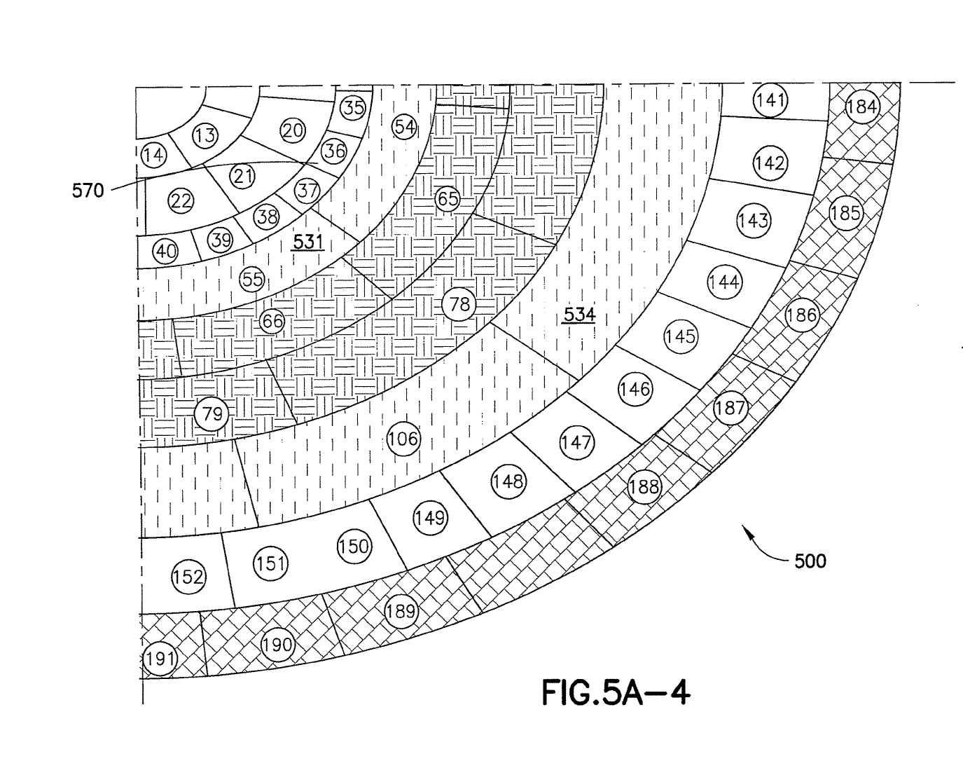

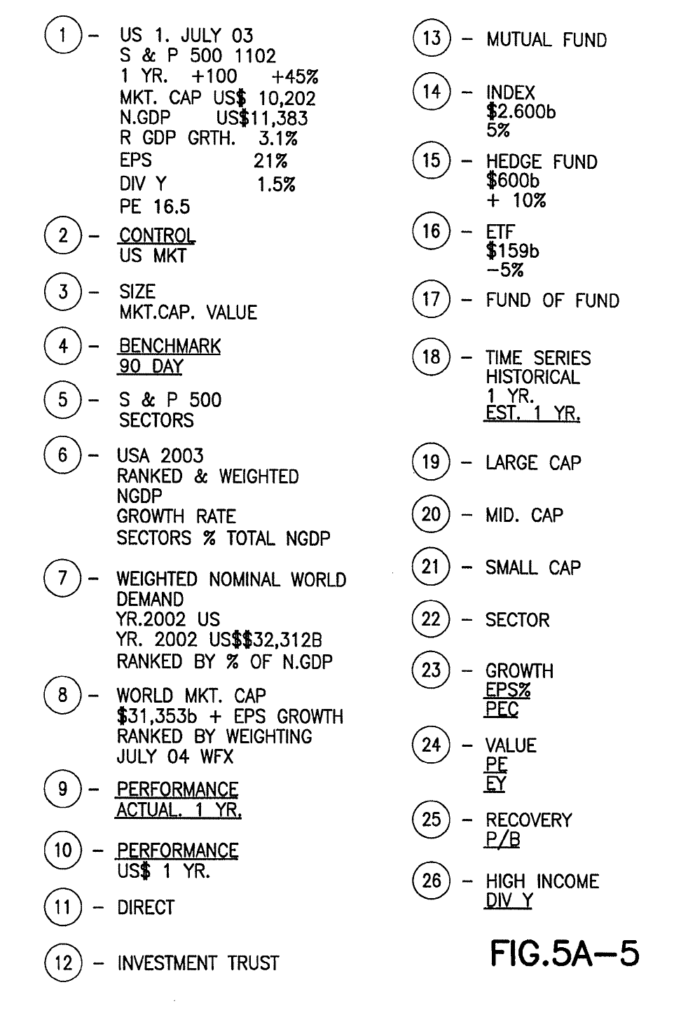

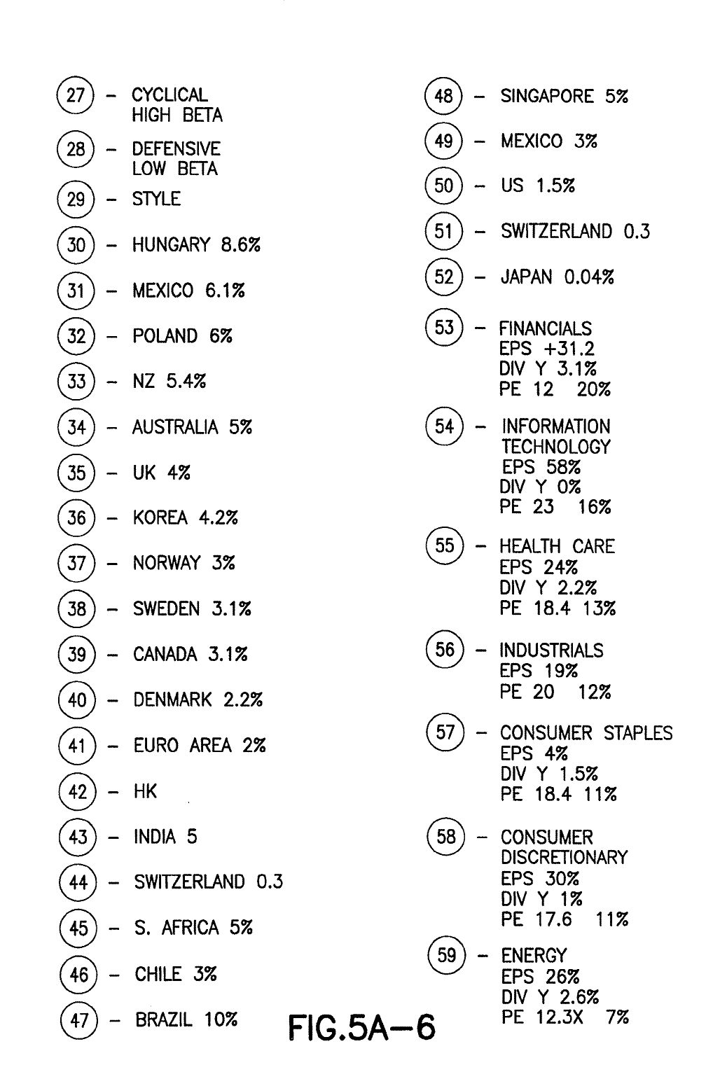

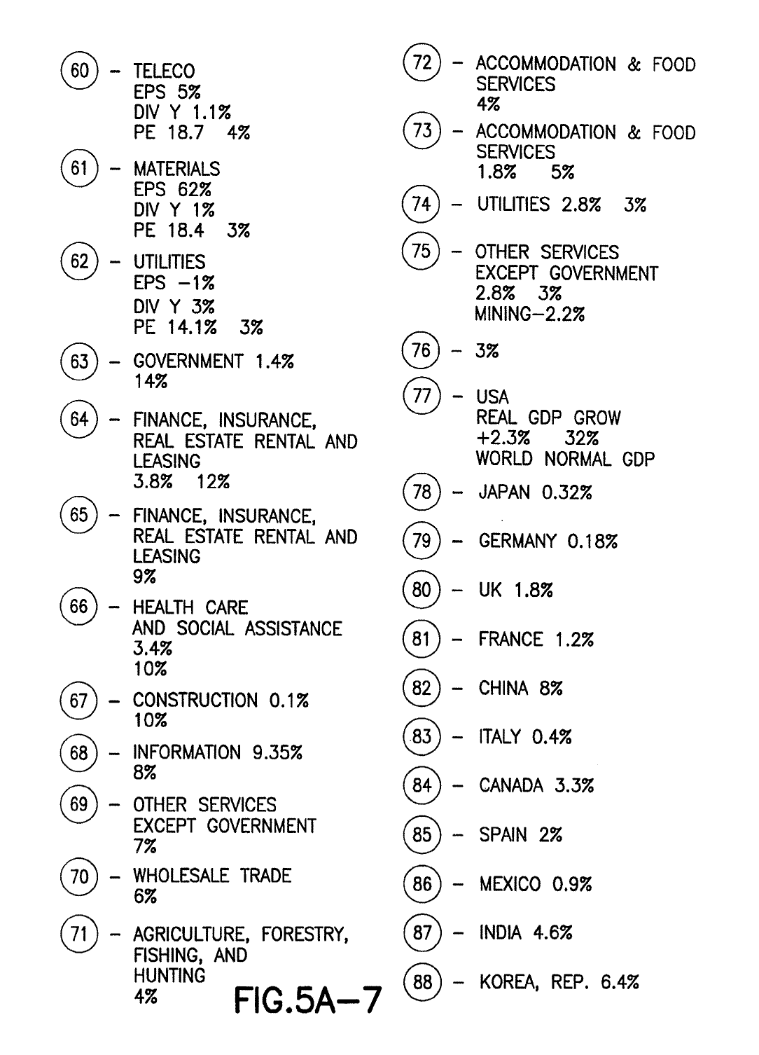

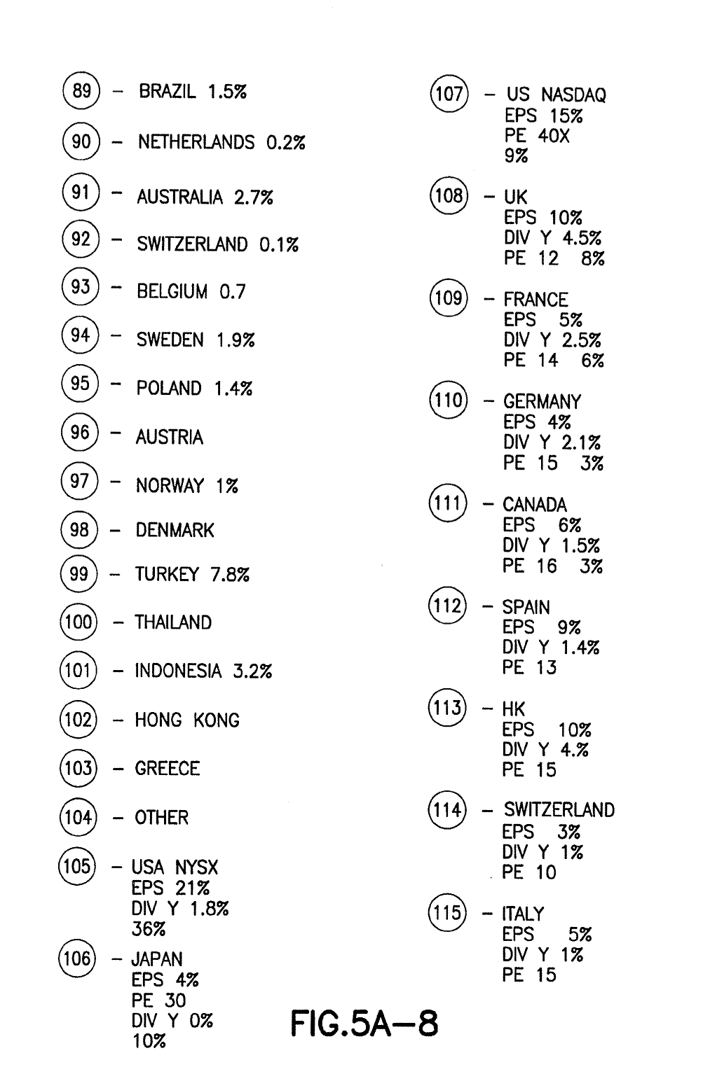

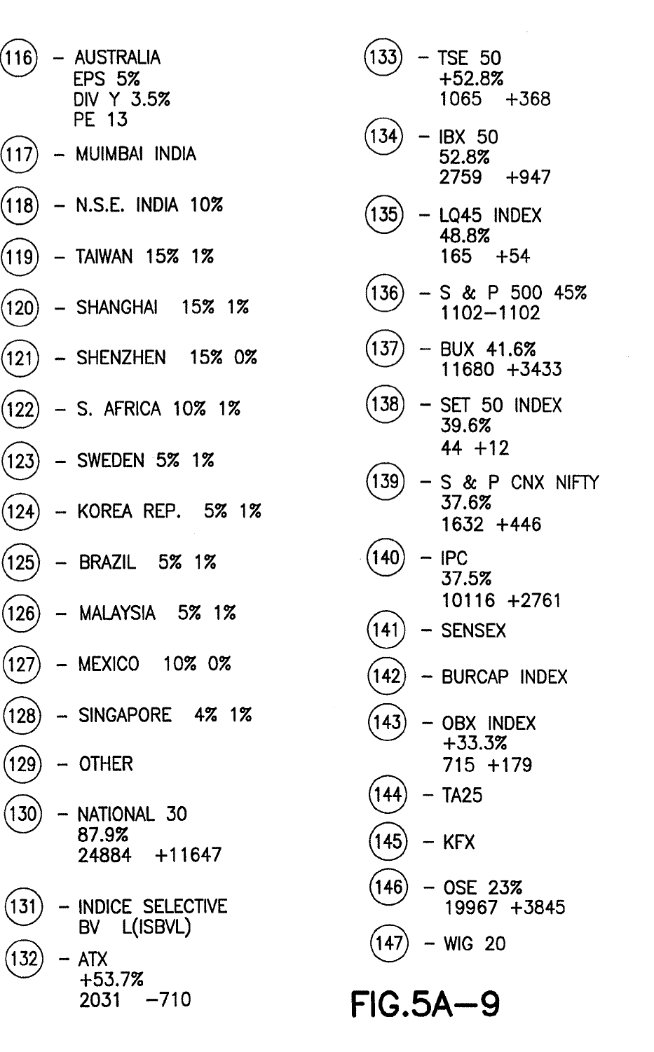

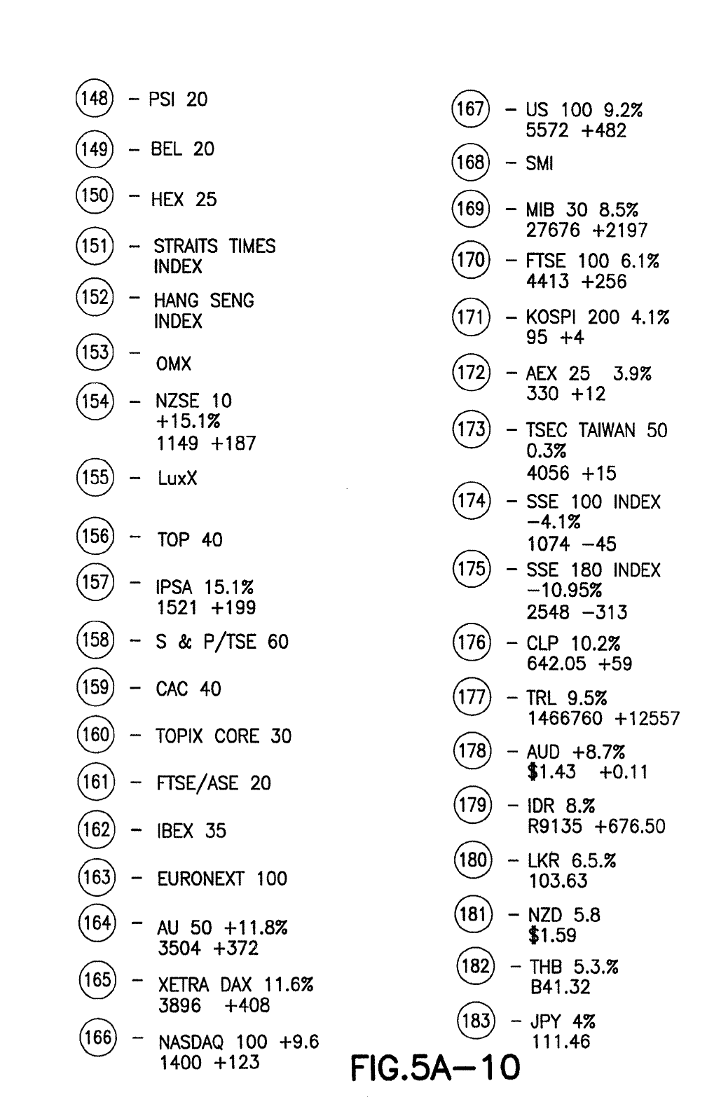

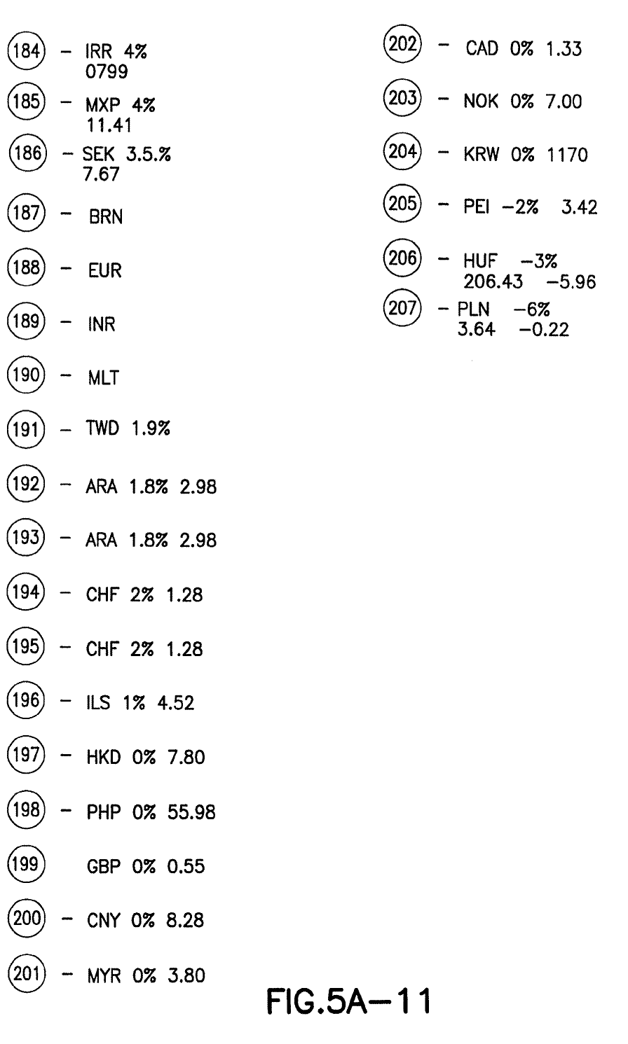

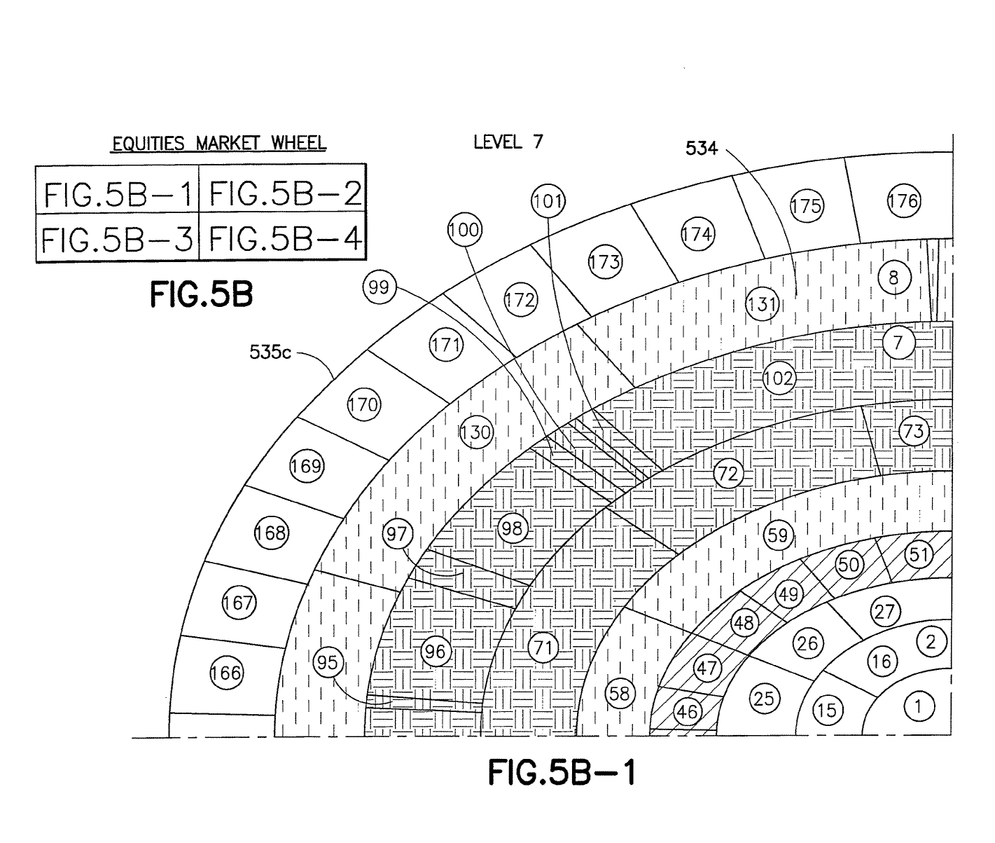

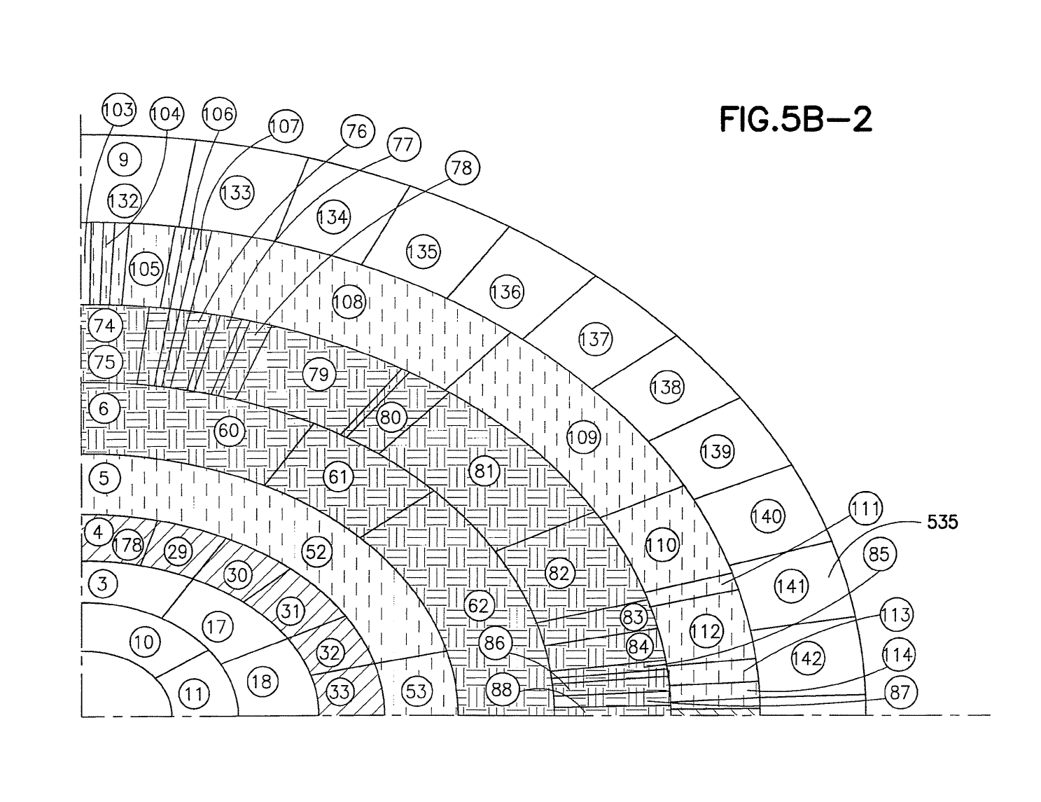

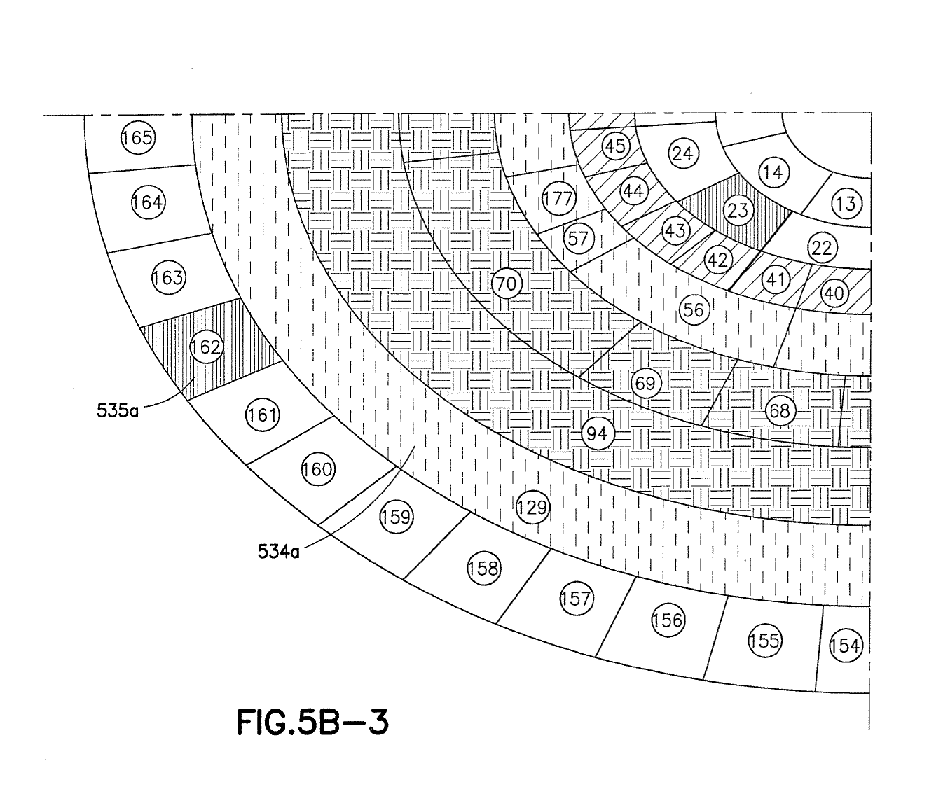

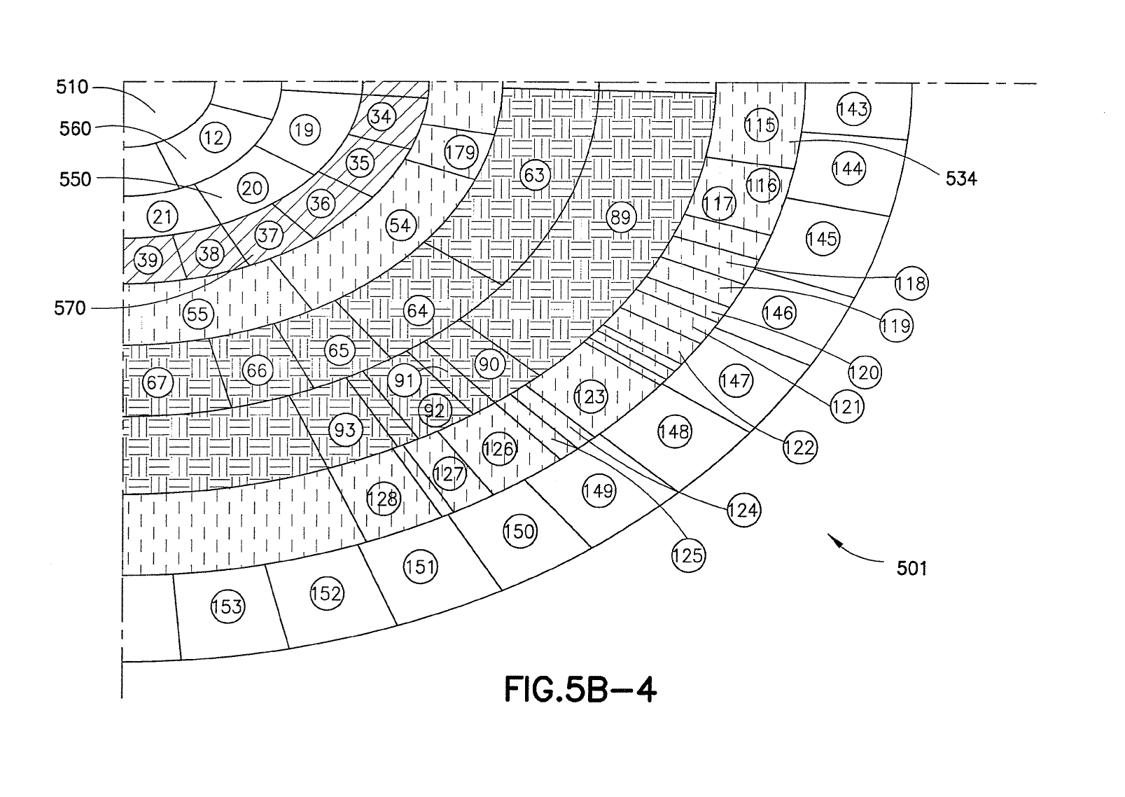

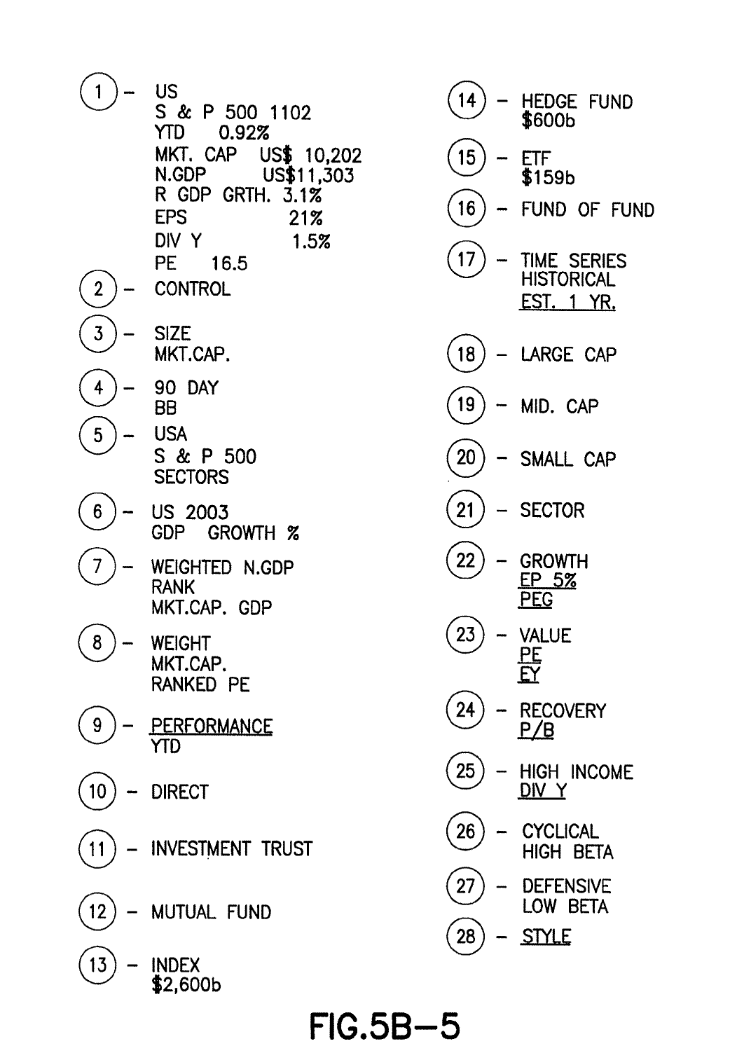

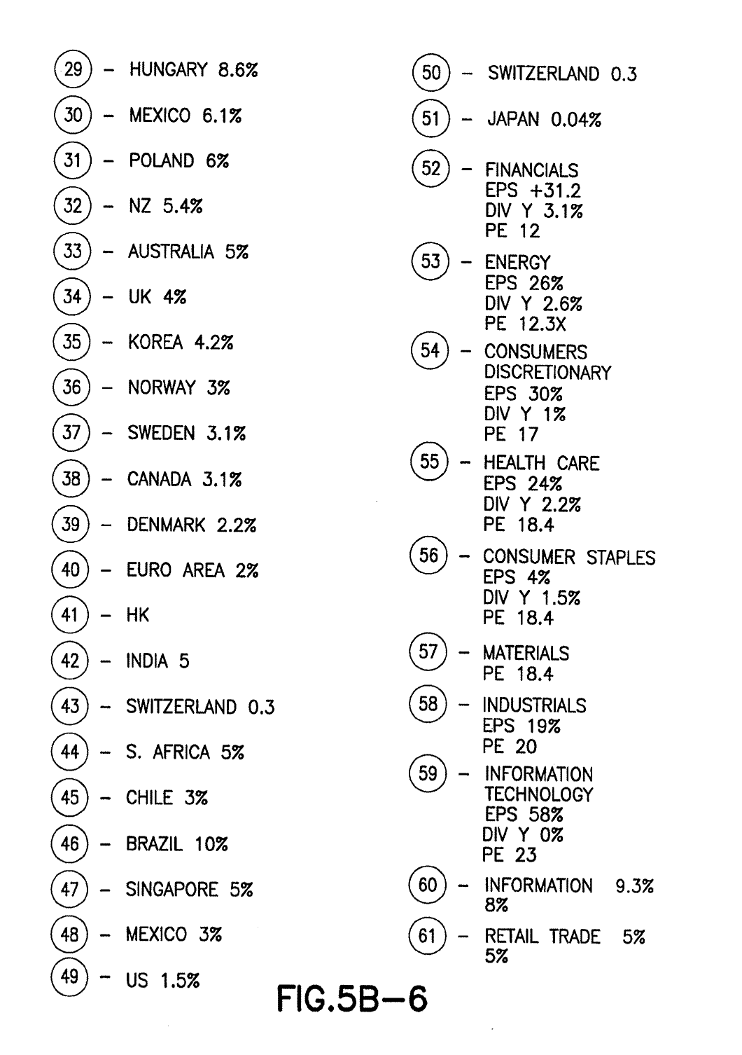

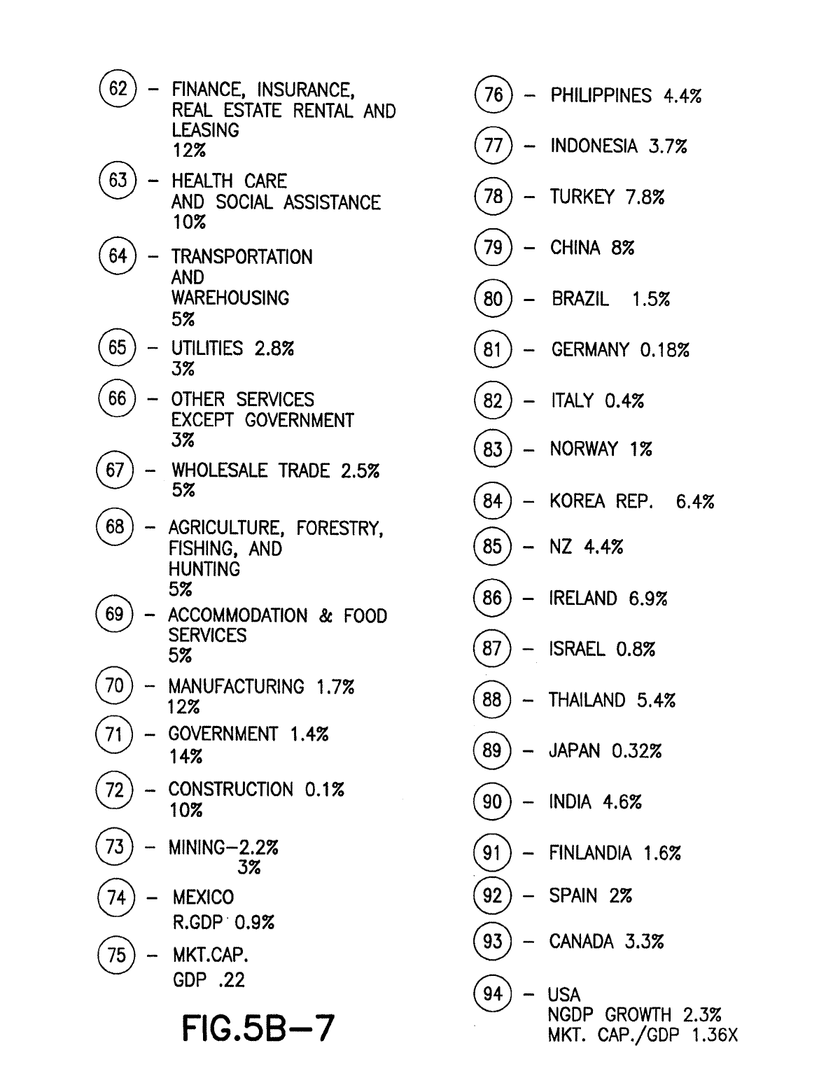

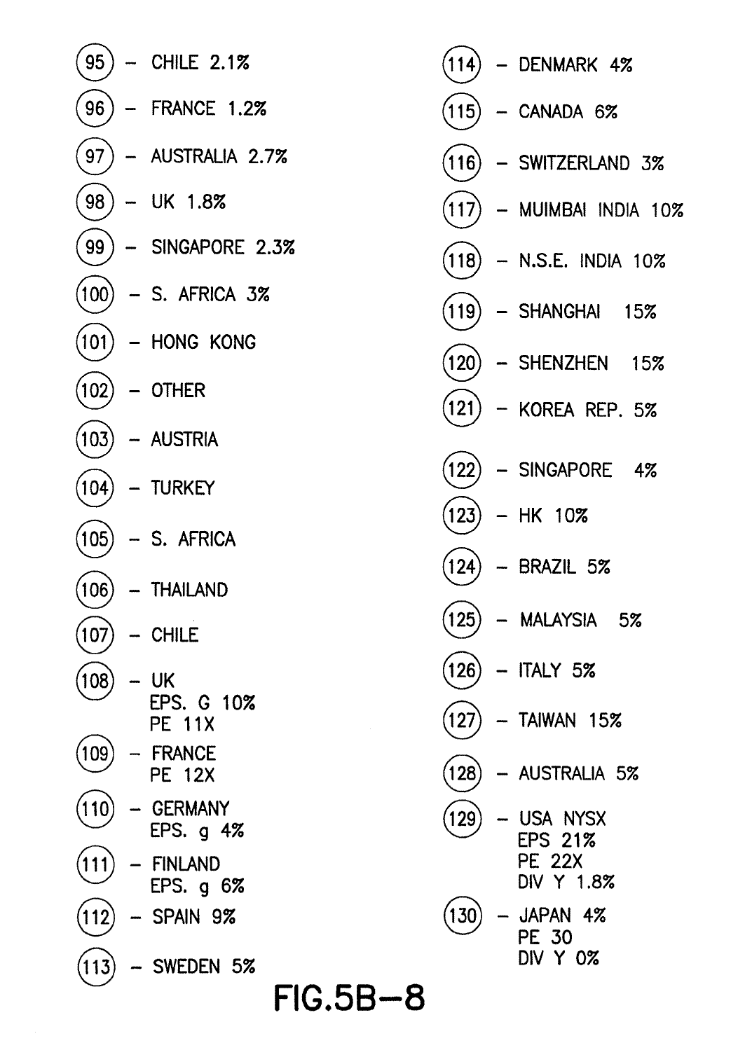

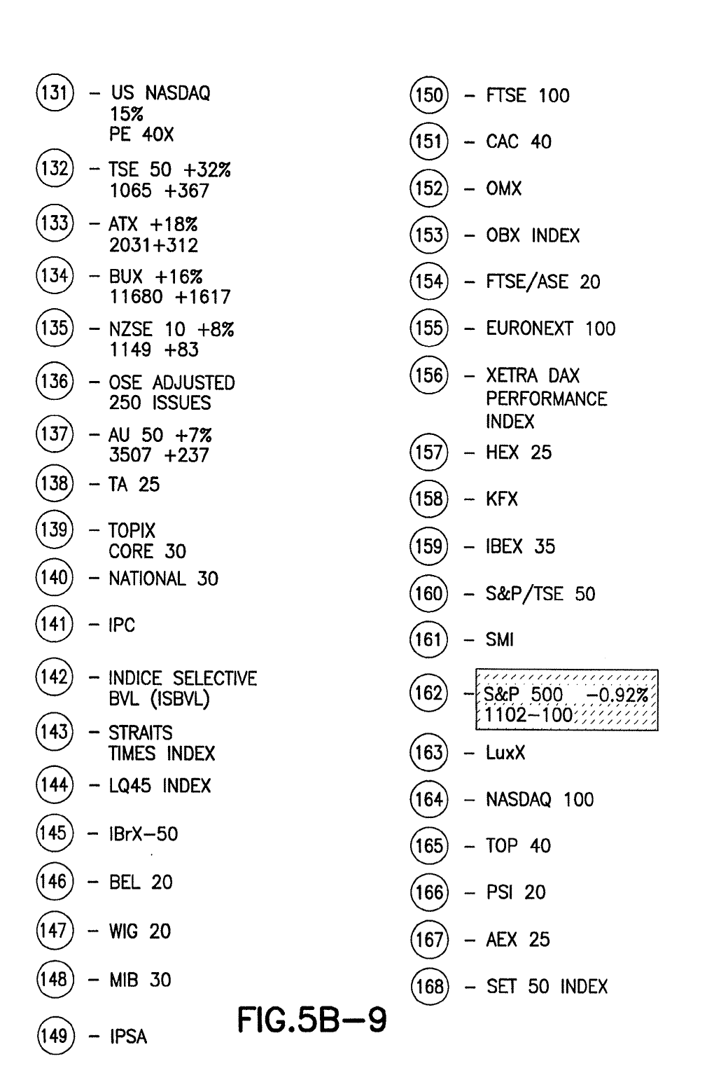

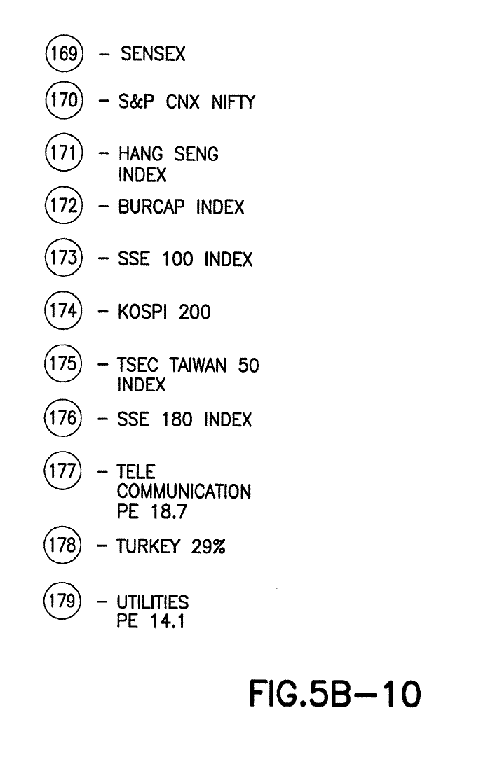

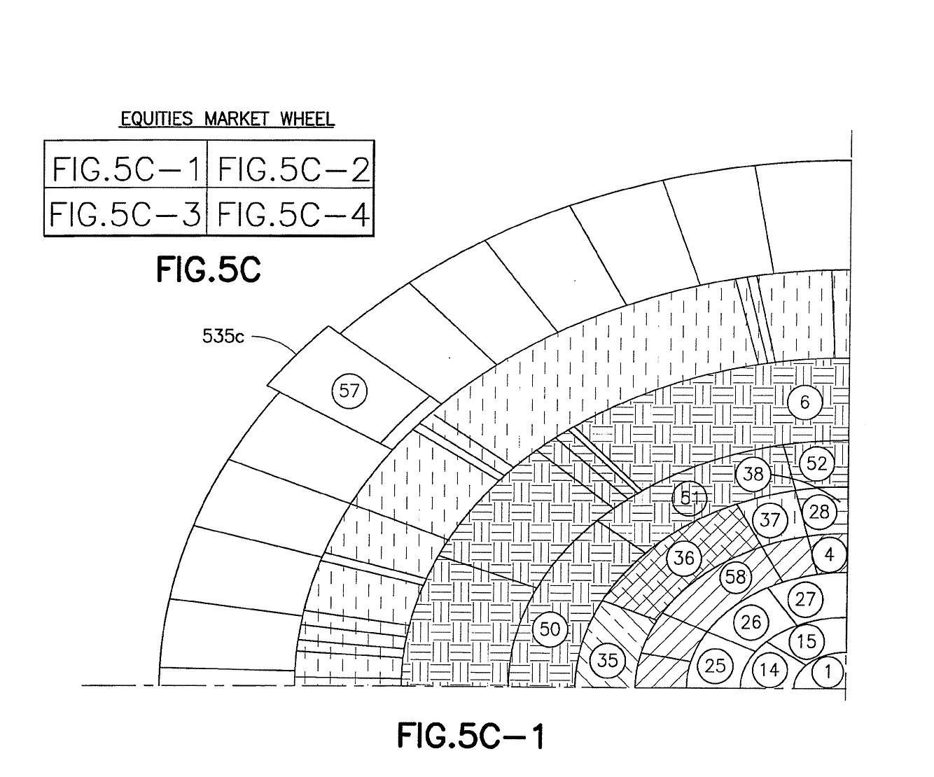

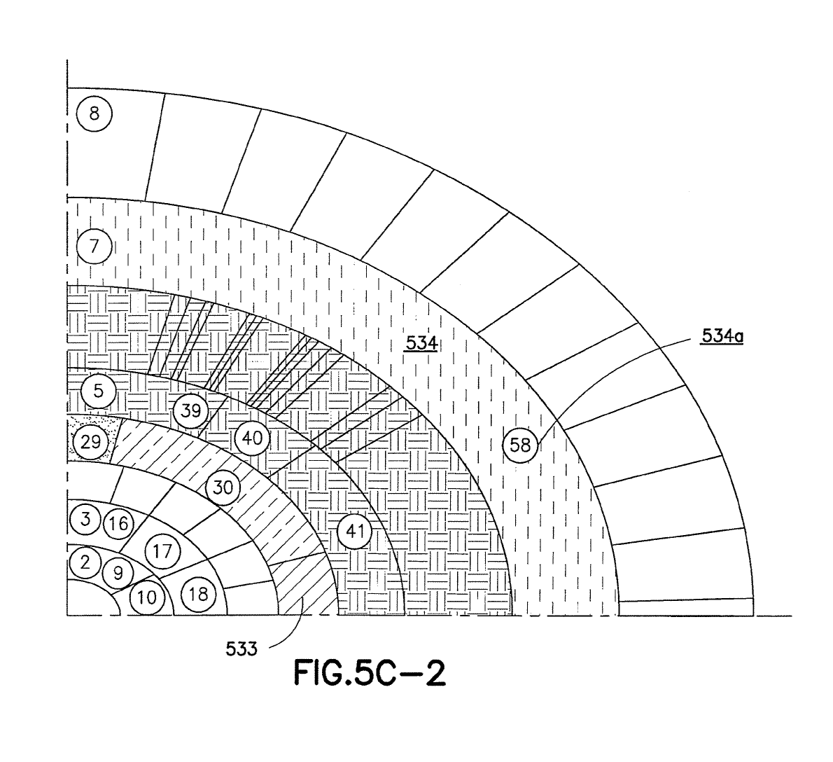

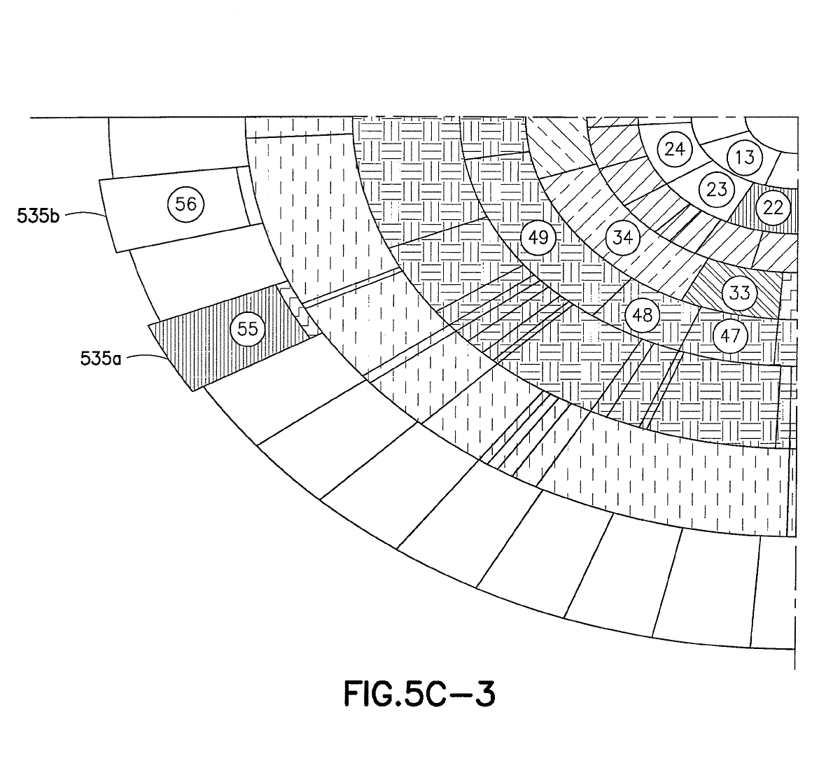

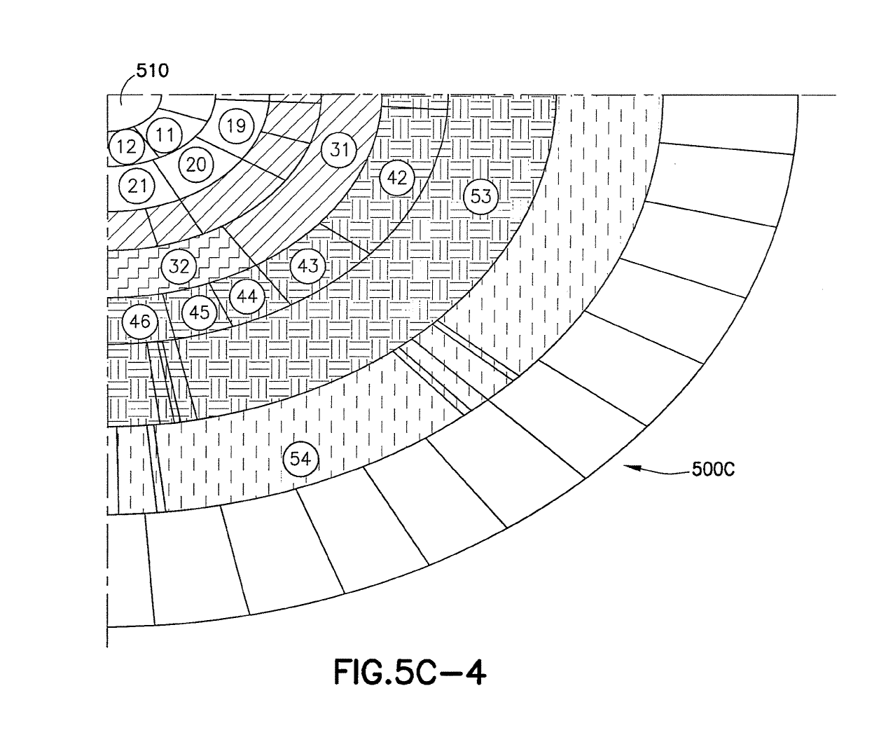

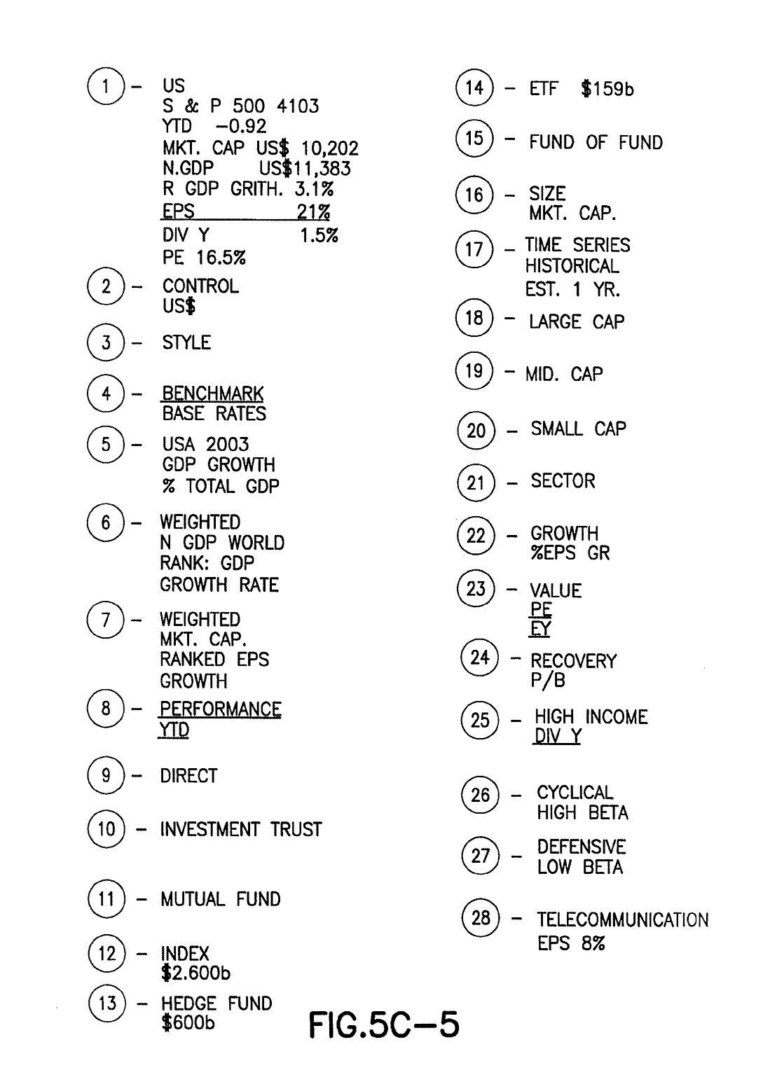

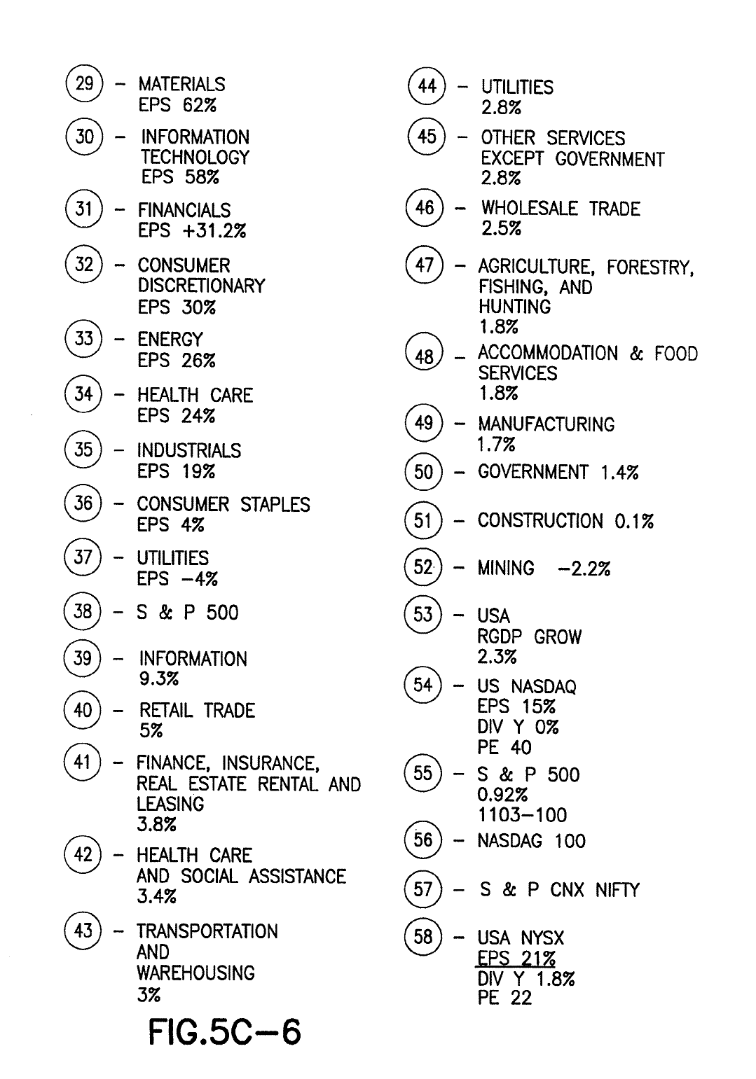

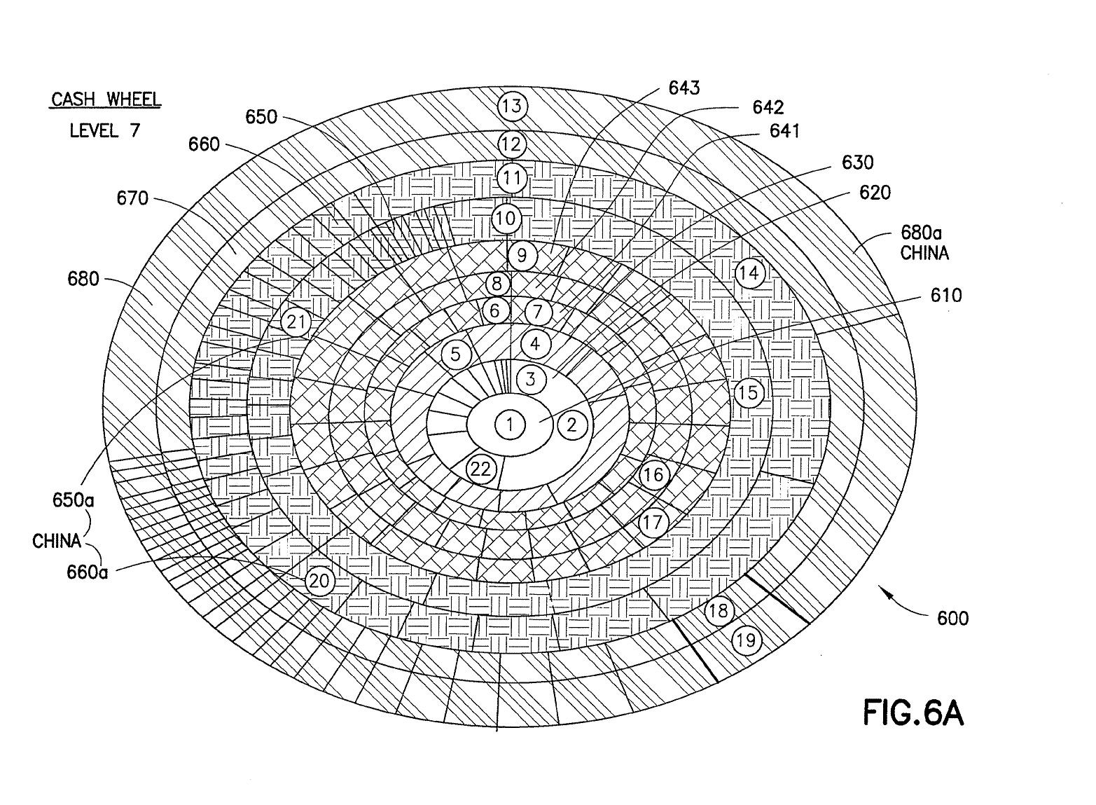

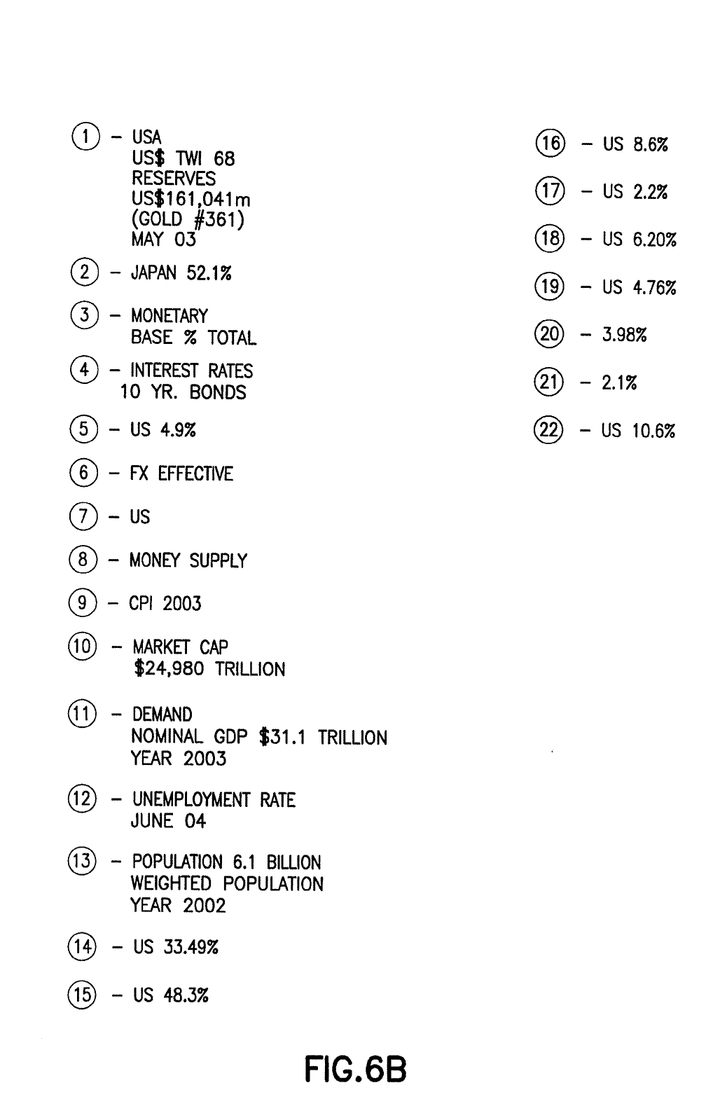

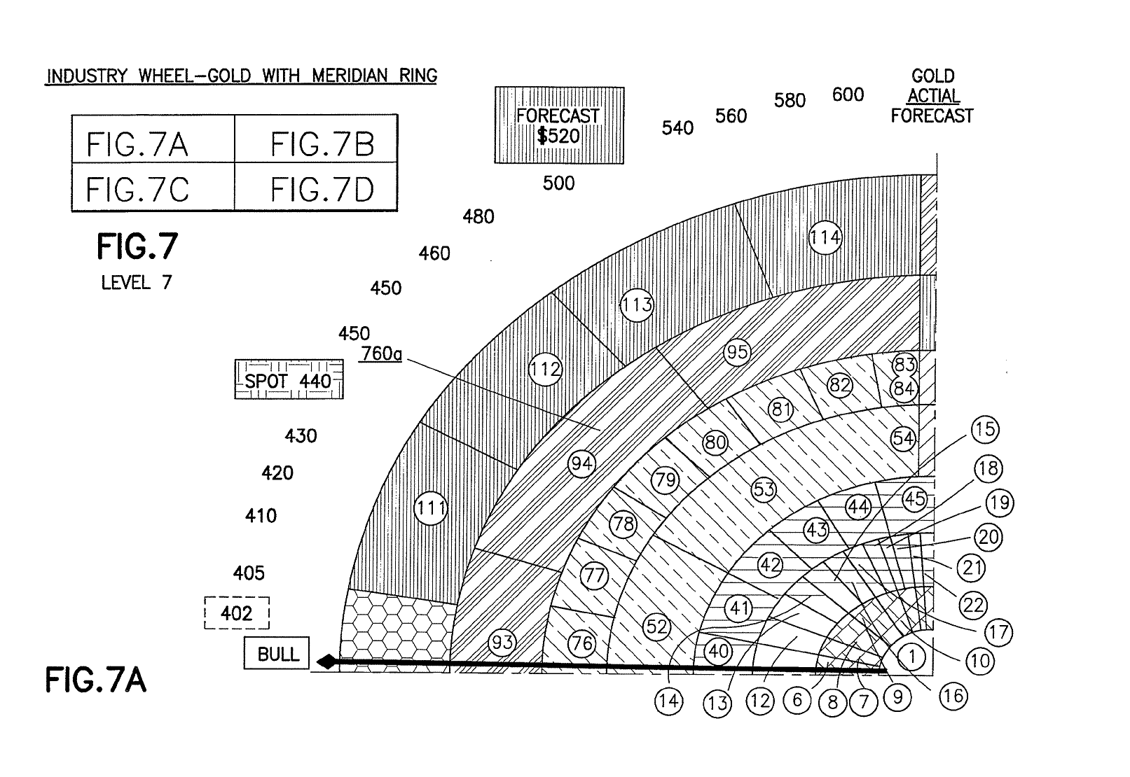

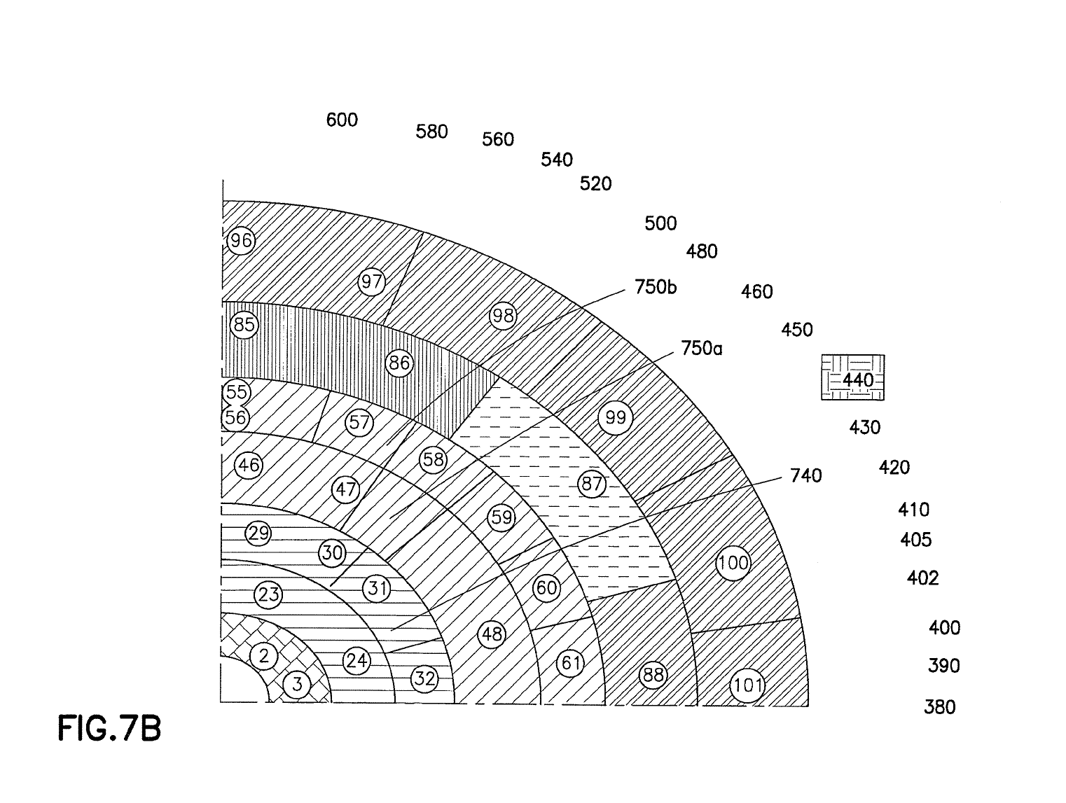

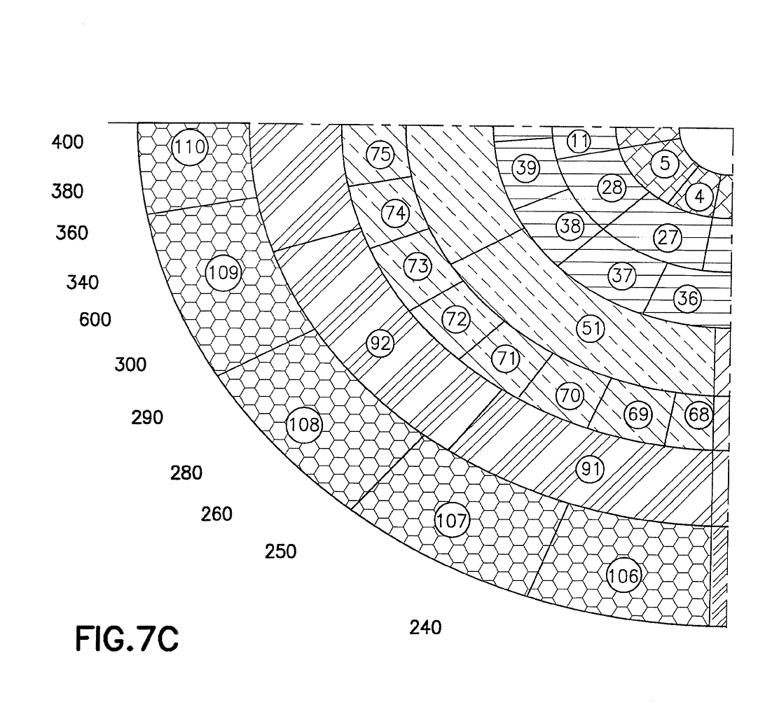

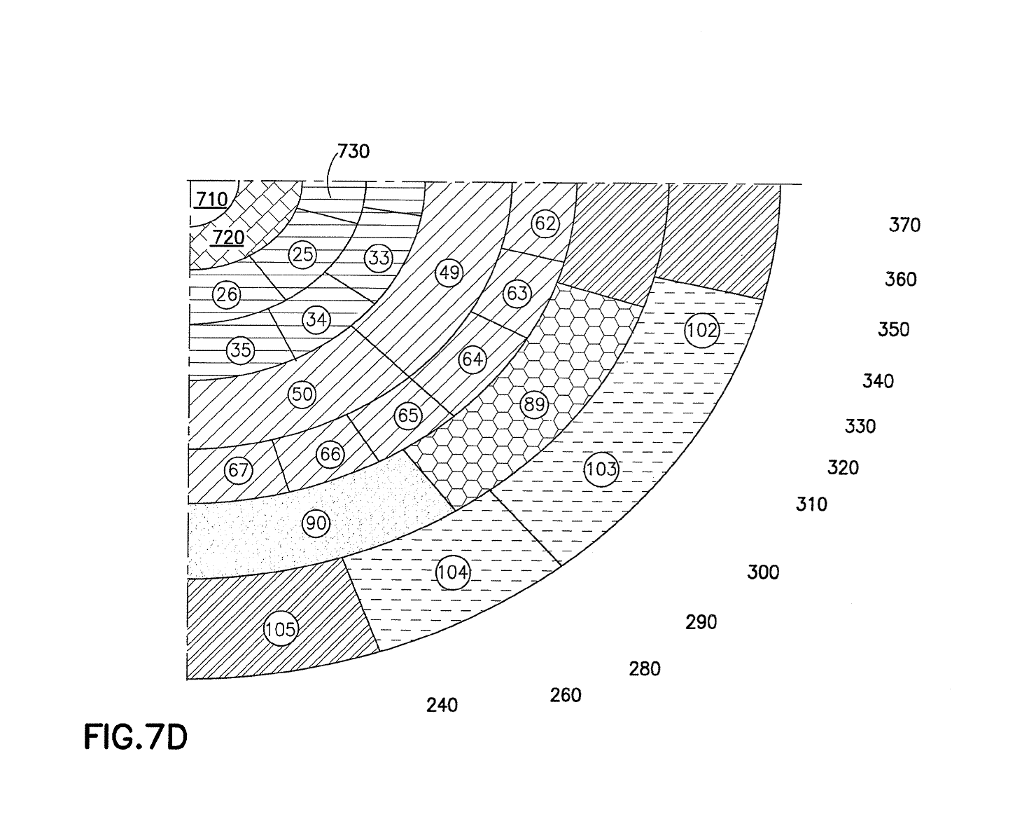

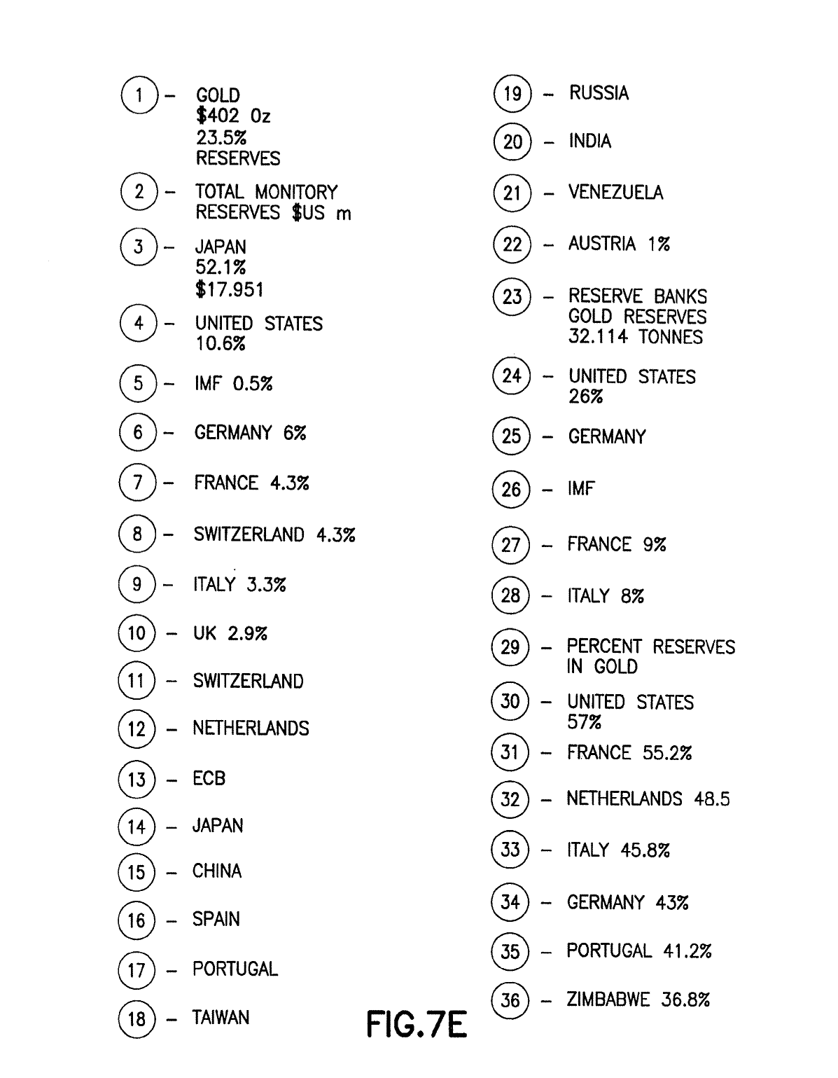

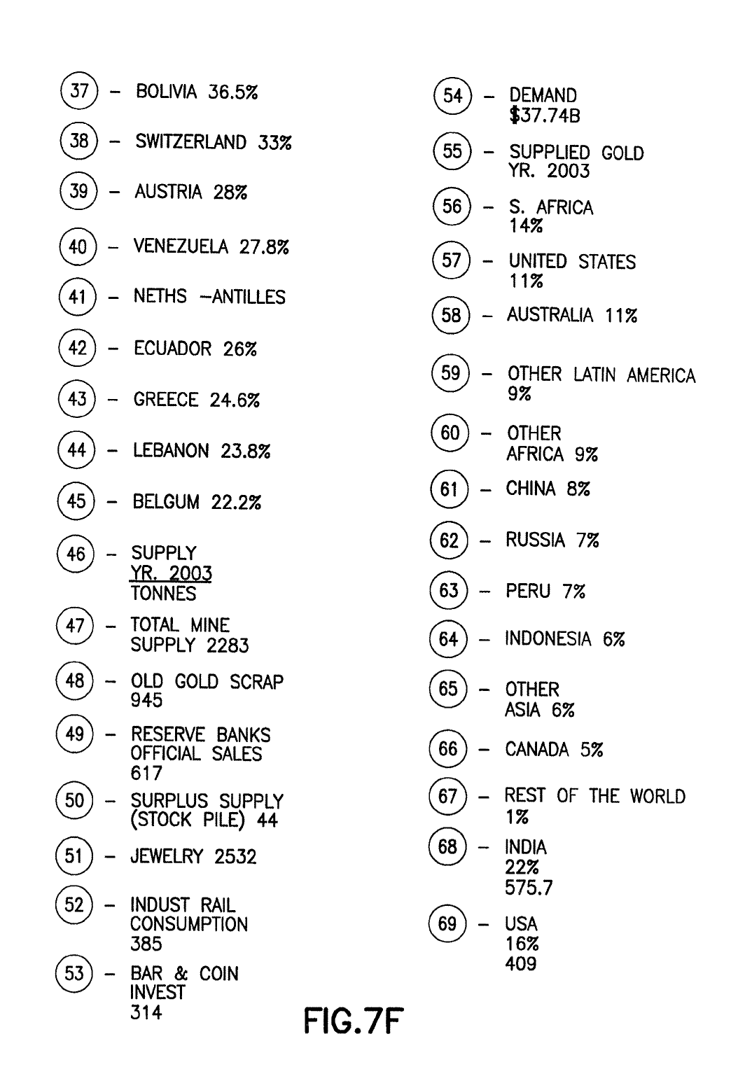

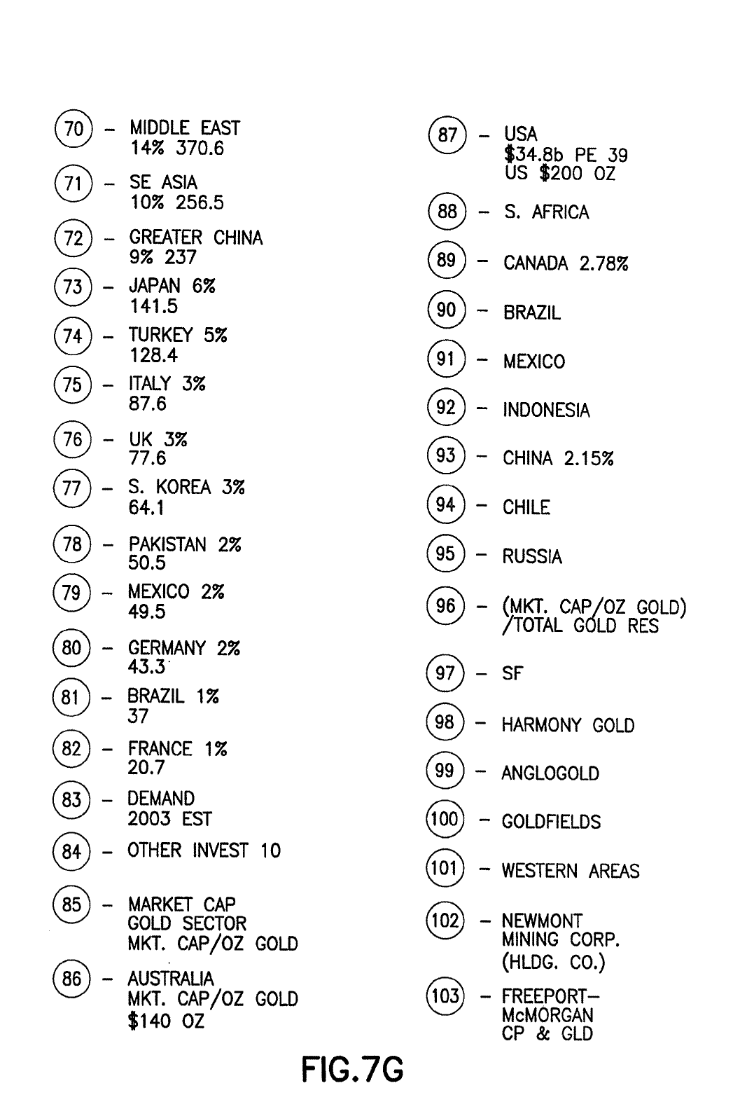

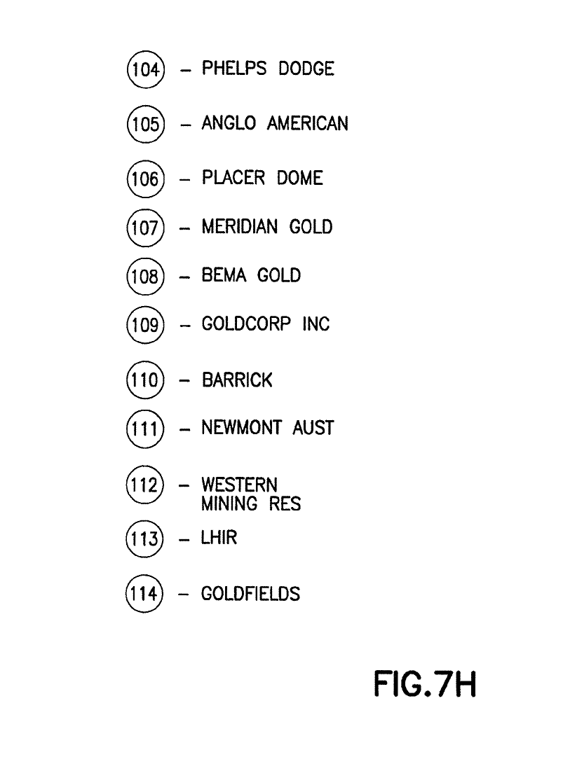

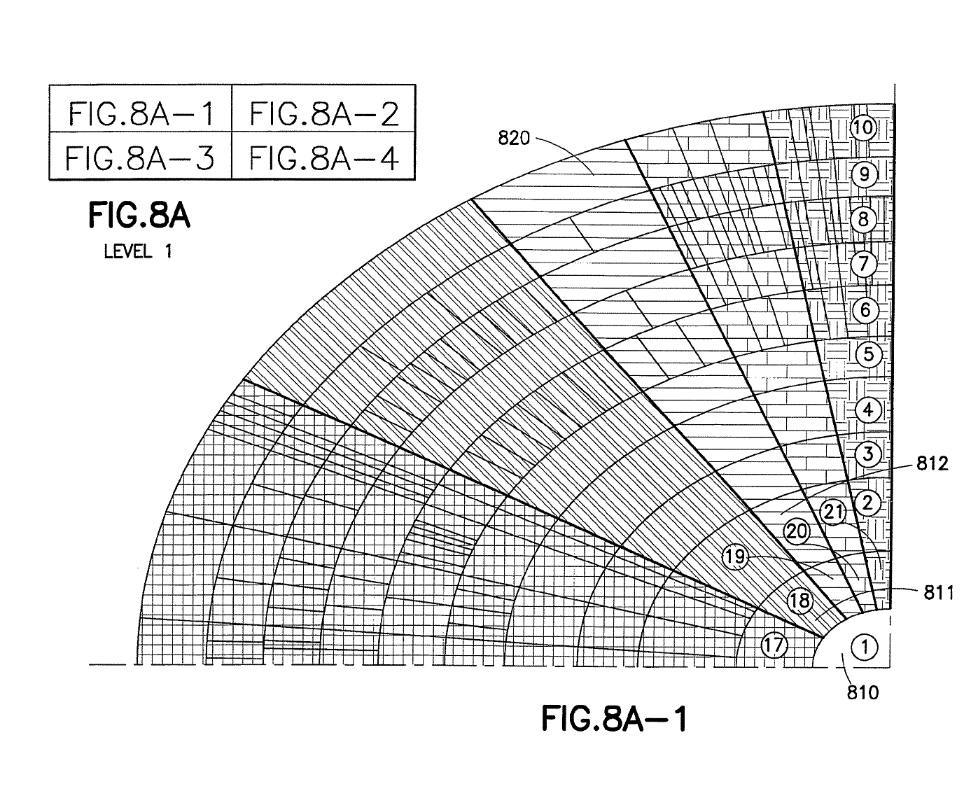

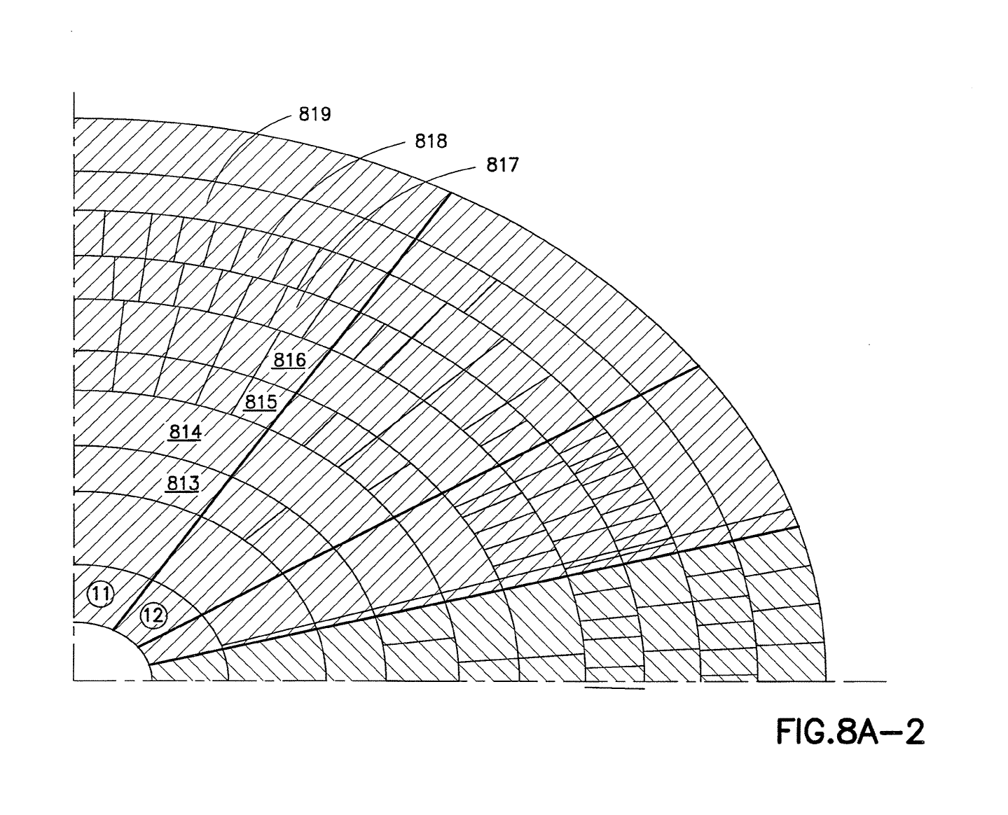

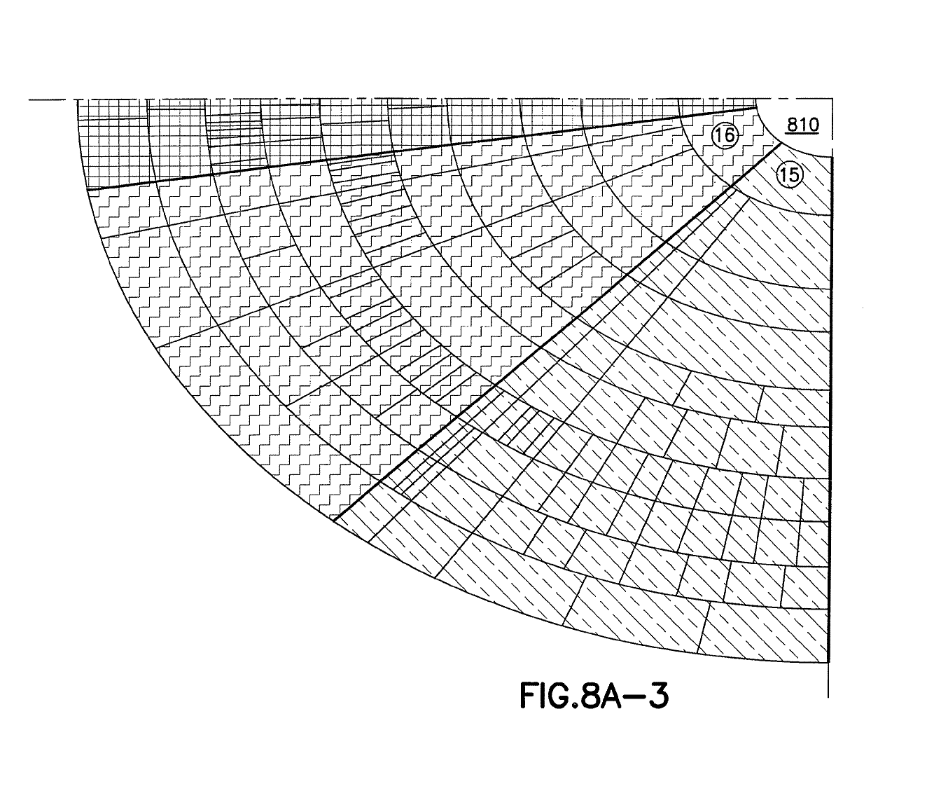

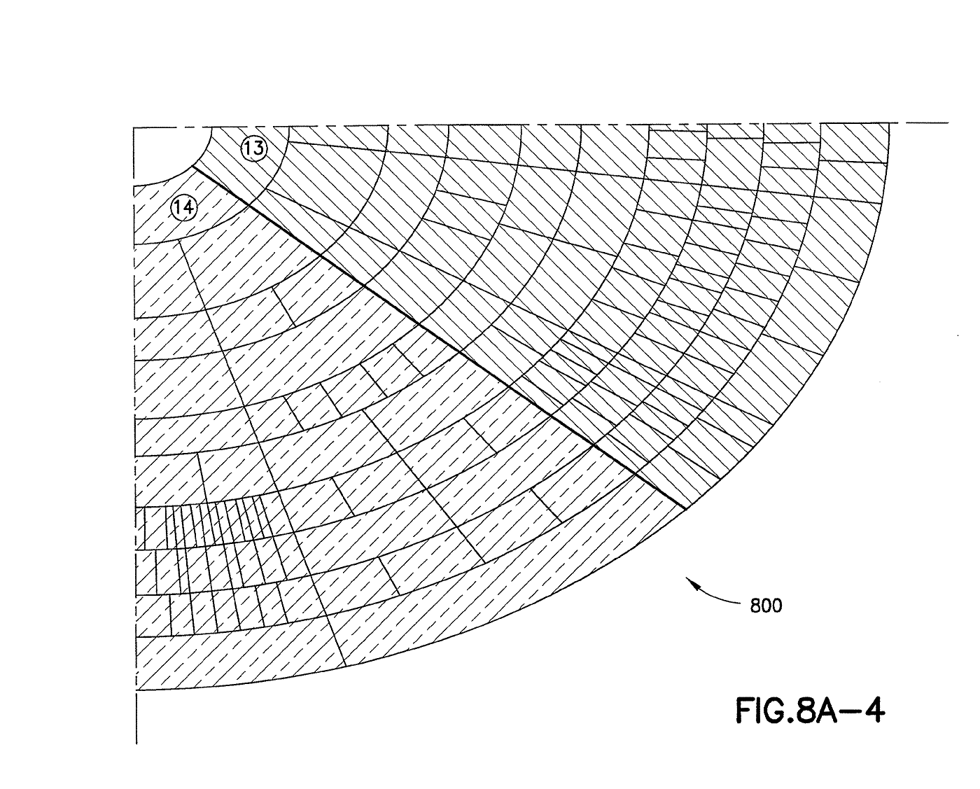

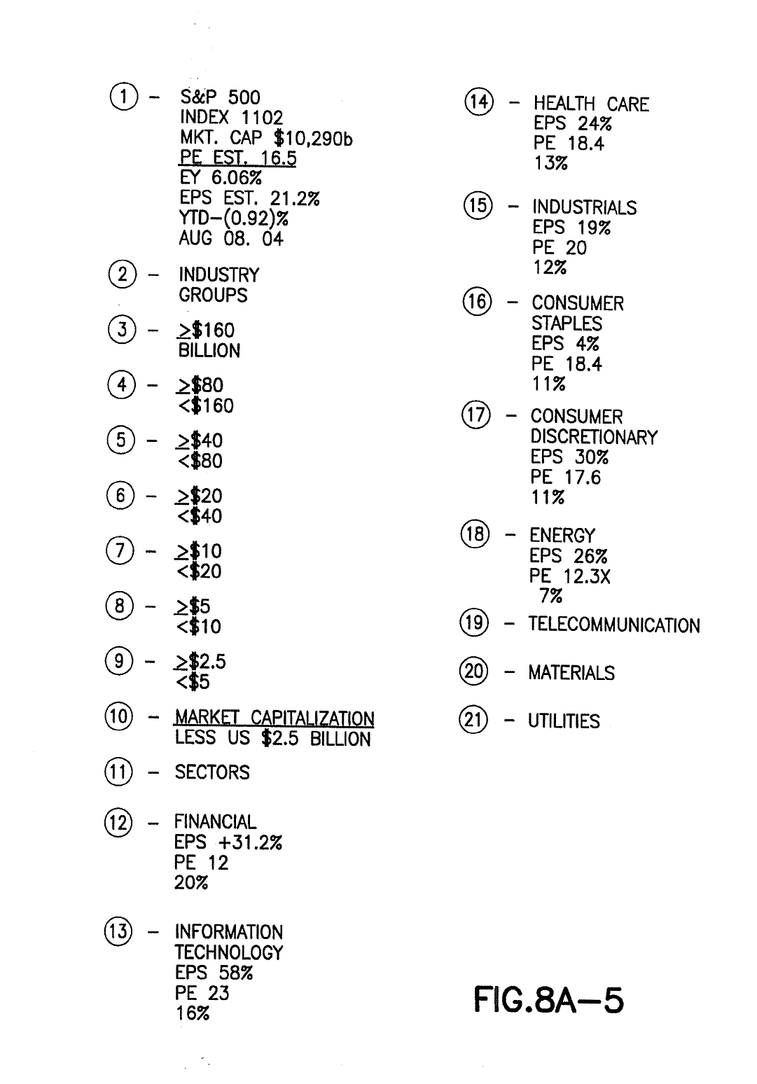

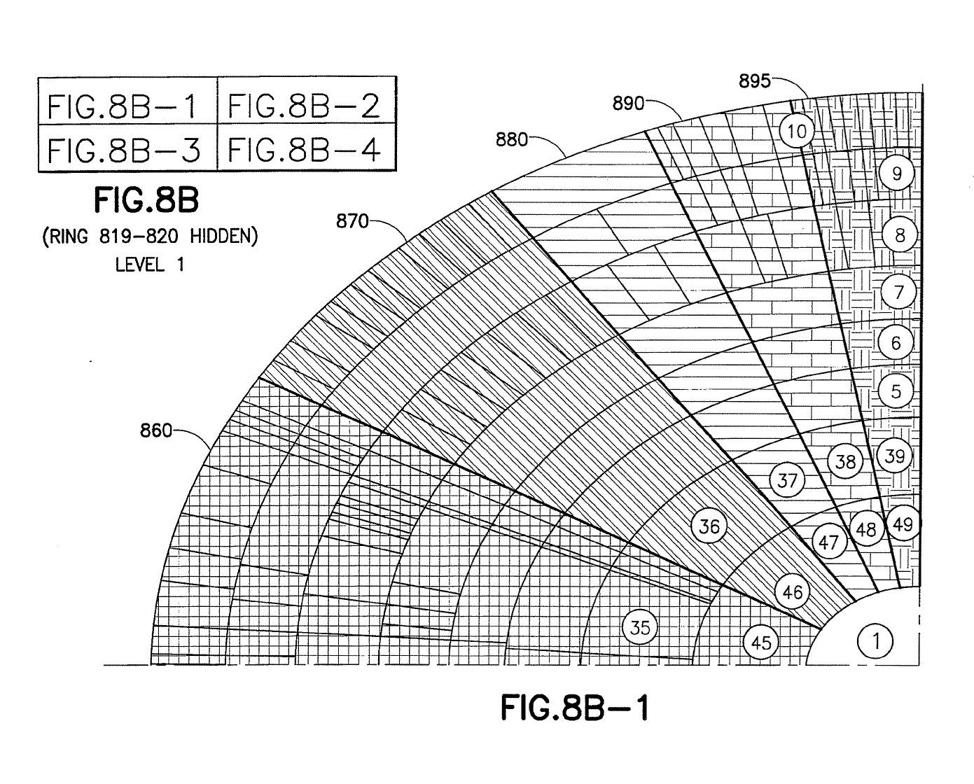

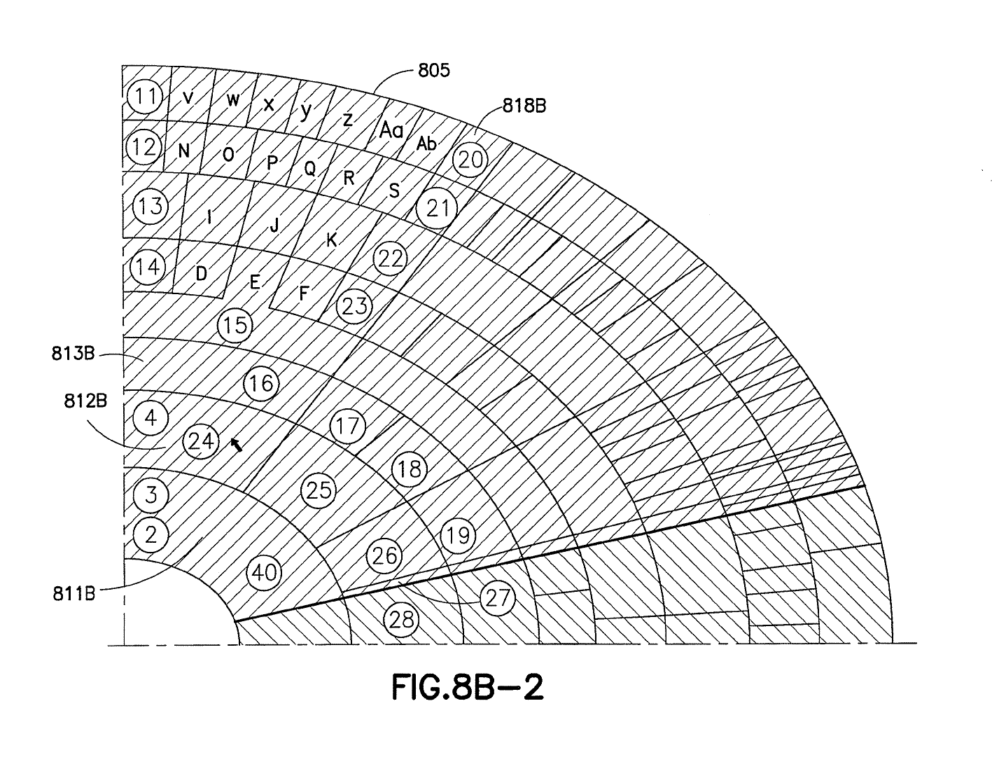

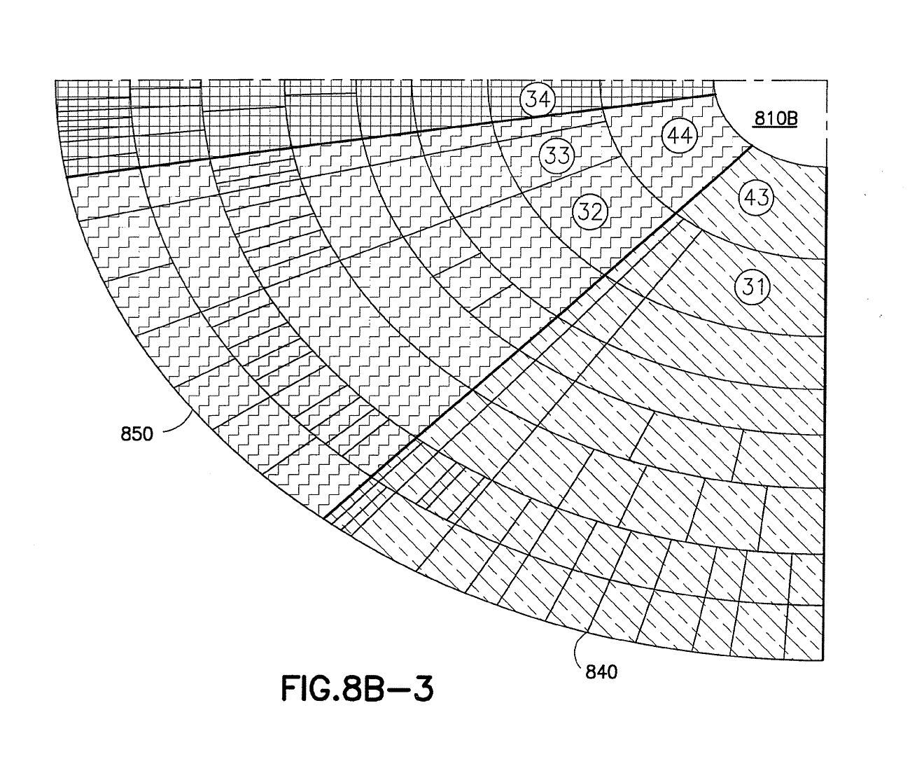

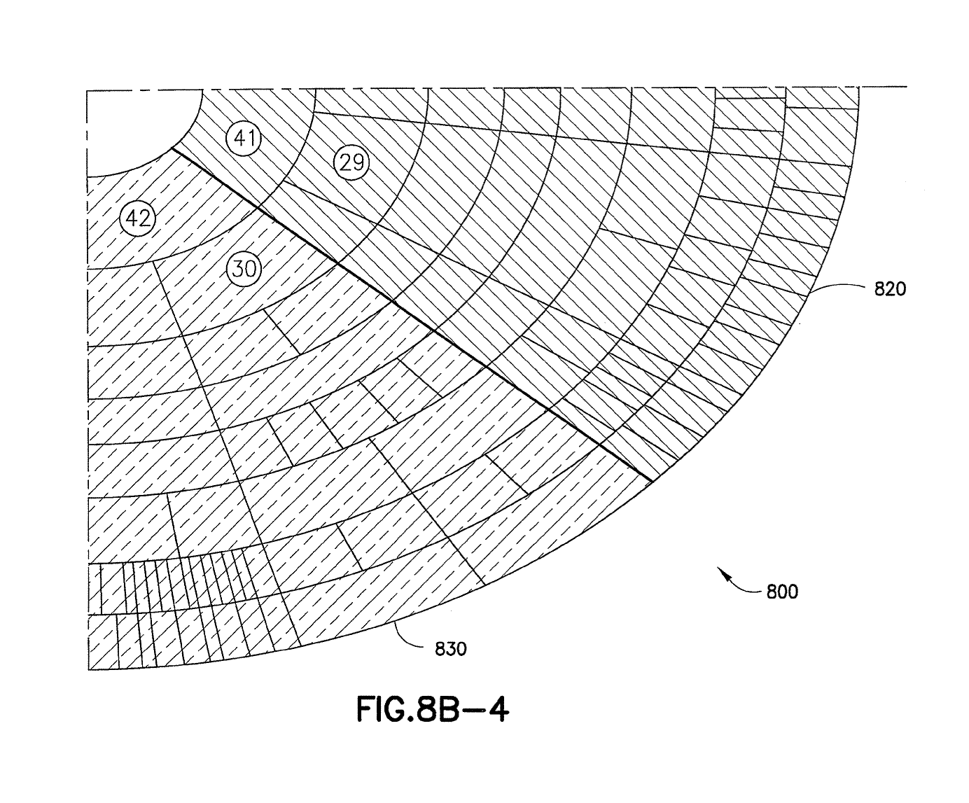

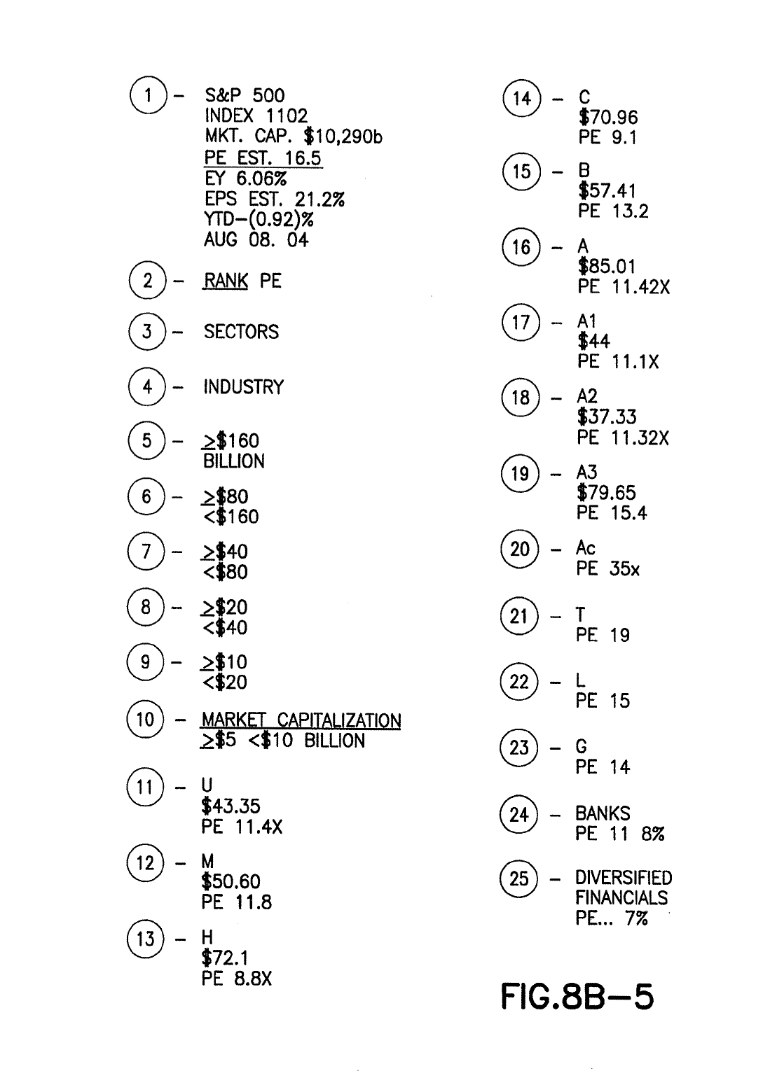

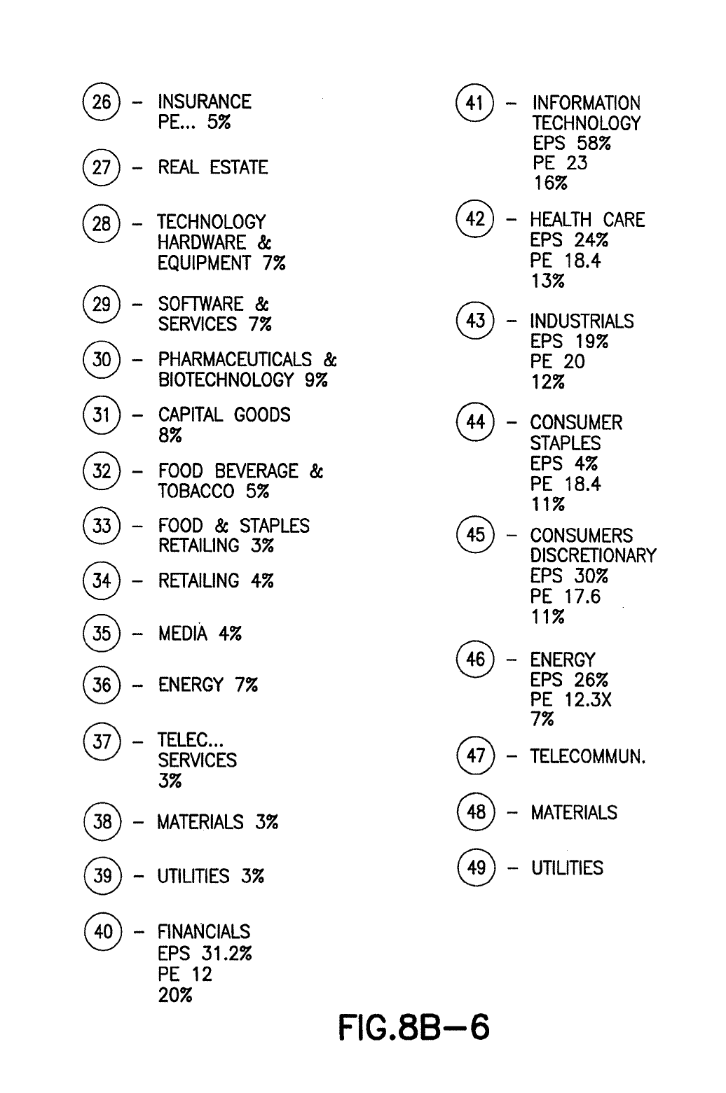

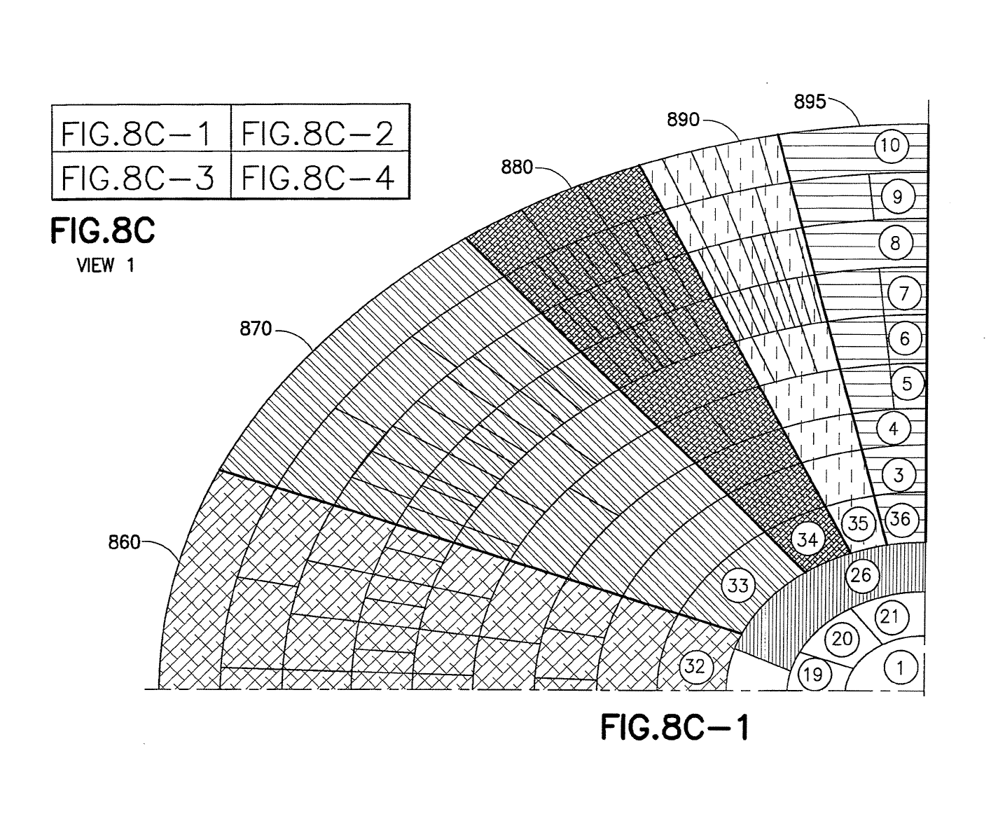

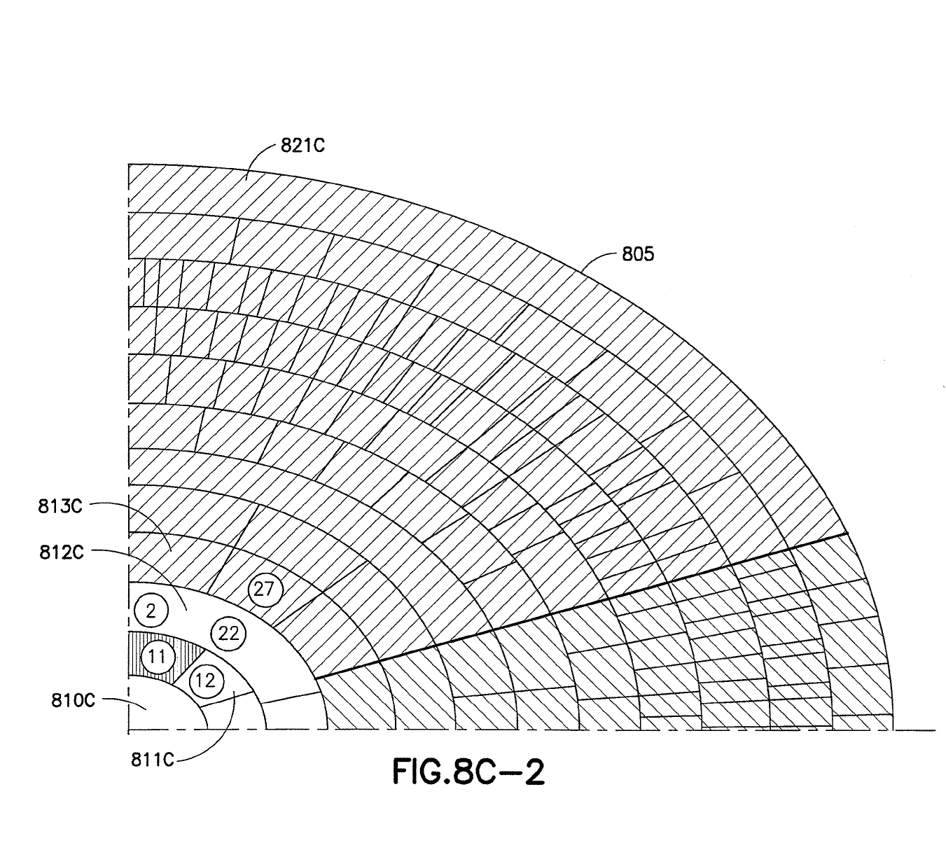

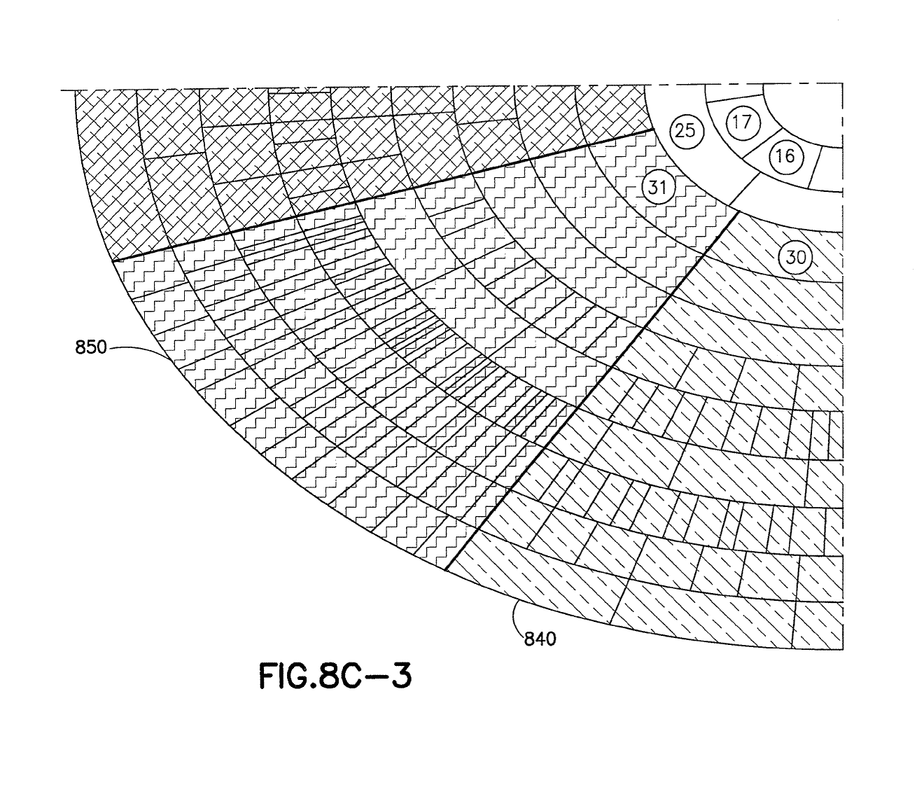

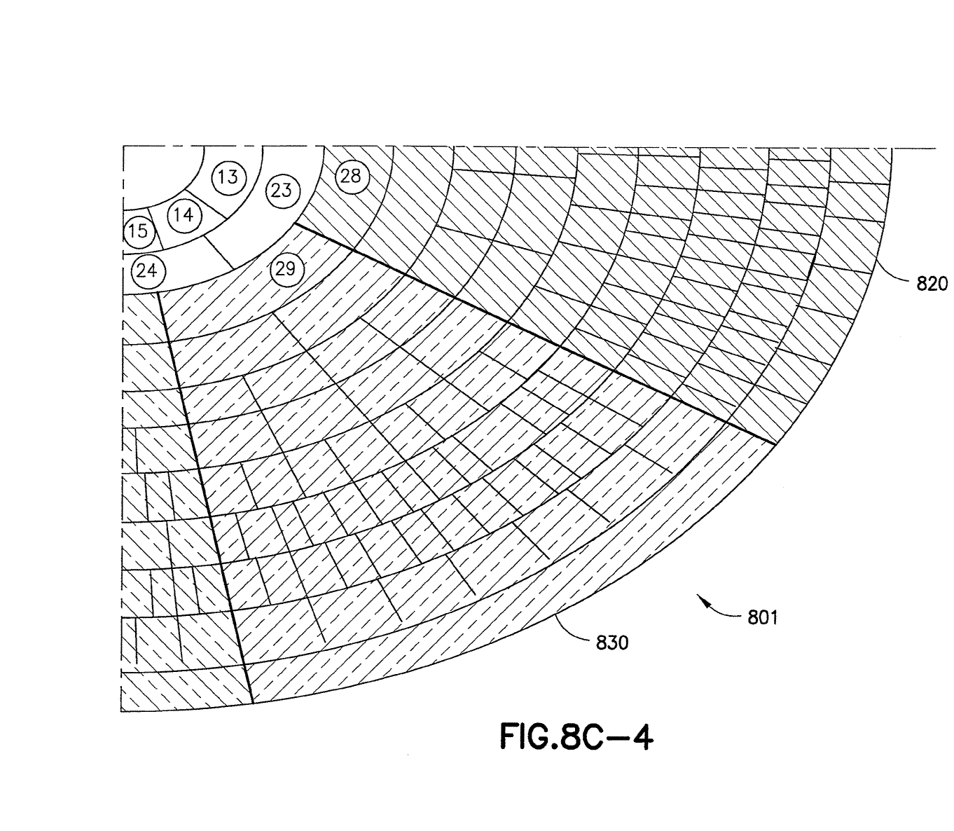

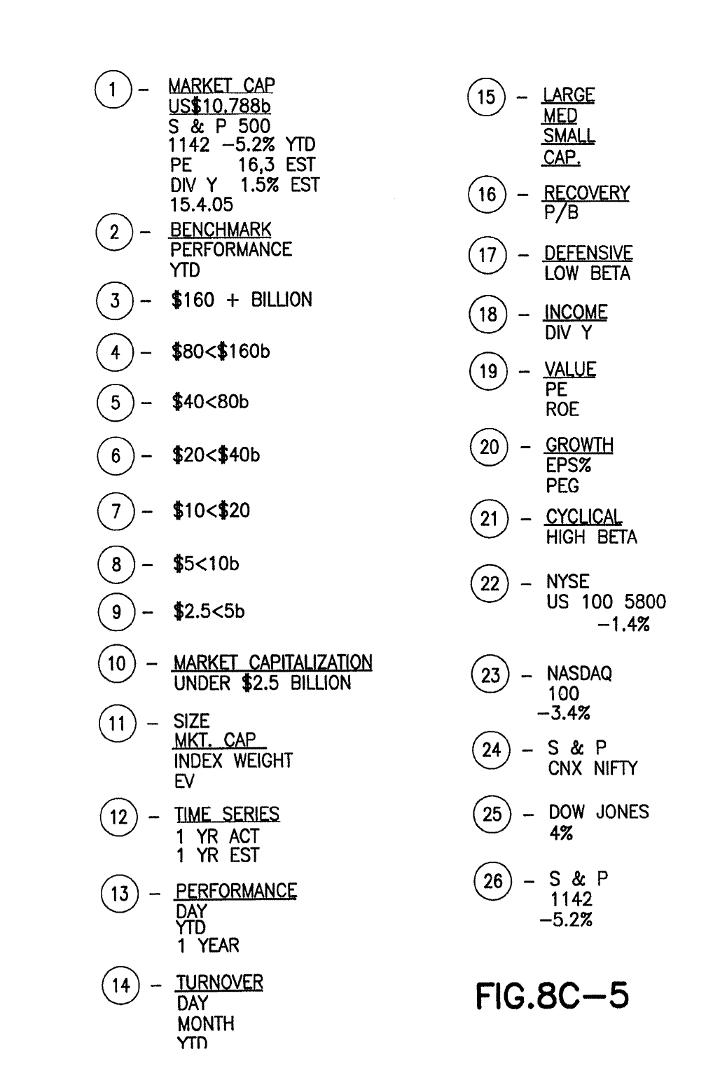

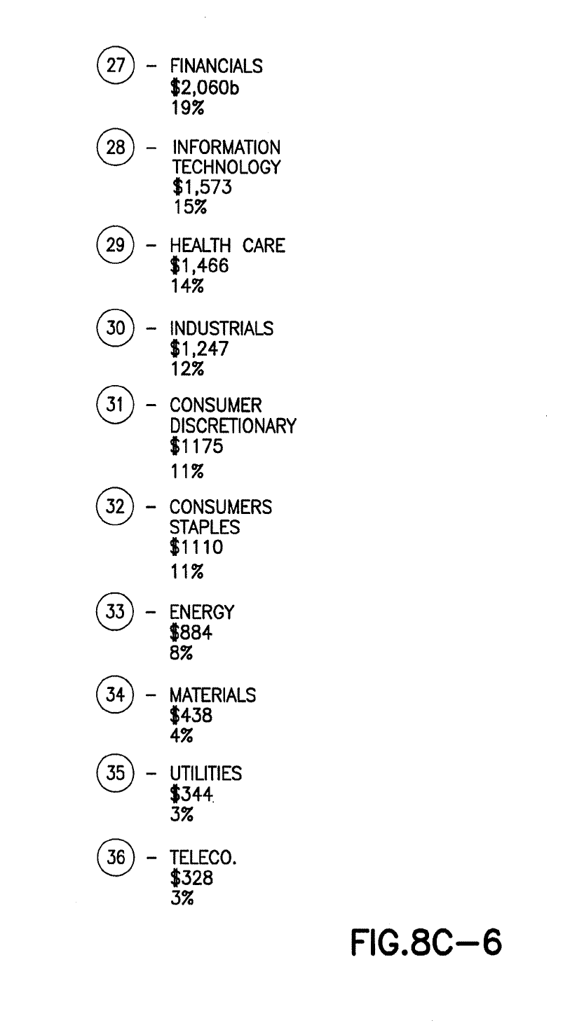

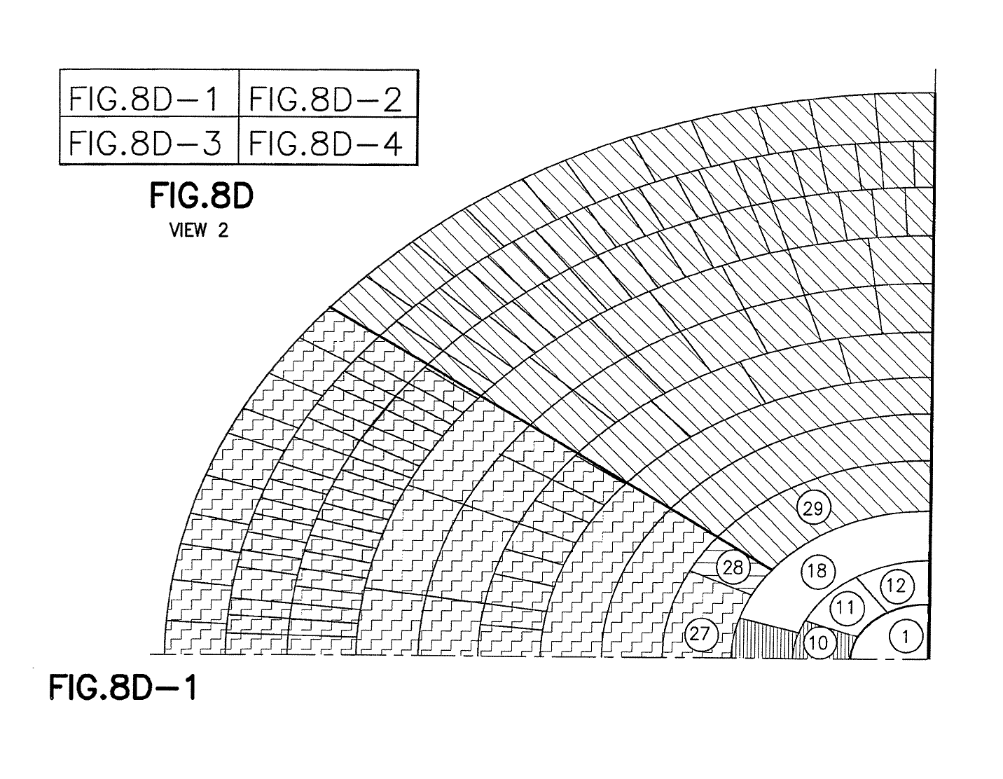

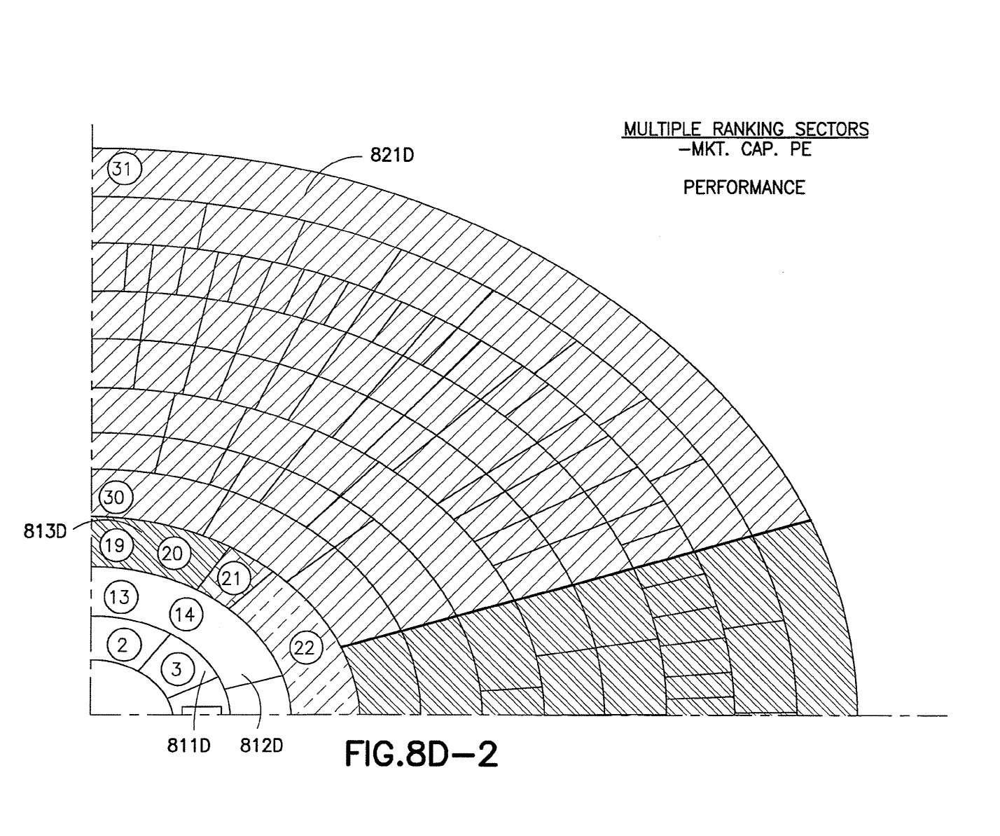

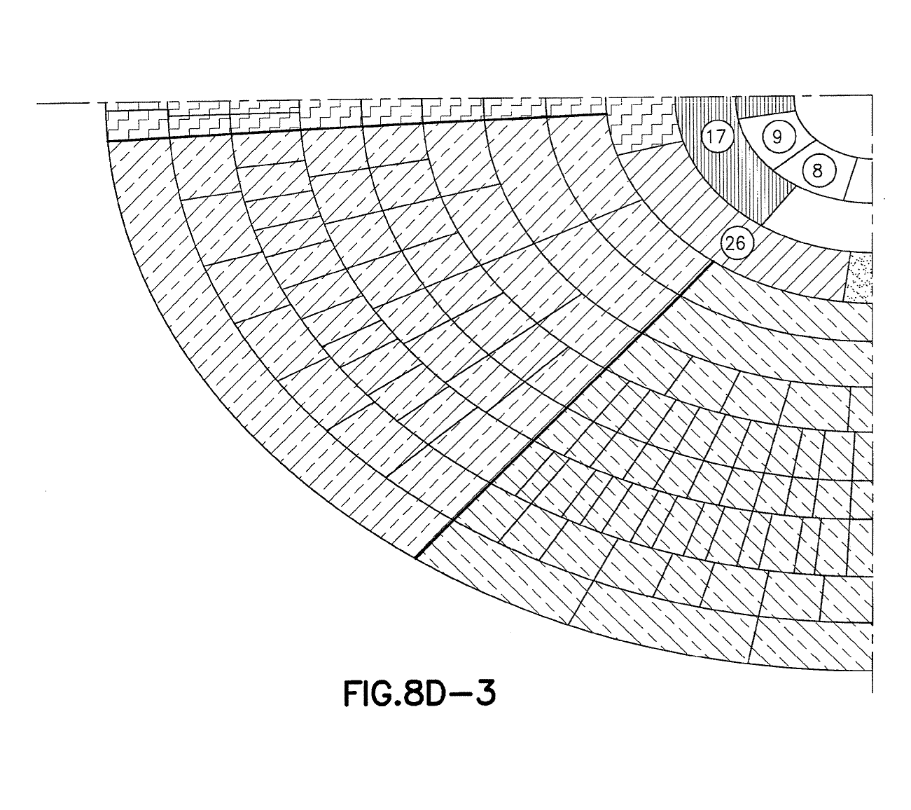

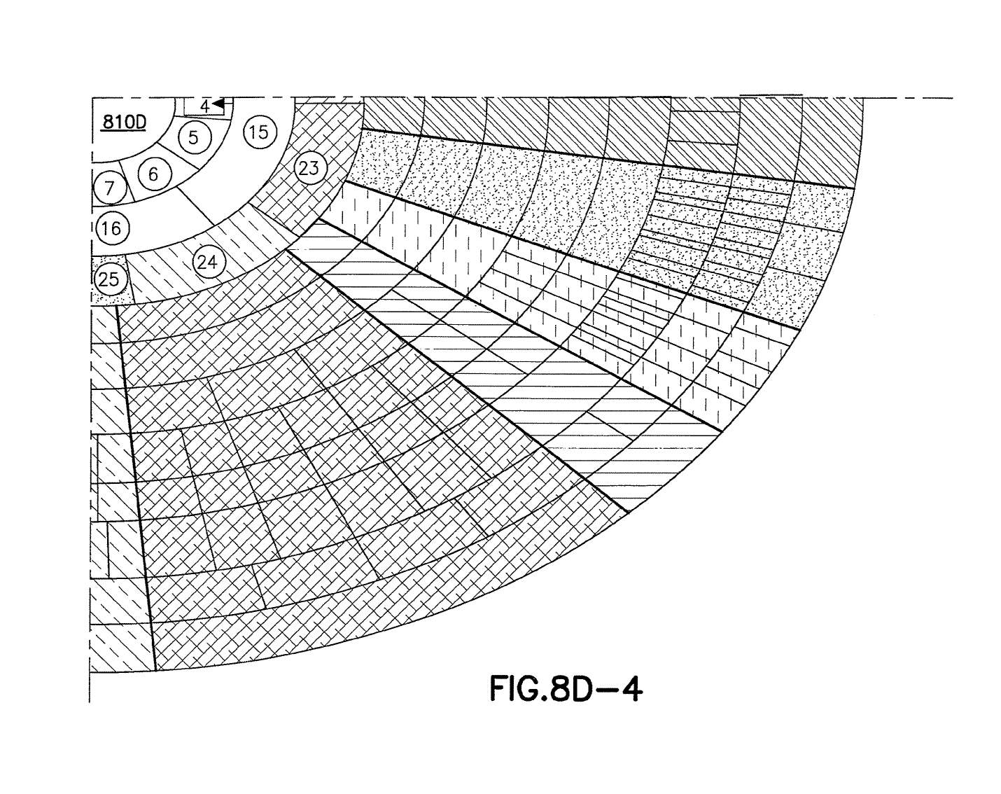

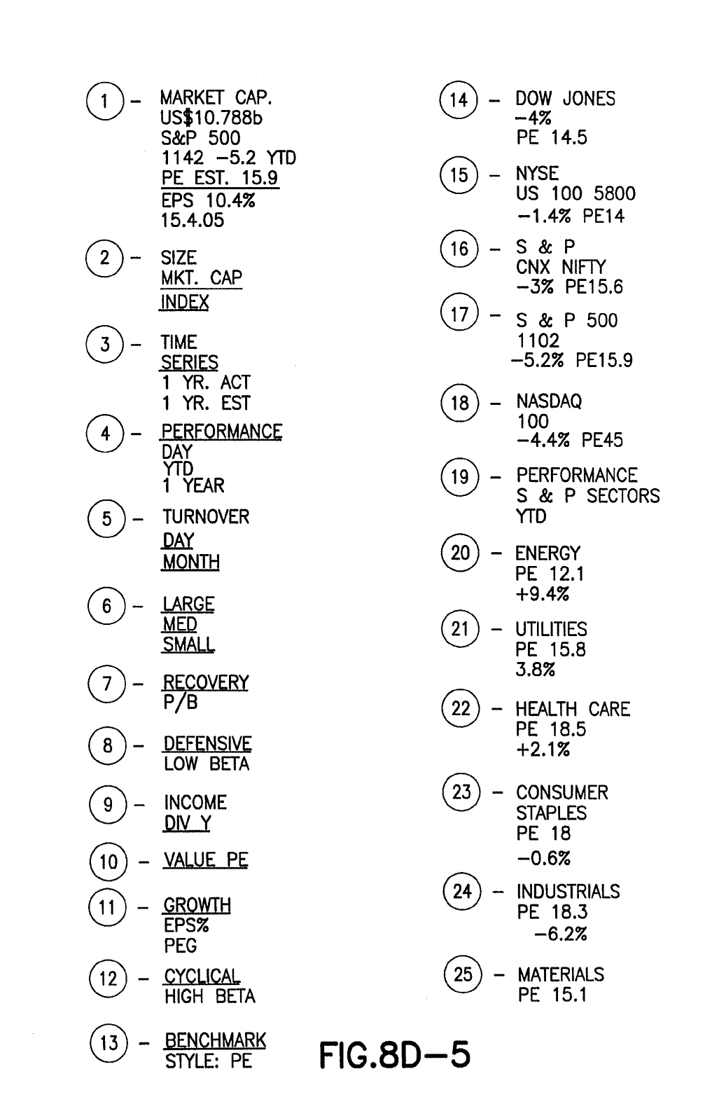

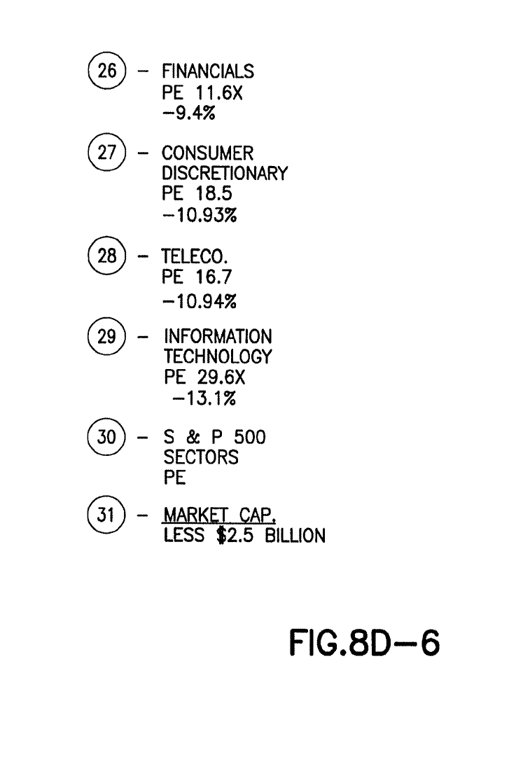

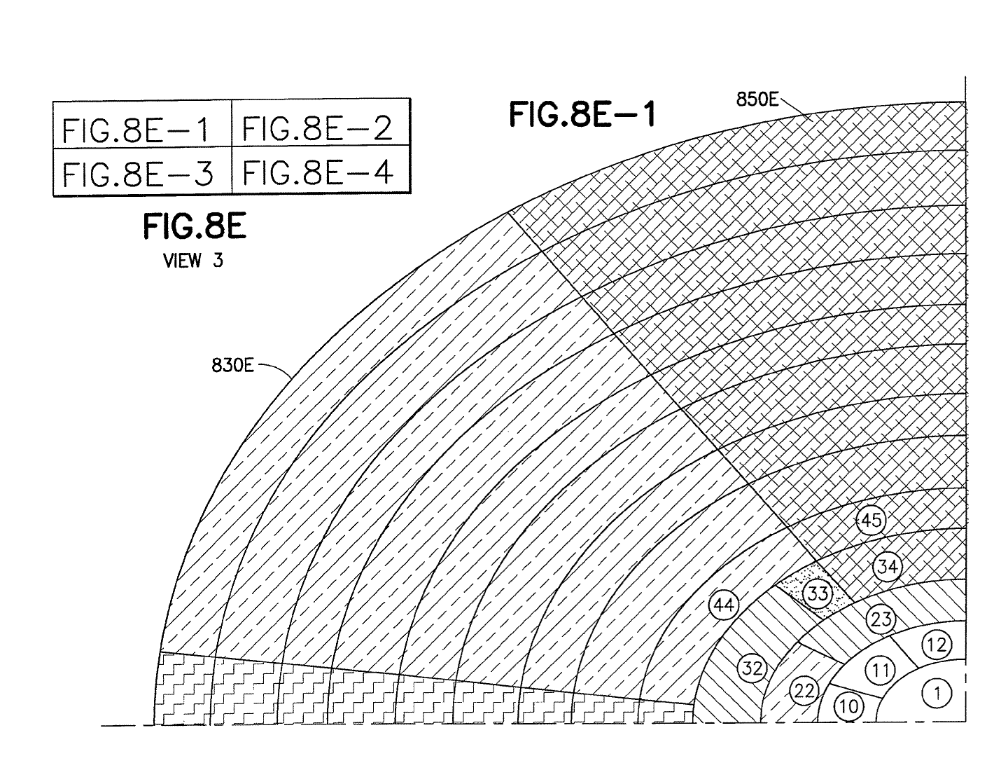

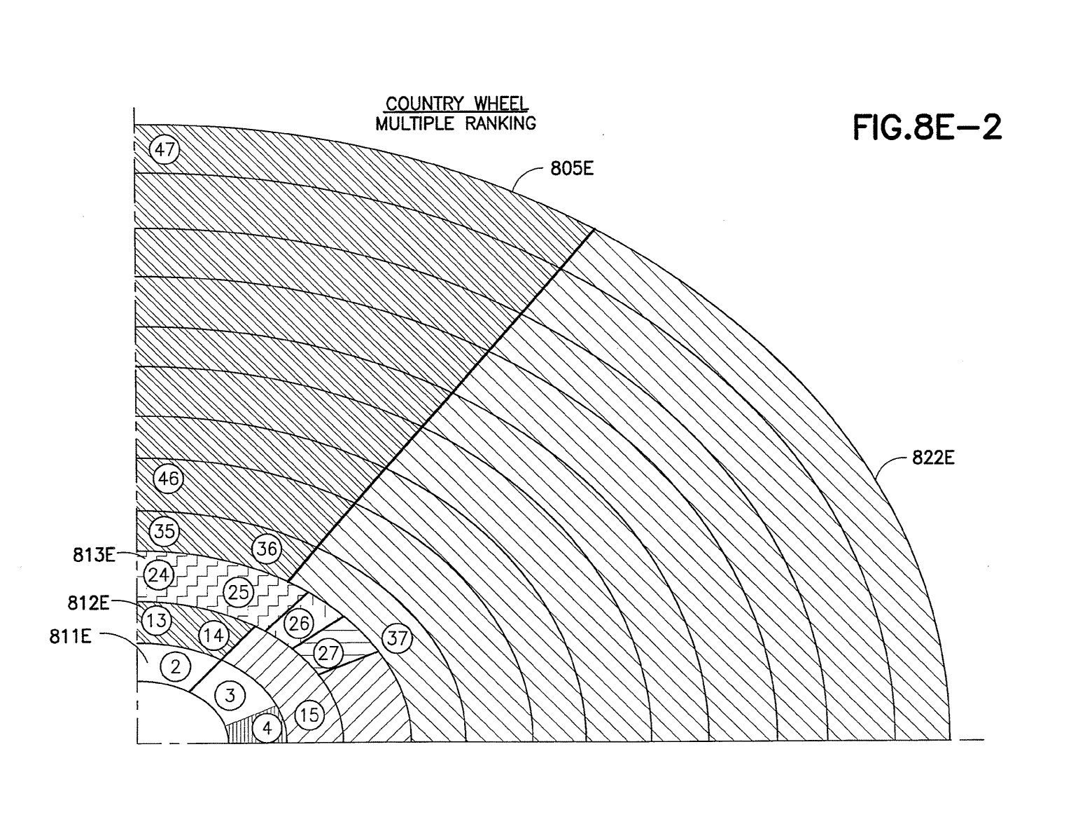

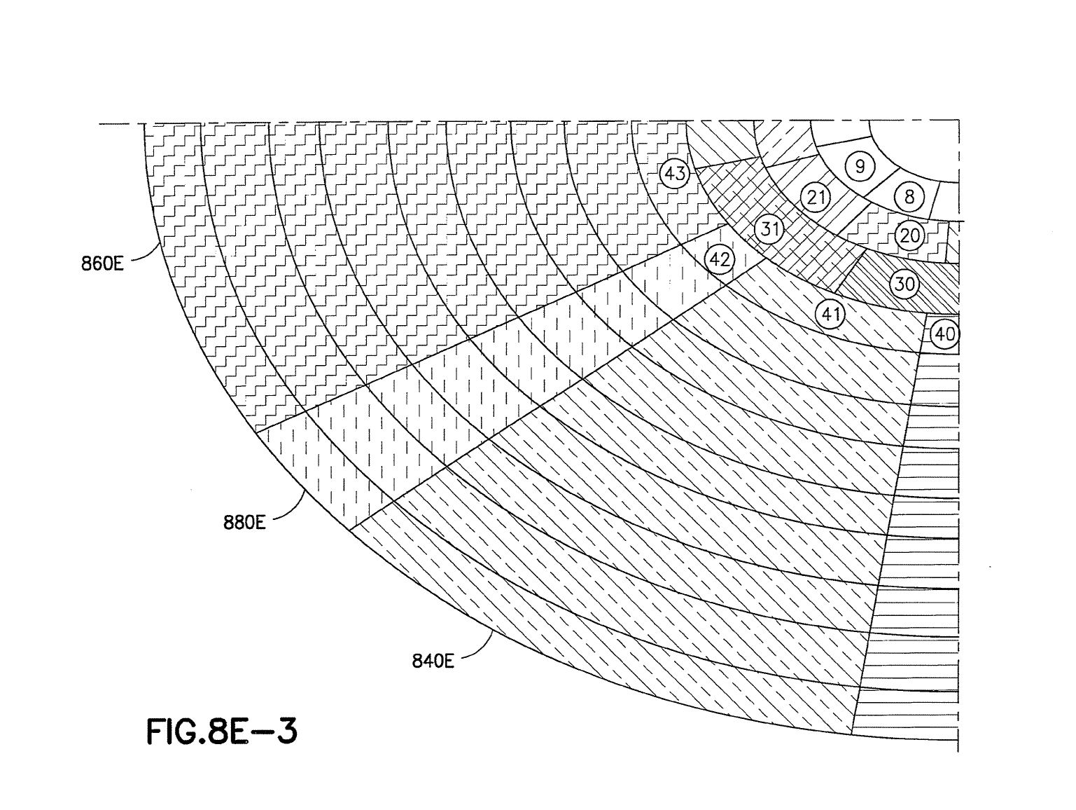

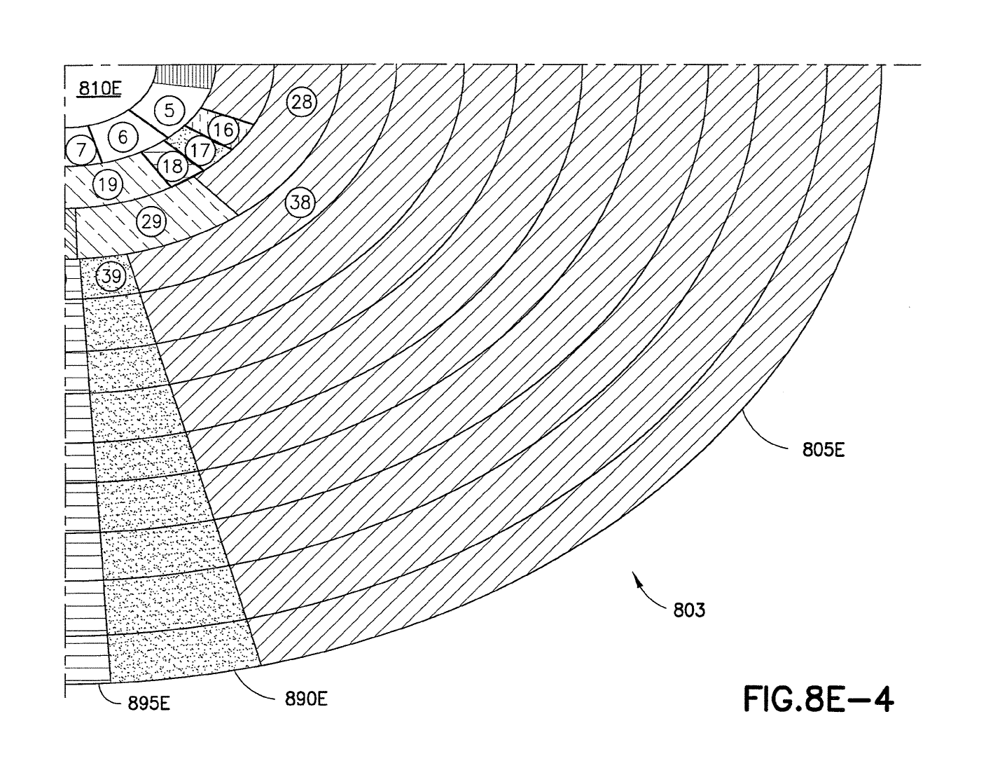

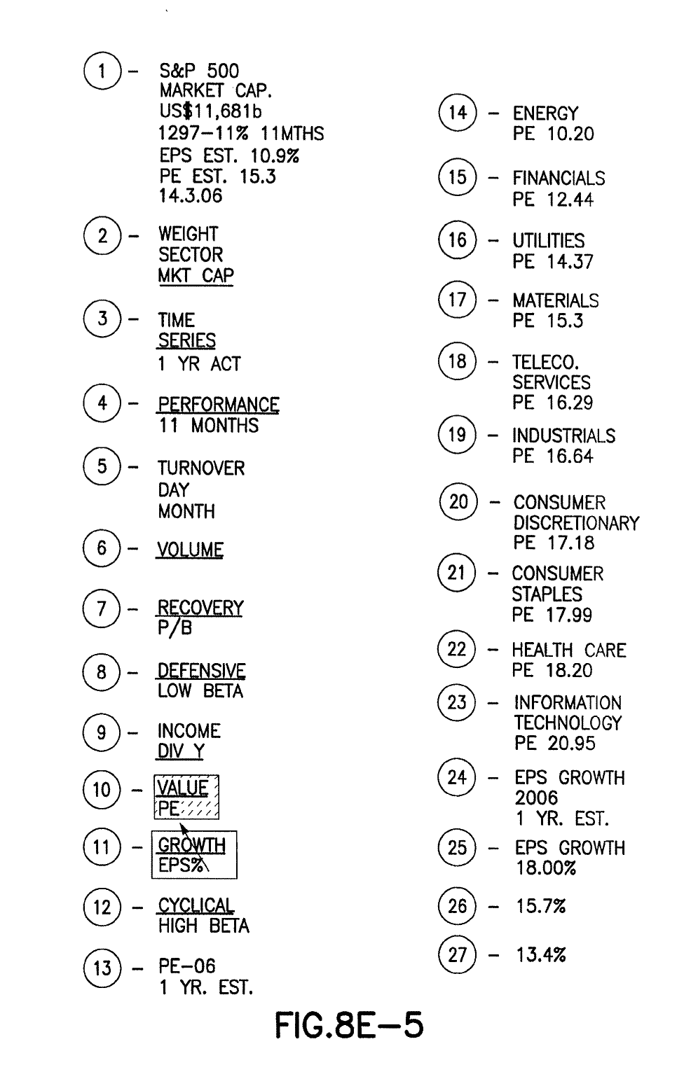

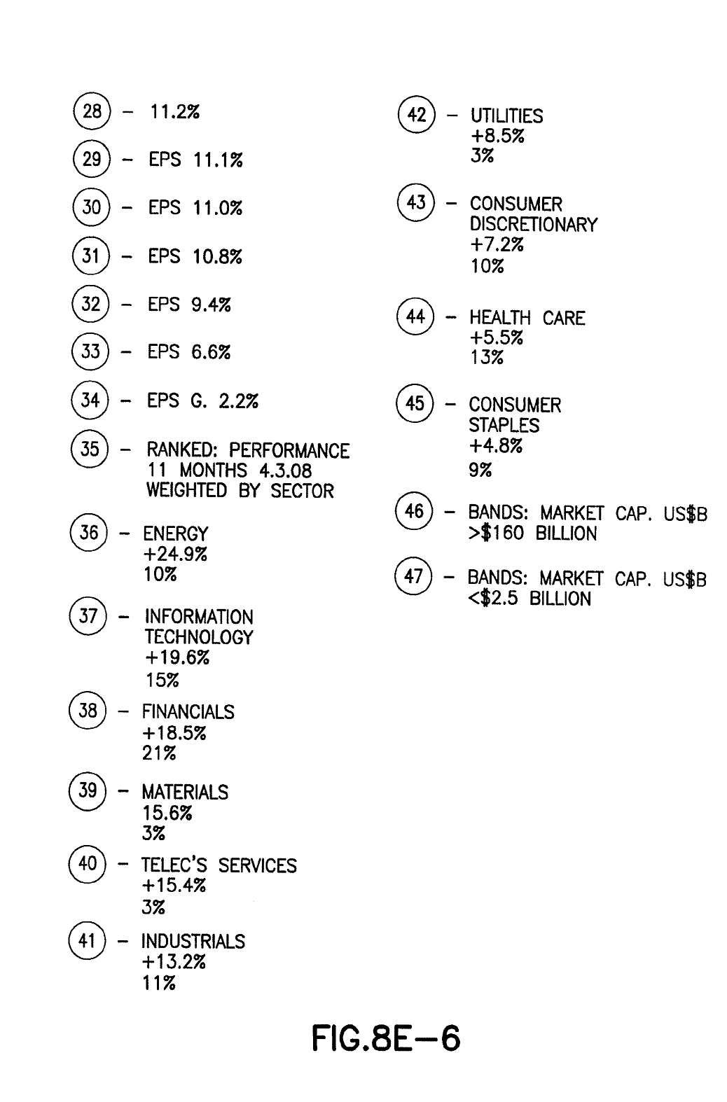

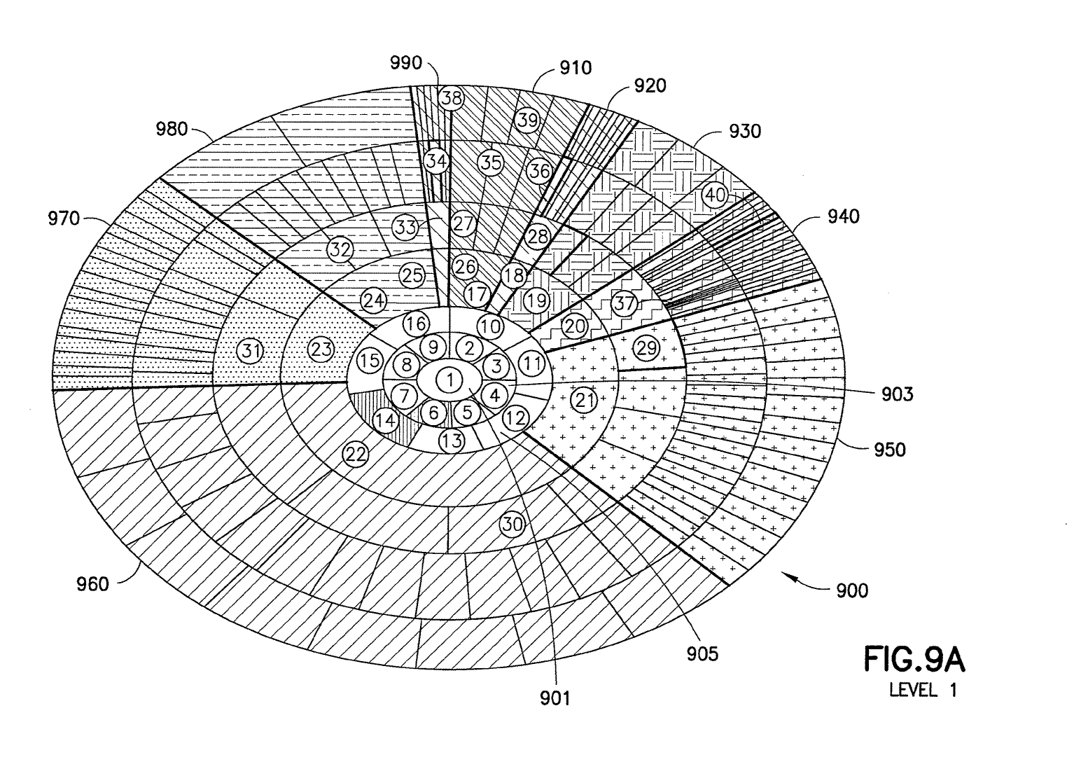

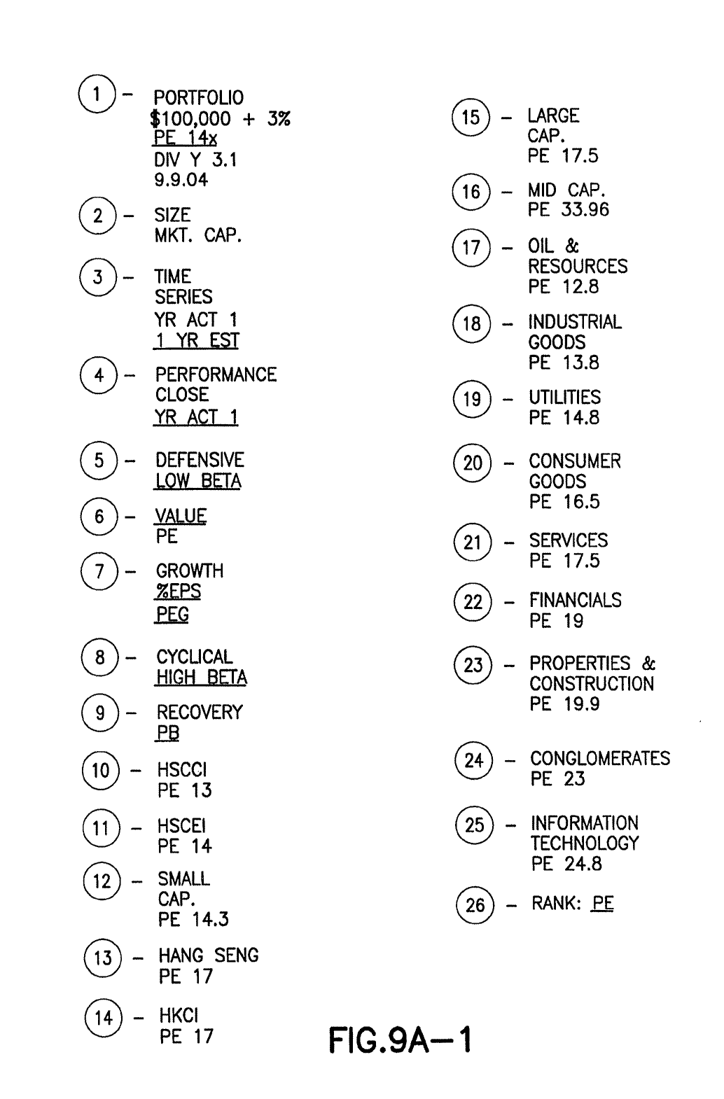

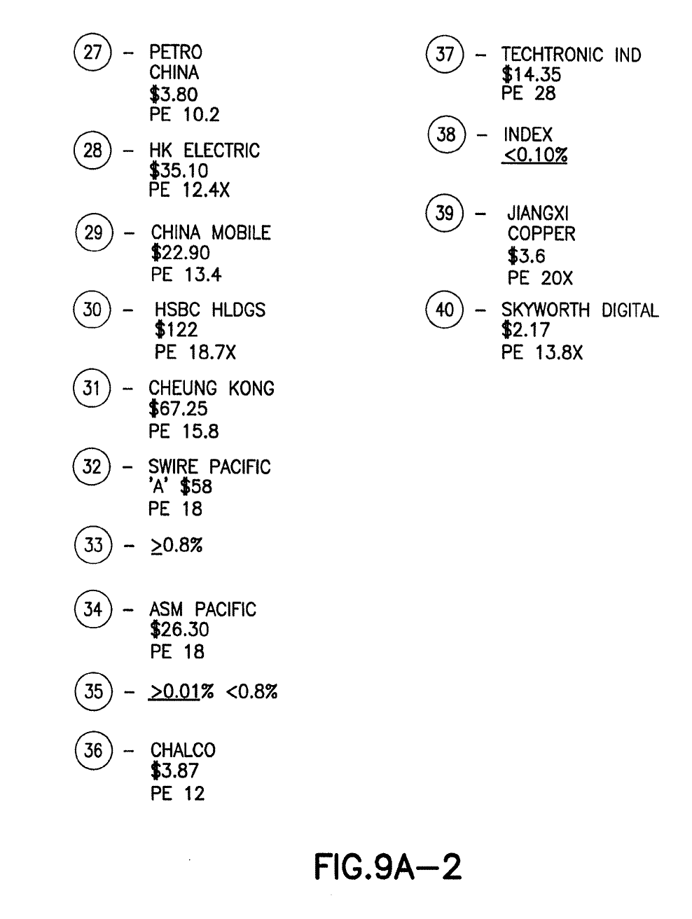

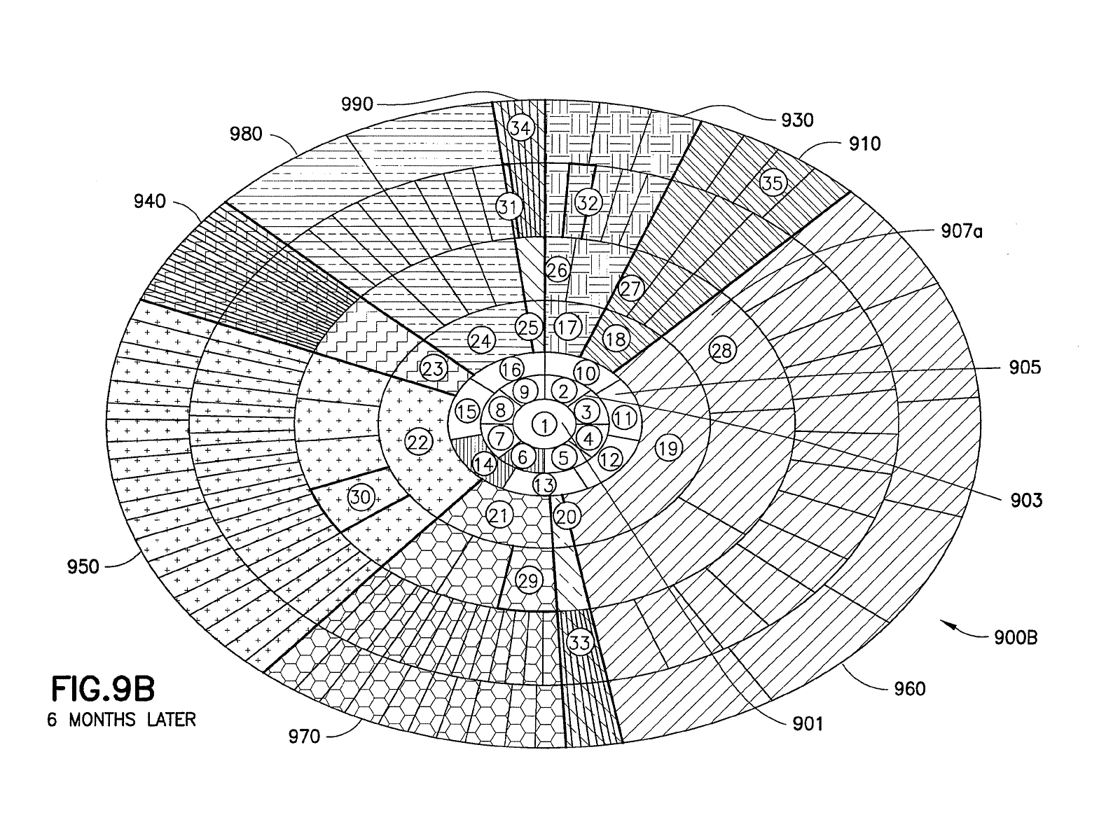

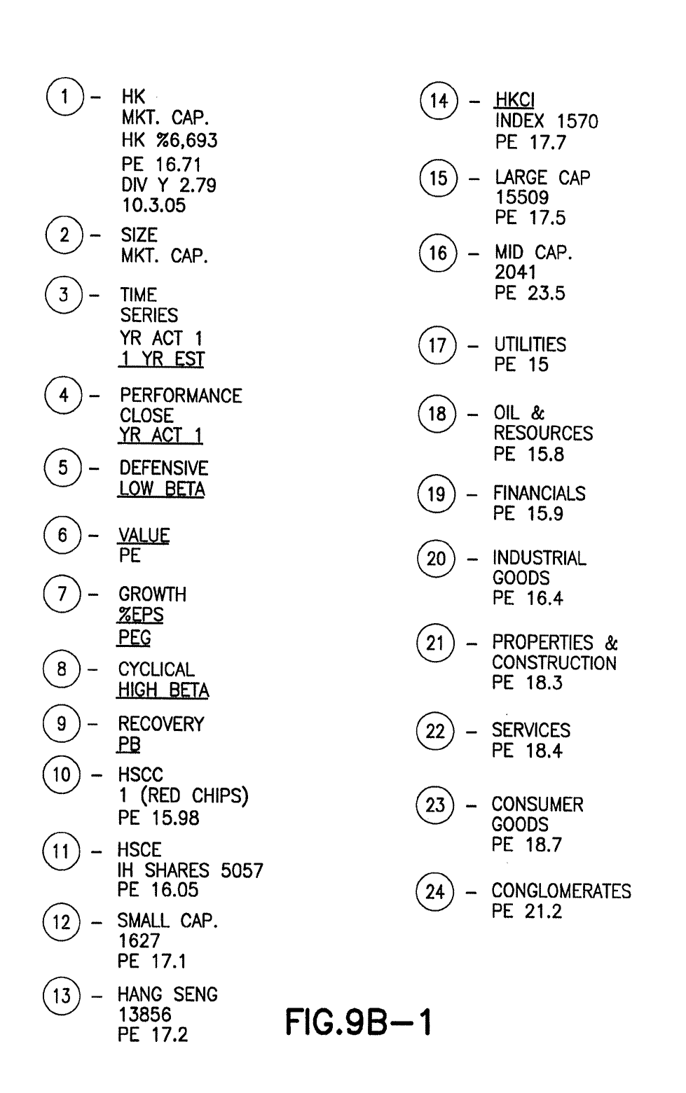

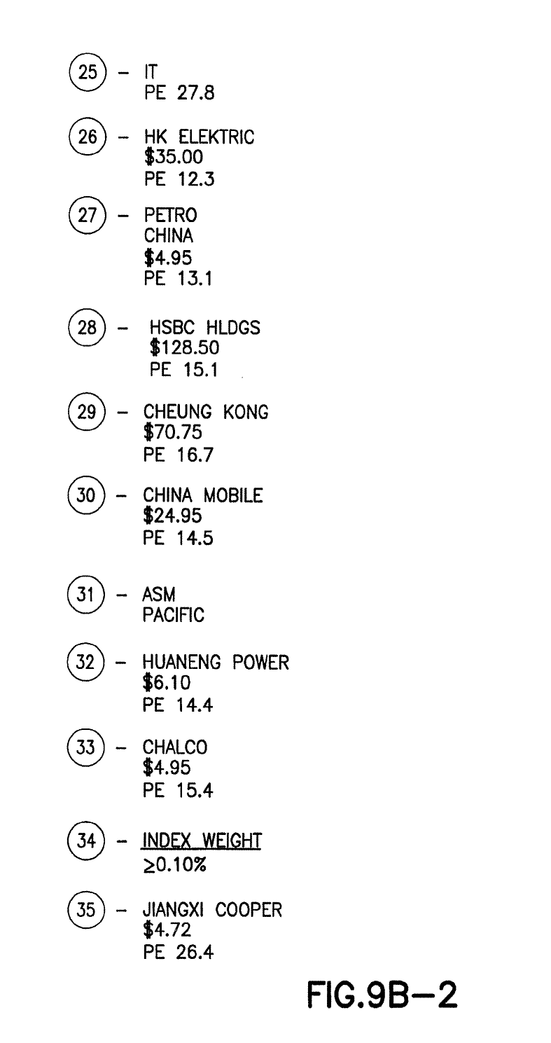

The FIGS. further collectively outline the way the Asset Sphere and wheels interact and readjust to changes in price or to changes in the user's selected style or estimated values on the meridian ring, starting with either the Asset Sphere of FIG. 1 or World Market (Directory) of FIG. 4, drilling down by sector or by a segment. Examples of components of the wheels, such as the Market wheels include; Equities (FIG. 5A) Cash, (FIG. 6), Gold, (FIG. 7) each representing sectors from the Asset wheel or Asset Sphere. Examples of a segment from the Equities wheel of the Country Price Wheels include US (FIG. 8A), and Hong Kong (FIG. 9A) With a further segment from the Country Price wheel being an example of a Market Efficiency wheel;

Financials 11A

The Wheels graphically display the risk versus the reward of the components on the wheel to each other, relative to the center values. Clarity and visibility are given to the supply (number of components in sector) and demand (ranking of components within ring and/or position from center), the risk (quartile on the wheel,) and control (inner rings represent a higher percentage of the center therefore more control over the center value) that can change the center value. The wheels consist of three key parts, center, “inner controls” comprising of an ownership, Style, and benchmark ring, and the outer “choice” rings. The “inner controls” combination is the key to the center's risk and performance, each ring powers the next ring, the user takes control of the direction, performance and the risk to the center values, due to the positioning of the selected components on the wheel which can form the center. The GUI guides the user to preserve or maximize center in a risk-adjusted way.

The subject investment guide empowers the professional or the individual by aligning ratios (forecast or historical) of the investment styles with the market price for a selected universe, in one user interface. A graphical user interface for the investment guide includes, in an embodiment, a substantially circular field and reference points designed utilizing terminology that the financial industry uses to sell products and to manage assets on behalf of investors. More specifically, ratios are linked with a product (generally referred to herein as an “asset”) name, and products are sorted by size within tiered rings or “risk bands.” Each successively outer ring has a higher risk and therefore requires a lower price to compensate for the extra risk “price” being measured by a valuation ratio e.g. PE. The further an asset is from the center of the wheel a lower valuation compensating for the higher risk being undertaken, alternatively higher valuation would require a higher return for the extra risk. The displayed assets on the wheel of the GUI become the user's “universe.” The wheel allows for total visibility of all assets in which it is possible to invest. Therefore, context or “perspective” is given to the manner and risks in which the center value is invested or may be invested.

Center can function in one of three different ways. It can:

1) Explain the wheel by displaying the mean values and/or the total value of the wheel. Segments can be positioned on the wheel relative to the mean “center”, 1^{st} quartile, 2^{nd} quartile above the mean, 3^{rd} and 4^{th} quartile below the mean.

2) Center “at Risk.” A user selects input at risk to protect and/or maximize.

3) Central noon notification for the wheel. The most preferred assets are identified the center with the color changing to Blue. The center reflects the segment with the highest frequency in the noon position throughout the wheel, weighted where the inner rings have a higher weight than the outer rings. Weights can reflect the user's preferred style. Series and ratios can be user selected or can use the default settings.

Risk can be measured by distance from the center and by size, the larger the segment, and/or closer to the center, the less relative risk the segment has. In this sense, “segment” is used generally and may refer to, for example, an equity or a particular company (e.g., AT&T), industry (e.g., healthcare), market (e.g., NASDAQ), cash or a particular currency (e.g. US$), bonds (e.g., Municipals), company bonds (e.g. GE 10 year Bond), or Mutual Funds (e.g. Growth Fund). That is, since the physically displayed size of segments is based on their respective magnitude of market capitalization, the size viewed by the user then becomes an indicator of relative risk, an industry standard. Specifically, “the larger it is, the less risk,” because of the larger market capitalization. Additionally a larger asset represents a higher percent of the center value if one has to achieve the center performance. The closer to the center a region is placed, the more control the asset associated with the region has over the center value. This risk is calculated based on considerations other than market capitalization. Considerations such as Beta, volatility measured by the standard deviation to the mean, liquidity measured by turnover as percent of total turnover or as percentage of Market size, legal title e.g. share versus an option, or freehold property versus a lease-hold property. Counter party risk (e.g. 90 day Bank bills versus 10 year corporate bonds), credit worthiness of the issuer (e.g. AAA grade versus BBB) and the like are used to determine relative risk, which are then incorporated into the guide, so that the effect of these factors can be displayed graphically. As seen, for example in FIG. 4, a center 410 of the wheel 400 displays a value (magnitude) of assets to be invested, specifically to preserve and maximize, and also can display a benchmark to outperform and/or other data.

Control Rings

The Control rings combination consists of a control, Benchmark and Style ring, normally the position adjacent to the center defines the user's universe. The Control ring reflects legal title and the degree of ownership of the center value, ranked by noon. Clicking on a segment will display choices available for that segment. The Benchmark ring exhibits the various benchmarks within the segments and can be ranked by the style ring, displaying the components of the selected benchmark or index, in the outer choice rings, which in turn may become the center value to outperform. The Style ring is divided into segments representing a ratio or various styles of investment including the corresponding ratios that distinguish the securities to that particular style, for example a growth style could contain the EPS growth rate. As shown in FIG. 5A, there is a wheel 500, a control 560 ring, a style 550 ring, and a Benchmark 570 ring.

Segments that are preferred for a selected (or default) investment style are ranked and displayed sequentially clockwise, starting at noon. The most preferred segment is displayed in its respective band nearest and to the right of a vertical line, which itself may or may not be displayed. Within each preferred segment, individual assets or sub-segments are ranked according to their desirability based on the selected investment style.

The field of the guide's graphical user interface 400 includes the use of multiple colors and families of colors to designate segments, sub-segments and individual assets belonging to particular asset classes. The color coding, in addition to size and physical arrangement, further facilitates rapid visibility and interpretation of the data displayed to the user. The positioning illustrates how a particular asset class, segment, or individual asset. relate to others. Specifically, whether each is above or below a mean (center) or above or below a user's center input “at risk” is demonstrated by being to, for example the left or right side of the wheel-shaped display area. Those on the right side (closer to the “noon” notification position) are more favorable for investment based on the default or user-selected investment style. The guide highlights risk to the center due to the diversification of a selected portfolio relative to the center benchmark weightings. The Center can reflect the sum of the wheel and/or the mean of the wheels' ratios. Segments in the 1^{st} quarter (nearest noon), and 2^{nd} quarter are above the mean representing 50 percent or 90 degrees of the wheel. Segments in the 3^{rd} and 4^{th} quarters are below mean. The GUI displays the universe in 4 quartiles relative to the center enabling the user at a glance to visualize where the best value or performance for a given style is with the noon notification. A concentration in any quarter or ring would be of higher risk than a balance portfolio throughout the wheel, as seen in FIG. 9A GUI 900. A return on investment equal to a benchmark displayed either in the center or in Benchmark ring of the guide can be achieved with no effort (for example, buy “buying” the index). The goal of the investor or manager is, of course, to outperform the index (benchmark). The guide highlights the risk of not achieving the goal, by displaying the position of the portfolio relative to the benchmark.

Asset Sphere

A “Clock” is formed when the Meridian ring circumferences a wheel or sphere. The Clock guides by giving relative directional notification to the center and/or the segments on the wheel, is uses the user's input to calculate the change in price and estimates, and positions the segments according to the users input values.

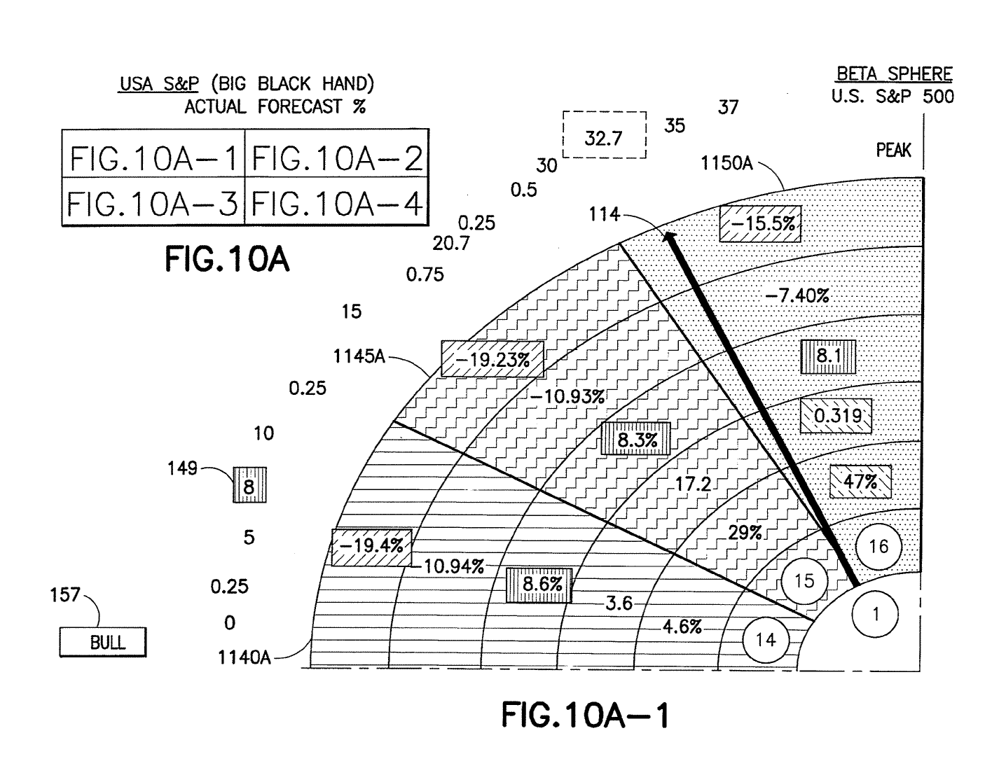

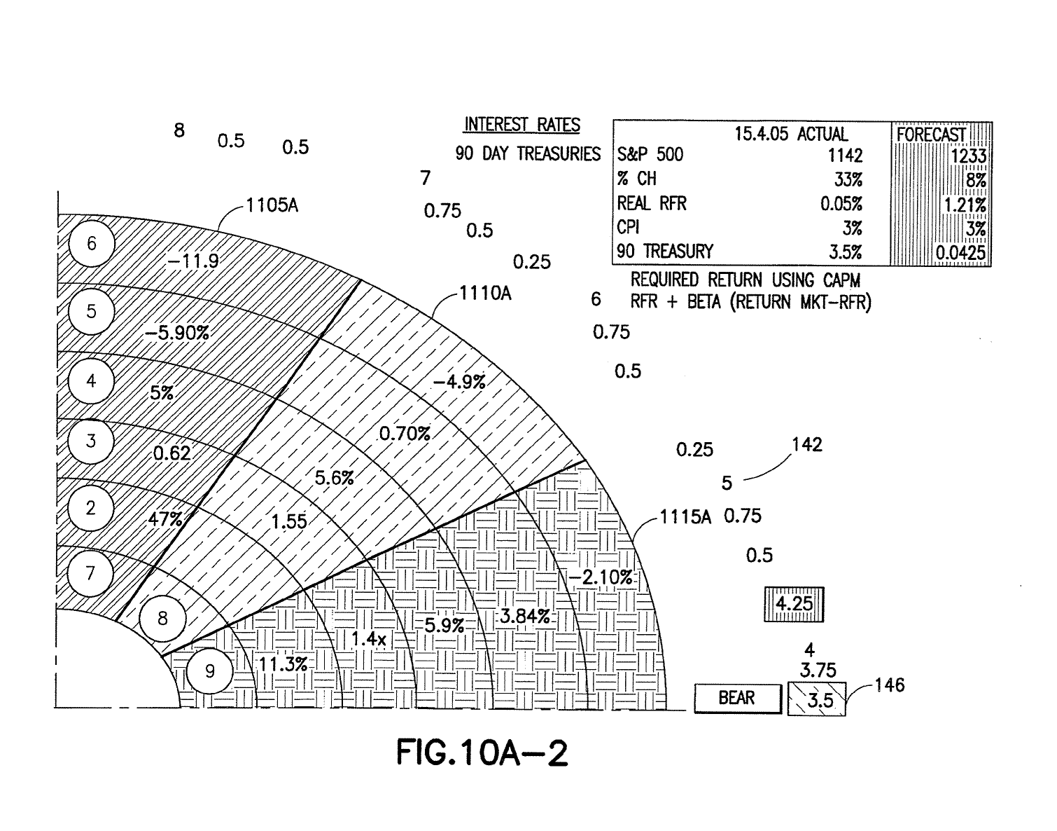

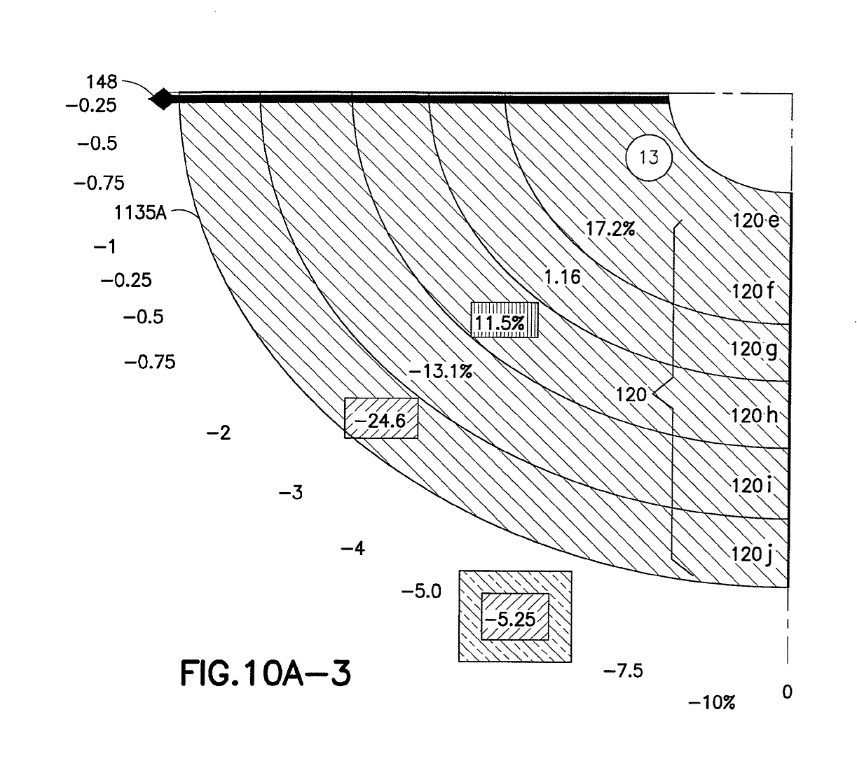

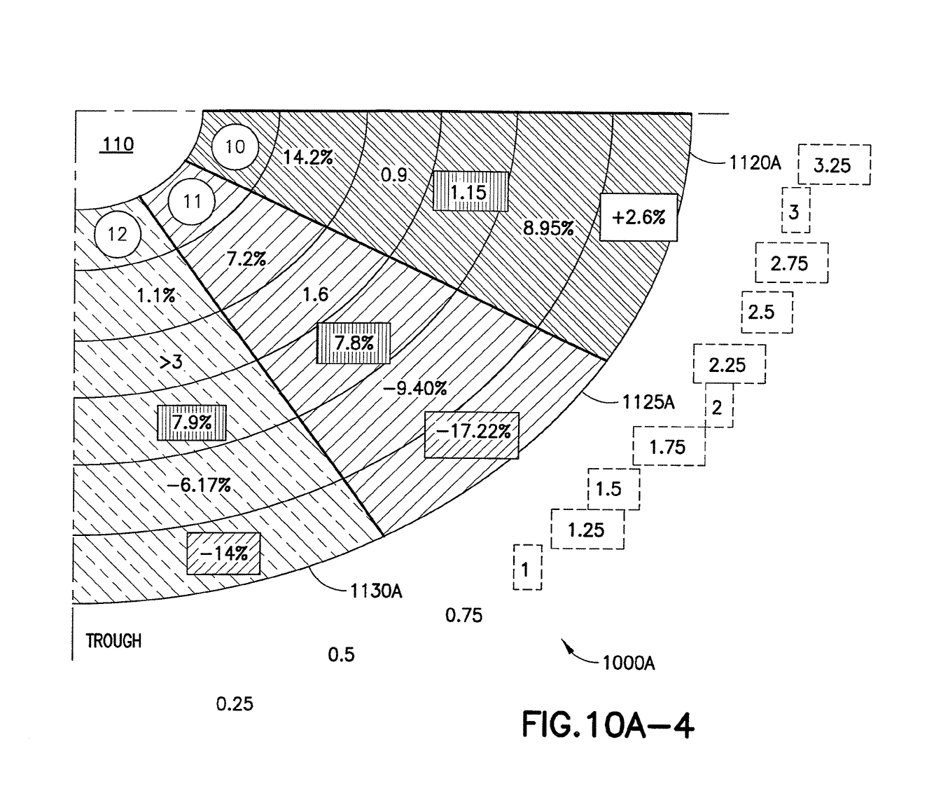

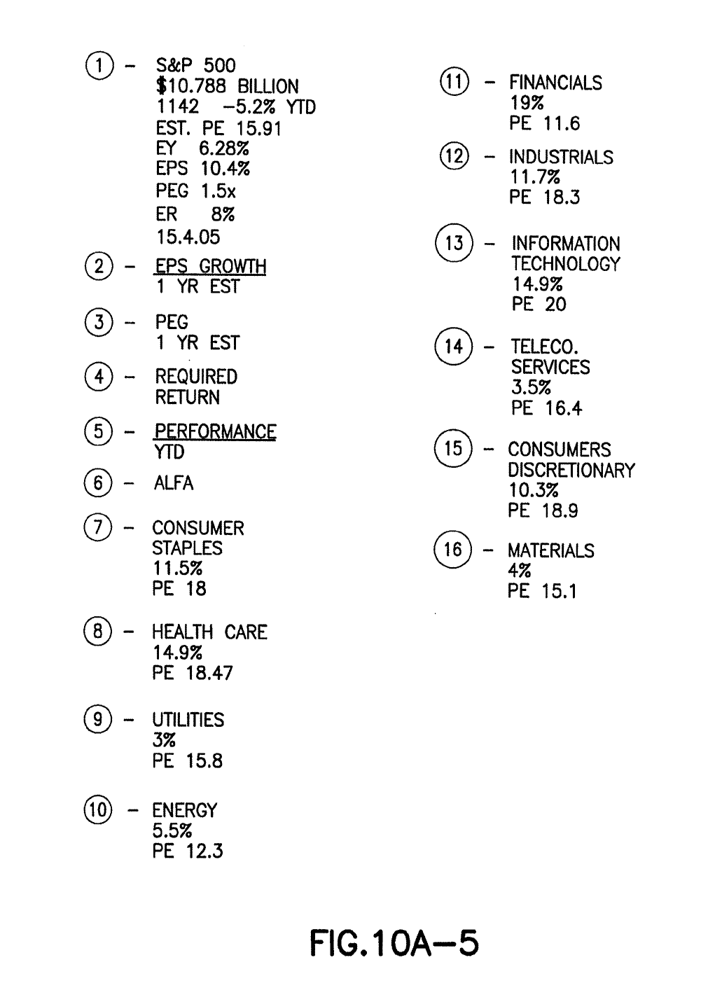

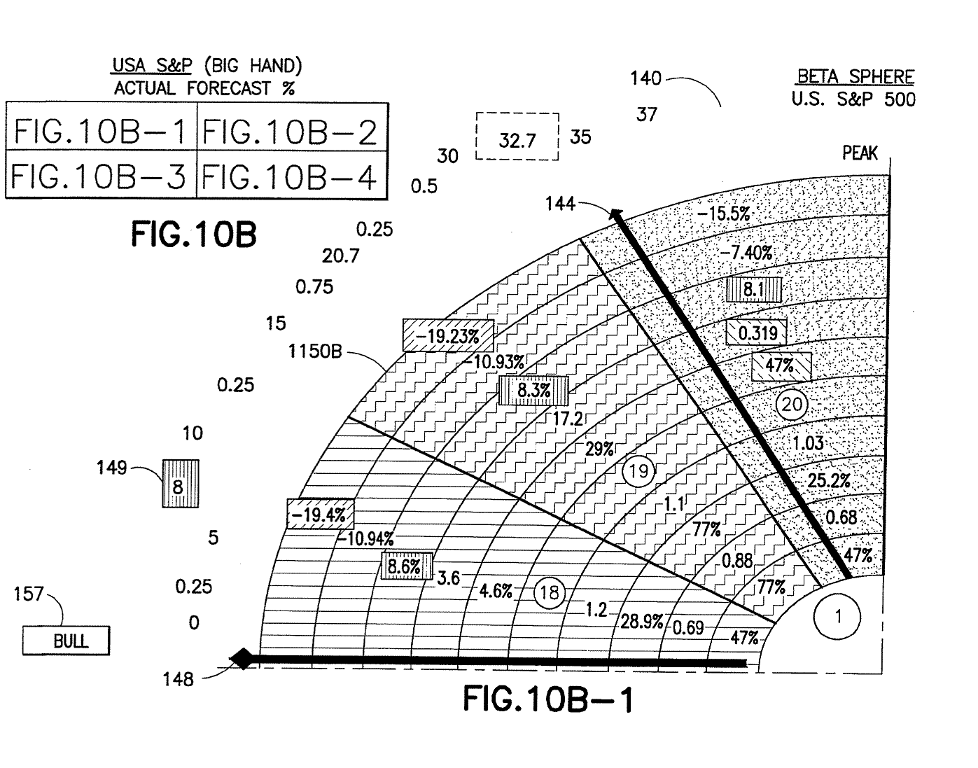

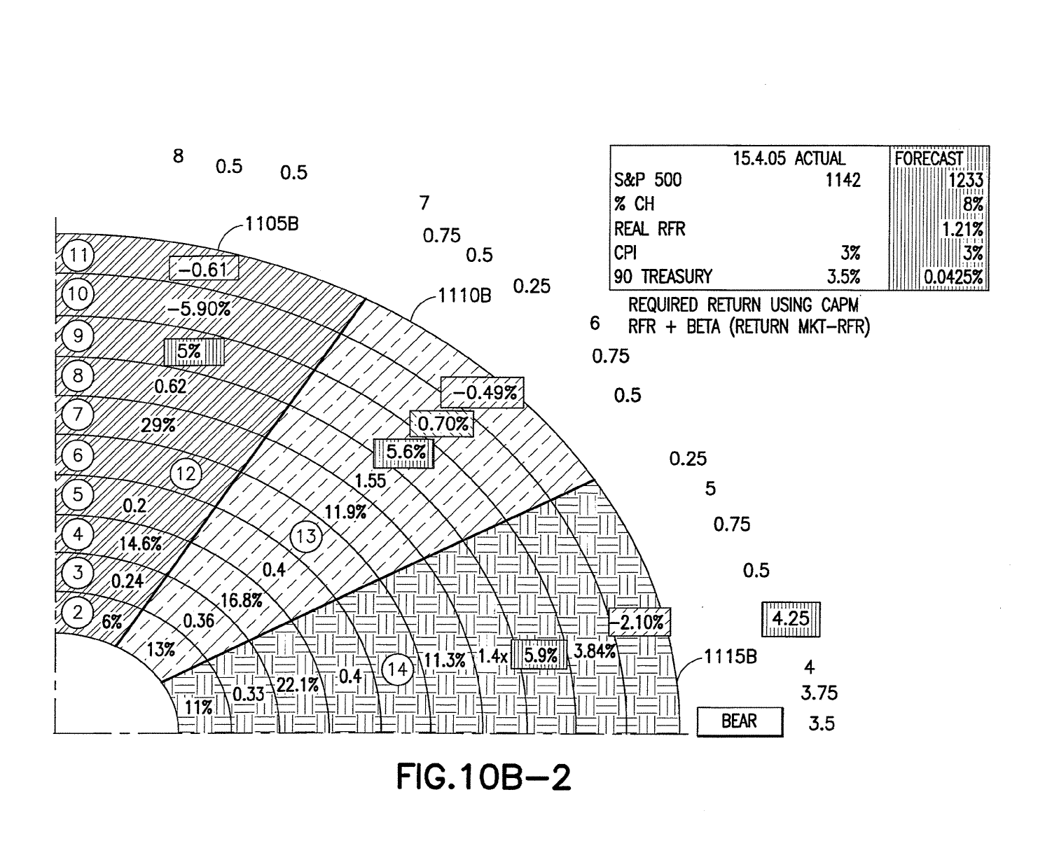

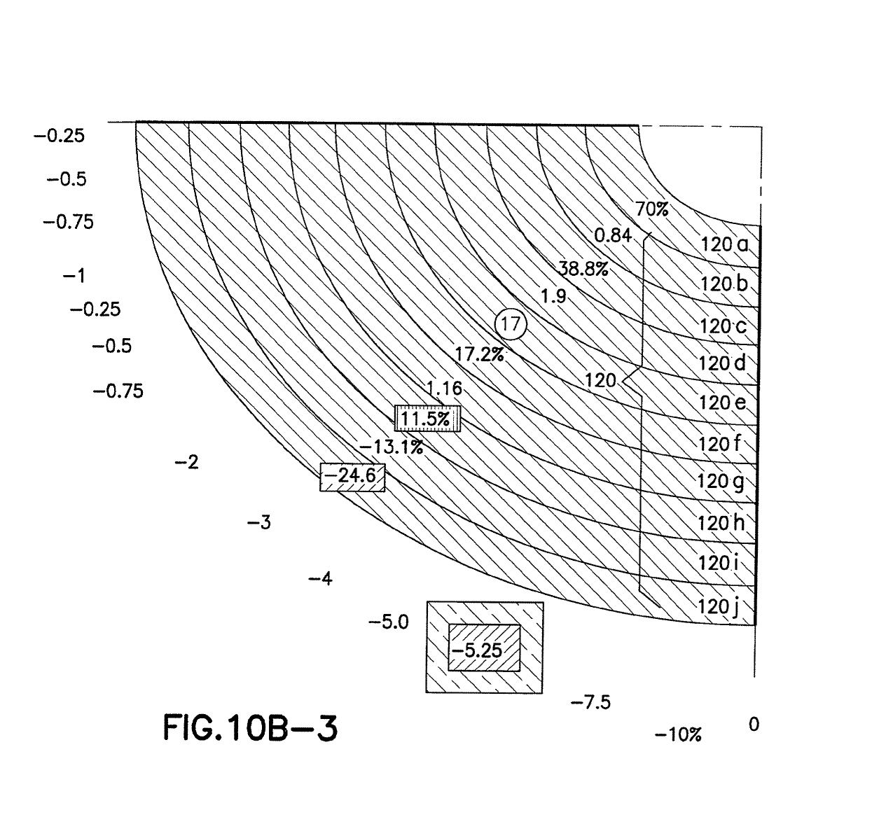

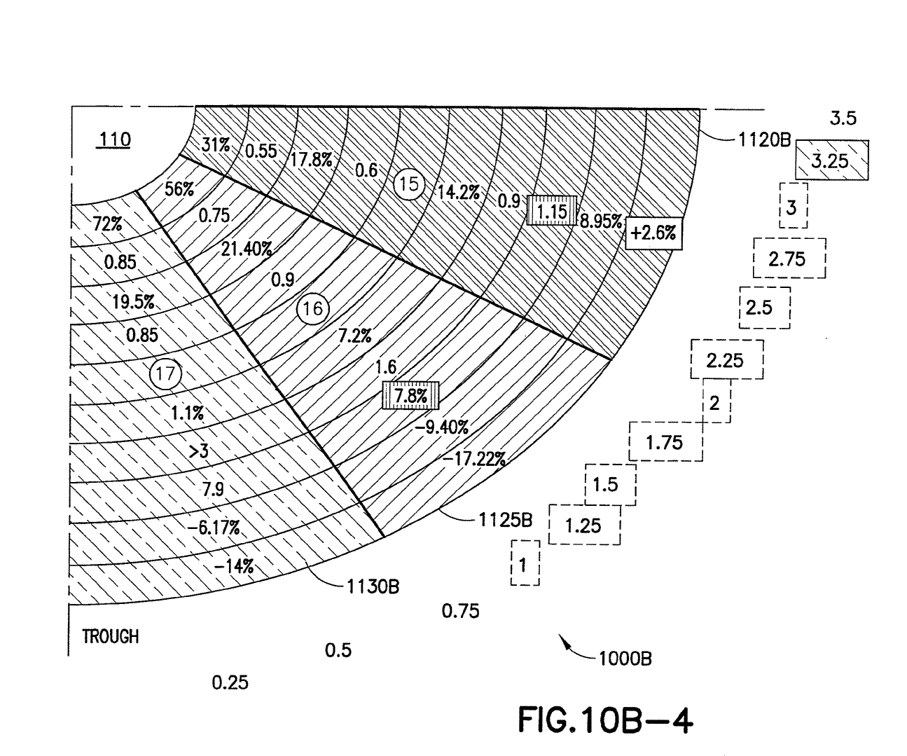

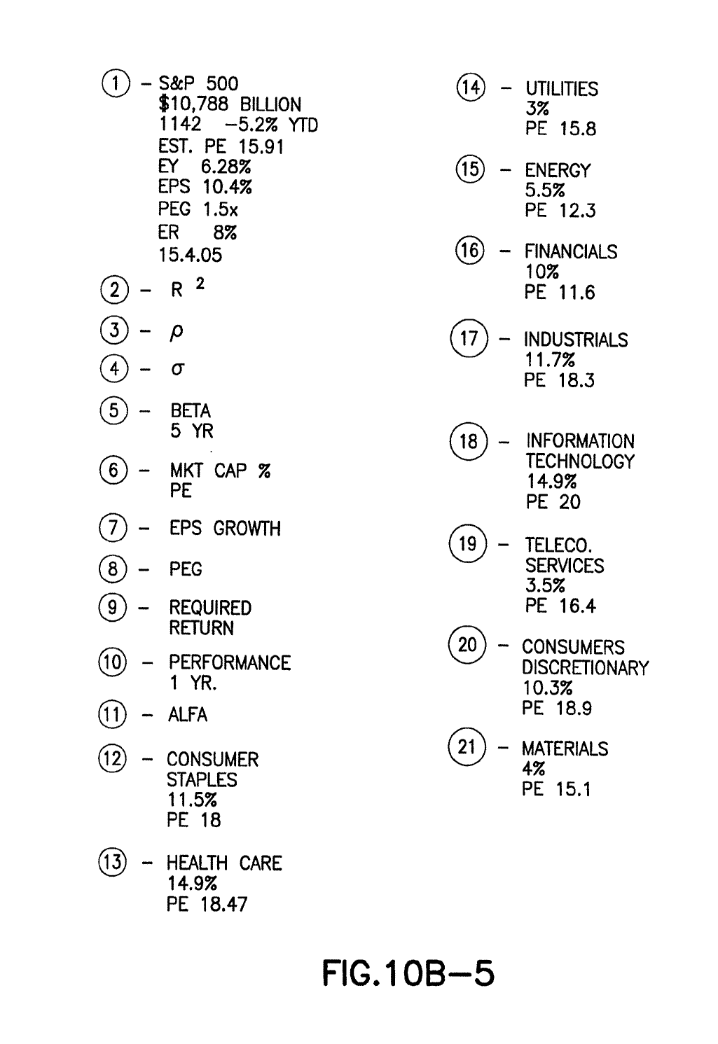

As seen, for example in FIG. 1, in the Asset Sphere's “Correlation Clock” (level 8), a center 110 of the wheel 130 displays a value (magnitude) of assets to be invested, specifically to preserve and maximize, and also can display a benchmark to outperform and/or other data. The field (e.g., 130 of the guide's graphical user interface 100 includes the use of multiple colors and families of colors to designate segments, sub-segments and individual assets belonging to particular asset classes. The color coding, in addition to size and physical arrangement, further facilitates rapid visibility and interpretation of the data displayed to the user. The positioning illustrates a particular asset class, segment, or individual asset direction relative to the other assets. Specifically, whether each is increasing or decreasing is demonstrated by being, for example, to the left or right side of the wheel-shaped display area. Those on the left side being more favorable for investment. The guide highlights risks to center due to segments' positions on the sphere. Segments are distributed to reflect relative direction of the segments assisting in the allocation of the center resource to the segments. For example, segments in FIG. 1 120 are distributed by the correlation if the opposite segment are negatively correlated. Diversification across segments reduces the overall risk to the center. Assets on the left will outperform assets on the right. FIG. 10 segments are disbursed relative to the center measured by beta. Assets on the left will outperform the center and the right side in a rising market and underperform in a falling market.

Meridian Ring

The meridian ring identifies the direction of assets on the wheel's/sphere's due to the correlation to the variables on the Meridian ring. The subject asset data visualization guide incorporates the principles of covariance and correlation in order to predict how certain asset classes and individual equities will behave based on economic fluctuation. Covariance measures the extent to which two variables move together over time. A positive covariance means that the variables tend to move together. Negative covariance means that the two variables tend to move in opposite directions over time. A covariance of zero means there is no relationship between the two variables. The covariance between two assets is computed from expectational (forward) or historical returns. The magnitude of covariance depends on the magnitude of the risky assets' standard deviations (represented by a lower-case Greek letter sigma (σ)), and the relationship between their co-movements. The covariance is an absolute measure of movement and is measured in return units squared. Covariance can be standardized by dividing by the product of the standard deviations of the two securities or risky assets being compared. This standardized measure of co-movement is called “correlation,” is represented by a lower-case Greek letter rho (ρ), and is calculated as shown immediately below:

$${ρ}_{1 , 2} = \frac{{Cov}_{1 , 2}}{{σ}_{1} {σ}_{2}} = {ρ}_{1 , 2} {σ}_{1} {σ}_{2}$$

where ρ1,2 is called the correlation coefficient between the returns of risky assets. The correlation coefficient has no units. It is a pure measure of the co-movement of the two stocks, and is bounded by −1 and +1. A correlation coefficient of +1 means that returns always move together in the same direction (they are perfectly positively correlated). A correlation coefficient of −1 means that returns always move in the exact opposite direction (they are perfectly negatively correlated). A correlation coefficient of zero means that there is no relationship between the two stocks returns (they are uncorrelated).

The coefficient of determination (“R²”) is defined as the percentage of total variation in the dependent variable relative to the independent variable. That is:

$$\begin{matrix}{R}^{2} = \frac{( total variation ) - ( unexplained variation )}{total variation} \\ = \frac{explained variation}{total variation} * \frac{SSR}{SST} \\ = 1 - ( \frac{SSE}{SST} )\end{matrix}$$

Where SSR is the explained variation: the sum of the squared distances between the predicted Y-values and the mean of Y. The explained variation is commonly referred to as the sum of the squares regression (SSR)}.

Where SST is the total variation of the dependent variable: the sum of the squared differences between the actual Y-values and Y. The mean of Y is the best estimate of the dependent variable, Y, given a value for the independent variable X

Where SSE is the unexplained variation: simply the sum of the squared errors. It is the sum of the squared vertical distances between the actual Y-values, and the predicted Y-values on the regression line.

Total variation is equal to the unexplained variation plus the explained variation or SST=SSE+SSR.

Dependent and independent variables. The dependent variable is the variable whose variation is explained by the other variable(s). The dependent variable is also referred to as the explained variable, the endogenous variable, or the predicted variable. The independent variable is the variable whose variation is used to explain the variation of the dependent variable. The independent variable is also referred to as the explanatory variable, the exogenous variable, or the predicting variable.

The X value is the Independent variable on the meridian ring 140, Figurel as an example and the Y value is the dependent values positioned on the sphere or wheels.

The graphical user interface 100 of the asset data visualization guide includes multiple user screens, each for displaying information at different levels of detail, for different asset classes, different sectors of the economy, and so on. Depending on the particular screen being viewed, a meridian ring 140 can be displayed, which provides direction for the information displayed in the rings of the circular field 130.

One embodiment of a main screen of the graphical user interface is illustrated in FIG. 1. Illustrated are traditional asset classes, with assets having a negative correlation to one another being positioned opposite each other, relative to a central point of the circular field 130.

The values displayed for the center value (and in other screens, for particular assets) are correlated to a change in a variable's direction (e.g., increasing interest rate becoming decreasing interest rate) or are simply a result of the variable's value (current interest rate). Which factor determines the displayed values is dependent upon the specific economic climate. That is, whether, for example, interest rates are changing or not, and/or depends on a default or user-selected setting.

In an example embodiment, the user forecasts the magnitude of the economic indicator(s), which may be GDP, interest rate or other economic indicators. In doing this, the user also forecasts a direction (increasing or decreasing) for these indicators. In some embodiments, as a result of these forecast values and directions, the computer system which operates the guide and the graphical user interface moves “clock” hands 144 and 148 accordingly. These arms graphically indicate to the user, the state of the economy based on the respective economic indicators. Generally, if the economy is expanding it is “bullish,” or contracting (recession) it is “bearish,” as depicted in the GUI 125 as a change in direction a “peak” or near a “trough.” These relative positions are illustrated in FIG. 1 by reference numbers 157, 155, 151 and 153, respectively. As an alternative, the hands are user-movable. More specifically, an outer indicator ring 125 provides details regarding the aforementioned state of the economy, such as indications of base interest rates increasing, unemployment rates falling, and the like. When a clock hand's 144, 148 direction is up (indicating an improving or “bullish” economic climate), assets on one side of the sphere will outperform a benchmark for part of the cycle. Conversely, when clock hands 144, 148 are falling, assets on the other side will under-perform a benchmark.

The angular position of the inner asset ring 120 is set by the position of the small hand 144 of the clock, this hand drives the larger, big hand 148, in a similar manner to a conventional mechanical clock. The big hand 148 moves at a slower rate than the small hand 144, and the small hand can lead or lag behind the big hand. Hands rotate full 360 degrees in a clockwise direction. In this embodiment, interest rates are indicated by the small hand 144, and growth is represented as GDP and indicated by the big hand 148. Interest rates control the growth rate which is graphically illustrated in the investment guide as a positional and directional relationship between the small hand 144 and the big hand 148.

Other embodiments of the guide, which all may or may not be linked together via the graphical user interface, include additional wheel-shaped fields with multiple rings referred to herein as “sector wheels,” which are described in more detail below. As seen in FIG. 1, the outer meridian ring 140 surrounds the circular field 130. The meridian ring 140 monitors the variables that can change the displayed price of a asset in the guide. Values are graduated on the outer meridian ring and are the independent variables. Assets in the field for individual assets are the dependent variables. Depending on the specific embodiment, the user can select current and forecast numbers for independent variables by dragging and dropping windows over them. These windows facilitate entry of the selection into the computer system in order for calculations to be performed. The windows further serve to emphasize which values are current, and which are forecast. Financial information such as GDP, CPI (representing demand and supply for money), interest rate and money supply can all change the price of money, thereby changing the value of an asset displayed on sphere. In one embodiment, “clicking” or “double clicking on meridian ring 140 will change the meridian ring, and display other independent variables.

The circular layout of the main screen, shown in FIG. 1, includes the indicia “peak”, “bear”, “trough” and “bull” respectively disposed at noon, 3 o'clock, 6 o'clock and 9 o'clock around the outer rim of the circular field 130, and on the inside of the meridian ring 140. The economic clock terms of “peak and trough, expansion and contraction” are thus merged with stock market terms of “Bull and Bear.” By doing this, the asset data visualization guide is provided with easily understandable direction.

The actual or forecast direction, which is in-part indicated by clock hands 144 and 148, is set by the user estimates 142, 149 (green color for “going”) on the meridian ring 140. The user can manually position the hands 144, 148 of the clock, by clicking and dragging, for example, to coincide with displayed market indicia. Of these, peak, bear, trough, bull or on a more detailed level, the indicator ring 125 provides further detailed indicia, such as indications of base interest rates increasing, unemployment rates falling, and the like. In the embodiment of FIG. 1, the small hand 144 indicates the current direction of the inner asset classes 120. The current direction of the economic cycle is indicated by the big hand 148.

The indicator ring 125 is a ring on the main screen of the asset data visualization guide, and displays, in words, the performance of the economy and industry (for a particular country, region or entire world), given the current and forecast independent variables on the meridian ring 140. The indicator ring 125 contains one or both of macroeconomic information and microeconomic information. The macroeconomic information is distributed into the various graphical segments 127 on the outer part of the ring. The inner part of the ring can include information related to the microeconomic cycle, such as business climate and conditions for companies.

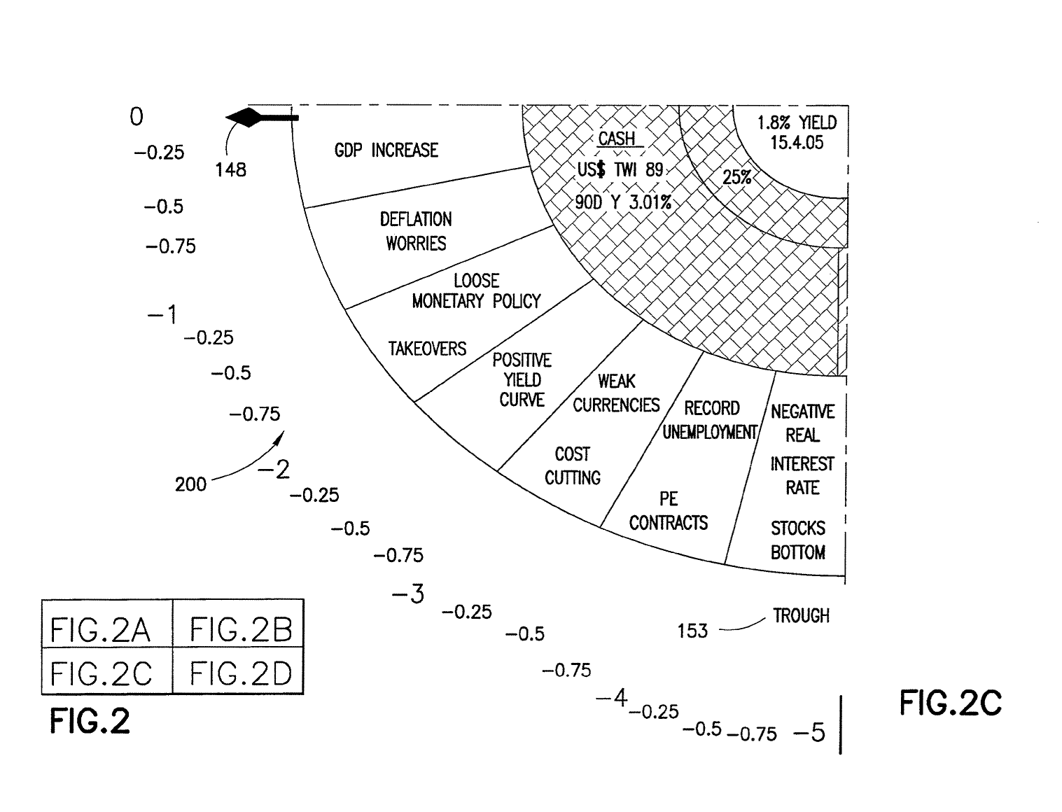

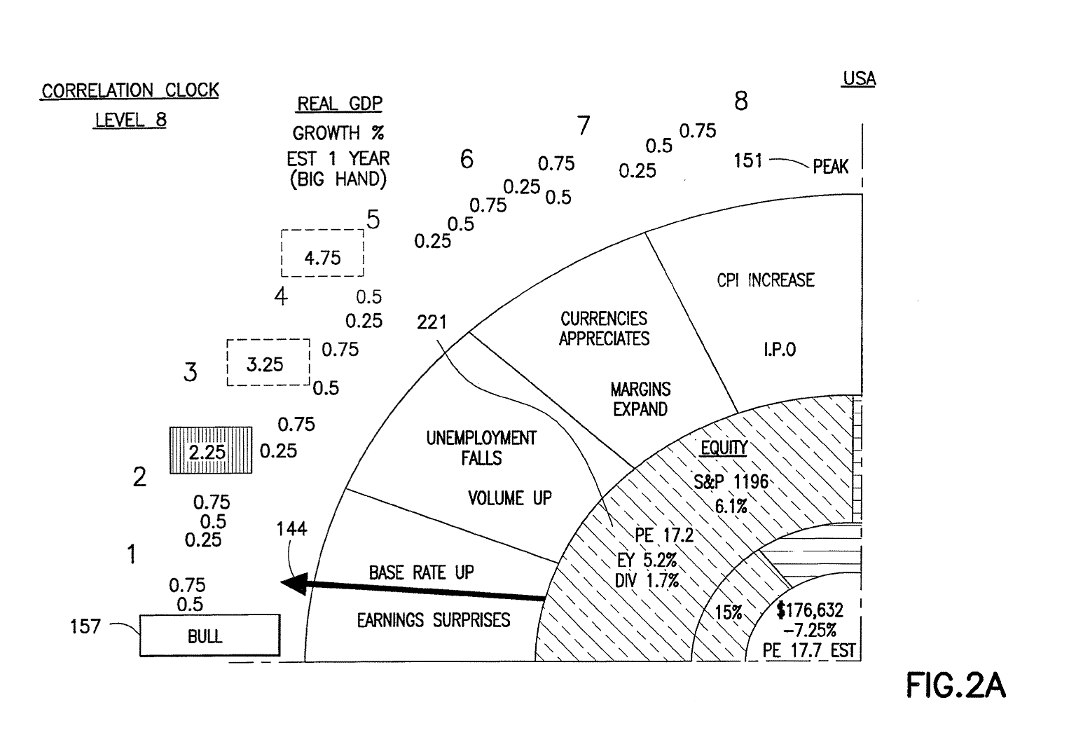

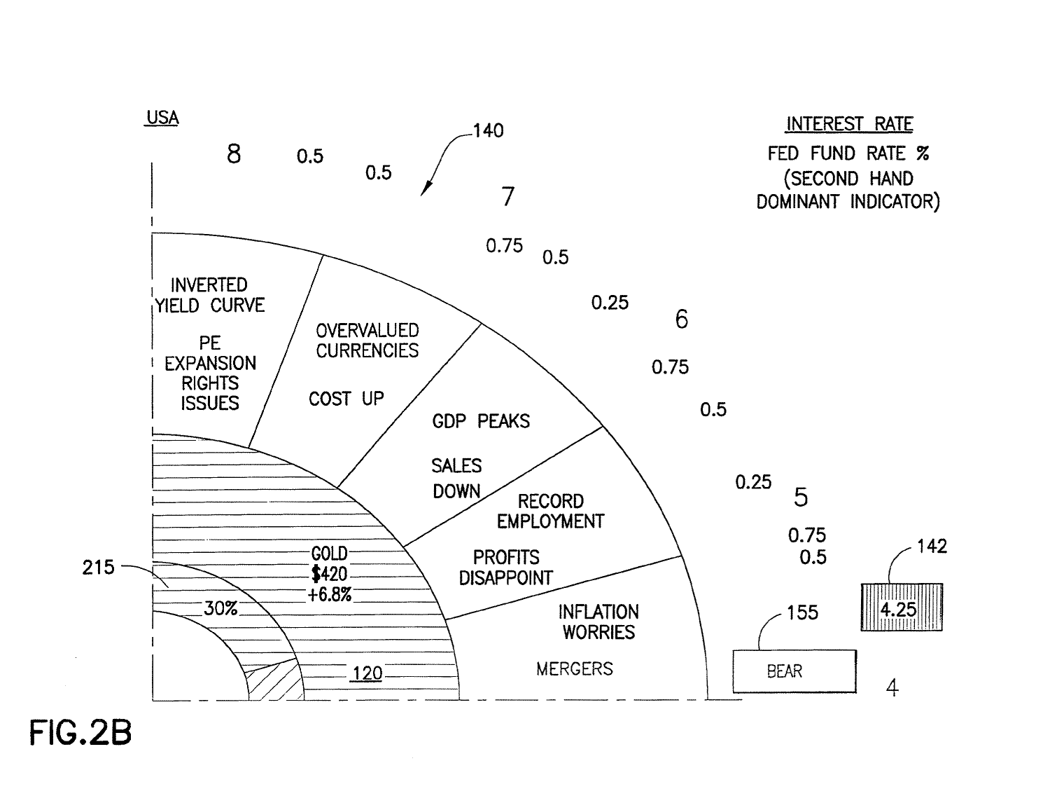

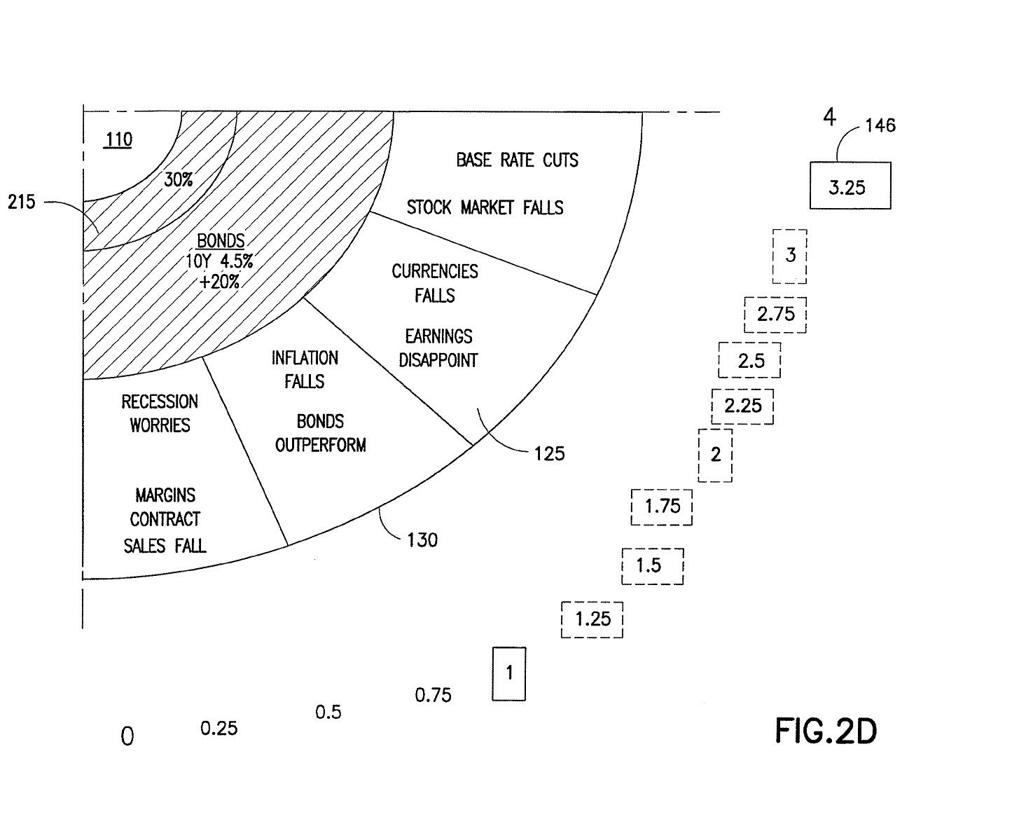

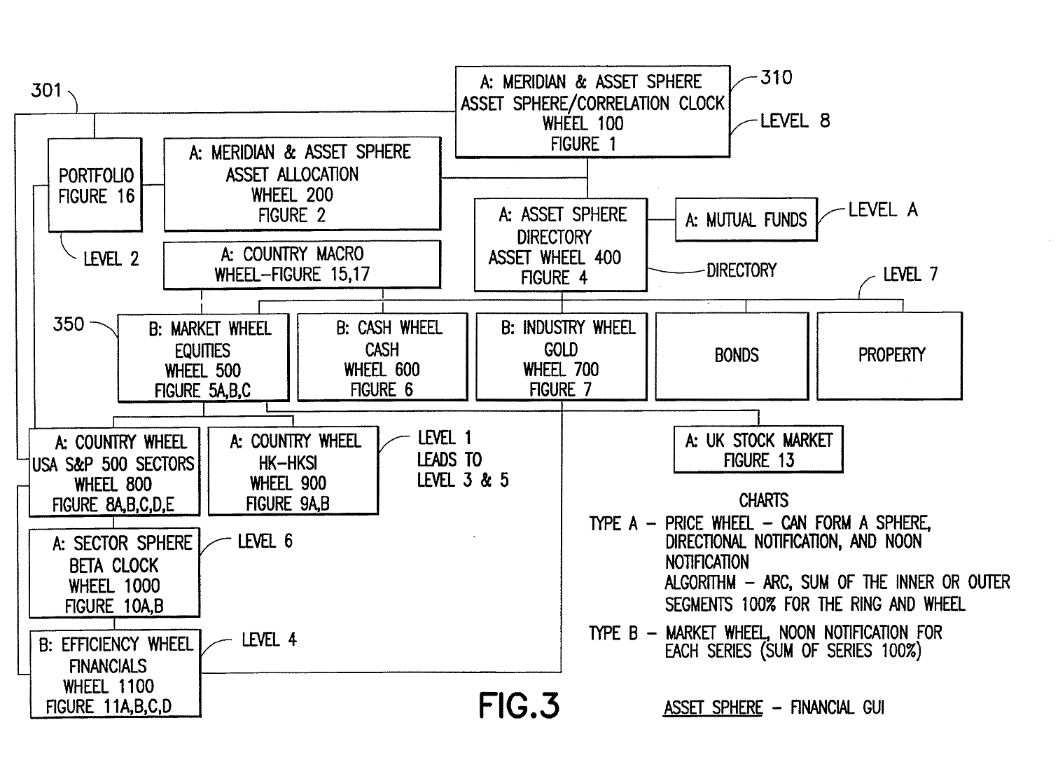

The embodiment of FIG. 2 is a variation of that of FIG. 1, and similar features of each embodiment have similar functions. Turning now to the example of FIG. 2, the rotatable asset ring 120 sets out types of assets or “asset classes” which can form subject of investment. In this embodiment, the asset ring 120 is balanced, and gives equal weight to each asset class. With an equal weight in each segment, the center value should not change as one segment goes up and another goes down as money flows in or out of the segments, wealth is preserved, but not maximized. A traditional asset allocation in the US would hold 48% Domestic equities, 14% International equities, 33% Domestic bonds, 1% International Bonds, 1% cash 2% Real Estate, 1% other. (source UBS. GBM-Pension Fund Indicators 2004).

The innermost display circle 110 sets out what is at risk. This can be an amount of a particular currency, other resources available to invest or the market capitalization, value or market mean. In this embodiment, it is U.S. $176,632. The next outermost ring is the allocation ring 215. This allocation ring 215 represents a user's allocation to each respective asset class in terms of a percentage of the center value displayed in display circle 110. Alternatively, the allocation ring 215 can display the user's allocation as a value, for example in US Dollars. There is preferably a correlation of color between segments of the allocation ring and respective segments of the asset ring 120, the same color being used for each respective pair of segments. The center display circle 110 also shows the current yield available (for example, in percent), predicted for the selected allocation of assets, indicated by the displayed percentages in the allocation ring. The user can compare this predicted center yield to the various asset class yields as well as to the base interest rate. The current 146 and forecast 142 base rates, which are user-input, are highlighted on meridian ring 140 by the window surrounding them. The aforementioned asset class yields are determined by way of other screens of the asset data visualization guide, details of which are set forth below. The base rate is the cost of money. A change in the cost of money will change the price (value) of money, that is the value of the currency. The base rate is the rate of which all other yields are priced. In an embodiment, 90-day treasury bills are the proxy for a risk free rate of return, since the treasury bills have limited interest rate or capital risk due to short time frame, rate determined by the base rate. As current and forecast yields change, due to changes in the economy, including interest rates, the center capital value in display circle 110 will change, reflecting any change in returns and any change in the risk of each asset verses its return. Depending on the specific implementation, the guide can be configured such that a user can hold a cursor over any asset class, or in other embodiments over any individual asset (e.g., a single mutual fund or stock, etc.), to display in a pop-up window or the like, a correlation to an opposite asset (e.g., gold vs. cash) and/or the Coefficient of Determination of the value of that asset class or individual asset to the Independent variable (e.g. interest rate) on the Meridian ring 140, or alternatively, to show last price, bid offer and the volume traded in an asset class or individual asset.

FIGS. 10A, and B, represent examples of the “Beta Clock” (level 6) which is an example variation of the “Correlation Clock” of FIG. 1, GUI 100. In this example the Sphere is fixed in position, with segments' positions automatically adjusted as the Beta or time period changes. Beta is a standardized measure of systematic risk where the market beta is equal to one represented as the center. Beta measures the sensitivity of a security's returns to changes in the market return. The sphere uses Beta to define the position on the sphere. The meridian again indicates the direction of segments on the sphere. The magnitude of the sector size can be represented in equal proportions on the sphere or in degrees relative to the change from the center.

The sphere is designed to merge quantitative methods with analytical research, with the user defining his required return, inputted on the meridian ring, thereby generating the required risk adjusted return for each sector. Each user has a different required rate of return due to everyone having a different risk profile. The sphere calculates the required rate of return and generates each of the sector's Alpha reflected in 120j as seen FIGS. 10A & 10B representing the excess risk adjusted return each sector has delivered over the time frame. In one embodiment segment positions on the sphere are arranged starting at noon moving clockwise ascending, and from the trough descending. The sector sphere notification communicated with the physical direction of 149 on the meridian ring 140 and can be represented on the sphere by the big hand 148 of the clock, and overall direction can be notified by the second (small) hand 144.

Notification in an embodiment being the left side outperforms the center and right side in a rising market and underperform both in a falling market. Equally the right side outperforms the left and center in a falling market and underperforms in a rising market, hands of clock can be present or absent. In one embodiment the big hand 148 notifies the relative direction that is the left or right side of the sphere inline with the meridian ring corresponding direction. Economic ring 125 is not shown in FIG. 10. This is not to say it could not be visualized as in FIG. 1. In one embodiment 120 Ring GUI 1000A remains fixed in position, divided into 10 concentric rings. The order of the rings could be from the inner ring to the outer ring 120a, b, c, d, e, f, g, h, i, j. In FIG. 10A rings 120e-j are exhibited, by clicking on the center 120 which expands or contracts, as shown in FIG. 10B where the sphere rings 120a-j are displayed in full.

The value of each rings ratio's is calculated using the values on one ring, with the respective ring values being used to generate the appropriate ratio requested by the user. There is typically a correlation of color between segments of the rings 120a to j, the same color being used for each respective segment. Segments of the 120 set out the sectors of the Index, which can form the subject of investment rings 120a-j profiling the risk versus the reward of the sector's past or expected performance. In this embodiment, the position corresponds to the degree of bullishness or bearishness. The inner most display circle sets out Benchmark and values. In this embodiment, it is S&P 500 level 1142 performance YTD 5.2%, PE 15.9, Earning Yield 6.25% EPS Growth 10.4% PEG 1.5. Expected Return of 8%, effectively the center explains the mean of the sphere of 120a-j. Each ring reflects the values of that sector 120. Ring functionality of the 1000 is given in detail in table 6 later. Each segment in the rings enables easy comparison of sector's ratios to each other and to the center. In an embodiment the order being: 120a coefficient of determination, 120b correlation, 120c volatility, 120d Beta, 120e PE, 120f EPS growth, 120g Price to Growth (PEG), 120h Required return generated from the user inputs on Meridian ring, 120I Performance and the outer ring 120j Alpha Ring. “Alpha” is defined as either the historical or expected out-performance of the sector given the level of risk.

For example, the GUI 1000A is similar to FIG. 1 with the GUI now showing sectors from 121 S&P 500, on ring 120. The meridian ring 140 which displays the independent variable S&P index 149, also becomes the center value 110, along with the 90 day bank bills representing the interest rate on the right side of the meridian ring 142. The wheel is fixed in position ring 120. Notification for “Sector Sphere” changes, as displayed in 1000A-B overweighing assets in line with forecast direction on meridian ring 140, additional guidance by the clock hands. Relative notification with big hand 148, overall direction on GUI 1000 is relative to the FIG. 1 GUI 101 relative direction of the sphere can be displayed by the second(small) hand 144.

GUI 1000A-B segment positions reflect sector risk relative to the center risk, measured by beta. Center represents an index and has a beta of 1. All sectors on the right will outperform the center and the left side in a falling market, and all sectors of the left will outperform the center and the right in a rising market.

Referring to 1000B, the segment size reflects the magnitude of the risk (leverage) relative to the center. The center has a beta of 1. Information and Technology 1135B has a beta 1.92. Therefore nearly twice the size of the segments on the left side of the GUI have almost twice the risk of the Index (center).

Segment position corresponds to the timing of when one should overweight one sector relative to the opposite side of the sphere, or reflects the degree of risk on the same side of the sphere. For example using FIG. 10B for reference, if a user estimates being near the end of a down cycle, noon to trough, a user may increase risk (beta), by increasing weighting in financials 1125B and reducing weight in consumer staples 1105B. When a user estimates being near the end of an up cycle, trough to noon, the user may increase holding in materials 1150B and reduce Information and Technology 1135B. Both will increase the return of a portfolio based on the user's forecasts and outperform the center in a risk adjusted way.

Equally overweighting a segment corresponding to 7 o'clock represents a very bullish stance due to the leverage to the center. Underweighting the opposite side will increase the risk but equally increase the reward e.g. Overweighting Information & Technology 1135B having a Beta 1.92, means it will move in the same direction as the center by 1.92x and underweight 1105B consumer staple beta 0.204. Correlation 120b, assist with the overweighting of assets, the sphere again can position segments negatively correlated to opposite each other also assists in ensuring a diversified portfolio with ease. All sectors on the left of the sphere will outperform the right on users' inputs. Big Hand 148 of the clock points to the bull 157, on the left side. Assets on the left will outperform the right side and also outperform the center Index 110. If the direction on the Meridian ring 140 is decreasing or if the hands of the clock were down in a “bearish” stance, you would overweight the bearish right side as these assets will fall less than the center or left side of the GUI, the opposite to FIG. 1. This serves to achieve a goal of preserving or maximizing the center in a risk adjusted way.

Economic Clock Merged with the Beta and Correlation Clock

The incorporation of the economic clock, including hand 148, with the meridian ring and wheels assists the user in allocating his or her assets among the asset classes displayed in the field 120 of the subject asset data visualization guide. The economic clock feature embedded with new charts and the meridian ring of the present invention aides the user in determining in which quarter the hands 144, 148 have been set by using the input and calculating the correlation or beta values.

According to one example implementation, the meridian ring 140 assists the user in deciding the correct position and direction for each hand 144, 148 in light of current and/or forecast economic conditions. The meridian ring 140, in conjunction with the indicator ring 125, incorporate the business cycle and economic cycle, and together give direction to the asset cycle, represented by the asset ring 120. The data input to the meridian ring can be input by a user or automatically obtained by the computer system running the asset data visualization guide. The business cycle is represented by the variables on the meridian ring 140. The hands 144, 148 of the clock, in line with the direction forecasted from the current value to the user estimated value on the meridian ring 140. This forecasted direction is key to the future values calculated and displayed for assets in the asset data visualization guide. If the forecasted direction is “up,” this is interpreted from the hands 144 and 148 of the clock being between the “6 o'clock” position (trough) and the “noon” (peak) position. This region of the asset data visualization guide indicates a “bullish” economy or, depending on the specific user settings, a bullish sector of the economy. In such an instance, as shown for example in FIG. 2, price will increase for asset classes on the left side of the asset ring 120, relative to those on the right side of the asset ring 120, since those on the left side will be performing well, given the forecast. At the same time, assets illustrated on the right side of the asset ring 120 will under-perform. The asset ring 120 rotates in accordance with the economic cycle and leads or lags, depending on the specific combination of variables on the meridian ring 140. For example, if interest rates are currently 1.75%, with forecast interest rates being 3%, and GDP growth is currently 4.75% and is forecast to increase to 3.25% then the inner allocation ring 215 can move in accordance with historical data for similar magnitudes of these independent variables, measured by either the Coefficient of Determination, which represents the degree to which the assets' movements are attributable to the change in the meridian ring 140 variables. Alternatively, predicted values are calculated by the sensitivity to change in Discount Rate 142, known as duration. The sphere in effect monitors the change in the Present Value Money for each asset class given a change to the variables on the meridian ring, calculated by Duration and the duration effect (formula below).

The meridian ring 140 monitors current variable values and directions of the variables' future values. The clock hands 144, 148, in conjunction with the indicator ring 125 and the bull 157, peak 151, bear 155 and trough 153 broad indications, monitor the user-estimated position of the economic cycle. The asset ring 120 monitors the asset cycle. Within the asset sectors, and in other screens of the asset data visualization guide, any individual stock or asset subclass may be in a different place in the cycle than the asset class as a whole. Such an individual stock or asset subclass may take advantage of the economic cycle due its own strengths, which can include, for example, management, balance sheet strength or sector growth above the average GDP growth rate. The inner allocation ring 215 illustrates the relative quantities actually or hypothetically invested by the user.

The indicator ring 125, representing the business and economic cycle (3^{rd} ring in FIG. 1, 4^{th} ring in FIG. 2), highlights the effect a change in values of independent variables values on the meridian ring 140 have on the business and economic cycle. The display field 130, every ring therein, and each part of the asset data visualization guide can be looked at in terms of four quadrants or quarters, each quarter being defined in increments of 90 degrees clockwise, starting from “noon.” As the hands 144, 148 move from quarter to quarter on the Clock face, the hands 144, 148 pass through the specific economic indicators of the indicator ring, which show, in words, how the movement of the demand and supply of world's resources are linked to the macroeconomic and business cycle. The variables on meridian ring 140 govern the speed of the cycle as well as the price of the cycle. The “price of the cycle” is, whatever the net result of a complete. The center value, displayed in center display circle 110, is a result of meridian current and/or forecasted values of the meridian ring variables.

People create demand and supply for goods and services, while governments aim to control demand and supply. Both people and governments, however, are able to change the speed of the aforementioned macroeconomic and business cycle represented in the indicator ring, and the bull 157, peak 151, bear 155 and trough 153 broad indications. The cycle from Peak 151, clockwise and back to Peak 151 can be short or long, and is normally several years. As the hands 144, 148 fall on the right side of the field 130 and the right side of the indicator ring 125, so too do demand, prices and output (“bearish”). Similarly, on the left hand side of the field 130 and the left side of the indicator ring 125, as the hands 144, 148 rise so too will demand, price and output. The user positions hands 144, 148 to the current position is in the cycle. The hands if correctly positioned rotate clockwise throughout the cycle. When the reserve bank changes interest rates, they change cycle, therefore, you may miss a whole quarter or half. For instance, 12 O'clock to 6 O'clock represents a down cycle due to an easing in monetary or fiscal policy to accommodate a change (a bit like daylight saving, fast forward). The clock hands need to be readjusted if policy changes. After the readjustment a clockwise direction resumes. The macroeconomic and microeconomic cycles work in unison, both impact each other, and both are sensitive to the Demand and Supply available.

Definition and Calculations of Duration

Bond and Equity calculations for sensitivity to a change in Interest rate. Bond Duration:

Duration is a measure of a bond's (or Portfolio's) sensitivity to a 1 percent change in interest rates. One way to calculate duration is as follows:

$$Duration = \frac{V -- V +}{2 Vo ( Δ y )}$$

Where V−=estimated price if yield decreases by a given amount, Δy
V+=estimated price if yield increase by a given amount, Δy
Vo=initial observed bond price
Δy=change in required yield, in decimal form

$$\begin{matrix}Duration effect = approximate percentage change in price \\ due to duration \\ = ( - ) ( duration ) \cdot ( Δ y )\end{matrix}$$

(negative sign because bond prices and yields move in opposite directions.)
Equities Duration: using Dividend Discount Model (DDM)

$$Present Value Equities = Price ( P )$$

$$P = \frac{D 1}{k \text{-} g}$$
k=equity discount rate (10 year Bond)
g=growth in dividends (S&P 500 growth in Dividend for one year)
Using correlation to forecast change in Equity Duration assuming all other things are held constant
1/P (correlation of P/correlation of k)=−1/(k−g)(1-correlation change in g to change in k)
Correlation change in g to change in k for 10 years.
S&P 500 empirical results based on regression of S&P 500 returns versus 10-year rates over the previous 40 years suggests a sensitivity of 2.7, i.e., subject to model limitations, equity returns fall 2.7% for every 1% rise in the 10-year rate

$$Expected rate of return = ( D 1 + P 1 - Pmkt ) / Pmkt$$

$$or = ( D 1 / Pmkt ) + g$$

where g=Retained earning (RR)×Return on Equity (ROE)
retained earnings=RR=Earnings retention rate (1−r) is the Index dividend payout rate
   P1=(EPS1)×(P/E1)
P1, D1=estimated one year future value of equities price and dividend
P2=estimated two year future value of equities price and dividend

$$Retention rate = 1 - \frac{dividends declared}{Operating income after taxes}$$

.Price earnings ratio in one year=P/E1=(D1/E1)/k−g
where k=Risk free rate (RFR)+Industry premium (RP)
k=required rate of return=(1+RFRreal)(1+IP)(1+RP)
RFR nominal=RFR real+Inflation premium (IP)
RFR real=determined by the supply and demand for capital in the country.
The real risk-free is the rate investors would require if there were absolutely no risk or inflation
   Bull or Bear Market—a Reflection of Monetary Policy

Bull and Bear markets are the result of the macroeconomic and microeconomic cycles, in turn a reflection of monetary policy. A bull market includes rising stock prices and increasing demand, normally resulting from an expansionary monetary policy due to increases in the growth rate of money supply. Usually implemented by Federal Reserve, Fed buys Treasury securities driving prices of bonds up and yields down, when Fed buys bonds it is selling money this results in lower real interest rates and cheaper currency, lower real interest rates make current consumption and investment less expensive. This then increases companies' sales, which in-turn leads to higher profit margins, the creation of jobs, wage growth, in-turn creating yet higher demand and even higher profits (micro cycle). A bear market includes falling stock prices due to falling demand, normally resulting from a restrictive monetary policy. This results in an overvalued currency with high interest rates, leading to falling sales, lower profits, job cuts, and increasing supply.

The market talks both about the peak and trough of the economic cycle (macro cycle) and the macroeconomic environment: peak, contraction, trough and expansion. The clock face aspect to the present invention, including the indicating clock hands 144, 148, and indicator ring 125 highlights how the macro and micro cycles remain linked to the same price controls (e.g., interest rates, exchange rates, money supply, employment rate, population growth, and wage rates (CPI) which can be represented on the Meridian ring 140.

The macro and micro cycles are both ultimately governed by the supply and demand of the resources available in any particular country. Strong demand (rising GDP) will lead to rising prices, leading to an expanding economy and rising stock prices (a bull market). In contrast, excess supply will lead to falling prices, in-turn leading to a contracting economy (falling GDP) and in-turn to falling stock (equity) prices (a bear market).

The present invention provides an improvement that graphically merges the terms “Bull market” and “Bear market” and the Economic clock terms “peak” and “trough” with the clock linking a direction of the asset allocation “mix” illustrated in FIG. 2 on the allocation ring 215. With the direction of the clock hands 144, 148 up or down, a bullish or bearish market are respectively indicated based on user forecasts on the meridian ring. The invention further monitors the 3 cycles: the economic cycles and stock market cycle, as well as the variable cycles on the meridian ring that change the price of all assets displayed through the asset data visualization guide.

Governments and reserve banks, in recent years, have aimed to control the rate of demand (GDP) though changes to fiscal and monetary policy. In essence, they often change the value of money (the price). Implementing an expansionary fiscal policy reduces taxes and therefore increases ability to spend, which in-turn increases aggregate demand. This results in increased GDP and higher Prices. The opposite applies when a restrictive fiscal policy is implemented. The result of each respective policy is either a budget deficit or a budget surplus, respectively. In terms of governmental monetary policy, an expansionary policy can be implemented by way of lowering the discount rate, lowering the required reserve ratio or by buying government securities. The reverse applies for implementation of a restrictive monetary policy.

The timing of the start of a bull market or the end of a bear market is usually when the macro environment has hit a Trough. That is, demand has stopped falling, but prices have yet to rise. With demand flat, the stock market bottoms, and confidence returns. Employment picks up, as does demand. Profits increase and the cycle starts again. Unfortunately, data released on the actual GDP is typically already 2-6 Months old.

Each country's asset mix may result in a different arrangement when displayed by the subject asset data visualization guide according to the same desired criteria. For different countries, each displayed with the same criteria, each asset class (e.g., gold, bonds, cash, and equity) could well have a different position in the asset ring 120 than for another country. The position of the asset ring 120 (and in some instances the arrangements of the asset classes thereon), depends on the correlation to meridian ring. Since the GDP and interest rates can vary between different countries, the position and arrangements of the asset ring 120 can thus be different for different countries. Depending on the time frame (e.g., 1 year, 5 years), the correlation between asset ring 120 position and the variables on the meridian ring 140 can change. Meridian ring 140 allows comparison of yields 120 or 110 verses actual or forecasted interest rate e.g. FIG. 2 Equities Earning Yield 5.2%, with Dividend Yield 4.5% verse the Base rate of 3.25%, with the portfolio Yield 1.8%. Bonds, 10 yr. 4.5%, cash, 90 day Bills (RFR) 3.01%, cash deposit rate 0.2%. In figure, 10A-B meridian ring values are used to calculate the required return using the inputs from the meridian ring values resulting in values in 120h and 120j. The meridian again indicates direction inline with the estimated value's direction, left or right half out perform inline physical direction.) For example, using FIG. 1 as a reference, if the asset ring 120 were rotated such that equities 121 were positioned at the peak 151, it would highlight a change in future direction of the price of equities from increasing on the left side of the field (where assets and asset classes that are or will perform most favorably are placed) to falling on the right side of the field 130 (where assets and asset classes that will under-perform are placed). Bonds opposite equities at the trough 153 are forecasted to change direction with the predicted fall in interest rates. Property and gold segments (“real assets”) would be on the right side of the field 130, signifying that they should under-perform cash, due the higher discount rate when calculating the present value of the asset, or an increase in opportunity costs. In the same example, equities 121 positioned at the peak would be overvalued relative to future demand. The respective government could look to make restrictive fiscal or monetary policies. An inverted yield curve would exist and demand would be set to fall as depicted on 127, Bondholders could anticipate policy and sell bonds leading to a lower bond price and higher yields, resulting in a short term reduction in demand but no long-term change. Unanticipated policy will change short and long term outlook, leading to lower CPI, where the big hand 148 on clock reflecting demand (GDP) would change position quickly bullish to bearish, or vice versa.

In another example, if the equities 121 position is falling (at or near the bear position 155), bonds outperform (at or near bull position 148). The price of a bond is simply the present value of its future cash flow stream, discounted at a given required rate of return (or Yield) 146. When this yield changes from one level to another, the bond's future cash flows are not affected, but the present value of those cash flows are calculated using the new discount rate (Yield) 142. Thus, if the discount rate goes down significantly, the present value of the future cash flows (Price) goes up. Equities and cash under-perform bonds due to lower demand, out-weighing lower interest rates. The Bonds discount rate may change given a change in the interest rates. The Fed Fund rate on meridian ring 140 is the base rate that all interest rates revolve around. Bond prices will rise with falling interest rates, the lower the interest rate the greater the fall. Present value of Money changes the price of all assets on the asset ring 120 all else being equal.

If the equities 121 position is at or near the trough 153, this indicates that equities will look to price in a recovery in demand (GDP). This position also indicates that profits will recover, and that the market will switch from bonds to equities as it becomes clear that interest rates have hit bottom and that the next move will be up. In such a situation, this also indicates that governmental monetary and fiscal policies will likely be accommodative.

If the equities 121 position is on the left side of field 130 (as shown in FIG. 1), at or near the bull (“Bullish”), this indicates to the user that demand will continue to expand. Equities, priced based on the interest rate and growth rate, will continue to increase given forecast interest and growth rates on the meridian ring 140. A user is able to understand through its positioning in the field 130, that equities, being bullish, remain a good value relative to other asset classes, due to rising demand and increasing prices. These higher prices lead to higher profits and rising stock prices. Bonds, being situated on the right (“bearish”) side of field 130, will continue to under-perform due to higher interest rates, leading to higher yields and a lower price of bonds. Thus, if a user uses the subject asset data visualization guide, he or she will be able to easily ascertain these changes by seeing the position of each asset class.

Another example is illustrated using FIG. 1 again, but rotating equities to the peak indicating a change in direction for Equities. By overweighing the right side of FIG. 10A inline with the direction of the variable 149 represented by the big hand 148 on sector sphere with an estimated fall in the S&P 500 versus the current increase the big hand would point to the right side of the sphere in FIG. 10A. The guide highlights the sectors that will out-perform the center due to the sector moving less than the Index move as represented in the center. The second (small) hand 144 represents the overall direction from FIG. 1, it should be inline with the second (small) hand of the sector sphere. Consumer staples will fall the least measured by Beta 0.2, meaning consumer staples will move 20% of the center move in either direction. They are the most defensive of all the sectors. Sectors corresponding to degree of increase or decrease relative to the center 110 and the timing as to overweight the relative sectors given the position in the cycle. If equities rotated back to bullish in FIG. 1, the Beta clock would provide notification to overweight the left side.

Interrelationship of User Screens

The subject asset data visualization guide includes a plurality of styles of user screens to display information in different styles, and to display different information. Certain individual user screens relate back to the main screen shown in FIG. 1, illustrating the asset wheel 100 or variations thereof, such as the alternative asset wheel 200 shown in FIG. 2, which includes the allocation wheel 215. The meridian ring 140 need not be displayed in order for the main screen showing the asset wheel 100 to relate to the additional user screens. It should be noted that in the foregoing example and in other examples presented in this paper and accompanying drawings, when the Meridian ring 140 is not displayed the notification position is placed at “noon.” However, it is to be understood that the notification position can be configured to be at any position. Additionally, the direction in which segments progress from most favorable can be clockwise, as is described herein, or alternatively can be counter-clockwise in other embodiments. The hierarchical structure can be viewed by levels, the guide moves from level to level and from room to room within each level as the user requests the information

These additional user screens include the market wheels for each of equities 500, cash 600 and gold 700 (Level 7) which is discussed in more detail below. Other additional user screens include country price wheels, for example, price wheel 800 for the U.S. S&P 500, shown in FIG. 8 (level 1), and price wheel 900 for the Hong Kong. Hang Seng Composite Index (HSCI), shown in FIG. 9 (level 1). Another market wheel for example is the Efficiency market wheel (Level 4)1100A whose components relate to the price wheel 800 or the wheel 900.

FIG. 3 shows a hierarchical structure and level of display fields, such as field 130, for use in the subject asset data visualization guide and graphical reproductions thereof, which may be in the form of the graphical user interface, video displayed on television and the like, and in printed material such as newspapers and magazines. In interactive embodiments, such as computer-based embodiments, the user can “drill down” from display screen to display screen in a variety of manners. A preferred set of possible selections, depending on the particular display screen being accessed by the user, is indicated by way of lines 301. For example, if the user is viewing asset wheel display screen 310 shown in detail in FIG. 1), he or she may then select the gold asset region 131, which will bring the user to gold wheel (shown in FIG. 7). Similarly, if the user is viewing the expanded asset wheel 400 shown in FIG. 4, the user can select individual indices within the equity region 430, such as the box representing the S&P 500 420a, which would bring the user to FIG. 8, which provides a breakdown of the multiple sectors covered by the S&P 500. Further detail is obtained and further options for selection of investment sectors are provided through this process of drilling down to more detailed wheels.

In some embodiments, the asset data visualization guide includes a “sphere” as a user interface. In some embodiments, this sphere can be an actual physical sphere that a user can have, for example, on his or her desk. Alternatively, the sphere can be a computer or video-based graphic, and can be user-interactive, or only user-viewable.

In cases where the asset data visualization guide is not user-interactive, and only user-viewable, such as in printed media (newspapers, magazines), or in non-interactive video, variables are set for viewers, prior to publication. The asset data visualization guide can be advantageously included in a financial periodical, such as a newspaper, and published with updated variables each day for reader guidance (The term “user,” as applied herein, refers to those people actively using the asset data visualization guide, for example by setting the variables, entering data, and/or preparing the asset data visualization guide for publication, those who ultimately use the guidance of the asset data visualization guide for guiding investment decisions, and in the case of non-interactive media (video and printed), for the sake of clarity, one who only uses the resulting information simply as published, and does not interact with the asset data visualization guide, is referred to as a “viewer” for non-interactive video or “reader” for printed media.).

When embodied as a sphere, one display field, such as display field 130, is arranged on a first hemisphere of the sphere reflecting directional notification of the assets. Another display field, such as the equities market wheel 500, shown in FIG. 5, is arranged on the other (second) hemisphere reflecting the noon notification, alternatively country price wheels or sector sphere also giving directional notification. The sphere can be supported within a ring, upon which the variables of the meridian ring 140 are included. The sphere itself can rotate within the ring, to orient appropriately with the ring, in-particular with the notification position of the ring, which, as described above, indicates what investments are most advantageous for investment. The supporting ring can also include the indicators “bear,” “trough,” “bull,” and “peak,” as shown in FIG. 1. A base for the sphere can include additional indicators, such as “supply” and “demand,” relating respectively to bear and bull markets.

When embodied as a sphere in interactive electronic format, such as in an interactive program resident on the user's computer, via the internet in interactive format, and in video (computer or television-based), the respective fields, such as the field 130 of the asset wheel 100 can function in precisely the same manner as they function in “two-dimensions” (displayed as circles). More specifically, the user can select various options, by “clicking” in the appropriate area of the field, and the display will respond by rearranging the display areas, if necessary. Also, in interactive versions of these embodiments, the user can manipulate the sphere in “space” through actions such as “click and drag” and the like. Alternatively, the user may simply push a button provided for changing views. Similarly, in non-interactive versions, the display can cycle through different views for the viewer, with all selections having been made in advance by a user affiliated with the media provider.

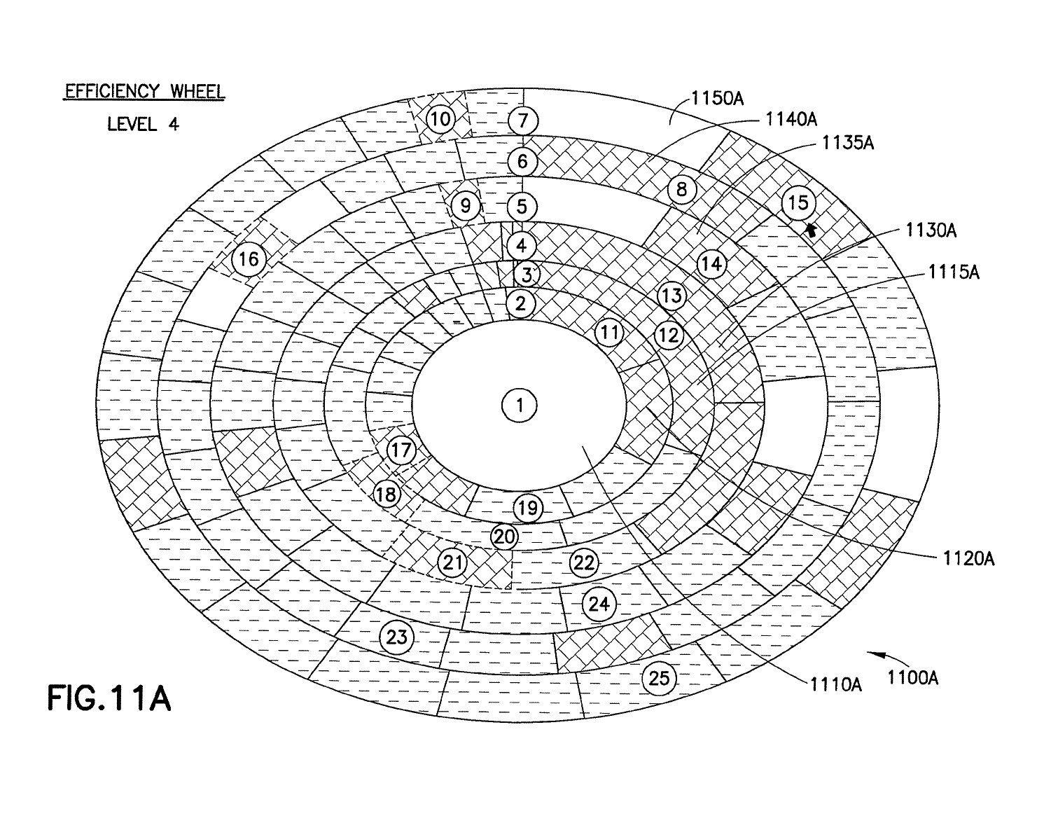

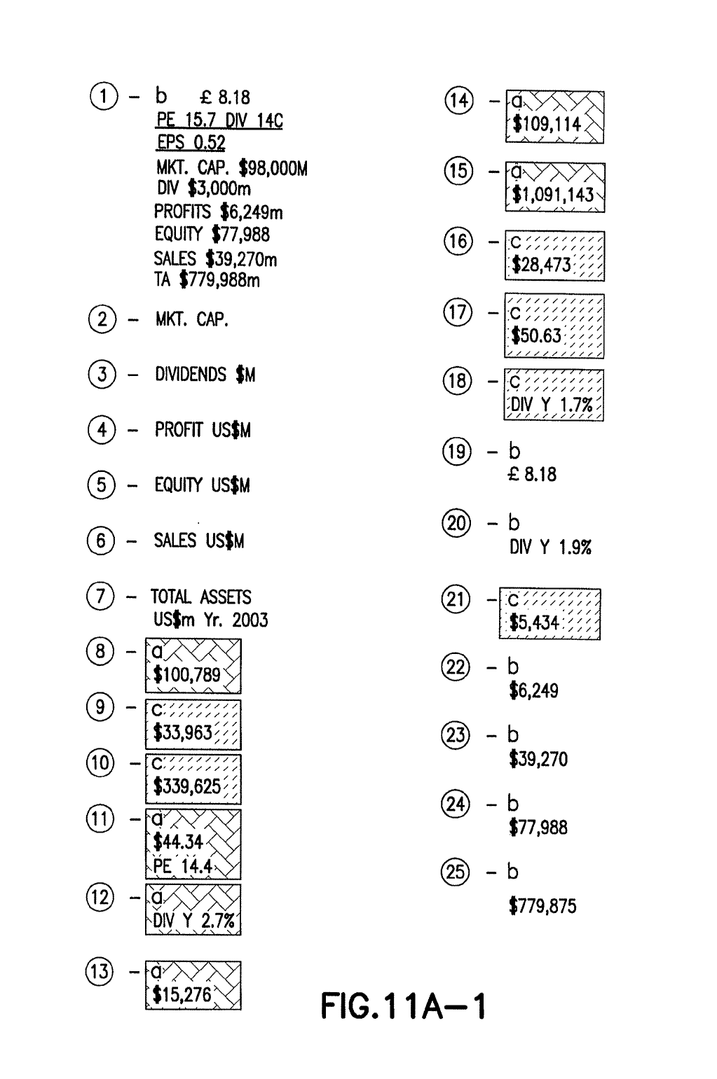

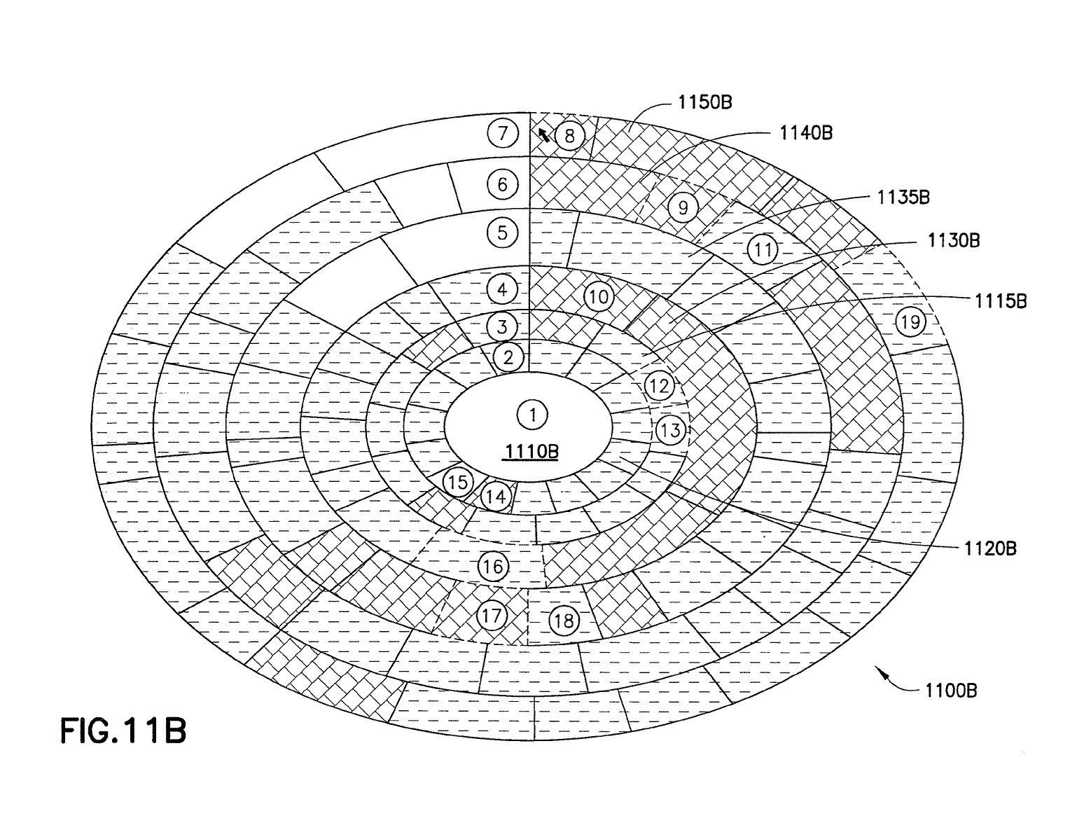

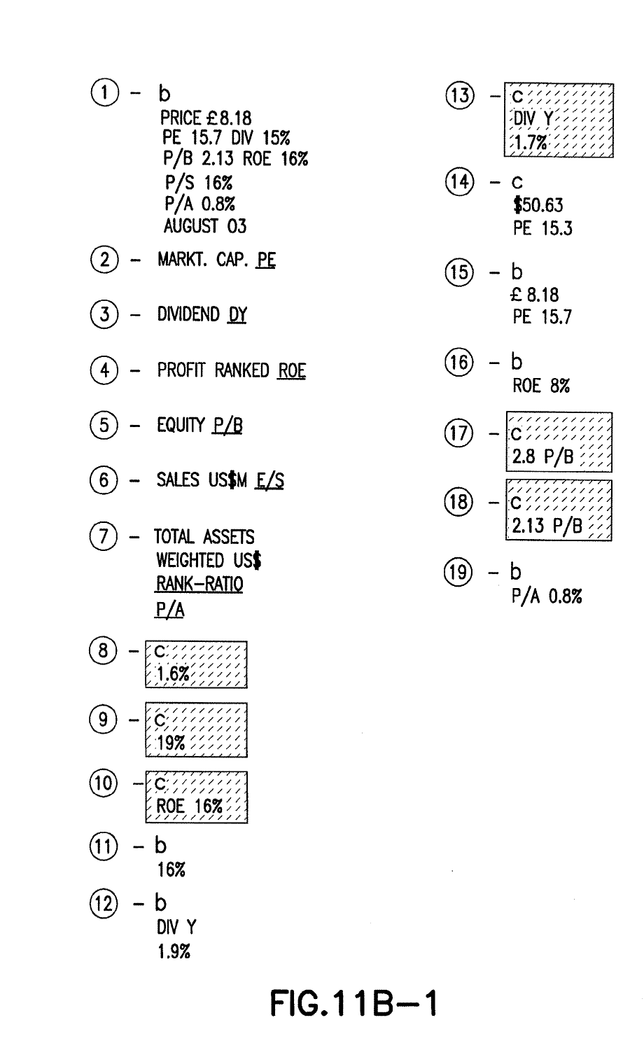

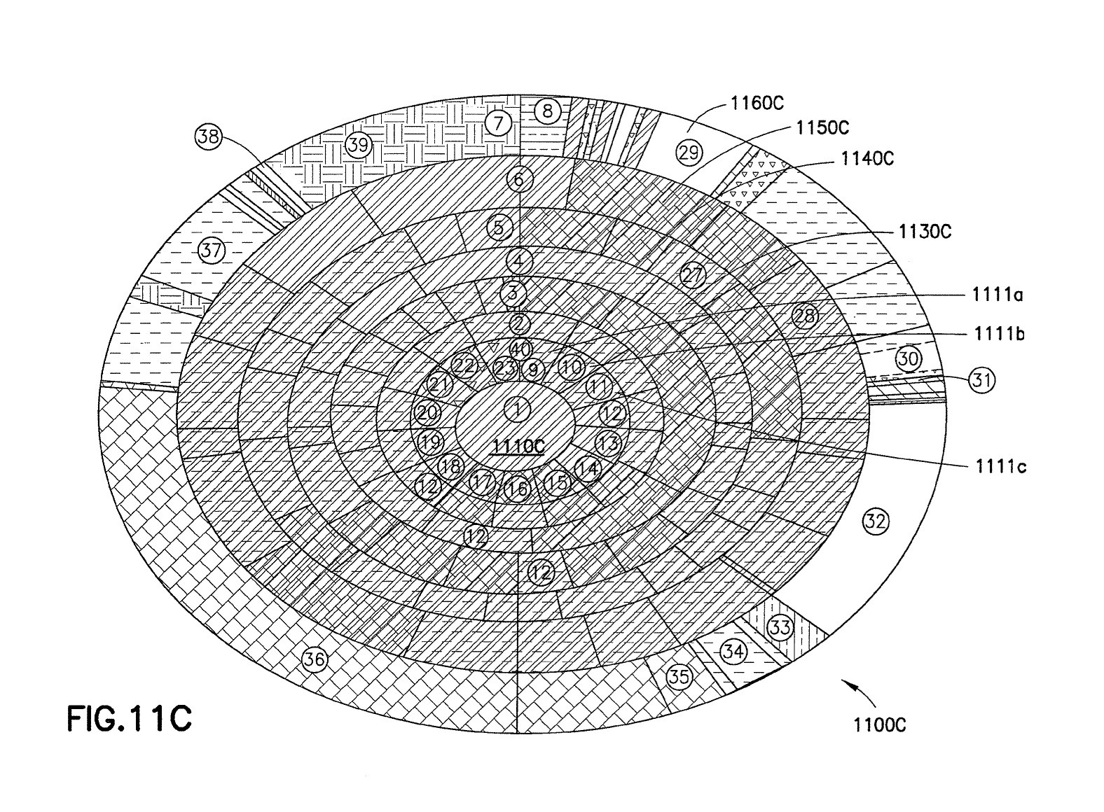

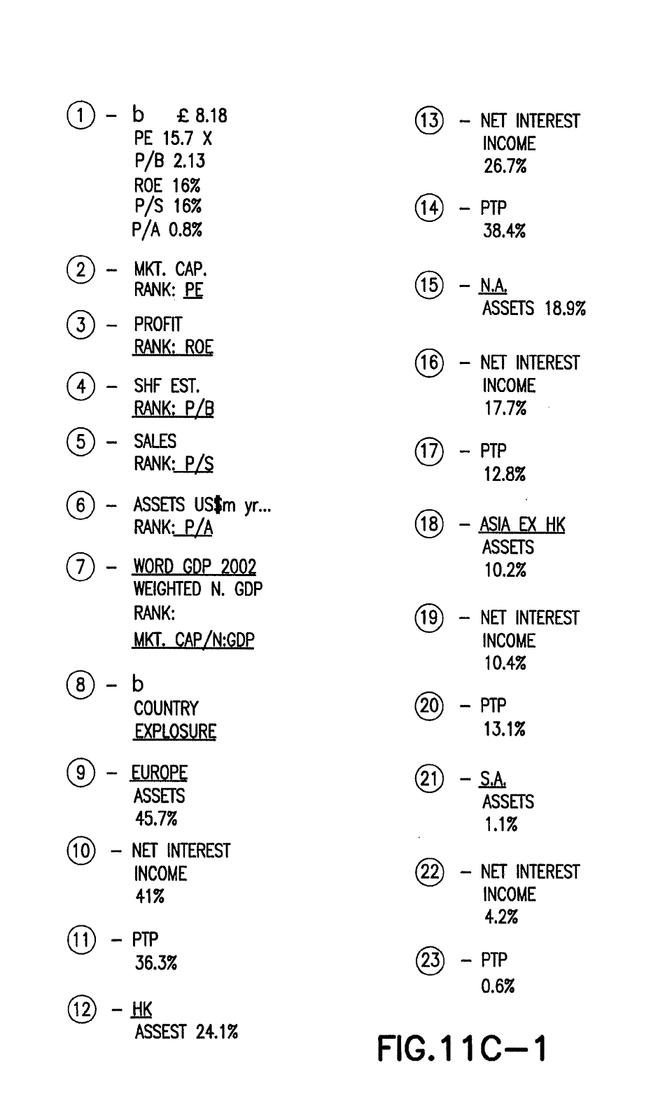

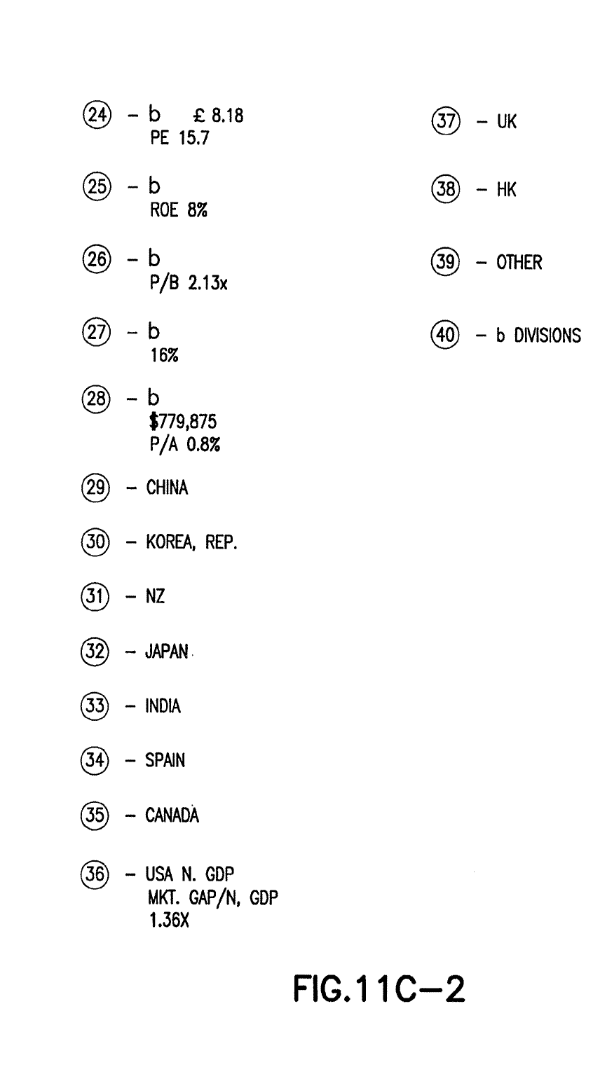

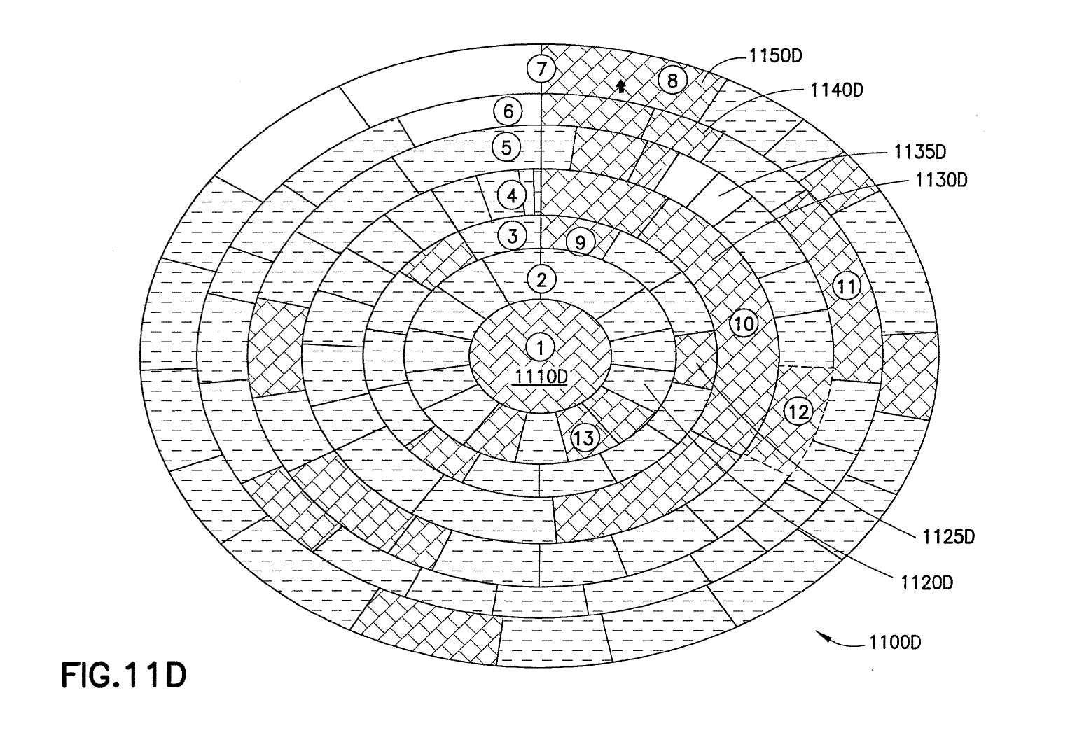

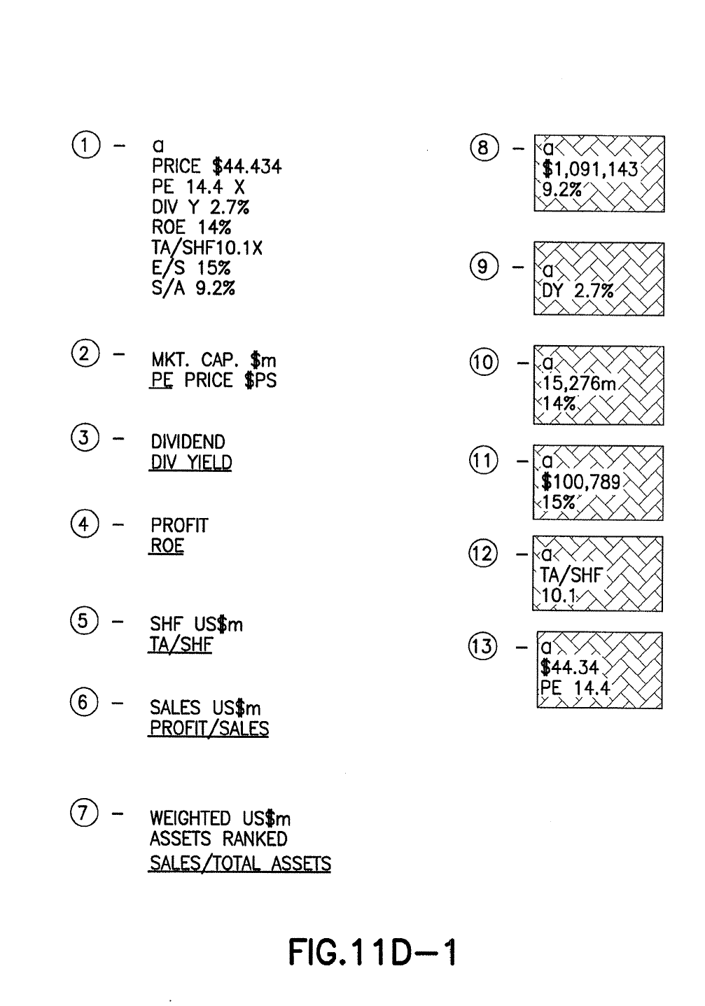

Advantages of the asset data visualization guide relate to its function as an interactive decision tool that is unique in many ways. The asset data visualization guide is able, through the multiple circular or hemispherical display fields, to sort and rank the total market by the user's individual investment style. Multiple display settings allow the user to select the manner in which data is displayed. The display settings can be selected in any appropriate manner, including but not limited to a drop down menu, a side menu and a dialog box. One default display setting places ranked choice rings, each individual segment (displaying e.g., a sector, a market, a stock) being weighted by market size, relative to the others in the same ring. In this instance, the weighting is accomplished based on data for the size of segment, such as market capitalization and nominal GDP, the smaller the size the greater the risk. Small market capitalizations or economies are higher risk than larger markets or economies, for example, due to less liquidity or higher volatility). Other possible weightings could consist of turnover, within the ring, or with the numerical data values displayed on a label, which may be permanent of “pop-up” when passing the cursor over the segment. In the example of FIG. 11A the default weightings is comprised of total assets, sales, equity, profit, dividends, and market capitalization. Here the size of the segment gives notification of total value relative to other companies within the series. The larger the segment the greater the value. Another display setting is based on the user's investment style. With such a display, the asset data visualization guide ranks the outer choice rings clockwise by a user-selected measure. In some embodiments, this measure is selected in a dedicated “style ring” within the circular or hemispherical field. Such user selected styles can include a ratio or by a style such as “value,” “growth,” “large cap,” “small cap” and the like, as seen in the style ring 550 shown in the example of FIG. 5A. Additionally, other criteria can be included in the style ring for user selection, such as time series with choice of historical data or forward estimates. In one example embodiment, the Control rings labels give other options that are available using a drop down legend if underlined. Default for Time series 500 of FIG. 5A, is 1 year historical, with other options underlined within the time series segment for example 1 yr. est. The outer 535 ring ranks the market performance, with a separate time series accessed by clicking on the performance legend. A choice may consist of, Year to Date (YTD), Year on Year (Y/Y) and the like. The center reflects the user input or the default setting. The values and ratios correspond to each ring on the wheel in descending order. The user can also select whether the individual segments are arranged in ascending or descending order, according to the selected measure.

A unique function of the guide is the ability to display both the aforementioned display screens in one GUI, that is it combines the physical size notification with the noon notification of style ring measure.

As an alternative display setting, the user may select to display data in terms of the investor style criteria. With such a display setting, the guide can be configured to only display stocks, other assets, or list only countries that meet selected criteria. The criteria can include one or more “greater than” settings and/or one or more “less than” settings.

A view panel is provided that offers a choice of data displays to the user. The user can select from a weighted display or un-weighted display. The user can select to have the above-mentioned style ring included in a ring within the circular or hemispherical field, or to have those selections in a separate menu.

The asset data visualization guide, through input data, tracks and monitors supply and demand, the performance and value of a portfolio, selected indices, sectors, or securities, and can calculate a market or sector mean and compare these aforementioned values to the market or sector mean. The central display area, such as central display area 110 is present in each style of wheel, and can display a variety of data. In one embodiment, the central display area 110 displays the mean of the market, a benchmark and/or the value of the user's portfolio. As such, the central display area displays, in a conspicuous location, what is “at risk,” while continuing to monitor all variables, independent and dependent, with the concentric rings around the center.

A further unique aspect is that data is weighted and color coded, and arranged in rings by segment size. This enables changes in sector weightings to be easily identified, by the user/viewer, by the change in the displayed size of a segment relative to other displayed items in the series or by a change in position within a ring or within a plurality of rings. Color-coding enables the user to quickly identify a segment's position on the wheel being viewed, the “noon,” 1^{st} quarter (upper right), 2^{nd} quarter (lower right), 3^{rd} quarter (lower left), and 4^{th} quarters (upper left) identifying desirability of investment in that asset. If cross-sectional time series analysis is selected (“Cross-sectional” refers to the examination of a firm's or sector's performance in comparison to other firms or sectors in the industry with similar characteristics to the firm being studied. “Time-series analysis” refers to examination of a firm's performance data over a period of time). It is performed via the asset data visualization guide, for countries, securities or economic series and, for example, if that particular country, security or economic series falls in the 3^{rd} or 4^{th} quarter (left side of clock) in one or all rings, it is below the mean for that measure. If it falls in the 1^{st} or 2^{nd} quarter (right side of clock), it is above the mean. The center can display the security with the highest frequency or lowest frequency in the noon position, with the inner rings having a higher weighting than the outer rings, indicating an out-performance or under-performance respectively for the wheel. Equally, the weighting can favor the user's selected style measure from the style ring, know as the central noon notification position. The center value can include the mean of the market representing the minimum an investor would want to achieve as a return. Additionally or alternatively, the center value can display what is at risk—i.e. the value of a portfolio, price of a commodity, price of gold or the value of a dollar, or company's profit. For example, on level 4, of FIG. 11A company “b's” financial data is shown in the center “at Risk” with aim to preserve and maximize. The wheel visualizes the competition, ranking their efficiency to generate profits relative to their assets bases verses “company b's” ability. In this FIG. any one stock that is positioned at the noon position in all of the rings would be the best value for money. Due to the stock-market's efficiency the market would never let a stock be in the noon position in all of the rings.

The asset data visualization guide is capable of identifying and illustrating the size and risk of stocks or other assets by way of their placement in the concentric rings on the various wheels. For example, using the US country wheel of FIG. 8A (level 1) as a reference, each ring's market capitalization reduces starting from the center working outwards. Ring 813 has a market capitalization equal or over US$160,000 million, ring 814 has a market capitalization of $80,000 to under $160,000 m, ring 815 $40,000 to under $80,000 m and so on, the further from the center, the higher the risk, ring 815 is twice the value of ring 817 enabling a clear perspective to the companies' size and their potential to improve their tier position, and/or their valuation ranking. The closer to the noon position within their sector the more favorable their valuations in regards to purchasing compared to the competition. The guide visualizes who they are competing with and their financial strength as represented on the wheel, equally it may assist with identifying larger or smaller companies they may want to buy to increase their market share. Large companies typically have lower risk and thus are placed closer to the center. They are ranked according to size or selected style measure within the ring. That is, the rings function as tiers of risk, with lower risk assets sitting toward the central display circle closer to the noon position within their sector ring sequential around the wheel. Additionally, if desired by the user, the assets are then arranged within that tier, according to a user's style or default settings with the preferred assets being arranged closer to “noon” on the vertical line for the sector in a clockwise direction. The guide at least partially graphically illustrates risk by the displayed size of an asset with the position of the asset demonstrating the difference in valuation risk compared to the mean of the sector or the wheel. The mean of the sector is displayed in ring 811 of FIG. 8B and the mean of the wheel in the center 810. Thus, a user can reduce risk by paying a lower price for small asset segments in the outer rings. By monitoring a company's position on the ring the and wheel progressive companies will be identified as moving inwards, as they increase in value.

The user controls can be embedded within the inner rings of the display area, controlling the positioning and components displayed on the outer rings with, in effect, each ring driving the next ring. There are 3 core “control rings” in some embodiments, and, as noted above, control rings may not be selected for every implementation. The “control ring” outlines ownership of the center, a “Style ring” defines the ranking of all adjacent outer rings, and a “Benchmark”displays components of that Index on all the outer rings. The control rings determine the position and the component on the outer rings, defining the center according to the user's input. See for example control rings 550, 560, 570, in FIG. 5A (level 7). Selecting different controls can drive the risk and return of the portfolio displayed in the center, and the user can identify how he or she wants to proceed, simply by selecting different controls. Some example controls are shown in ring 560 of FIG. 5A and include “mutual fund,” “index” and others. By selecting different directions for types of investment, different outer display rings can be displayed, illustrating different strengths and weaknesses of each respective direction. Utilizing the subject asset data visualization guide the user has the information to make informed decisions. with the user's selected style governing the risk and return on capital invested, and hypothetical income received, displayed in the center display region.

The asset data visualization guide contains a tracking device, tracing by country code, a country, an index, or stock within the wheel, thereby monitoring the countries' Indices, stock, or a portfolio of securities position relative to a change in price or with change in the selected user's input. For example, as shown in FIG. 5A, when the user clicks on the index S&P 500, 535a, the tracker highlights the user input segment (for example, in green), with all the US related segment positions on the wheel being highlighted. The tracker displays the US GDP components in 533, and the S&P 500 sectors in ring 531, the center explaining the mean and/or total of the wheel. In the example of FIG. 5B, the display wheel traces the position of 535a with a change of user's input in the style ring 550.

Software and Computer Systemization

The subject asset data visualization guide is, in many embodiments, computer based. As mentioned above, the asset data visualization guide can be embodied in other media, such as television or in printed media such as newspapers, magazines or books or physically in a model.

When embodied in a computer system, the computer system may be a central computer, or resident on a local computer. That is, a user can have a computer program of the asset data visualization guide resident on his or her personal computer. In this case, updated valuation data related to the various markets can be sent over a network, for example, the internet. Alternatively, the asset data visualization guide can be provided to the user via a network, such as the internet. The software necessary for creating the asset data visualization guide can be resident on a remote computer, and provided to the user in the form of a web page, which itself can be either interactive or non-interactive. The data can be transmitted to the user's personal computer via the network in HTML or another effective computer language.

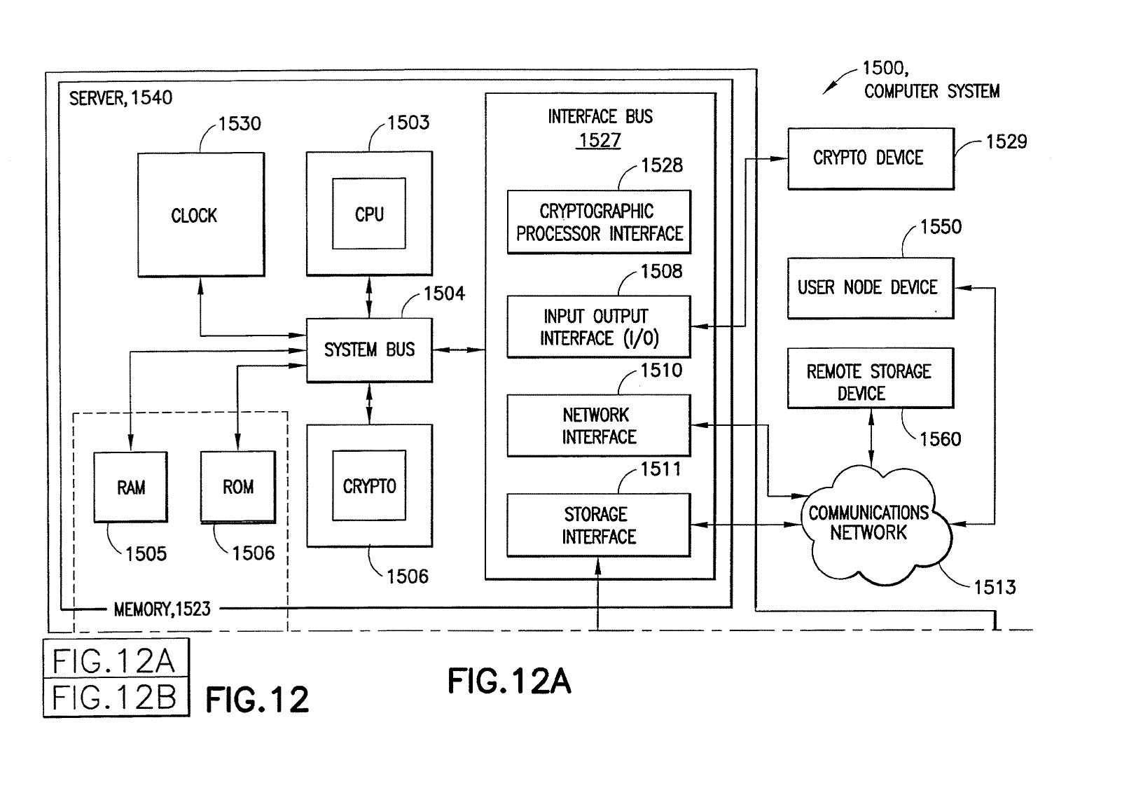

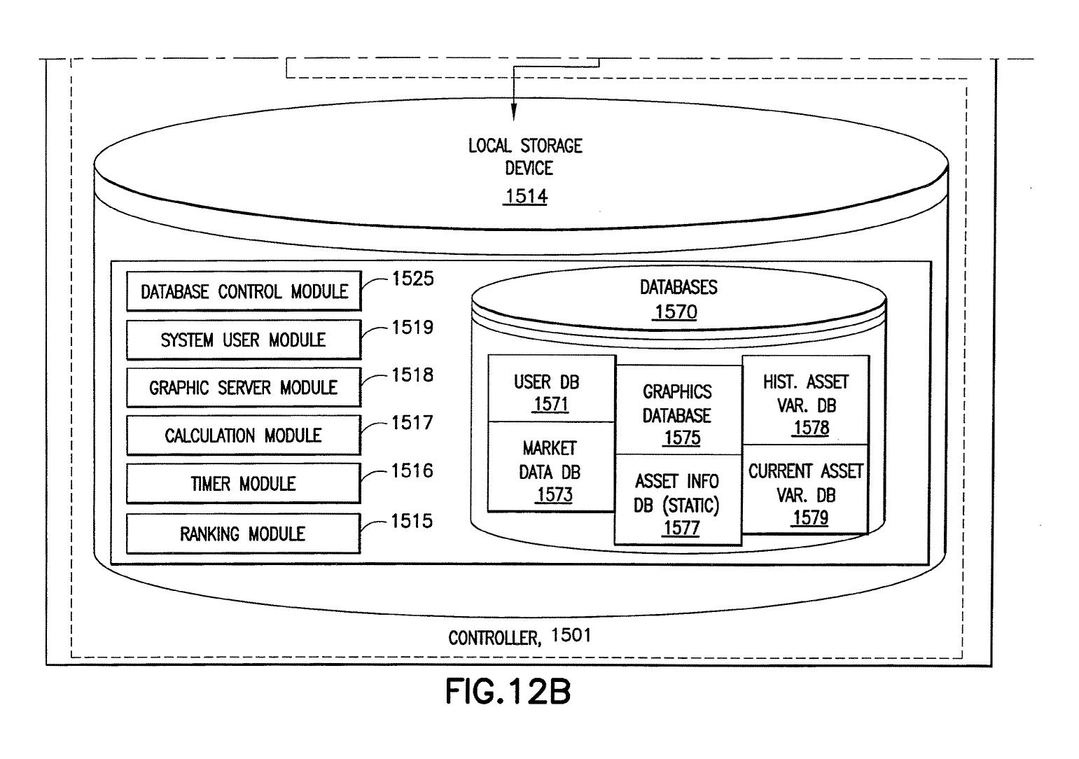

FIG. 12 illustrates one example schematic representation of a configuration of a computer system suitable for creating an implementation according to the present invention. The user node device 1550 in this embodiment is typically a user's personal computer, which is connected via a communications network 1513 to a server 1540.

The computer in which the graphical investment system primarily resides, be it a central server 1540, a personal computer or other, includes memory 1523 for at least in-part storing user and market information. A relational database schema can be utilized, and the database populated with static data related to individual assets. Such database can be a dedicated market data database 1573. Other databases can include a user database 1571 for storing data related to a specific user, a user portfolio, user preferences and the like.

The calculation module 1517 utilizes data from the market data database 1573 to calculate values for selected variables, such as PE ratio, YTD earnings, and the like, to be used in rankings of the assets by the ranging module 1515.

Additionally, within the memory 1523, a database control module 1525 is provided to control access to the databases. A graphics module 1519 works with a graphics database 1575 to retrieve the graphics for display to a user. The graphics module 1519 can be enabled to retrieve, create and/or manipulate the multiple styles of wheels. The graphics module 1519 can also be enabled to utilize data directly from the market data database 1573, user database 1571, asset information database 1577, historical asset variable database 1578 and/or the current asset variable database 1579.

The ranking module 1515 allows the server 1540 to respond to requests by a user, via the graphic server module 1518 to display data in a ranked fashion, according to the invention. Ranking data can be stored by the server 1540 in the current asset variable database 1579, for example, or another database.

The graphic server module 1518 also receives data from the user, and thus can receive user selections and change the displayed information, depending on the particular user selection. The graphic server module 1518 can provide the graphics for any type of wheel, hemisphere or sphere necessary. Since much of the same raw data and calculated data are necessary for more than one type of wheel, the graphic server module 1518 can use data already used to display one wheel for display of another wheel. Alternatively, the graphic server module can re-access data in other databases each time a wheel is displayed.

Data is received into the market data database 1573. In order to provide the most accurate guidance to a user, the data can be essentially continuously updated, updated at regular intervals, which may be accomplished via the timer module 1516, may be updated only when prompted by the user, or may be updated when initially commencing use of the asset data visualization guide. The data can be supplied over the communications network 1513, or may be entered in another manner. Updated market data can be entered manually by a user. Various variables are calculated by the calculation module 1517 or equivalent, and are stored in the current asset variable database 1579. Later, these variables can be transferred to the historical asset variable database 1578 and assigned a time stamp for later retrieval and use. The ranking module 1515 utilizes the data in the current asset variable database to rank individual assets, as well as whole asset classes according to selected criteria.

For example, if PE ratio is of interest, and a user desires to display assets in terms of PE ratio. Variables including price and earnings data are received into the market data database 1573 for an asset. The calculation module 1517 utilizes this price and earning data to calculate PE ratio for that asset. The PE ratio is calculated similarly for other assets, and it is all stored in the current asset variable database 1579. This data is retrieved by the ranking module 1515 , which compares the PE ratios and then assigns an order to the assets according to PE ratio. This order can be associated with the asset in the current asset variable database 1579 and stored for later retrieval and use.

The system 1500 also enables a user to perform data trace and monitor particular assets. A user can select a particular country or security, and the system the rings associated with that country or security will adjust to changing market data received by the market data database 1573, according to a selected investment style. The graphic server module 1518 can be configured to provide a graphical history, for example by way of a left-behind shadow, trail or the like.

The system 1500 further provides the ability to perform cross sectional analysis. The manner in which the analysis is performed is set by the selected user's investment style, selected, for example by way of the style ring 550, or by way of a selected control, such as those in control ring 560. The graphic server module 1518 accepts these inputs in many embodiments, by user selections in displayed style ring 550 and/or control ring 560. Cross-sectional analysis entails screening coverage of the entire “universe” of securities and countries at a single, selected point in time. If such point in time is present, then data from the current asset variable database 1579 is utilized by the system. If such point in time is in the past, data from the historical asset variable database 1578 is used. Depending on the implementation, any number of databases may be combined with one another. For example, data stored within the historical asset variable database 1578 can be stored with the data from the current asset variable database 1579 in the same database.

When, for example, evaluating assets for a selected criterion e.g., PE ratios less than 20 for any market, index, or security, the data base control module 1525 makes a request for the price per share (the P's) for all companies, and then one request for earnings per share (the E's) and, wherein the calculation module 1517 then calculates the resultant P/E for all. The ranking module 1515 then ranks the markets, indices, or securities and instructs the graphic server module 1519 to only display data labels for data items meeting the selected criterion.

The system 1500 further provides the ability to perform cross-sectional time series analysis, which can be selected via the style ring 550, shown in FIG. 5A e.g., earnings growth greater than 20 percent for the last 5 years. In processing such a user request, the database control module 1525 utilizes historical data, such as that from the historical asset variable database, and may utilize current data from the current asset variable database 1579 and/or the market data database 1573. The database control module 1525 searches the appropriate databases for a selected country or countries and securities, using the aggregate calculations. The graphic server module 1518 then displays specific outer rings (such as rings 531, 532, 534 in the example of FIG. 5A), customized to display countries and assets meeting selected criteria.

FIGS. 8 and 9B illustrate by way of example the US S&P 500 index and the Hong Kong exchange, respectively. When using wheels, the user can select certain criteria, via a menu or the like, which may include centrally located user-selections, such as style ring 903 and control ring 905 of wheel 900. The user may select to display, for example, assets having a PE less than 20 and greater than 1; an EPS greater than 10% and less than 50%; and a PEG of less than 1.0 and greater than 0.1 over the last 5 years. To calculate P/E ratio, the database control module 1525 makes a request for the price from the historical asset variable database. Additionally, the current asset variable database 1579, and/or alternatively from the market data database 1573, depending on the implementation, can also be utilized. The database control module 1525 then requests earnings per share from these databases for the same time period. The calculation module then calculates the resultant PE for the last 5 years. Earnings per share can be calculated by requesting profit data and requesting adjusted shares on issue, the calculation module calculates the resultant EPS. Earnings per share growth rate calculated by requesting from the database, the average EPS as a percent increase on the prior year. The calculation module then calculates the resultant average growth rate for the last 5 years. PEG (price to earnings to growth) ratio can be calculated by the calculation module 1517 by calculating PE ratio and EPS growth as calculated above, dividing the former by the latter, and averaging over the 5 years in question. The ranking module 1515 then sorts countries or securities and display only those meeting the above criteria.

As a general note, though embodiments are described as retrieving data from internal databases within the system, the data can alternatively be obtained directly from an outside source. The databases can be populated by this outside source, and then utilized to retrieve the data. As a further alternative, data can be entered manually, directly into the databases.

The system 1500 further provides the ability to perform weighted cross-sectional analysis at a point in time. Within a displayed ring, the user has the ability to display a series weighted by value, and can choose to utilize a secondary ranking. The secondary ranking can be a measure from the style ring at a point in time or over a chosen time frame. For example, assets can be arranged by market capitalization for the defined universe, and weighted and ranked by PE over the last 5 years.

The style ring (e.g., 550 in FIG. 5; 903 in FIG. 9) is a prime user aide in the graphical user interface displayed by the system 1500. The style ring is divided into segments each containing a ratio, or grouped by the style of investment a money manger may be described by, with the corresponding ratios to that style of investment. Tables 1 and 2, below, list example user selections for choices in the style ring. Choices, corresponding to segments in the style ring, are shown in the table along the top line of each table, with the possible measure selections therefore in the columns underneath. These selections are only example and are not exhaustive.

TABLE 1
Style rings components -right side

| | TIME | | | LARGE | MID | SMALL |
|---|---|---|---|---|---|---|
| SIZE: | SERIES: | PERFORMANCE: | SECTOR | CAP | CAP | CAP |
| Market Cap. | One year | Close | | | | |
| | Forward | | | | | |
| | est. | | | | | |
| Total Assets | Close | 1 month | | | | |
| Earnings | | YTD | | | | |
| Equity | One year | 1 year | | | | |
| | Historical | | | | | |
| Enterprise | Five year | 5 year | | | | |
| value | Historical | | | | | |

TABLE 2
Style Ring Components-left side

| | | | | CYCLI- | DEFEN- |
|---|---|---|---|---|---|
| GROWTH | VALUE | RECOVERY | INCOME | CAL | SIVE |
| EPS growth | P/E | P/B | Div Y | Beta | Beta |
| % change | | | | | |
| PEG | ROE | Stock | Div Growth | | |
| | | Performance | % change | | |
| | | % change | | | |
| P/S | ROA | A/E | | | |
| | | Asset/Equity | | | |
| Sales | P/CF | Total debt | | | |
| Growth % | | Ratio | | | |
| change | | | | | |
| Payout | Interest | Debt/Equity | | | |
| Ratio % | Cover | (D/E) | | | |
| Sustainable | Expected | A/E | | | |
| Growth | rate of | | | | |
| | return | | | | |
| | EV/EBITDA | | | | |

As a reference, the ratios utilized above and throughout this document include:
1. Price to Earnings (P/E) ratio:

$$Trailing or Historical P / E = \frac{Market Price per share}{EPS over previous 12 months}$$

$$Leading or Forward P / E = \frac{Market Price per share}{Forecasted EPS over next 12 months}$$
2. Price to Book (P/BV) ratio:

$$P / B ratio = \frac{market value of equity}{Book value of equity} = \frac{Market price per share}{book value per share}$$

Where book value of equity=common shareholder' equity=((total assets−total liabilities)−preferred stock)
3. Price to sales (P/S) ratio

$$P / S ratio = \frac{market value of equity}{Total sales} = \frac{market price per share}{sales per share}$$
4. Price to Cash Flow (P/CF) ratio:

$$P \text{/} CF ratio = \frac{market value of equity}{Cash flow} = \frac{market price per share}{cash flow per share}$$

Where CF=CF, CFO, FCFE, or EBITDA: each of these definitions of cash flow being as follows:
CF=earning plus non-cash charges (CF)=net income+depreciation+amortization
CFO=Adjusted cash flow
FCFE=Free cash flow to equity
EBITDA=Earnings before interest, taxes, depreciation and amortization
5. Beta=β

$$β = \frac{Covariance mkt i}{Variance of market} = \frac{Standard Deviation i}{Standard Deviation mkt} \underline{\times } correlation coefficient i mkt$$

Where “i” indicates values for individual risky assets and mkt is an abbreviation for market
6. Du Pont Analysis—year end FIGS. (used in wheel 1100 of FIG. 11D)

$$Return on Equity ( ROE ) = \frac{Net Income}{Equity at year end}$$

$$\begin{matrix}Return on equity = \frac{Net income}{S ales} \times \frac{Sales}{Equity} \\ = ( net profit margin ) \times ( equity turnover )\end{matrix}$$

$$Return on equity = \frac{Net income}{Sales} \times \frac{sales}{Assets} \times \frac{assets}{Equity}$$

$$Return on equity = ( net profit margin ) \times ( asset turnover ) \times ( equity multiplier )$$

Extended Du Pont System:

$$ROE = ( ( \frac{EBIT}{Sales} ) \times ( \frac{sales}{assets} ) - ( \frac{interest expense}{assets} ) ) \times ( \frac{assets}{equity} ) \times ( 1 - tax rate )$$

$$ROE = ( ( operating profit margin ) \times ( total asset turnover ) - ( interest expense rate ) ) \times ( financial leverage multiplier ) \times tax retention rate$$
7. Total assets turnover=sales/average assets
8. Equity turnover=sales/average equity
9. Gross profit margin=gross profit/net sales
10. Net profit margin=net income/net sales
11. Return on capital=(net income+interest expense)/average total capital
12. Return on common equity=(net income−preferred dividends/ average owners' equity
13. Debt/equity ratio=long-term debt(not including deferred taxes)/total equity
14. Interest coverage=(net income+income taxes+interest expense)/interest expense
15. Cash flow=((net income+depreciation+change in deferred tax))/long-term debt (not including deferred taxes)
16. Retention rate=1−(dividends/earnings)
17. Sustainable growth rate=g=retention rate×ROE
18. Basic Earnings per share

Basic EPS=net income−preferred dividends
Weighted average number of common shares outstanding

$$Diluted EPS = \frac{Adjusted income available for common shares}{\begin{matrix}Weighted \text{-} average common and \\ potential common shares outstanding\end{matrix}} \\ Where adjusted income available for common shares is$$

$$earnings available for common shares + Dividends on convertible preferred stock + \frac{After \text{-} tax interest on convertible debt}{Adjusted income available for common shares}$$
19. Dividend=net income×payout ratio
   where payout ratio=dividend/net earnings
Dividends per share (D)=EPS×payout ratio
Dividend yield=Dividend per share/market Price per share as a percent
20. Required rate of return=k=RFR+Beta(Rmkt−RFR)
20. Expected rate of return=(D1+P1−Pmkt)/Pmkt

or=(D1/P mkt)+g

where g=Retained earning×ROE
retained earnings=RR=Earnings retention rate (1−r) is the firms dividend payout rate
P1=(EPS1)×(P/E1)
P1, D1=estimated one year future value of security price and dividend
P2=estimated two year future value of security price and dividend

$$Retention rate = 1 - \frac{dividends declared}{Operating income after taxes}$$
21. Price earnings ratio in one year=P/E1=(D1/E1)/k−g
   where k=Risk free rate (RFR)+Industry premium (RP)
   k=required rate of return=(1+RFRreal)(1+IP)(1+RP)
   RFR nominal=RFR real+Inflation premium(IP)
   RFR real=determined by the supply and demand for capital in the country.

The real risk-free is the rate investors would require if there were absolutely no risk or inflation
22. Price to growth (PEG)=market price per share/earnings growth per share
23.

$$23. Holding period return = \frac{P 1 - P 0 + CF}{P 0}$$
24. Arithmetic Mean=A measure of mean annual rates of return equal to the sum of the annual holding period rates of return divided by the number of years
25. Geometric Mean=The nth root of the product of the annual holding period returns for n years minus 1.

$$26. Interest Cover = \frac{earnings before interest and taxes}{Interest Expense}$$

$$27. Debt to equity ratio = D \text{/} E = \frac{Total long term debt}{total equity}$$

$$28. Assets to equity Ratio = A \text{/} E = \frac{Total assets}{Equity}$$

$$29. Total debt ratio = \frac{current liabilities + Total long \text{-} term debt}{total debt + total equity}$$

$$30. Sales Growth = \frac{this years sales - last years sales}{last year ’ s sales}$$

Same, for earning growth, dividends, total assets, shareholders funds, or any other year on year comparison.

FIG. 4 illustrates one embodiment of the main asset wheel 400 (Directory). The asset wheel 100 of FIG. 1 or asset wheel 400 is typically used as a starting point for a user when using the guide. The asset wheel 400 represents the world market and highlights asset classes in which one can invest, the market it trades on and the instruments available to secure the exposure. The inner display circle assists in reinforcing to the user that he or she has control over his or her wealth, and can display the value of assets being invested (and thus at risk), as well as actual yield of the assets or a percent yield based on predictions made based on historical data according to user selections. The outermost rings (e.g., rings 402-405) are rings that are arranged farthest from the center display circle 410 of the field 431 to represent a reduced amount of user control. For example, if mutual funds are selected from mutual fund ring, control of the assets passes from the user to a Mutual Fund Manager to invest in the assets represented by the more inner rings on the user's behalf. Control of the user's wealth passes to the fund manager, and thus this selection is physically arranged toward the outside of the field 431. Asset wheel 400 is shown as a circle, and the outer rings 402-405 are illustrated as relatively narrow rings. The asset wheel 400 can be provided, as mentioned above, with a hemispherical or spherical shape. Other wheels can be provided a hemispherical shape and can be oriented relative to the asset wheel 400, embodied as a hemisphere, as an opposed hemisphere, both in total substantially forming a sphere. Additionally, these relatively narrow outer bands can be expanded with further details and selections, to be similar in appearance to the more inner rings, such as ring 420. When expanded, these rings can increase the overall diameter of the asset wheel 400, or spread further across a sphere on which an asset hemisphere is placed. Alternatively, when expanding the outer rings, inner rings can be reduced in size or collapsed to a minimum thickness, as the rings 402-405 are shown in FIG. 4. Each ring of futures 405, options 404, warrants 403, and mutual funds 402 has a segment corresponding to one asset sector, such as ring sector 402a corresponding to equity and ring sector 402b, corresponding to cash. Alternatively or additionally, sectors of the outer rings 402-405 can relate to more than one asset sector, such as mutual fund ring sector 402e.

In general, the concentric rings are ranked by risk and control over the center value displayed in circle 410, representing the asset(s) or resource(s) at risk. The concentric rings of field 431 are further divided into 4 quarters, one of which is divided in half again to yield 5 sectors. The sectors are representative of classes of investments, or “asset classes,” while the central circle 410 is representative of money or resources which can be used for investment. The next ring 430 is arranged into 5 sectors representative of equity 430a in the first quadrant starting at “noon,” working clockwise, cash 430b in the ₂nd quadrant, bonds 430c in the 3^{rd} quadrant, property 430d in the first half of the 4^{th} quadrant, and gold 430e in the second half of the 4^{th} quadrant. The position of each asset sector 430a-e changes on asset ring in correlation with variables on the meridian ring 140, the change in position being as simple as a rotation of ring 430. The variable on the right side of meridian ring can be preselected to effect the change in position of asset ring 430. Each sector 430a-e, of the asset ring 430, is color-coded. As exemplified in FIG. 4, the sectors 430a-e are assigned blue, white/gray, red, tan and gold, respectively. Though the meridian ring 140 is not shown in FIG. 4, it may be incorporated therewith, and/or associated with asset wheel 100, which is functionally related to asset wheel 400. The rings can display value and/or percent change, or these variables can be displayed by the user holding his or her mouse over a particular region or “data point.” The next concentric ring 440 lists in sectors thereof, markets corresponding to each respective class of assets displayed in asset ring 430. The color coding continues across ring borders to related rings. Precisely the same color can be used, or merely the same color family (e.g., “blues”) can be used for related segments in different rings. For each of the 5 asset classes in asset ring 430, the markets are arranged respectively in ring 440 as stock market (for equity), foreign exchange market (for cash), fixed interest market (for bonds), real estate market (for real estate) and bullion market (for gold). The next concentric ring displays types of instruments arranged by counterparty risk. In an embodiment, risk increases when moving clockwise in the ring. For example, for the foreign exchange market in rings 440 and 450, spot, forward, and NDF trades each have inherently increasing risk, in that order. Therefore the price of assets reflects the increase in duration. The next concentric ring 420 is further sub-divided into more specific instruments. These instruments can also be ranked by risk, as measured by size or counter party risk, within each quadrant or sub quadrant. Ranking need not be limited to risk, but can be any measure, for example return or liquidity. The next set of concentric rings represent mutual funds 402, warrants 403, options 404 and futures 405. Each are instruments that are leveraged to the underlying asset in the asset ring 430. Instruments in each successively more outer ring have an increasing risk level, all have no control on asset, or title to underlying asset class due to no legal title or ability to sell the underlying asset until option exercised, or physical delivery has taken place.

The asset data visualization guide can be configured to prompt the user with questions and guide the user in making investment decisions. The asset data visualization guide can also provide detailed definitions to the user regarding particular classes of assets or instruments, automatically, or upon request.

FIGS. 5A-C illustrate examples of Equities market wheel functionality. The market wheel 500, as with other wheels, includes a plurality of concentric rings, within the innermost ring, displaying the selected country values as per the outer rings, which are referred to herein as the “choice rings.” The central circle 510 defines what asset is at risk to be preserved and maximized, and what benchmarks to outperform. In the example embodiment of FIG. 5A, the default setting, the central circle 510 displays the users input values from ring 535 descending as follows: 1. Performance, 2. Index and index level, 3. time series and performance value, 4. market capitalization value, 5. nominal GDP value, 6. real GDP growth rate value, 7. index EPS growth as a percent value, 8. Div Yield value, and 9. PE value. The notification position, which is the position at which assets are indicated to be most favorable to the user, is in an embodiment the “noon” position, but can be at other positions if so desired. All wheels can have a central noon notification, being the stock, sector or country with the highest weighted frequency in the noon position displayed in the center. The rings can be weighted to the user's criteria with the center being the most favorable in the defined universe.

The first ring is the control ring 560. It is divided into segments grouped by ownership of the center value for market capitalization. Each segment of control ring 560 can list the value of holding by that owner and percentage change over time. For example, of the listed US$10,202 billion Market cap illustrated in the center circle 510, US $600 billion is controlled or “owned” by hedge funds

The 2^{nd} ring is the style ring 550. It enables the user to select cross sectional time series analysis, among other selections, which are arranged along the ring in separate segments, which act as regions for the user to select through the graphical user interface, if so-embodied. Selections of segments can be made from the left side of the style ring 550 and selection of a measure from the right side of the style ring 550.

Markets and sectors rings can be ranked and weighted by size (market capitalization) as in FIG. 5A, or weighted by size and ranked based on one year historical PE, as in FIG. 5B. In effect, there are 2 notifications within the ring, one, a measure of risk by value (size segment) and two, by order, with the ratio defining the value, therefore the position on the wheel. Rings 531 532 533 534 535 are referred to as the “choice rings”. Referring again to FIG. 5A, the sector and market capitalization rings 531 and 534 are light blue and are ranked from the noon notification position, clockwise by size with the rings weighted by market capitalization. Additionally, these rings may also be ranked by the user's selected style. The GDP-related economy rings 533 and 532 are illustrated in dark blue, segments within these rings being ranked from a noon notification position, clockwise, weighted by size and ranked in relation to the style criteria. For example in FIG. 5A, ring 532 is ranked by growth rate as percentage of real GDP, weighted by Nominal GDP, ring 533 is ranked by US GDP sector growth rate as a Percentage of US nominal GDP, segment size weighted by sectors Nominal GDP for the US.

The third ring is the benchmark ring 570, which is illustrated in FIG. 5A and can be denoted by, for example, the color red identifying the Asset Class “Bond” from FIG. 4. The ring sets out in its segments the current risk-free rate, exemplified by 90-day treasury bills, for each listed country in the benchmark ring 570. The risk-free rate is the rate to which predicted asset returns will be compared.

The fourth ring is the sector ring 531, which sets forth a country's index consisting of listed companies in various sectors in that country. In the example of FIG. 5A, the country is the US, and the index is the S&P 500 (e.g., financial sectors, healthcare, industrials) are ranked by dollar value, segment size reflects percent of the series, and can include with them the index level, price, earnings growth rate and PE ratio. When the user selects a ratio (e.g., P/E ratio) from the style ring 550, the values of the segments take on new meaning the ring is weighted by the size of the segment and ranked to noon for the selected ratio, as displayed in FIG. 5B ranked to PE, and FIG. 5C ranked to EPS growth.

The 5^{th} ring 533 represents the selected country's Real GDP, or alternatively Nominal Volume & Price. The volume measure is provided for tracking product growth. The user can compare earnings per share growth of sector 531 with real or nominal growth in the corresponding economic sector 533, ensuring stock market sector forecasts are inline with the growth rates reported or forecasted.

Depending on the embodiment, for any wheels or hemispheres described herein, the percent of the circumference of a ring that a segment takes up can be directly related to the percentage of the measure being illustrated. For example, in the US GDP growth and % of total ring 533 in FIG. 5, each sector displayed (e.g., retail trade, construction), makes up the entire GDP of the selected country, in this case, the US. If “accommodation and food services” makes up 5% of the entire GDP, then it can be displayed in a segment that is 5% of the circumference of that ring. That is, a 5% value would result in 5% of 360 degrees of a circle, or 18 degrees. Thus, a sector in ring 533 for accommodation and food services of 18 degrees can be displayed. This might not be desired in all cases, and might not be possible in all cases, particularly when sectors constitute a very small percentage of a measure, since they would essentially be invisible. In such a case, the system can be configured to size the appropriate sector to be relatively close to the actual percentage, and adjusting other sectors as necessary to maintain an appropriate approximate proportion. Naturally, whatever measure is of interest, the percent of total can be used to size the sectors accordingly.

The 6^{th} ring 532 represents in its sectors, the total Nominal GDP of user-selected countries, with the sector labeled “other” representing the balance of countries. Sector size reflects the size of the economy relative to other segments in ring 532, then by the user's style input, with noon notification on selected ratio. For example, in FIG. 5B, the US has the largest weight with 32% of the series World Nominal GDP yet is positioned in the 3^{rd} quarter with the value GDP to Stock-market capitalization of 1.36x (a broad measure of value).

The 7^{th} ring 534 represents the total market capitalization of the selected countries in the selected universe with the sector “other” representing the balance of countries. The country sectors in this market capitalization ring 534 are, depending on the embodiment, ranked by magnitude of market capitalization, and secondarily ranked by the user style input. Two notifications being the position relative to noon, and the segment size within the ring. Segment size enables a comparison of the total market capitalization of a country, with the total GDP of the respective country along with a comparison of the size of the segments in each ring.

The 8^{th} ring 535 represents index performance for selected countries. The indices can be ranked according to performance, the best performing indices being located clockwise from the notification position. In FIG. 5A the 9^{th} ring 536 represents the US$ performance for the last 12 months, again ranked to noon.

The guide assists by positioning components according to the measurers defined by the industry, into quartiles 1^{st} quarter and 2^{nd} quarter are positioned above the mean and 3^{rd} and 4^{th} quarters are positioned below the mean of that series, as shown in FIG. 5B rings 534, 532. The user can now compare segment size in both 534 and 532 and the ranking of both. For example, 534a on a PE 22, represents the 3^{rd} highest valuation positioned in the 3^{rd} quarter with segment size reflecting the largest market capitalization at 36% of the series. FIG. 5C reflects the change in position of 534a with the style selection changed to Growth from Value in ring 550. Growth positions 534a at noon, highest EPS growth of the series, with segment size being the weighted market capitalization of the countries in the series. FIG. 5C is displayed without the data labels; however, by positioning the mouse over the segment the data information will be displayed.

It should be noted that the above-described sets of rings for this market wheel 500, as well as for other wheels described herein in, are meant to serve as examples to the reader to enhance understanding of the subject invention. In this market wheel 500 and in other wheels, it is possible to hide rings from view, add rings and/or eliminate rings.

The term “Real GDP,” (GDP) as used above and throughout is defined as follows:

$$Real GDP current period = nominal GDP current period \times \frac{GDP deflator ( base year )}{GDP deflator ( current period )}$$

The GDP is the most commonly used measure of economic performance, and is computed by summing the total market value of all domestically produced final goods and services during a selected year. The GDP is designed to measure the market value of production that flows throughout an economy, as measured by final production. The “Real GDP” corresponds to real or actual changes in production, while the Nominal GDP reflects both changes in production and changes in price.

$$Inflation rate \text{:} I = \frac{this year ’ s price index - last year ’ s price index}{Last year ’ s price index}$$

$$Unemployment rate = ( number of unemployed ) / ( number in the labor force )$$

FIG. 6 illustrates an example of the cash wheel 600, which is a version of the market wheel 500 without the inner style ring 550. The cash wheel 600 monitors and tracks in a similar way to the market wheel 500, the selected country input data “at risk” which is displayed in the center display circle 610 summarizing the selected countries' values from the outer rings. The inner rings are, as with market wheel 500, the “inner controls” to the center value, however the difference is that the controls in cash wheel 600 are government controls to the supply of money ring 642 and the speed money ring 630 goes around. Money Supply ring 642 multiplied by velocity equals Nominal GDP ring 660 and, equally, Price multiplied by real output equals Nominal GDP which thereby controls the growth of the economy. Similar to Market wheel 500, the notification position is preferably noon, though this can be different in alternate embodiments, along with a central notification if configured.

Inner rings 620, 630, 641, 642, change the values on the outer rings 650, 660 670, 680. Equally, a change in the outer rings will produce a change in the values of the inner rings over time. Inner rings change the center values quickly inline with the “short run” economic theory, where the outer rings change the center value slowly, and inline with the “long run” economic theory. For example, , 680a has the largest Population position at noon representing 21% of the worlds population yet only representing 2.1% of world's stock market capitalization, 650a in fourth quarter, generating 3.98% of the world's Demand measured by Nominal GDP 660a. A change in the price will change the demand for that currency. A user input at “Risk” in FIG. 6 is US$, i.e. you are dominated in US dollars, therefore US dollar is the center, at risk.

Table 3, below relates factors effecting the price of money to the location (ring(s)) that illustrates those factors on the cash wheel 600, and to the measure used to determine rankings of segments within the rings of the cash wheel 600. Supply and demand equaling the price as shown in 610. Each ring represents either supply or demand that can change the center value and each ring impacts the value of the next ring.

TABLE 3

| FACTORS EFFECTING | INFORMATION | MEASURED AND LOCATION ON |
|---|---|---|
| PRICE OF MONEY | DISPLAYED | WHEEL |
| “At risk” | Currency + | Center circle - Total Monetary reserves, |
| Nominal Value | Official Reserves | as reported by the IMF. USD TWI. |
| | | Reserves (Value) at risk |
| Who Controls Supply | Monetary Reserves | 1^{st} ring 620 - Governments Official |
| Money | as % of Total | Reserves ownership of monetary |
| | Official Reserves | Reserves. (Control gives ability to |
| | (reported to IMF) | change price increase or decrease supply |
| | | of money to market) |
| Demand for money = cost | Interest Rate | 2^{nd} ring 630- Benchmark - Interest |
| of money | | Rates: Base, 90 day Treasury Bills or 10 |
| | | year bond. |
| Value of Money = Price | Effective Exchange | 3^{rd} ring 641 - PPP - Purchasing power |
| | rate Or Relative PPP | Parity of each respective currency in the |
| | | ring 641 |
| Demand for money | Money Supply | 4^{th} ring 642 - Growth in Money supply |
| | | in the financial system either M1, M2 |
| Supply of money | Inflation rate | 5^{th} ring 643- Inflation rate of each |
| | | respective country, actual or forecast. |
| Future demand | Stock Market | 6^{th} ring 650 - Market capitalization of |
| | capitalization | the countries, |
| Demand | N GDP | 7^{th} ring 660 - Demand (nominal GDP) |
| | | of the countries as a percentage of world |
| | | demand and estimated growth rate |
| Potential Demand & | Unemployment | 8^{th} ring 670 - Unemployment rate of |
| Supply | | countries listed in the 9^{th} ring (described |
| | | immediately below) as percentage of |
| | | that country's labor force. |
| Demand & | Population Base | 9^{th} ring 680 - Population as a percentage |
| Supply | | of the World Population and/or growth |
| | | rate. |

### Cash Wheel

The Money supply is defined and measured according to one of the following two classifications.

M1 is the narrowest definition of money. M1 is defined as currency in circulation (coins and paper), checkable deposits maintained in depository institutions, and traveler's checks.

M2 equals M1 plus savings deposits and time deposits less than $100,000 held in depository institutions plus money market mutual fund shares.

Money is a financial asset that provides the holder with future purchasing power, distinguished from credit, which is a liability acquired when you borrow funds.

The supply of money is determined by the central bank and is independent of the interest rate, when a central bank increases the money supply the real interest rate falls, which reduces the opportunity cost of holding money and increase the demand for money. As nominal GDP increases as the result of inflation and/or increased output, the demand for money also increases.

Relative Purchasing Power Parity

Economists employ three versions of PPP. On the most basic level, PPP states that identical goods should have the same price regardless of the location. Empirical research suggests that relative PPP does tend to hold more closely over the longer term. Currencies that become overvalued or undervalued in relation to PPP over time tend to eventually revert to the long-term level predicted by relative PPP, therefore PPP is somewhat useful in exchange-rate determination in the short run because currencies that are overvalued relative to their PPP-determined fundamental value will tend to depreciate, while undervalued currencies will tend to appreciate. However, the adjustment period can sometimes be quite long (i.e., several years). Relative PPP depends on the ratio of the growth rates of prices in two countries. It is the rate of inflation (i.e., the relative rate of change in prices).

$$et = e 0 ⨯ \frac{( 1 + iDC ) t}{( 1 + iFC ) t}$$

where: et and e0 are the expected future and current spot rates respectively in DC/FC, and iDC and iFC are the inflation rates in the domestic and foreign countries, respectively.

In effect, each ring answers a question. Such question can be for current values, and/or future (estimated) values, depending on what selections are made by the user. Table 4, below, compares the region of the cash wheel and corresponding questions answered by the ranking of regions within each respective ring. The cash Wheel 200 asks a question as do all of the wheels—What Currency will hold value over the cycle? All the Wheels ask the questions “where is the supply and demand? ” and “who can change the supply or demand thereby changing the center value?” Demand+Supply=Center Value, be it for total world reserves or a $, YEN, £, Gold, Oil, a share price, or the like.

TABLE 4
Example of Cash Wheel functionality

| WHEEL | INFORMATION | FUNCIONALITY/ | |
|---|---|---|---|
| PART | DISPLAYED | RELATIONSHIPS | QUESTION FOR RINGS |
| Center | Currency + | “At risk” US TWI | User's Benchmark |
| circle | Official Reserves | Total of 1^{st} ring (US$ or %) | currency, or currency of |
| 610 | | | choice |
| 1^{st} ring | Monetary Reserves as | Gold Wheel 700 center | Who has the money? Who |
| 620 | % of Total Official | value 710 price of gold * | controls the price of |
| | Reserves | Govt. reserves in gold as | money? Who has |
| | (reported to | report to IMF + other official | Ownership of the center |
| | IMF) | assets as reported to IMF | assets? |
| 2^{nd} ring | Interest Rate | Asset Wheel 100, 131 + ring | What is the cost of currency = |
| 630 | | 643 CPI | (Interest Rates)? |
| | | | Interest Rate = cost of |
| | | | Money (govt. control) will |
| | | | change Demand |
| 3^{rd} ring | Real Effective | PPP results from inputs from | What is relative strength of |
| 641 | Exchange Rate 1995 | 643, FIG. 4 431a spot US$, | the currency? |
| | base 100 | 431b forward US$ = Price | |
| | Alternatively | (center) | |
| | Relative | | |
| | PPP | | |
| 4^{th} ring | Money Supply | Inputs Interest rates 630 = | What is the demand for |
| 642 | | GDP 660 | currency (MS)? |
| | | | Money supply − (govt. |
| | | | control) impact on 643 CPI |
| 5^{th} ring | Inflation rate | Inputs interest rate 630 = | What is the supply of the |
| 643 | | center 610 | currency (CPI)? |
| | | | Supply = CPI |
| 6^{th} ring | Stock Market | Input wheel 100, 121 Price 0 = | What is the Price and |
| 650 | capitalization | (Dividends in1 year/ | Growth for future demand |
| | | Earning in 1 year)/(k − g) | (Market cap., PE and |
| | | k = Required return input 630 | Growth rate)? Value = |
| | | g = FIG. 1000 147 g | Market Cap = Price of the |
| | | wheel 200 149 + ring | Demand generated.(GDP) |
| | | Expected return = wheel 200 | |
| | | 215 | |
| 7^{th} ring | N GDP | Input Interest rate, wheel | What is the Current |
| 660 | | 100, 146 or 630 + 643 | Demand for money in that |
| | | Inflation rate = demand for | country |
| | | Money 620 | |
| 8^{th} ring | Unemployment | Factor of 600 | What is the potential |
| 670 | | | demand? Spare capacity − |
| | | | unemployment rate. (Ability |
| | | | to consume Good and |
| | | | Services increases with |
| | | | disposable income, if |
| | | | unemployed limited ability |
| | | | to consume good and |
| | | | services) |
| 9^{th} ring | Population Base | 680 = 660 in the long run. | What is the future demand? |
| 680 | | | What is the population |
| | | | growth rate? People create |
| | | | both the supply and demand |
| | | | leading to Long run change |
| | | | in GDP |

Real effective exchange rates take account of price level differences between trading partners. Movements in real effective exchange rates provide an indication of the evolution of a country's aggregate external price competitiveness.

Nominal risk-free rate=real risk-free rate+expected inflation

Short Run—time until new capacity comes on stream

Long Run—after new capacity comes on stream

Based on empirical evidence of McCandless and Weber, two primary conclusions emerge: first, that the correlation between inflation and the growth rate of money supply is almost 1 varying between 0.92 and 0.96, second, there is no correlation between either inflation or money growth and the growth rate of real output. Thus there are countries with low output growth and low money growth and inflation and countries with low output growth and low money growth and inflation. “Equal there is no long-run trade-off between the rate of inflation and the rate of unemployment” Taylor source Monetary Theory and Policy by Carl E. Walsh

In general, when sectors of each ring are ranked, if two sectors are calculated to have the same ranking, they can simply be placed next to each other. Alternatively, they can each be assigned a split sector, so that it is clear that they are of equivalent ranking. In such an instance, each of the similarly ranked assets would be placed in the same sector, which would be divided, for example, parallel to the circumference, to illustrate multiple assets with the same rank. This principle is applicable throughout every embodiment of the invention.

FIG. 7 illustrates an example industry wheel 700, which details the gold sector of the asset wheel (100, 200, 400). This gold wheel 700 is a supply and demand wheel, and is similar to the above-described market wheels. Gold wheel 700 includes the tracker of the user input traced by the country code throughout the wheel, segments can be highlighted with the respective countries labeled in bold. The center display circle 710 conforms to the user input by displaying appropriate values at risk or the commodity, in this case, gold, used to price the outer companies on rings 760a, 760b, enabling a comparison of physical gold price to value of a country's gold sector 760a, being the sum of the respective country in 760b or companies 760b owning or mining gold. The 4^{th} and 5^{th} rings 750 a, b, which represent supply and demand of gold, are divided in half, with supply on the right and demand on left, the values of which can be estimated or historical. The amount difference between supply and demand brings about the price (e.g., $402) displayed in the center 710 at a given point in time. Color coding is preferably employed, with each ring having a predetermined color. For example, in FIG. 7, Control rings consist only of the Ownership ring, with the center configured to rank the outer rings being white, gold rings 730, 740 are yellow, cash ring 720 is white and grey, blue is for the demand half of supply/demand rings 750a,b, red is for the supply half of supply/demand rings 750a,b, and countries can also be assigned a color. Rings 760a, 760b can be weighted and ranked as in the market wheel 500 by a value such as PE, Market Capitalization/Total ounces of Gold reserves or another ratio, by clicking on the center to display the control rings.

When viewed by a user, the user can see from the center circle 710 that the center gold price represents 23% of world monetary reserves as reported by IMF and can be calculated by the sum of the 2^{nd} ring multiplied by the center value then divided by the sum of the 1^{st} ring 720, which is also the 1^{st} ring in 620. (Official Reserves for US gold reported at $42.2222 per fine troy ounce. Understating official reserves relative to other countries near market value for gold reserves and has been market to market), The center market price of gold can be used for ring 720 and 620 when reporting Official reserves, calculated from 730 multiplied by the center.

If the user asks, “Which Government has the resources to buy Gold?” he or she can see that the US holds 10.6% of world monetary resources by looking at cash ring 720. If the user asks, “What Percent of gold do they currently own?” he or she can see that the US owns 26% of Worlds Reserve Bank's gold, as shown in gold ring 730. If the user asks, “How much does Gold represent of monetary reserves?” the user can look in gold ring 740 and see that the US has 57% of its reserves in Gold. Similarly, for production, the user can view the supply ring 750b and see that the US is responsible for 11% of world production (in 2003), had demand for 16% and was therefore a net buyer of gold. If the user asks, “At what price is gold in the ground traded, and how does it compare to other countries' valuations?” the answer can be found in ring 760a representing gold Sector or sub sector of Stock Exchange of that country at US $200 ounce. If the question is, “What Price, compared to gold, do securities trade for?” The answer can be found by reviewing a ratio of Market capitalization to gold reserves, or resources, which are shown in outer ring 760b, again ranked to the noon notification.

FIGS. 8A and 8B are one example of a country Price wheel 800 (level one). This country wheel 800 represents the US S&P 500, and includes sector weights and components within the respective rings. In general, the country wheels focus on Macro analysis, by comparing a stock and sector (e.g., rings 813, to 810, 811 and 812 P/E ratio to the overall market PE). The guide is capable of comparing different ratios to one another, using historical data or estimated data.

Each ring, as with other wheels, provides a function. In these country wheels, the more inner rings include broader sectors of the economy (e.g., energy, industrials). Successively more outer rings provide further specificity. Depending on the selections made by a user, these rings can change. The center represents the values for the wheel and the measure to which the securities have been ranked, in this case by PE. It is possible to read the guide with the data labels as in FIG. 8A or without in FIG. 8B due to the postion and color on the wheels. Referring to FIG. 8B, in the financials sector which is the entire “pie-shaped” region in the upper right, denoted as red, the first ring's sub-sector reads, “Financials.” This represents the largest sector of the market show by the magnitude of the pie region equivalent to 20% of the wheel therefore in the Noon Notification position. The second ring weighted and ranked again by the size of the sector, possible user selections in the second ring are “banks,” “diversified financials,” and “insurance” and “Real Estate.” Again the choices offered in the third ring respectively are Banks companies “A,” Diversified financials “A1,” “A2,” A3” all of which represent the larger and thus are the “least risky” in respective sectors in the US in which to invest. Accordingly, these Financials are assigned the innermost ring, where A1 out of the three large financials it offers best value on a PE 11.1. Within diversified financials it offers the best value and is positioned closest to noon within the industry. The wheel ranks the securities sequentially around the wheel within each sector (represented by the pie shape). The securities positioned clockwise nearest to noon within the sector ring being the most favorable for that sector within the risk band.

In the example of FIG. 8B the user has selected “banks.” representing the largest sector within the Financials comprising 8 percent of the Financials market capitalization. Accordingly, the choices offered within the same industry are ranked to the industry vertical line which represents the closets to the noon position. Therefore, the preferred asset within the industry and risk band in descending, outward order are, ring 812B “A,” the largest of the banks, moving out risk tiers on the vertical line, “B,” “C,” “H.,” “M,” “U”.

The tracker displays the securities on the vertical line closest to noon inline according to the user input. The smaller and accordingly “more risky” banks are represented in outer rings and furthermost away from the noon position. In this example “Ac” ring 818 represents the least attractive on this measured, the most risky due to its smaller size and higher PE reflected in the outer right side of the segment within the Banks. Notification of the ratio used to rank components is highlighted in the center ring. The tracker highlights the securities positioned closest to the noon position on the vertical line for each sector within each of the risk bands (rings ) representing the most active according to the measure.

The market and country wheels allow the user to view the wheels on an equal weighting or weighted basis, with or without the control rings. The “Control, Style and Benchmark” rings can be positioned between the center and the first ring, or as a normal legend outside of the wheel

The relationship and algorithm among rings on FIG. 8A is shown in Table 5.

| | | DISPLAY VALUES |
|---|---|---|
| WHEEL PART | DISPLAY | US$MILLION |
| Algorithm Rings | Labels | Range in Value |
| Center | Defines chart | Values US$m Sum 1^{st} or Sum 2^{nd} |
| 100% of the individual components values | | or Sum 3^{rd}-10^{th} |
| | | Ratio's Mean of Wheel |
| 1^{st} Arc is sum of categories within this | Sector Name Price, | Weighted as Percent of Center |
| ring = center | PE, DY % of Center | Display $US value/Percentage |
| 2^{nd} Arc sum of 1^{st}, divided by components | Sub Sector Name | Each Sub-Sector as percent of 1^{st} |
| within a categories of the 1^{st} ring. Sum of | Price, PE, DY | ring categories Equal weight within |
| ring equal to the 1^{st} rings total | | the Arc ring |
| 3^{rd} Arc sum of previous rings categories | Stock, Price, | Over $160,000 equal weight within |
| divided by components within each category | PE, DY | arc, ranked by PE |
| (according to the 1^{st} ring categories) in this | | |
| ring. Sum of ring equal to the 1^{st} rings total | | |
| 4^{th} Arc sum of previous rings categories | | Under US $160,000 |
| divided by components within each category | | Over US $80,000 |
| (according to the 1^{st} ring categories) in this | | equal weight in the arc, ranked by |
| ring. Sum of ring equal to the 1^{st} rings total | | PE |
| 5^{th} Arc sum of previous rings categories | | Under US $80,000 |
| divided by components within each category | | Over US $40,000 |
| (according to the 1^{st} ring categories) in this | | equal weight in the arc, ranked by |
| ring. Sum of ring equal to the 1^{st} rings total | | PE |
| 6^{th} Arc sum of previous rings categories | | Under US 40,000 |
| divided by components within each category | | Over US 20,000 |
| (according to the 1^{st} ring categories) in this | | equal weight in the arc, ranked by |
| ring. Sum of ring equal to the 1^{st} rings total | | PE |
| 7^{th} Arc sum of previous rings categories | | Under US $20,000 |
| divided by components within each category | | Over US $10,000 |
| (according to the 1^{st} ring categories) in this | | equal weight in the arc, ranked by |
| ring. Sum of ring equal to the 1^{st} rings total | | PE |
| 8^{th} Arc sum of previous rings categories | | Under US $10,000 |
| divided by components within each category | | Over US $5,000 |
| (according to the 1^{st} ring categories) in this | | equal weight in the arc, ranked by |
| ring. Sum of ring equal to the 1^{st} rings total | | PE |
| 9^{th} Arc sum of previous rings categories | | Under US $5,000 |
| divided by components within each category | | Over US $2,500 |
| (according to the 1^{st} ring categories) in this | | equal weight in the arc, ranked by |
| ring. Sum of ring equal to the 1^{st} rings total | | PE |
| 10^{th} Arc sum of previous rings categories | | Under US $2,500 Of the index |
| divided by components within each category | | equal weight in the arc, ranked by |
| (according to the 1^{st} ring categories) in this | | PE |
| ring. Sum of ring equal to the 1^{st} rings total | | |

The center display in this embodiment, is the 100% of the value on the chart representing the “Market Capitalization” of this index at risk, which is in this case equal to the sum of all of the securities in each ring on the country wheel 800. Alternatively, the value displayed in the center can be the mean of a selected sector (e.g., consumer staples). The Market Price of a security multiplied by the shares on issue equals the Market capitalization of that security. The sum of all securities is the market capitalization of that “universe,” be it of selected securities, an Index, or an Exchange. The magnitude of the center value displayed in circle 810 depends on how an index is compiled and how it is represented on the weighted wheel.

3 Main Index Compositions:

Price Weighted Series:

Arithmetic average of current security prices—Computationally, a price-weighted index adds together the market price of each stock in the index and then divides this total by the number of stocks in the index. The index divisor (denominator) must be adjusted for stock splits and other changes in the index portfolio, an example is the Dow Jones Index

Market Value Weighted Series:

Calculated by summing the total value (current stock price times the number of shares outstanding) of all the stocks in the index. This sum is then divided by a similar sum calculated during the selected base period. This ratio is the multiplied by the index's base beginning value; an example is the S&P 500. A value-weighted index assumes you make a proportionate market value investment in each company and is one of the main reasons for Standard & Poor's moving to a Float Adjustment, as of 1 Mar. 2005.

With a float -adjusted index, the value of the index reflects the value available in the public markets. Each stock having a investable weight factor (IWF) calculated:
IWF=(available float shares)/(total shares outstanding)
Where available float shares is defined as total share outstanding less shares held in one of three groups where the group holding exceed 10% of the outstanding shares.
The float-adjusted index is calculated:
Index=(Σj (PjSjIWFj))/(Divisor)
Where Pj is the price of stock j, Sj is the total shares outstanding of stock j and IWFj is the investable weight factor. The divisor is the index divisor.
S&P uses a bottom-up methodology to derive official earnings for U.S. indices. The methodology aggregates company-level data for the broad indices and each of their respective GICS categories.
1. The Global Industry Classification Standard (GICS) Includes: Sector, Industry Groups, Industries, Sub-Industries.
   The earnings per share (EPS) of the individual companies in an S&P index are collected quarterly, and multiplied by their corresponding index shares to derive the dollar earnings contribution of each company to the index. These are summed for all the companies in the index to derive total quarterly index earnings. This is divided by the corresponding index divisor to produce the index earnings value published by Standard & Poor. The movement to float-adjusted indices will not change the methodology.
   The adjustments are as follows:
1. The number of shares in the calculation will be the float-adjusted shares as determined by S&P
2. The divisors used in the calculation will be those of the corresponding float adjusted price index.
3. The resulting P/E calculations published by S&P will be calculated with a float-adjusted price series and a float-adjusted earnings series.
   Unweighted Price Indicator Series:

Places equal weight on all stocks regardless of their price or market value, in effect percentage change. Value Line geometric mean, FT ordinary share index equals the weighted geometric average.

The wheel can display all securities greater than a preselected value, and can rank these in tiers as shown above in Table 5. Also, as described above, the wheel can be configured to display stocks in a particular index when the index is selected by the user.

In one embodiment, the center value is the mean of the overall country wheel 800, which represents an entire index or select sector or sectors. Each sector is the mean of a sub sector, which in-turn is the mean of the components within sector rings. The mean used can be either an arithmetic mean or geometric mean, depending on Index (as above).

Additionally, the center value in circle 810 can represent a portfolio at risk, with which the user can compare the center portfolio value resulting from different selected assets chosen by ranking rings by different ratios or by performance.

FIGS. 8C, and 8D involve an example of the S&P 500 with the data refreshed from FIG. 8A with the a change in date and and a change in style in FIG. 8D to PE. In FIG. 8A components are ranked by market capitalization, sector value displayed by the arc and the color throughout the wheel. The “Control rings” positioned next to the center. The Wheel is configured to rank sectors by market capitalization, financials 813C in noon position with the largest weight of 19%, without the Industry ring as seen if FIG. 8A ring 812. In this example, the Style ring 811C and Benchmark ring 812C positions are interchangeable. The style ring controls ranking of the components within the choice rings 813C-821C. The Benchmark ring controls the Index to be displayed in outer choice rings, which may form the center value. The style ring, depending on the configuration, controls the position of components in all the consecutive rings. For example in FIG. 8C Benchmark ring 812C has selected the S&P 500 Index, and accordingly it displays the components of the Index in outer choice rings 813C-821C. In the style category 811C market capitalization has been selected, the outer securities rings are ranked closest to the vertical nearest to noon being the most favorable clockwise within sectors according to the dollar value ranges within each ring.

FIG. 9A (Level One) illustrates a stock watch list on a index wheel 900. Similar to the country wheel 800, it includes the control rings, style ring 903 and Benchmark ring 905 for user selection in the investment process. In this example, the user has selected to rank assets in the outer rings by value (PE), and has selected the HKCI index for display of possible assets for investment and is highlighted in a color, for example, green. The user selects various assets all of which would affect the center portfolio value (Shown as $100,000) in central display circle 901, should the user actually invest in those assets. The actual or predicted PE and yield and performance, shown as an example PE 14.1x Yield of 3% and performance of the portfolio plus 3% in the central circle 901, and varies depending on user selections.

Alternatively, the user can conFIG. the asset data visualization guide to display a portfolio wheel that only ranks assets owned by the user, and can rank them in a similar nature to the above-refernced FIG. 16 (Level two) which is an example of a Portfolio wheel.

The ratios in the style ring 901 highlights the user's inputs Each of the values displayed in the center circle 901 represent the sum of the values from the constituent (user-selected) sectors on the wheel, divided by the number of constituents selected, or by the index.

In this wheel 900, as well as in other wheels described in this paper, segments can display links to alternative measures, which the user can click. For example, the growth sector in style wheel 901 allows the user to choose EPS growth rate or PEG as a measure.

The FIG. 9B embodiment 900B reflects the change in values and position of the components on the wheel 900A over time, enabling a snap shot of the re-rating or de-rating of the sectors, visualized by the color and the change in positions over the time frame. Value is measured by the change in segment size represented by the arc and by the color representation on the wheel, in this example it represents the market capitalization on the wheel, contracting or expanding as the money flows from one sector to another, ranked by PE. The change in a segment position is assisted by color changes on the wheel.

For example, comparing FIG. 9A September 2004 to FIG. 9B March 2005, industrials 920, which are, “dark Blue” are in the 1^{st} quarter in FIG. 9A and in the 2^{nd} quarter in FIG. 9B ranked by PE. For example, Consumer Goods 940 was re-rated to the 4^{th} quarter in FIG. 9B now the third most expensive sector from 1^{st} quarter, with financials 960 being de-rated in FIG. 9B below the mean and looking attractive due to being positioned near to noon. Utilities 930 in Noon position of PE 15 versus a market of 16.7 or in September 03 a PE of 14.8. The sector color code, enables one to compare size of sectors in one country to another, for example Financials, colored red representing 35% of HKCI as opposed to 20% in FIG. 8A US S&P 500.

Using again the concept of the physical direction of the clock, assets on the left have gone up and are no longer attractive compared to other assets on the wheel based on the user's selected criteria, the center again reflecting the market mean.

FIGS. 10A-B are examples of a sector sphere, or “Beta Clock” (Level 6) used when the meridian ring is present. The sphere gives notification for direction of the assets on the sphere which can change from the wheels' notification (noon position). The sector wheel (or sphere) can be used for either exceptional (estimated/forward) values, historical values, or a mix of both. The wheel explains each sector relative to the center and to other components within the wheel. The center becomes the mean of the wheel. This sphere can be used in conjunction with sphere FIG. 1 or independently using one or two Independent variables on the meridian ring 100. Notification on the sphere is directional when within a asset class i.e. S&P 500, representing a segment of equities from the Asset sphere of FIG. 1 or the world market of FIG. 4. Notification changes, with the left side outperforming the right side and center in a rising market and the right side outperforming the left and center in a falling market.

For example, referring to FIG. 10, the user inputs on the meridian ring the expected performance of S&P 500, an Independent variable, which becomes the center value or “Benchmark” to outperform. A change in the independent variable may change the price of the assets on the sphere. The user has projected an 8% return for the S&P 500, with forecast interest rates on the meridian ring increasing, indicating a bullish user style. The estimated 90 day Treasury (RFR) increasing, also indicating a bullish style. Direction should be the same direction as in GUI 200 due to it being a predictor in itself as to the future direction of the base rates142 on the Asset sphere FIG. 2. The user is bullish, therefore, all assets on the left side of the sphere will outperform the center 110, and the right side, and for example Information and Technology will move 1.94 times the center move. If a user was bearish, the right side would outperform the center and left side. For example, consumer staples will move 0.2 times the market move based on the Beta for a given time period. Each sector on the sphere is a component from the Asset Wheel FIG. 4 or the Asset sphere FIG. 2 and in turn, the Country wheel FIG. 8A 811. Each ring in 1000A-B explains the risk, price, growth and performance versus the Index risk, price, growth and performance helping to assist a user to Protect and maximize his return against the market returns.

FIG. 10B displays FIG. 10A in full when the user clicks on the center. The outer rings expand and display the four inner rings, breaking down the elements of each sector, displaying the volatility measures and correlations. The wheel gives the profile of the sectors' past performance, future expectations, and calculates the expected return of a unit of risk.

Referring to FIG. 10B Financials 1125b starting from the center and working outwards contains a value of 56% of financials performance is explained by the move in the Index center, it is positively correlated 120b to the center at 0.75, therefore holding assets in other sectors not correlated will assist to diversify a portfolio, e.g. consumer staples. Financial returns have a volatility 120c risk of 21.4% measured by Standard Deviation relative to the center (mean), and a Beta 120d of 0.90 and thus will move less than the center in both directions. A PE of 11.6 is cheaper than the market PE of 15.91, with EPS growth forecasted at 7.2% less than Index growth of 6.28% and is on a price for growth of 1.6 versus the index of 1.5 indicating the Index has a lower price for growth than financials, therefore financials will under perform on that measure.

The Required return 120h for Financials is 7.8%. Using the variables inputted on the meridian ring and the CAPM generated required return for unit of risk, one can measure risk versus reward. Performance ring 120i year on year is up 9.4% receiving a positive ALFA 120j and risk adjusted return is above the required rate of 17.2%. The user can compare the ALFA of other sectors, Information and Technology Required Rate of return was 24% where performance YTD was up 13.1%, therefore the investor did not get paid for the amount of risk receiving a negative ALFA.

In FIG. 10B the estimated interest rate has changed from FIG. 10A, therefore changing the values in the outer required rate of return 120h, and the Alfa 120j rings have readjusted displaying the updated values.

Table 6, below, relates elements (rings) of the sector wheel 1000 to the information displayed in that part, its functionality and/or relationship to other rings and calculation.

TABLE 6

| | SYMBOL OR | VALUES OF | | |
|---|---|---|---|---|
| WHEEL | NAME | INFORMATION | FUNCTIONALITY/ | |
| PART | DISPLAYED | DISPLAYED | RELATIONSHIPS | CALCULATION |
| Center | | Mean | Values explains the | Sum. or mean of the |
| | | of each ring | wheel, mean of each | rings |
| | | | ring equals the center | |
| | | | value | |
| 1^{st} | R² | Coefficient of | degree sector | Square 2^{nd} ring (2^{nd} ring |
| | | Determination | movement are | r²) = (1^{st} ring = R²) |
| | | | attributable to change | |
| | | | in center (index) | |
| 2^{nd} | r | Correlation | r = center and the 4th | 4^{th} ring &center |
| | | | | covariance |
| | | | | 4^{th ring} σ *center σ |
| | | | | r = covXY/standard |
| | | | | deviation center (mean |
| | | | | of 3^{rd}) * standard |
| | | | | deviation 3^{rd} sector ring |
| 3^{rd} | σ | Standard | Center and 5^{th} | Square root of variance |
| | | Deviation | variance | |
| | | measuring | | |
| | | volatility | | |
| 4^{th} | β | Beta | (2^{nd} and 3^{rd} ring | Beta = (σi/σₜₘₖₜ₎)*p1, 2 |
| | | | values) | i is the stock, |
| | | | | or covimkt/var mkt |
| 5^{th} | Sector | Price and Yield | Mkt cap. as | PE = Price/earnings |
| | PE, DE, | of Sector | percentage of center | |
| | Size Sector | | PE 5^{th}/6^{th} ring | |
| 6^{th} | EPS Growth | EPS growth | Percent of sector | (EPS est. − EPS last |
| | | Percent | growth relative to | years earnings)/EPS last |
| | | | center and other sector | year |
| | | | growth rates. | |
| 7^{th} | PEG | Price to Growth | 6^{th} growth rate/5^{th} Price | Price/Growth Rate |
| 8^{th} | Required | Percentage | Meridian ring RFR | CAPM = RFR + BETA* |
| | Return | | 4^{th} ring beta | (Market Return − RFR) |
| | | | (Center-or mean of 9^{th} | |
| | | | ring) | |
| 9^{th} A | CV | Coefficient of | 8^{th} ring divided by the | Standard deviation of |
| or | | Variation | center | returns divided by the |
| | | | | expected rate of return |
| 9^{th} B | Sharp Ratio | Sharp Ratio | Meridian ring (RFR), | Return of Portfolio |
| or | | | center returns and | minus RFR divided by |
| | | | center SD | the standard deviation |
| | | | | of the portfolio |
| 9^{th} C | Performance | Performance | Actual performance | 9^{th} ring divided by |
| | | Est. or Historical | or relative to center | center performance |
| | | As Percentage | | |
| 10^{th} | α | Excess return | 9^{th} ring − (4^{th} ring* | Required(expected |
| | Alfa | for unit of risk | center return) | return) − (beta*actual or |
| | | | or 9^{th} − 8th | predicted market return) |

### Sector Sphere

Accordingly, the values in each ring of the sector wheel 1000 are mathematically related to other rings. Definitions of these values are as follows:
Center=Independent variable, (each sector segments' being the dependent variable) Center is the mean of each of the rings.
1^{st} ring Represents Coefficient of Determination=(R²) is Defined as the Percentage of the Total variation in the Dependent Explained by the independent variable.

$$\begin{matrix}R 2 = \frac{Total variation - unexplained variation}{total variation} \\ = \frac{explained variation}{total variation} \frac{SSR}{SST} \\ = 1 - ( SSE / SST )\end{matrix}$$

2^{nd} ring Correlation=r
Correlation Coefficient (ρ_{1,2)}

A standardized measure of the relationship between two series that ranges from −1.00 to +1.00.

The lower the correlation between the returns of the stocks in a portfolio, all else equal, the greater the diversification benefits.

$$Correlation = \frac{{ρ}_{1 , 2}}{σ x σ y}$$

3^{rd} ring Standard Deviation (σ)

A measure of variability equal to the square root of the variance

The standard deviation is the positive variance σ².

Variance of a random variable is the expected value of the squared deviations of each observation from the random variables expected value.
σ²(x)=sum p(xi)[xi−E(X)]²

$$Historical data variance {σ}^{2} = \frac{{\sum }_{t = 1}^{n} {( Rt - R average return )}^{2}}{n}$$

Rt=return in period, n=number of returns
Historical Standard deviation=square root of the variance
4^{th} Ring Beta=β

A standardized measure of systematic risk based upon an asset's covariance with the market portfolio. Beta measures the sensitivity of a security's returns to changes in the market return.

5^{th} Ring Index Earnings and Price, PE-Price Earning Multiplier

The number by which expected earnings per share is multiplied to estimate a stock's value; also called the earning multiplier
P0=D1/(Ks−g)
where D1 next year's dividend
ks=the investor's required rate of return
g=the firm's expected constant growth rate
ks=(D1/P0)+g=Expected rate of return, if in equilibrium

The value (Price) using the Dividend discount model (DDM) says the value of a share is the present value of its expected dividends, D, discounted at the appropriate required rate of return, k.

$$Value = \frac{D 1}{P 0} = K - g$$

Value=E(EPS)×E(PE)
Specific Multiplier Approach

Estimates industry dividend payout ratio (D/E), required rate of return, k and growth rate, g.

$$P / E = \frac{D / E}{k - g}$$

k=RFR+RP industry
or
k industry=RFR+(Beta industry)(Rmkt−RFR)
g=growth rate or estimated by RR*ROE
Future Industry Index=EPS1*(P/E)1
   6^{TH} Ring Earning Per Share

The amount of income a company earns for every share of common stock it has outstanding.

$$Basic EPS = \frac{( net income - preferred dividends )}{ \begin{matrix}Weighted average number \\ of common shares outstanding\end{matrix}}$$

7^{th} Price to Growth (PEG)

Stock's price-earnings ratio divided by the firm's expected growth rate of earnings, relative valuation tool

8^{th} Ring—Required Return or Expected Return

Expected rate of Return: The return that analyst's calculations suggest a security should provide, based on the market's rate of return during the period and the security's relationship to the market.

Required rate of return: The return that compensates investors for their time, the expected rate of inflation, and the uncertainty of the return.

Two Methods

Capital Asset Pricing model (CAPM) holds that the expected return on risky asset E(Ri) is the risk-free rate (RFR) plus a beta-adjusted market risk premium.
Expected Return on risky asset=E(Ri)=RFR+beta(Rmkt−RFR)
1. Compare investor's expected rate of return from the purchasing the stock to the firm's required rate of return.
   Required rate of return=RFR+beta(Rmkt−RFR)
   Expected rate of return=(D1+P1−Pmkt)/Pmkt
   Risk free rate (RFR)s The basic interest rate with no accommodation for inflation or uncertainty.
   The pure time value of money.
2. Expected rate of return=(D1/Pmkt)+g
   Estimating Industry Total Return:
Industry return=[(dividend)+(ending value-beginning value)]/beginning value
Expected return Index Expected Div+(index price end-index price beg)/index price beginning Portfolio Expected returns
   E(Rp)=Sum n i=1wiE(Ri)=w1E(R1)+w2E(R2)+ . . . +wnE(Rn)
   9^{TH} ring can be either of the 3 measure, Coefficient of Variation, Sharp Ratio, or Performance.
   1 Coefficient of Variation

Standard deviation of returns divided by the expected rate of return. Measure of relative variability to indicate risk per unit of return.

2. Sharp Ratio:

Measures the reward-to-variability ratio, measures excess return per unit of risk

$$Share Ratio = \frac{rp - rfr}{σ p}$$

rp=portfolio return
rf=risk-free return
σ=standard deviation of portfolio returns
   3. Performance

The total return from an investment for a given period of time stated as a percentage. Using actual or estimated performance.

Future stock value estimate=P1=(EPS1)(P/E)1

$$V 0 = \frac{( D 1 + P 1 )}{1 + k} . \qquad 1$$

if V0>Pmkt, buy the stock it's under-priced.
if V0<Pmkt sell, short it is overpriced.
Actual or estimated by expected return using capital asset price model (CAPM).
CAPM a theory concerned with deriving the expected or required rates of return on risky assets based on the asset's systematic risk levels.
Systematic risk: the variability of returns that is due to macroeconomic factors that affect all risky assets. Because it affects all risky assets, it cannot be eliminated by diversification.
10th ring ALFA; Excess Return received for unit of risk paid for.
α Alfa of a risky asset is equal to the mean return of risky asset minus (beta of the risky asset multiplied by the mean return of the market).

FIGS. 11A-D illustrate examples of an Efficiency Market Wheel. The efficiency wheels 1100A-D analyze the efficiency of an entity's ability to generate a return from the assets under its management's control. The efficiency wheels 1100A-D can use historical or estimated data. Results are numerically displayed by Ratio (e.g., PE ratio), by Earning per share (EPS) and/or by Value (US$ . . . ) in the rings of the respective companies, each segment is weighted by the total value of the ring. The center displays either a user input or the company achieving the central noon notification position.

The Efficiency Wheel (Level 4) examples, such as illustrated in FIGS. 1100A-D, combine Macro analysis, by comparing stock P/E ratios, and microanalysis by using calculated points estimates for projected payout ratio, required rate of return and growth rate in dividends, using the equation: (PE)1=(D1/E1)/(k−g). Projected stock value Vo=D1/ke-gc knows as the constant growth dividend discount model (DDM) or a version thereof.

The software component of the efficiency market wheel functions similarly to the software of the Market wheel. Notification is again noon for rings with a central noon notification, positioned in the center of the wheel, indicating the company with the highest efficiency relative to the price, for the wheel on the whole. The center displays the company with the highest frequency in the noon position, inner rings can have higher weighting than the outer rings, and the center reflects the security most likely to outperform. The weightings can reflect the user preferred style method used in the country Price Wheels e.g. such as shown in FIGS. 8A & B, Value with PE ring having a higher weight for the noon notification. The user can select the series and the ratios, or use the default settings as in FIG. 11A,

The wheels 1100A, B, C and D each include a plurality of concentric rings, each ring represents the “make up” of the companies, represented by Total Assets, Sales, Earnings, Shareholders Funds, Dividends paid and the Market capitalization in the respective rings. The center exhibiting the company at “risk.” The efficiency of each company explained by the accompanying ratio, ranked to noon within the series, measuring each company's ability to generate profits from their asset base. The center reflects the company with the highest efficiency relative to the price of that company.

Each ring can be weighted to the ring's total value enabling the user to view size of segment, as compared with a competitor's size. Again, with the concept of the clock, the noon position indicates to the user that the company or asset at that location is the most advantageous in its ring, for the measure used in ranking. FIG. 11A shows the default setting of an embodiment. The functionality of each is explained in Table 7. A user selects a company by clicking on the respective company. The GUI displays the position of that company throughout the wheel, thereby tracing that company's efficiency to generate profits from their respective asset base. The inner ring monitors the price the market will pay for their ability. The GUI monitors position on the wheel, updating when prices or other data change. The wheel displays selected securities data in the center circle 1110A. A Company that makes a loss can be excluded from one or all of the inner rings, respectively representing the market capitalization 1120A, dividend 1115A, and profits 1130A.

The user can see the companies' order, representing the first, second, third or fourth quartile, in-line with the clock aspect. Segments are weighted with the mean of the wheel coinciding with 90 degrees, ranked by ratios or values displayed in the center clockwise, starting at the noon position being the most favorable. The wheels 1100A-D can have a color code for each region, so that the user can quickly see what region or entity has the largest assets, sales, equity, market cap, and/or profit in each ring enabling comparison to other companies' abilities to generate profits given their asset and sales base.

As seen in the embodiments of FIGS. 11A-D, Europe is represented in the color lilac, and the USA in white and Gray and Asia in white. The USA Banks Total Assets makes less than a quarter (4 out of 20 or 45 degrees of the ring) of the top 20 global banks (as seen the outermost ring 1150. In FIG. 11A (white and Gray segments), but they have nearly 50% of all the profit (as seen in 1130A white & Gray segments).

It should be noted that in the described embodiments the term “circular” is used for convenience. In other implementations, circles and rings can be ovals, for example. Additionally, the rings and central “circle” can be polygons, for example, octagons or even other shapes, such as squares or triangles, if desired, the particular shape selection being one of visual convenience and otherwise an unimportant aspect of the approach.

In one example embodiment, referring to FIG. 11A, 1100A, the concentric rings are ordered working from the outer rings to the inner rings, by Supply (Bank Assets) 1150A, Demand (Sales) 1140A, Risk (equity) 1135A, resulting in Profits 1130A, Dividends 1115A represent the return, and Market capitalization 1120A represents the price. The central circle 1110A represents price of the selected company, price derived from profits1130A, estimated Dividend 1115A, and the discount rate on asset sphere FIG. 1 on the Meridian ring 142, and growth rate, derived from 1130A and 1115A. The center lists the selected asset and values at risk, components from the rings and each ring has a respective financial ratio linking it to the next for example 1150A Total Assets divided by sales 1140 total asset as a percent measuring the companies' ability to generate sales from assets and the companies' ability to generate profit 1130A from sales 1140A, measuring the financial risk of the company by the leverage a company has derived from total assets 1150A to equity 1135A. The user can rank by either the ratios or by the Per Share $ value by clicking on the measures underlined in the center. As shown in FIG. 11A, company “b” has been selected, traced by white label and with a black border throughout the wheel. “b's” values and ratios from each ring are displayed in the center circle 1110A. “b” is just above the mean on the right hand side of the wheel of the selected banks, against which it is compared, except for sales where it is just below the mean on the left-hand side of the wheel. “b's” is positioned near the mean therefore displayed around the 6 o'clock position on the wheel. The USA banks on average are positioned in the first quarter by size. It can be seen that European banks dominate the wheel, easily seen since more lilac is displayed than any other color. Company “a” is in the noon position more than any other bank, each ring being weighted by size. Notification is at noon, so if size is the user's preferred measure then “a”, with the highest frequency at noon, would be the user's best option for investment. Central noon notification would position “a” into the notification point, the center being the most favorable on the criteria, with the center turning blue. Company “c” is highlighted in yellow, and the ranking for “c” position in each ring is visible due to its unique color of the label on the wheel. Its position on the left side of the sphere is the least favorable as measured by the US dollar value of Total Assets, Sales, and profits. This enables the user to see clearly how the efficiency wheel dynamics work when sorting with ratios or values in the center, since movement of these color coded segments is more easily visually tracked than if they were not color coded.

Referring to FIG. 11B, using the controls in the center and ranking the companies on the corresponding ratios “c's” position has changed to the right side of the wheel, above the mean on average, ranked by the ratios measuring the values from FIG. 11A and calculating the required ratios and then ranking the companies to the required order. The Noon position signifies the maximum for each measure of each ring out of the displayed companies.

As shown in the asset ring 1150B of FIG. 11B, “c” is ranked first, having a profit to asset ratio of 1.6%,it is therefore the most efficient at generating sales from assets. However, “c” is a small segment, each segment representing the dollar values for each such as the profits and Assets and so on, reflected relative to the universe, and therefore it has a small amount of resources relative to its competitors. This might signify to a user that “c” might have limited growth opportunities unless it increases its total assets.

As shown in the sales ring 1140B, “c” is ranked number two, generating a profit from sales of 19%.

The equity ring 1135B reflects “c” ability to generate profits from equity base, relative to the current price of equity represented in market capitalization 1120B. It is efficient as seen in the profit ring 1130B in the noon position. The market will pay more for a higher return, therefore “c's” position reflects this and is above the mean positioned in the 3^{rd} quarter, with a price to book value of 2.8x.

As shown in the profit ring 1130B, “c” is the most efficient asset, with the highest ROE position in the noon position, therefore the market will pay more for this return reflected by the current Price of equity 1120B represented by the current Market Capitalization 1120B. The market will pay more for a higher return, therefore, “c's” position is above the mean, positioned in the 3^{rd} quarter and is therefore less attractive according to the current price as shown in 1120B.

The dividend ring 1115B, again reflects the return “c” pays to its shareholders relative to the current market price 1120B. Again, “c” is positioned in the noon position.

As shown in the Market capitalization ring 1120B ranked by PE, “c” is positioned in the 3^{rd} quarter, reflecting the price 1120B relative to the profits 1115B. Again, price reflects the above average ability to generate profits from its assets.

As shown in FIG. 11C, a further two rings can be added: the World demand (GDP) 1160C ring on the perimeter and an inner ring 1111C with dividing of profits and assets of center (as can be seen by sectors 1111a-c) to countries on world demand ring 1160C, with ring segment weighted by the dollar value of the economy relative to the series. Color coding enables country risk to be applied to the capital and profit generated (larger economies are less risky than small economies). World demand in the outermost ring 1160C, the color corresponds to where the profits and Assets are based. The profits and Assets are in the split inner ring 1111a-c. The asset and profit of “b” can now be compared to the demand and value of markets in the world that it operates, comparing the segments values by Percentage in 1111a to the corresponding values in 1160C. Segment size again signifies risk to the assets and profits due to the physical size of the economies that have generated the profits, equally it highlights the risk to the Assets within that country. For example 1111c color coded to represent Europe, “b” holds 45.7% of their assets in Europe, 1111b 41% of Net Interest Income generated in Europe, and 36.3% Pre Tax Profit. Equally Europe is the 2^{nd} largest market.

FIG. 11D is an example of the efficiency wheel visually representing the center the company most efficient at generating profits 1130D from their asset base 1150D, and sales 1140D, accounting for leverage risk 1135D relative to the market price 1120D.

Company “a” is represented in the central noon position for the wheel 1100D. Inner rings' noon position carries higher weighting than the outer noon positions. The center 1110D displays stock to Outperform in which case the center circle notification changes color to Blue, or alternatively Red to underperform where the security furthermost from noon on the wheel is again, weighted with the inner rings having a higher weight. In this example using the default weights for each ring from the center outwards we get the following: PE weight 1.2, DY weight 1.1, Earnings, weight 1, Equity weight 1, Sales weight 1, and Assets weight 1, with a maximum score of 6.3. “a” has the highest score of 2.1, and is therefore positioned in the center. The weights can be customized to coincide with the user's preferred style as selected in the style ring within the country price wheels.

Table 7, below, compares the rings, and the factor by which they are weighted, ratio used, etc.

TABLE 7
Efficiency Wheel Default for the Central Noon Notification and represents the Supply, Demand and Risks, to the Price of the center input.

| | NAME & WEIGHT | | | | |
|---|---|---|---|---|---|
| | SERIES US$ MILLION | | | | |
| | OR VALUE BY PER | NAME OF THE RATIOS | | CENTRAL NOON | RINGS |
| | SHARE VALUE | DEFAULT B FIG. 11 D | FUNCTIONALITY | WEIGHTS | REPRESENT |
| Center 1110A | Input Values on | Input Values on the 6^{th}- | Displays input ranked in | Max 8.5 | Most efficiency |
| | the 6^{th}-1^{st} rings | 1^{st} rings, descending | Noon on all rings or the | sum rings | or At Risk |
| | | | input that has Noon position | | |
| | | | the most often. | | |
| | | | Alternatively displays users | | |
| | | | input at “Risk” | | |
| 1^{st} ring 1120A | Market Capitalization | Price/Earnings (PE) | 1120A divided by 1130A | 1.2 | Price Present |
| | | | | | value Of future |
| | | | | | profits |
| 2^{nd} ring 1115A | Dividend | Dividend/Price (DY) | 1115A divided by 1120A | 1.1 | Return (Growth rate) |
| 3^{rd} ring 1130A | Earnings (Profits) | Return of Shareholders | Multiplication of Ratios | 1 | Return (Earnings) |
| | | Funds (ROE) | 1150A, 1140A, 1135A | | |
| 4^{th} ring 1135A | Shareholders funds(SHF) | Assets/SHF (T/SHF) | 1150A divided by 1135A | 1 | Risk |
| | (Equity) | | as a percent | | (Shareholders Funds) |
| 5^{TH} ring 1140A | Sales | Earnings/Sales (E/S) | 1130A divided by 1140A | 1 | Demand (sales) |
| | | | as a percent | | |
| 6^{th} ring 1150A | Total Assets | Sales/Total Assets (S/A) | 1140A divided by 1150A | 1 | Supply (competition) |
| | | | as a percent | | |

What is claimed is:

1. A system for guiding a user's financial investments, the system comprising:
a server configured for running a program;
a storage device for storing a program and reference data for the program;
a processor in communication with said storage device, said processor operative with said program to:
receive data related to preselected assets;
store the data related to the preselected assets in said storage device;
access the stored asset data when requested by said program;
receive input data from the user regarding user preference, the program selecting a default preference in the absence of user-input preference;
calculate variables, including relative risk, market capitalization and price to earnings ratio, for each preselected asset, based on the stored asset data;
arrange the preselected assets according to one of a user-selected criteria or either the user preference or the default preference; and
display the arranged preselected assets to the user, a region of the display representing each asset or asset class, in a preselected fashion, to enable the user to determine, based on the physical position and size of each relative to other displayed asset regions, how variables of the preselected asset compare to variables of other displayed assets.

2. The system of claim 1, wherein said processor is operative with said program to arrange and display the preselected assets in regions represented as components within concentric rings, each successively larger ring indicating that assets in that ring pose increased risk to a user investment than assets in smaller rings.

3. The system of claim 1, wherein said processor is operative with said program to arrange and display the preselected assets in regions represented within concentric rings such that assets having variables that are more favorable, according to user-selected criteria, are arranged closer to a notification position than assets having variables that are less favorable.

4. The system of claim 3, wherein the notification position is a first position arranged clockwise from a noon position.

5. The system of claim 3, wherein the assets are displayed in regions ordered by importance sequentially, in a clockwise direction.

6. The system of claim 1, wherein said processor is operative with said program to additionally identify selected display regions by altering the appearance of the region.

7. The system of claim 6, wherein the appearance of a region is altered by enhancing a border of the region so that the border has a different color or line-weight than unselected regions.

8. The system of claim 6, wherein the appearance of a region is altered by changing the color of the selected region.

9. The system of claim 1, wherein said processor is operative with said program to additionally display, in each respective region representing an asset or asset class, at least one calculated variable.

10. The system of claim 1, wherein said processor is operative with said program to receive updated user-selected criteria for automatic arrangement and display.

11. The system of claim 1, wherein said processor is operative with said program to additionally accept a user selection of at least one preferred display criteria.

12. The system of claim 1, wherein the user-selected criteria is the relative magnitude of market capitalization.

13. The system of claim 1, wherein said processor is operative with said program to additionally assign different colors to each asset class in order to enable the user to easily distinguish different classes of assets and determine how variables of the preselected asset compare to variables of other displayed asset classes.

14. The system of claim 1, wherein the user-selected criteria is the relative risk of an asset.

15. A graphical investment guide for assisting a user in investment of assets, the graphical investment guide comprising:
at least one central display area for displaying user data;
a plurality of concentric, rings for displaying variables related to preselected assets, a first of the at least one of the concentric rings being rotatable about the at least one central display field, the first rotatable ring displaying a plurality of regions representing asset classes, the relative position each region, indicating to the user, the desirability of investing in the asset represented by that region;
at least one indicator region arranged around the concentric rings for displaying a range of at least one economic indicator; and
at least one indicator pointer, pointing to selected values of the at least one economic indicator.

16. The graphical investment guide of claim 15, wherein the plurality of regions representing asset classes are arranged within the at least one rotatable ring such that asset classes having a substantially negative correlation to one another, relative to changing interest rates, are arranged substantially opposite one another on the rotatable ring.

17. The graphical investment guide of claim 15, wherein the position of a region at which desirability of investing in an asset is indicated is a position immediately clockwise from a noon position.

18. The graphical investment guide of claim 15, further comprising a second rotatable ring for illustrating graphically to the user, the user's portfolio asset allocations relative to all of the user's assets.

19. The graphical investment guide of claim 18, wherein the allocation is illustrated by relative size of regions representing each asset class, and a label, illustrating numerically the percentage of money allocated to each respective asset class.

20. The graphical investment guide of claim 18, wherein corresponding regions of the first and second rings are colored with substantially the same color, each different asset class being assigned a substantially different color.

21. The graphical investment guide of claim 15, wherein the indicator pointers are clock hands.

22. The graphical investment guide of claim 15, wherein assets are preselected by the user.

23. The graphical investment guide of claim 15, wherein assets are preselected by a default setting.

24. The graphical investment guide of claim 15, wherein one displayed economic indicator is an interest rate.

25. The graphical investment guide of claim 15, wherein one displayed economic indicator is GDP.

26. The graphical investment guide of claim 15, wherein one displayed economic indicator is a cyclical representation of a peak, trough and bull and bear, representing phases of an economy.

27. The graphical investment guide of claim 15, wherein one displayed economic indicator is a set of descriptive terms for events seen historically, correlated to degrees of economic performance.

28. The graphical investment guide of claim 15, wherein the user data includes at least one of a value at risk, date, predicted yield, actual yield, user selections, and preselected reference data.

29. A method for guiding user investment based on market data, the method comprising:
arranging a plurality of regions, each representing a respective asset or asset class, in one of a plurality of interrelated areas;
selecting a reference position indicating to a user that any asset region displayed in a predetermined position relative to the reference position is most advantageous for investment according to user preferences;
using market data to rearrange the asset regions to reflect changes in the market data to provide updated investment guidance.

30. The method of claim 29, further comprising providing to a user choices for investment style, the user choice being used to recommend assets for investment.

31. The method of claim 29, wherein market data is used periodically to rearrange the asset regions.

32. The method of claim 29, wherein market data is used periodically to rearrange the asset regions when prompted by the user.

33. The method of claim 29, wherein updated market data is used continuously to rearrange the asset regions.

34. A computer-based investment guidance system having, in memory, an interaction interface, comprising:
instruction signals, wherein the interaction interface is responsive to user and system event signals and wherein the instruction signals are issueable by a processor to invoke:
a plurality of interrelated areas representing tiers of risk;
a display area to display the interrelated areas, and
wherein the interrelated areas drawn in the display area represent data for a plurality of investable assets,
wherein portions of the interrelated areas' reference data and respond to user selections allowing a user to access referenced data,
a selection facility to specify any investable asset responsive to user selections,
wherein the investable asset selection facility is disposed in communication with the display area such that user selections specifying an investable asset instruct the display area to change to alter the appearance in the display area, depending on the specific investable asset selected.

35. The computer based investment guidance system of claim 34, wherein the appearance of the display area is changed to display a different set of concentric rings having more detailed data regarding the selected investable asset.

36. A method for guiding user investment based on market data, the method comprising:
providing a first area, divided into a plurality of asset classes, the asset classes constituting possible investment classes in which a user may invest;
providing a second area, related to the first area and arranged adjacent to and along the first area, the second area being divided into the same plurality of asset classes as the first area, and further divided into subsets within the asset classes, all subsets from all asset classes in the second area constituting possible subsets in which a user may invest.

37. The method of claim 36, further comprising a third area, concentric with the first two areas, and arranged adjacent to and along the first area, the third area being divided into the same plurality of asset classes as the first area, and subsets within the asset classes of the second area, and further divided into individual assets in the third area, all assets from all asset classes in the third area constituting possible assets in which a user may invest.

38. A data visualization system comprising:
a computer display displaying thereon Type A wheel graphically illustrating, through use of color, relationships among data, the Type A wheel having components that can be reconfigured based upon a user selection.

39. A data visualization method for guiding investment based on market data, the method comprising:
graphically displaying market-related information by arranging a plurality of regions, each representing a component of a universe, in one of multiple interrelated areas; and
selecting a reference position based upon a user preference for indicating to a user the advantageousness of investing in a particular component of the universe based upon position of the region corresponding to the particular component relative to the reference position.
